(19) United States
(12) Patent Application Publication
(10) Pub. No.: US 2009/0171592 A1
(43) Pub. Date: Jul. 2, 2009

(54) Homology Models of Mammalian Zinc Transporters and Methods of Using Same

(75) Inventors: Dax Fu, Leonia, NJ (US); Min Lu, Lake Bluff, IL (US)

Correspondence Address: BROOKHAVEN SCIENCE ASSOCIATES/;BROOKHAVEN NATIONAL LABORATORY, BLDG. 185 - P.O. BOX 5000, UPTON, NY, 11973, US

(73) Assignee: Brookhaven Science Associates, LLC, Upton, NY (US)

(21) Appl. No.: 12/327,867

(22) Filed: Dec. 4, 2008

Related U.S. Application Data
(63) Continuation-in-part of application No. 12/136,962, filed on Jun. 11, 2008.
(60) Provisional application No. 60/943,419, filed on Jun. 12, 2007.

(51) Int. Cl. G06F 19/00

(52) U.S. Cl. 702/19

(57) ABSTRACT

The present invention is a method of identifying a compound that has a sufficient level of binding with a target site on a mammalian zinc transporter, or a portion thereof. The method comprises (a) providing a homology model of a mammalian zinc transporter, or portion thereof, comprising at least one target site; and (b) employing computational means to evaluate the level of binding of the compound with the target site, or a portion thereof. If a sufficient level of binding is found, then a compound is identified.

### CROSS-REFERENCE TO RELATED APPLICATIONS

This application is a continuation-in-part of U.S. patent application Ser. No. 12/136,962 filed Jun. 11, 2008, which is incorporated herein by reference in its entirety, and which application claims the benefit of U.S. Provisional Application No. 60/943,419, filed Jun. 12, 2007, which is incorporated herein by reference in its entirety.

This invention was made with Government support under contract number DE-AC02-98CH10886, awarded by the U.S. Department of Energy. The Government has certain rights in the invention.

### BACKGROUND OF THE INVENTION

The present invention relates to atomic resolution models of an Escherichia coli membrane transporter, termed YiiP, and more particularly to homology models of human zinc transporters based on YiiP. This invention also relates to methods of using the human homology models to screen and design compounds useful for treating disorders mediated by zinc transporters.

Zinc is essential for cellular growth and differentiation. The total zinc content in a living cell is sustained at sub-millimolar levels, mostly in a protein-bound form. Ligated zinc can serve as catalytic or structural cofactors in a host of biological processes ranging from gene expression to immune functions (Berg et al., Science 271:1081 (1996)). A pool of loosely bound zinc in the brain plays an additional role in modulating neurotransmission (Hirzel et al., Neuron 52:679 (2006)). Pre-synaptic vesicles of glutamatergic neurons and insulin-containing secretory vesicles of pancreatic β-cells are particularly rich in zinc, with concentrations exceeding 1 mM.

While zinc is abundant in some specialized subcellular organelles, abnormally elevated zinc concentrations in the cytoplasm may exert cytotoxic effects. For instance, excessive zinc may contribute to neuronal cell death during brain ischemia and to β-amyloid deposition in Alzheimer's disease (Koh et al., Science 272:1013 (1996); Bush et al., Science 265:1464 (1994); and Lee et al., Proc. Natl. Acad. Sci. U.S.A. 99:7705 (2002)). Thus, free cytoplasmic zinc concentration of a living cell is typically maintained well below the nanomolar level.

Since zinc ions are impermeable to the lipid barrier of biological membranes, zinc transporters play an indispensable role in moving zinc ions across cell membranes. Two families of ubiquitous zinc transporters are involved in zinc acquisition and detoxification. The ZIP family (ZRT, IRT-like protein) facilitates zinc influx into the cytoplasm to provide ample supplies of cellular zinc; whereas the CDF family (Cation Diffusion Facilitator) promotes zinc efflux from the cytoplasm to avoid excessive zinc build-up. These zinc transporters move Zn²⁺ across the otherwise impermeable membrane barriers (Palmiter et al., EMBO J. 14:639 (1995); and Nies et al., J. Ind. Microbiol. 14:186 (1995)). In glutamatergic synapses, a mammalian CDF, termed ZnT-3 (Zinc Transporter-3), is responsible for sequestering cytoplasmic Zn²⁺ into pre-synaptic vesicles (Cole et al., Proc. Natl. Acad. Sci. U.S.A. 96:1716 (1999)). In pancreatic β-cells, yet another mammalian CDF, ZnT-8, stimulates zinc accumulation and insulin secretion (Chimienti et al., J. Cell. Sci. 119:4199 (2006)). Emerging evidence has linked ZnT-8 to the pathogenesis of type-2 diabetes (Sladek et al., Nature 445:881 (2007)).

Three bacterial CDF homologs, YiiP and ZitB from Escherichia coli and CzcD from Ralstonia metallidurans, have been characterized functionally and are related to their mammalian counterparts with 25-30% sequence identity (see FIG. 1 of Lu, et al. (2007) Science 317, 1746-1748, the contents of which are incorporated herein by reference).

YiiP is a homodimer of two 30-kDa integral membrane proteins, each composed of six transmembrane segments (TMs) and a hydrophilic carboxyl terminal domain (CTD) located in the cytoplasm (Wei et al., J. Biol. Chem. 280:33716 (2005)). Metal binding and transport by YiiP have been mapped to strictly conserved D49 and D157 in the transmembrane domain (TMD) with binding affinities for Zn²⁺ and Cd²⁺ in the submicromolar range (Wei et al., J. Biol. Chem. 281:23492 (2006)).

The measured Zn²⁺ binding affinity of YiiP is several orders of magnitude lower than expected for effective Zn²⁺ equilibrium binding from an extremely limited cytoplasmic pool. Further, YiiP transports Zn²⁺ across the membrane at a 30-ms timescale (turnover rate=34 s⁻), differing from many zinc metalloproteins where the timescale for releasing bound Zn²⁺-cofactors is typically hours or even days. It has not been clear how this thermodynamic and kinetic paradox is solved by YiiP, which acquires cytoplasmic Zn⁺ against a thermodynamic gradient, achieves high Zn²⁺ mobility across the membrane, and yet maintains a Zn²⁺ selectivity against similar divalent cations several orders of magnitude more abundant in vivo.

Malfunctions of zinc transporters impair zinc transmembrane movements which are the root cause of many zinc homeostatic disorders. At present, little is known about the structure and molecular mechanism of zinc transporters. Solutions to these and other fundamental questions would provide the basis for rational drug design targeting zinc homeostasis disorders.

### SUMMARY OF THE INVENTION

The present invention relates to crystals of YiiP. The crystals are produced by contacting a YiiP protein with an aqueous solution comprising at least one type of zinc salt; at least one type of polyethylene; and at least one type of detergent; and allowing the crystals to grow. At least one detergent belongs to the maltoside family, including, for example, dodecyl-maltoside, undecyl-maltoside, decyl-maltoside, nonyl-b-D-maltoside, or combinations thereof. Examples of the polyethylene include polyethylene glycols with molecular weights ranging from about 250 to about 5000 KDa. In one embodiment, the aqueous solution further comprises a detergent selected from the group consisting of phospholipid analogues. The aqueous solution can further comprise additional salts. The ratio of salts:detergent:polyethylene in the aqueous solution ranges from about 20:0.1:1 to about 135:2:50.

Three-dimensional structures of YiiP complexed with Zn²⁺ are provided by using the YiiP crystals. The three-dimensional structures are defined by structure coordinates found in Appendix I, or defined by structures with coordinates having a 0.75 Angstrom root mean square deviation from the structure coordinates in Appendix I.

Based on the three-dimensional structure coordinates of YiiP, homology models of mammalian zinc transporters, or portions thereof, are provided. Examples of such homology models include the homology model of mammalian zinc transporter-3 and of mammalian zinc transporter-8.

In one embodiment, the invention relates to a method of identifying a compound that has a sufficient level of binding with a target site on a mammalian zinc transporter. The method comprises (a) providing a homology model of a mammalian zinc transporter, or portion thereof, comprising at least one target site; (b) computationally providing a candidate compound; and (c) computationally evaluating the level of binding of the candidate compound with the target site. If a sufficient level of binding is found, then the compound is identified. An example of a sufficient level of binding is indicated by a dissociation constant of about 10⁻² M or tighter. Included among target sites are zinc binding sites, including Site Z1, Site Z2, Site Z3, and Site Z4 and combinations thereof.

A candidate compound can be computationally provided by several different methods. Examples of such methods include (1) assembling molecular fragments into a candidate compound, (2) designing a candidate compound de novo, (3) modifying a compound known to bind with a target site to form a candidate compound, and (4) screening a database for a candidate compound.

In one embodiment, the identified compound is synthesized. The synthesized compound can further be screened for biological activity.

In one aspect of the invention, a method for evaluating the ability of a candidate compound to bind with a mammalian zinc transporter comprising at least one target site is provided. The method comprises a) constructing a computer model of a target site defined by a mammalian homology model; b) selecting a candidate compound to be evaluated by a method selected from the group consisting of (i) assembling molecular fragments into the candidate compound, (ii) selecting the candidate compound from a small molecule database, (iii) designing the candidate compound de novo, and (iv) modifyng a ligand known to bind to a target site, or a portion thereof, to form the candidate compound; c) employing computational means to perform a fitting program operation between computer models of the candidate compound to be evaluated and the target site in order to provide an energy-minimized configuration of the candidate compound in the target site; and d) evaluating the results of said fitting operation to quantify the association between the candidate compound and the target site.

Until the present invention, the ability to obtain the atomic structure coordinates of YiiP, or any other YiiP related zinc transporter (e.g., CDF transporters), has not been realized. The YiiP structure reveals the overall architecture of a representative zinc membrane transporter thereby yielding insights into the molecular mechanisms of Zn²⁺ binding, selectivity and transport. Active sites in zinc transporters are highly conserved from bacteria to human. Thus, the YiiP structure is used as a structural template to assist in the drug discovery process, including modeling the homologous human zinc transporters and screening for compounds that modulate human homolog zinc transporters thereby leading to the identification of clinically relevant pharmaceuticals useful for treating diseases mediated by zinc transporters.

For a better understanding of the present invention, reference is made to the following description, taken in conjunction with the scope of the invention set forth in the claims.

### BRIEF DESCRIPTION OF THE DRAWINGS

FIG. 1. YiiP with bound Zn²⁺. (a) Stereo diagram of YiiP homodimer viewed from the membrane plane. Zn²⁺ ions are represented as spheres. Transmembrane helixes are numbered 1-6, α-helices and β-strands in CTD are labeled as H1-2 and S1-3, respectively. IL2 is indicated by an arrow. (b) Stereo view from the extracellular side along the membrane normal. Dimerization contacts between IL1 and IL3 are indicated by arrows.

### DETAILED DESCRIPTION OF THE INVENTION

YiiP is a membrane transporter that catalyzes Zn²⁺/H⁺ exchange across the inner membrane of Escherichia coli. YiiP is a homodimer composed of protomer-A and protomer-B. Mammalian homologs of YiiP play a critical role in zinc homeostasis and cell signaling.

### Crystals of YiiP-Zinc Complexes

In one embodiment, the invention provides crystals of a YiiP in complex with zinc.

### Methods of Crystallization of YiiP

In a preferred embodiment, crystals are obtained by the method that follows. An E. coli protein is contacted with an aqueous solution comprising at least one type of zinc salt, at least one type of detergent belonging to the maltoside family, at least one type of polyethylene, and one or more types of additives.

Examples of suitable zinc salts include zinc chloride, zinc sulfate and zinc acetate. Additional salts can be included in the solution, such as, for example, sodium citrate and sodium chloride.

Detergents assist in keeping YiiP soluble in aqueous solution. The preferred detergents belonging to the maltoside family, include, for example, dodecyl-maltoside, undecyl-maltoside, decyl-maltoside and nonyl-b-D-maltoside.

Other detergents can be included in the solution in addition to maltoside detergents, such as, for example, phospholipid analogues that have a phosphocholine headgroup.

Polyethylene functions as a protein precipitant by inducing crystal nucleation and growth. The preferred types of polyethylene include, for example, polyethylene glycols of various molecular weights, ranging from about 250 to about 5000 KDa, preferably ranging from about 400 to about 4000 KDa, can be used.

In a preferred embodiment, the ratio of salts:detergents:polyethylene ranges from about 20:0.1:1 to about 135:2:50.

Additives can also be included in the aqueous solution, such as, for example, inhibitors of protease (e.g., benzamidine), glycerol and carbon diols (e.g., 1,3-propanediol).

Crystals of a YiiP complex can be grown using conventional techniques well-known in the art of protein crystallography, including batch crystallization, liquid bridge, dialysis, vapor diffusion and hanging drop methods (see, e.g., McPherson, Preparation and Analysis of Protein Crystals, 1982, John Wiley, New York; McPherson, 1990, Eur. J. Biochem. 189:1 23; Weber, 1991, Adv. Protein Chem. 41:1 36). Crystals are grown at a suitable temperature as would be known by a skilled artisan. For example, the temperature can range from about 10° C. to about 30° C., preferably about 20° C.

In an especially preferred embodiment, crystals are obtained by the methods provided in the Examples.

### Characterization of the Crystals

A crystal of the invention can be characterized by any of a number of methods known to a skilled artisan. In a preferred embodiment, X-rays are used to determine “structure coordinates” of the protein structure in crystalline forms. The phrase “structure coordinates” refers to mathematical coordinates derived from mathematical equations related to the X-ray diffraction patterns obtained by diffracting X-rays off a crystal. The diffraction data are used to calculate electron density maps of the unit cell comprising the crystal. Such maps are used to establish the positions of the atoms (i.e., the structure coordinates) within the unit cell.

In one embodiment of the present invention, the X-ray structure of YiiP in complex with zinc at 3.8-Angstrom resolution is provided. YiiP structure coordinates are given in Appendix I. Appendix I contains Parts A and B corresponding to protomer-A and protomer-B of the YiiP homodimer.

Those of skill in the art understand that a set of structure coordinates determined by X-ray crystallography contains standard errors. Accordingly, for purposes of this invention, any set of structure coordinates for a YiiP that has a root mean square deviation of less than or equal to about 2.0 Å, more preferably less than about 1.5 Å, most preferably less than about 0.75 Å, when superimposed, using backbone atoms (e.g., N, Cα, C and O), on the structure coordinates listed in Appendix I shall be considered identical with the structure coordinates listed in Appendix I when at least about 50% to about 100% of the backbone atoms of YiiP are included in the superimposition.

The X-rays can be produced in a conventional source (such as a sealed tube or a rotating anode) or using a synchrotron source. Methods of characterization include, but are not limited to, precision photography, oscillation photography, and diffractometer data collection. Methods of X-ray detection include, but are not limited to, photographic film, hot-wire detectors, image plates and CCD cameras. Methods for data reduction and structure determination are embodied in a wide variety of computer programs, including but not limited to, Denzo/Scalepack, CCP4 and X-Plor/CNS. Methods for obtaining the three-dimensional structure of a crystal, as well as atomic structure coordinates, are well known in the art (see, e.g., Ducruix and Giege, 1992, Crystallization of Nucleic Acids and Proteins: A Practical Approach, IRL Press, Oxford, England and McRee, Practical Protein Crystallography, 1993, Academic Press, and references cited therein).

### Structure of YiiP

YiiP is a homodimer composed of protomer-A and protomer-B. Each protomer is composed of 298 residues. The homodimer is held together in a parallel orientation through four Zn²⁺ ions at the interface of cytoplasmic domains, where two transmembrane domains (TMDs) swing out to yield a Y-shaped structure. Each cytoplasmic domain adopts a metallochaperone-like protein fold, while each transmembrane domain features a bundle of six transmembrane helices and a tetrahedral Zn²⁺-binding-site located in a lipid-exposed cavity open to the periplasm.

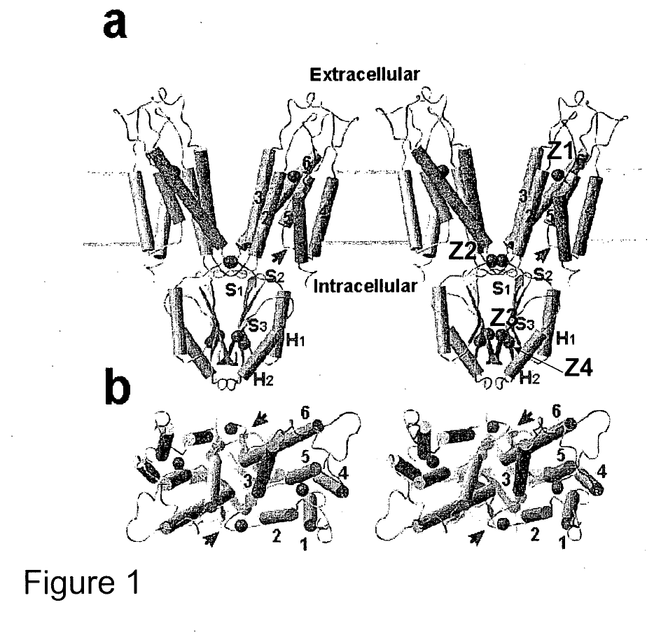

Residues 1-211 of YiiP are folded into the transmembrane domain (FIG. 1 of the present application and FIG. 2a of Lu, et al. (2007)). Each transmembrane domain is composed of six transmembrane (TM) segments (i.e., TM1-6). Adjacent helix pairs in TM1-3 and TM4-6 all align in an antiparallel orientation. See Examples for a more detailed structural description.

### YiiP Binding Sites

Four zinc binding sites have been characterized on YiiP, designated as Z1, Z2, Z3, and Z4. These sites are highly conserved among zinc transporters in the CDF family; that is, these sites in human and bacterial proteins are composed of identical or chemically similar residues.

The Zn²⁺ in site-Z1 is tetracoordinated by highly conserved D45, D49 from TM2, and H153, D157 from TM5 (FIG. 4 of Lu, et al., (2007)). All these residues are essential for Zn²⁺ transport activity.

The Zn²⁺ in site-Z2 binds to an intracellular (IL) loop that connects TM2 and TM3 (i.e., IL1) (FIG. 4 of Lu, et al., (2007)). This loop is semi-conserved and harbors many potential Zn²⁺ ligating residues.

Located within a cleft between two C-terminal domains, sites Z3 and Z4 are bridged by the highly conserved D285 via a bidentate coordination (FIG. 4 of Lu, et al., (2007)). The two Zn²⁺ ions straddle all three β-strands of one subunit and coordinating residues from an α-helix of the neighboring subunit.

The intracellular cavity relating to Site-Z2 is constituted by R11 and its neighboring Zn²⁺-ligating residues, including conserved E79 and E200. Zn²⁺ binding to site-Z2 triggers a protein conformational change that breaches the thin protein barrier between intracellular and extracellular cavity, leading to the movement of Zn²⁺ from site-Z2 to site-Z1 (FIG. 3 of Lu, et al. (2007)).

### Uses of the Crystal Structure of YiiP

YiiP structure coordinates can be used in molecular modeling and design, as described more fully below. An aspect of the present invention encompasses the structure coordinates and other information, e.g., amino acid sequence, connectivity tables, vector-based representations, temperature factors, etc., used to generate the three-dimensional structures for use in the software programs described below and other software programs as would be known by a skilled artisan.

The invention encompasses machine readable media embedded with the three-dimensional structures of the models described herein, or with portions thereof. As used herein, “machine readable medium” refers to any medium that can be read and accessed directly by a computer or scanner. Such media include, but are not limited to: magnetic storage media, such as, e.g., floppy discs, hard disc storage medium and magnetic tape; optical storage media, such as, e.g., optical discs and CD-ROM; electrical storage media, such as, e.g., RAM and ROM; and hybrids of these categories such as magnetic/optical storage media. Such media further include paper on which is recorded a representation of the atomic structure coordinates, e.g., Cartesian coordinates, that can be read by a scanning device and converted into a three-dimensional structure with an OCR.

A variety of data storage structures are available to a skilled artisan for creating a computer readable medium having recorded thereon the atomic structure coordinates of the invention, or portions thereof, and/or X-ray diffraction data. The choice of the data storage structure will generally be based on the means chosen to access the stored information. In addition, a variety of data processor programs and formats can be used to store the sequence and X-ray data information on a computer readable medium. Such formats include, but are not limited to, Protein Data Bank (“PDB”) format (Research Collaboratory for Structural Bioinformatics; http://www.rcsb.org/pdb/docs/format/pdbguide2.2/guide2.2_frame.html); Cambridge Crystallographic Data Centre format (http://www.ccdc.cam.ac.uk/support/csd_doc/volume3/z 323.html); Structure-data (“SD”) file format (MDL Information Systems, Inc.; Dalby et al., 1992, J. Chem. Inf. Comp. Sci. 32:244-255), and line-notation, e.g., as used in SMILES (Weininger, 1988, J. Chem. Inf. Comp. Sci. 28:31-36). Methods of converting between various formats read by different computer software will be readily apparent to those of skill in the art, e.g., BABEL (v. 1.06, Walters & Stahl, © 1992, 1993, 1994; http://www.brunel.ac.uk/departments/chem/babel.htm). All format representations of the polypeptide coordinates described herein, or portions thereof, are contemplated by the present invention.

By providing computer readable medium having stored thereon the structure coordinates of the invention, one of skill in the art can routinely access the coordinates of the invention, or portions thereof, and related information for use in modeling and design programs, described in detail below.

While Cartesian coordinates are preferred representations of the three-dimensional structures, those of skill in the art will readily recognize that other representations of the structure are also useful. Therefore, three-dimensional structures of polypeptides, as discussed herein, include not only the Cartesian coordinate representation, but also all alternative representations of the three-dimensional distribution of atoms. For example, atomic coordinates may be represented as a Z-matrix, wherein a first atom of the protein is chosen, a second atom is placed at a defined distance from the first atom, a third atom is placed at a defined distance from the second atom so that it makes a defined angle with the first atom. Each subsequent atom is placed at a defined distance from a previously placed atom with a specified angle with respect to the third atom, and at a specified torsion angle with respect to a fourth atom. Atomic coordinates can also be represented as a Patterson function, wherein all interatomic vectors are drawn and are then placed with their tails at the origin. This representation is particularly useful for locating heavy atoms in a unit cell. In addition, atomic coordinates may be represented as a series of vectors having magnitude and direction and drawn from a chosen origin to each atom in the polypeptide structure. Furthermore, the positions of atoms in a three-dimensional structure may be represented as fractions of the unit cell (fractional coordinates), or in spherical polar coordinates.

Additional information, such as, e.g., thermal parameters, which measures the motion of each atom in the structure; chain identifiers, which identify the particular chain of a multi-chain protein in which an atom is located; and connectivity information, which indicates to which atoms a particular atom is bonded, is also useful for representing a three-dimensional molecular structure.

### Mammalian Homology Models

In certain embodiments of the invention, a YiiP crystal structure is used as a template to assist in constructing homology models of mammalian (e.g., human) zinc membrane transporters. A mammalian zinc membrane transporter homology model is a three-dimensional structural atomic resolution model based on the YiiP sequence and a YiiP crystal structure. Examples of mammalian homology models include models of the zinc transporter-3 and zinc transporter-8.

### Sequence Alignment

Structural similarity of YiiP with a particular mammalian zinc transporter protein can be inferred from sequence similarity, which can be determined by one of ordinary skill through visual inspection and comparison of the sequences. Alternatively, structural similarity can be inferred through the use of well-known alignment software programs such as, for example, CLUSTAL (Wilbur et al., Proc. Natl. Acad. Sci. USA, 80:726-730 (1983)) and CLUSTALW (Thompson et al., “CLUSTAL W: improving the sensitivity of progressive multiple sequence alignment through sequence weighting, positions-specific gap penalties and weight matrix choice” Nucleic Acids Research, 22:4673-4680 (1994)) and BLAST® (Altschul et al., J. Mol. Biol., 215(3):403-10 (1990)). CLUSTAL W is available at www.ebi.ac.uk/clustalw/; BLAST® is available at www.ncbi.nlm.nih.gov/BLAST/. A residue within a first protein or nucleic acid sequence corresponds to a residue within a second protein or nucleic acid sequence if the two residues occupy the same position when the first and second sequences are aligned.

FIG. 1 of Lu, et al. (2007) shows the sequence alignment of YiiP and representative members of the CDF protein family. Any other mammalian zinc transporter sequence can also be aligned with YiiP, as would be known to a skilled artisan.

### Secondary Structure Assignments

Secondary structures are regularly repeating local structures stabilized by hydrogen bonds. The most common examples are the alpha helix and beta sheet.

In one embodiment, secondary structures of the mammalian protein can be based on YiiP crystal structure coordinates. The structures coordinates are provided in Appendix I and include structures that have a root mean square deviation of backbone atoms of less than about 2.0 Å, more preferably less than about 1.5 Å, and most preferably less than about 0.75 Å, when superimposed on the structure coordinates of Appendix I.

In another embodiment, secondary structures of the mammalian protein can be predicted by using prediction software. An example of such software is the PHD program (Rost, B. & Sander, C. “Prediction of protein secondary structure at better than 70% Accuracy” Journal of Molecular Biology 232:584-599 (1993)). PHD is available at www.predictprotein.org. Once a secondary structure prediction is obtained, it is compared to the YiiP structure to ensure that the mammalian homology model has a similar makeup of secondary structural components.

FIG. 1 of Lu, et al. (2007) also shows the secondary structures (labeled as TM1-6, H1-2, and S1-3) of YiiP and representative members of the CDF protein family. The secondary structures of any other mammalian zinc transporter can also be obtained by the aforementioned methods.

### Homology Modeling

Any type of homology modeling technique can be used in the present invention. Three major classes of homology model generation methods are typically used, i.e., fragment assembly, segment matching, and satisfaction of spatial restraints. (See Baker et al., “Protein structure prediction and structural genomics” Science 294(5540):93-96 (2001).)

### Fragment Assembly

The fragment assembly method of homology modeling relies on the assembly of a complete model from conserved structural fragments identified in closely related solved structures. For example, a modeling study of serine proteases in mammals identified a sharp distinction between “core” structural regions conserved in all experimental structures in the class, and variable regions typically located in the loops where the majority of the sequence differences were localized. Thus unsolved proteins could be modeled by first constructing the conserved core and then substituting variable regions from other proteins in the set of solved structures. (See Greer J., “Comparative model-building of the mammalian serine proteases” J. Mol. Biol., 153(4):1027-42 (1981).) Different implementations of this method differ mainly in the way they deal with regions that are not conserved or that lack a template. (See Wallner et al., “All are not equal: A benchmark of different homology modeling programs” Protein Science 14:1315-1327 (2005).)

### Segment Matching

The segment-matching method divides the target into a series of short segments, each of which is matched to its own template fitted from the Protein Data Bank. Thus, sequence alignment is done over segments rather than over the entire protein. Selection of the template for each segment is based on sequence similarity, comparisons of alpha carbon coordinates, and predicted steric conflicts arising from the van der Waals radii of the divergent atoms between target and template. (See Levitt M., “Accurate modeling of protein conformation by automatic segment matching” J. Mol. Biol. 226(2):507-33 (1992).)

### Satisfaction of Spatial Restraints

In the satisfaction of spatial restraints method, one or more target-template alignments are used to construct a set of geometrical criteria that are then converted to probability density functions for each restraint. Restraints applied to the main protein internal coordinates (e.g., protein backbone distances and dihedral angles) serve as the basis for a global optimization procedure that originally used conjugate gradient energy minimization to iteratively refine the positions of all heavy atoms in the protein. (See Sali et al., “Comparative protein modelling by satisfaction of spatial restraints” J. Mol. Biol. 234(3):779-815 (1993).)

This method can be applied to loop modeling which can be extremely difficult due to the high flexibility of loops in proteins in aqueous solution. (See Fiser et. al, “ModLoop: automated modeling of loops in protein structures” Biomformatics 19(18):2500-1 (2003).) Also, this method can be used with electron density maps derived from cryoelectron microscopy studies which provide low-resolution information that is not usually itself sufficient to generate atomic-resolution structural models. (See Topf et al., “Refinement of protein structures by iterative comparative modeling and CryoEM density fitting” J. Mol. Biol. 357(5):1655-68 (2006).) To address the problem of inaccuracies in initial target-template sequence alignment, an iterative procedure can be used to further refine the alignment on the basis of the initial structural fit. (See John et al., “Comparative protein structure modeling by iterative alignment, model building and model assessment” Nucleic Acids Res. 31(14):3982-92 (2003).)

The most commonly used software in spatial restraint-based modeling is MODELLER and a database called ModBase has been established for reliable models generated with it. (See Pieper et al., “MODBASE, a database of annotated comparative protein structure models, and associated resources” Nucleic Acids Res 32, D217-D222 (2004).) MODELLER is available at www.salilab.org/modeller/.

### Model Assessment

Assessment of homology models is typically performed with two methods: statistical potentials or physics-based energy calculations. Both methods produce an estimate of the energy (or an energy-like analog) for the model or models being assessed; independent criteria are needed to determine acceptable cutoffs.

Statistical potentials are empirical methods based on observed residue-residue contact frequencies among proteins of known structure in the PDB. They assign a probability or energy score to each possible pairwise interaction between amino acids and combine these pairwise interaction scores into a single score for the entire model. Some such methods can also produce a residue-by-residue assessment that identifies poorly scoring regions within the model, though the model may have a reasonable score overall. These methods emphasize the hydrophobic core and solvent-exposed polar amino acids often present in globular proteins. Examples of popular statistical potentials include Prosa and DOPE. Statistical potentials are more computationally efficient than energy calculations. (See Sippl M J, “Recognition of Errors in Three-Dimensional Structures of Proteins” Proteins 17:355-62 (1993).)

In a preferred embodiment of the present invention, a homology model is evaluated by a statistical potential program such as, for example, PROCHECK available at www.biochem.ucl.ac.uk/roman/procheck/procheck.html.

Physics-based energy calculations aim to capture the interatomic interactions that are physically responsible for protein stability in solution, especially van der Waals and electrostatic interactions. These calculations are performed using a molecular mechanics force field; proteins are normally too large even for semi-empirical quantum mechanics-based calculations. The use of these methods is based on the energy landscape hypothesis of protein folding which predicts that a protein's native state is also its energy minimum. Such methods usually employ implicit salvation, which provides a continuous approximation of a solvent bath for a single protein molecule without necessitating the explicit representation of individual solvent molecules. A force field specifically constructed for model assessment is known as the Effective Force Field (EFF) and is based on atomic parameters from CHARMM. (See Lazaridis et al. “Discrimination of the native from misfolded protein models with an energy function including implicit solvation” J. Mol. Biol. 288:477-487 (1999a).)

One newer method for model assessment relies on machine learning techniques such as, for example, neural nets, which may be trained to assess the structure directly or to form a consensus among multiple statistical and energy-based methods. Recent results using support vector machine regression on a jury of more traditional assessment methods outperformed common statistical, energy-based, and machine learning methods. (Eramian et al., “A composite score for predicting errors in protein structure models” Protein Science 15:1653-1666 (2006).)

A homology model can also be evaluated by experimental assessment. Based on the model, point mutations are made and their effects on protein structures and functions are predicted. Biochemical and biophysical experiments are followed to examine mutation-structure and mutation-function correlations. If the experimental results are consistent with the model predictions, then the proposed model is likely correct. For example, if the model predicts residue X is involved in metal binding, a mutation of residue X is expected to disrupt metal binding. A direct binding measurement of metal ions to mutant X tests this prediction.

### Use of the Mammalian Homology Models in Drug Discovery

In one embodiment of the invention, homology models are used to rationally design compounds that modulate the activity of mammalian (e.g., human) homolog zinc transporters.

The design of compounds that bind to target sites generally involves consideration of two factors. First, a compound must be capable of physically and structurally associating with a target site. Non-covalent molecular interactions important in this association include hydrogen bonding, van der Waals interactions, hydrophobic interactions and electrostatic interactions.

Second, a compound must be able to assume a conformation that allows it to associate with the target site directly. Although certain portions of a compound will not directly participate in these associations, those portions of a compound may still influence the overall conformation of the molecule. This, in turn, may have a significant impact on potency. Such conformational requirements include, for example, the overall three-dimensional structure and orientation of a compound in relation to all or a portion of a target site and/or the spacing between functional groups of a compound comprising several chemical entities that directly interact with a target site.

### Computer Simulation Techniques

Computer fitting of candidate compounds (i.e., compounds to be tested) to target sites can predict how well a compound will bind to the target site based on the shape and chemical structure of the candidate compound. (See, for example, Bugg et al., Scientific American December 1993 pp. 92-98; and West et al., TIPS 16:67 74 (1995).)

Such computational evaluation avoids the unnecessary synthesis of compounds that are unlikely to bind mammalian zinc transporters with adequate affinity. Only those candidate compounds that are indicated by computer modeling to bind the target site with sufficient binding energy (i.e., a binding energy corresponding to a dissociation constant with the target site on the order of about 10⁻² M or tighter) are synthesized and tested for their ability to bind to mammalian zinc transporters using binding assays or mammalian zinc transporters function assays known to those of skill in the art.

Models of target sites are developed using the homology model coordinates in conjunction with computer-modeling techniques. The target site models characterize the three-dimensional topography of target site surface, as well as factors including van der Waals contacts, electrostatic interactions, and hydrogen-bonding opportunities. The target sites of the homology models include the Zn⁺² binding sites as described above and in the Examples.

Computer simulation techniques are then used to map interaction positions of functional groups (e.g., protons, hydroxyl groups, amine groups, divalent cations, aromatic and aliphatic functional groups, amide groups, alcohol groups, etc.) that are designed to interact with a target site on the homology model. These interaction positions are designed into a candidate compound with the expectation that the candidate compound will specifically bind to the target site. The interaction positions can be particularly designed into pharmacophores of candidate compounds. A pharmacophore is an ensemble of steric and electronic features that is necessary to ensure the optimal supramolecular interactions with a target site (e.g., a binding site) and to trigger or block a biological response. The ability of the candidate compounds to interact with a target site through any or all of the available types of chemical interactions, including hydrogen bonding, van der Waals, electrostatic, and covalent interactions are considered. However, compounds that interact with a target site through non-covalent mechanisms are preferred.

A candidate compound is computationally designed and/or evaluated by means of a series of steps in which various chemical entities or fragments are screened and selected for their ability to associate with individual target sites. Several different processes are available to screen chemical entities or fragments for their ability to associate (e.g., bind) with a target site, as discussed below.

The process can begin by visual inspection of, for example, a target site on a computer screen based on a mammalian zinc transporter's coordinates, or a subset of those coordinates. Selected candidate fragments or chemical entities can then be positioned in a variety of orientations or “docked” within a target site of the mammalian zinc transporter.

Docking may be accomplished using software such as Quanta (Molecular Simulations, Inc., San Diego, Calif.) and Sybyl (Tripos, Inc. St. Louis, Mo.) followed by energy minimization and molecular dynamics with standard molecular mechanics force fields such as, for example, CHARMM (Molecular Simulations, Inc., San Diego, Calif.) and AMBER (University of California at San Francisco).

Other examples of specialized computer programs which can assist in the process of selecting candidate fragments or chemical entities include but are not limited to: GRID (Goodford, P. J., “A Computational Procedure for Determining Energetically Favorable Binding Sites on Biologically Important Macromolecules,” J. Med. Chem., 28:849-857 (1985)) (GRID is available from Oxford University, Oxford, UK); MCSS (Miranker, A. and M. Karplus, “Functionality Maps of Binding Sites: A Multiple Copy Simultaneous Search Method,” Proteins: Structure, Function and Genetics 11:29-34 (1991)) (MCSS is available from Molecular Simulations, Inc., San Diego, Calif.); AUTODOCK (Goodsell, D. S, and A. J. Olsen, “Automated Docking of Substrates to Proteins by Simulated Annealing,” Proteins: Structure, Function, and Genetic, 8:195-202 (1990)) (AUTODOCK is available from Scripps Research Institute, La Jolla, Calif.); DOCK (Kuntz et al. “A Geometric Approach to Macromolecule-Ligand Interactions,” J. Mol. Biol. 161:269-288 (1982)) (DOCK is available from University of California, San Francisco, Calif.); CERIUS II (available from Molecular Simulations, Inc., San Diego, Calif.); and Flexx (Rarey et al. J. Mol. Biol. 261:470-489 (1996)).

After selecting suitable candidate chemical entities or fragments, they can be computationally assembled into a single compound. Assembly may proceed by visual inspection of the relationship of the fragments to each other or a three-dimensional image of the fragments in relation to the target site displayed on a computer screen. Visual inspection may be followed by manual model building using software such as the Quanta or Sybyl programs described above.

Other examples of software programs that can aid one skilled in the art in connecting the individual chemical entities or fragments include, but are not limited to: CAVEAT (Bartlett et al. “CAVEAT: A Program to Facilitate the Structure-Derived Design of Biologically Active Molecules” in “Molecular Recognition in Chemical and Biological Problems,” Special Publ., Royal Chem. Soc., 78:182-196 (1989)); CAVEAT is available from the University of California, Berkeley, Calif.; 3-D Database systems such as MACCS-3D (MDL Information Systems, San Leandro, Calif.); Martin, Y. C., “3-D Database Searching in Drug Design,” J. Med. Chem. 35:2145-2154 (1992)); and HOOK (available from Molecular Simulations Inc., San Diego, Calif.).

As an alternative to building candidate compounds from individual fragments or chemical entities, they may be designed de novo using the structure of a mammalian zinc transporter target site, optionally, including information from co-factor(s) or known activators or inhibitor(s) that bind to the target site. De novo design can be effected by programs including, but not limited to LUDI (Bohm, H. J., “The Computer Program LUDI: A New Method for the De Novo Design of Enzyme Inhibitors”, J. Comp. Aid. Molec. Design, 6:61-78 (1992)) (LUDI is available from Molecular Simulations, Inc., San Diego, Calif.); LEGEND (Nishibata, Y., and Itai, A., Tetrahedron 47:8985 (1991) (LEGEND is available from Molecular Simulations, San Diego, Calif.); and LeapFrog (available from Tripos Associates, St. Louis, Mo.).

Candidate compounds can also be provided by screening libraries of compounds available from a number of sources or can be derived by combinatorial chemistry approaches known in the art. Such libraries include, but are not limited to, the available Chemical Director, Maybridge, and natural product collections. In one embodiment of the invention, libraries of compounds with known or predicted structures can be tested for docking to the mammalian zinc transporter structures of the invention.

Instead of finding new compounds which bind to the target sites, in one embodiment, known ligands are altered through the use of the molecular modeling and design techniques. Examples of known ligands include zinc and organic channel blockers for cationic channels, such as, for example, calcium channels and potassium channels. This may be carried out by docking the structure of the known mammalian zinc transporter ligand on a homology model structure and modifying the shape and charge distribution of the ligand to optimize the binding interactions with the mammalian zinc transporter. The modified ligand can be synthesized or obtained from a library and tested for its binding affinity and/or functional effects. The ligand can be designed into a compound.

Additional molecular modeling techniques also may be employed in accordance with the invention. See, for example, Cohen et al. “Molecular Modeling Software and Methods for Medicinal Chemistry,” J. Med. Chem. 33:883-894 (1990); Hubbard, Roderick E., “Can drugs be designed?” Curr. Opin. Biotechnol. 8:696-700 (1997); and Afshar et al. “Structure-Based and Combinatorial Search for New RNA-Binding Drugs,” Curr. Opin. Biotechnol. 10:59-63 (1999).

Evaluation of the Efficiency with which a Candidate Compound Binds to Target Sites

Following candidate compound design or selection, the efficiency with which a candidate compound binds to a mammalian zinc transporter can be tested using computational evaluation. Specific computer software is available in the art to evaluate compound deformation energy and electrostatic interactions. Examples of programs designed for such uses include, but are not limited to, Gaussian 92, revision C (Frisch, M. J., Gaussian, Inc., Pittsburgh, Pa. (1992)); AMBER, version 4.0 (Kollman, P. A., University of California at San Francisco (1994)); QUANTA/CHARMM (Molecular Simulations, Inc., San Diego, Calif. (1994)); and Insight II/Discover (Biosym Technologies Inc., San Diego, Calif. (1994)). These programs can be run, using, e.g., a Silicon Graphics workstation, Indigo, 02-R10000 or IBM RISC/6000 workstation model 550. Other hardware and software combinations can be used to carry out the above described functions, and are known to those of skill in the art.

A sufficient level of binding is indicated by a dissociation constant of about 10⁻¹ M, more preferably of about 10⁻² M, most preferably of about 10⁻³ M or tighter. The smaller the dissociation constant, the tighter the binding will be.

Additionally, the efficiency with which a candidate compound binds to a mammalian zinc transporter can be optimized using the aforementioned software. For example, a candidate compound can be optimized so that in its bound state it would preferably lack repulsive electrostatic interaction with its target site. These repulsive electrostatic interactions include repulsive charge-charge, dipole-dipole, and charge-dipole interactions. It is preferred that the sum of all electrostatic interactions between the candidate compound and a mammalian zinc transporter, when the candidate compound is bound, make a neutral or favorable contribution to the binding enthalpy. Such optimization features can be designed into the compound.

### Optional Improvement(s) of a Candidate Compound

Once a candidate compound has been optimally selected or designed, as described above, substitutions can then be made in some of its atoms or side groups to improve or modify its binding properties. Generally, initial substitutions are conservative in that the replacement group will have approximately the same size, shape, hydrophobicity and charge as the original group. Components known in the art to alter conformation should be avoided in making substitutions. Substituted candidates can be analyzed for efficiency of fit to mammalian zinc transporters using the same methods described above.

### Screening for Biological Activity

Once a compound has been identified using any of the methods described above, it can be screened for biological activity. Any one of a number of assays of mammalian zinc transporter function known to those of skill in the art can be used. These include, but are not limited to, facilitation of zinc influx into, or zinc efflux out of, a cell or its intracellular zinc-containing membrane compartments.

### Direct Binding Assays

Compound interaction with mammalian zinc transporters also can be evaluated using direct binding assays including isothermal calorimetry titrations, filter binding assays, such as are known to those skilled in the art. Binding assays can be modified to evaluate candidate compounds that competitively inhibit the binding of known mammalian zinc transporter binding compounds such as zinc. These and other assays are described in International Publication WO 00/69391, the entire disclosure of which is incorporated by reference in its entirety for all purposes.

### Pharmaceutical Compositions and Therapeutic Uses Thereof

In certain embodiments, compounds identified by the methods of the invention can modulate mammalian zinc transporter activity. Such compounds can act either as an antagonist or as agonist of mammalian zinc transporter activity. These compounds can be useful in treatment of mammalian zinc transporter-mediated disorders. The invention also provides pharmaceutical compositions comprising a therapeutically effective amount of such compounds together with a pharmaceutically acceptable diluent, carrier, solubilizer, emulsifier, preservative and/or adjuvant.

In a preferred embodiment, compounds which modulate the activity of ZnT-8 (also known as SLC30A8) are provided, as described in the Examples. ZnT-8 has been identified as a major drug target for type-2 diabetes (Sladek et al., (2007) Nature 445:811-5; Scott, et al. (2007) Science 316:1341-1345; Saxena, et al. (2007) Science 316: 1331-1336).

The following examples are set forth so that the invention may be understood more fully. The examples are for illustrative purposes only and are not to be construed as limiting this invention in any manner.

### EXAMPLES

### Materials and Methods

Crystal preparation and data collection. YiiP was over-expressed and purified as described in Chao et al., J. Biol. Chem. 279:17173 (2004). Crystals were grown at 20° C. by mixing equal volumes of protein (10 mg/ml) and a reservoir solution containing 100 mM Na-citrate (pH 6.0), 5 mM ZnSO₄, 3 mM Fos-Choline-12, 100 mM NaCl, 200 mM (NH₄)₂SO₄, 10% (v/v) PEG400, 15-20% (w/v) PEG2000, 4% (w/v) benzamidine, 10% (w/v) glycerol and 4% (v/v) 1,3-propanediol. Crystals grew to a full size of about 150 μm×50 μm×20 μm within 2 months and belong to space group P222₁ (a=106.7 Å, b=110.8 Å, c=130.7 Å). Prior to data collection, crystals were flash-frozen into liquid nitrogen. All x-ray diffraction data were collected at the beamline X25 of the National Synchrotron Light Source at Brookhaven National Laboratory (BNL). Heavy metal derivatives were prepared by incubating crystals with 2 to 50 mM heavy metal compounds for 2 to 24 hours at 20° C. Mercury soaking converted the space group to P2₁ (a=105.4 Å, b=131.0 Å, c=115.5 Å, β=92.7°). Only a small fraction of YiiP crystals were of data collection quality, thus more than 3,000 crystals had to be screened. Among the 102 datasets collected, 31 were used for data merging and structure analysis. X-ray diffraction data were indexed, integrated and scaled using the HKL2000 suite (Otwinowski et al., Methods Enzymol. 276:307 (1997)). Subsequent data analyses were performed using programs in the CCP4 suite (Acta Crystallogr D50:760 (1994)) unless otherwise stated.

Structure determination and model refinement. For the KAu(CN)₂ dataset, initial heavy atom sites were found by manual inspection of difference Patterson maps and refined using the program SHARP (De La Fortelle et al., Methods Enzymol 276:472 (1997)). Heavy atom positions for other heavy metal derivatives were determined by difference Fourier analysis and refined with SHARP. The resulting MIRAS phases were employed to locate zinc binding sites by difference anomalous Fourier analysis. MIRAS and zinc SAD phases were combined, and then improved by density modification and phase extension to 3.8 Å. Two-fold non-crystallographic symmetry averaging was not used because its application deteriorated the electron density. Additional mercury sites were located by difference anomalous Fourier analysis using molecular replacement phases from a model in P2₁ space group, which was obtained using the program PHASER (R. J. Read, Acta Crystallogr. D57:1373 (2001)). Inter-crystal averaging and temperature factor sharpening were followed to further improve the experimental maps. Maximum-likelihood structure refinement for space group P222, was carried out using the program REFMAC (Murshudov et al., Acta Crystallogr. D53:240 (1997)). Ramachandran analysis indicated that 514 residues are in the favorable region, 51 in the generously allowed region, and 7 in the disallowed region. All graphic presentations were prepared using the programs RIBBONS (M. Carson, Methods Enzymol. 277:493 (1987)) and PYMOL (DeLano Scientific).

### YiiP Structure Determination.

Following an extensive screening for crystallization conditions, YiiP crystals were obtained. Although several metal ions improved the stability of YiiP in detergent micelles, only Zn²⁺ yielded crystals of diffraction quality. X-ray diffraction data were obtained from native and twelve heavy atom derivative crystals for multiple isomorphous replacement and anomalous scattering phasing (Table 1). The resulting experimental maps to 3.8 angstroms revealed two YiiP protomers per asymmetric unit, but only one of the protomers could be readily traced as a continuous polypeptide chain (Lu, et al. (2007), supplemental materials). Protein sequence registration was established by utilizing electron densities for bulky side chains, eleven major heavy metal binding sites and an experimental topology model (Wei et al., J. Biol. Chem. 280:33716 (2005).) Subsequent structure refinement and model rebuilding resulted in a structural model with R_{cry} and R_{free} of 32.2% and 32.9%, respectively. The final model contained all but the first 4 and the last 10 residues of the 300 amino acids in each protomer. The limited resolution of the diffraction data precluded unambiguous placement of all protein side chains. Only structural features that are clearly shown in electron density maps are discussed.

TABLE I
Statistics for x-ray data analysis and structure refinement

| | Resolution | Observations | Completeness | Rsym^{a} | | Ph.P^{b} | Rc^{c} | Site |
|---|---|---|---|---|---|---|---|---|
| Crystal | (Å) | Overall/Unique | (%) | (%) | I/σ | Iso/Ano | Iso/Ano | # |
| Native | 30-3.80 | 105529/15534 | 97.3(91.9) | 12.9(42.9) | 13.3(1.9) | NA | NA | NA |
| KAu(CN)₂ | 30-4.00 | 118633/13204 | 96.2(81.8) | 9.7(44.9) | 17.1(2.6) | 1.57/0.49 | 0.69/0.96 | 2 |
| AuThio | 30-4.25 | 45259/10946 | 99.2(98.2) | 12.0(51.5) | 10.0(2.1) | 1.00/0.32 | 0.82/0.99 | 2 |
| K₂PtCl₄ | 30-4.25 | 77142/11044 | 97.3(86.6) | 10.1(39.0) | 13.9(2.0) | 1.00/0.39 | 0.85/0.99 | 8 |
| Au + Pt | 30-4.30 | 69749/11072 | 99.3(99.0) | 13.4(61.4) | 10.6(1.9) | 0.80/N.A. | 0.92/N.A. | 9 |
| CsCl | 30-4.20 | 83094/11677 | 99.2(99.6) | 14.5(51.0) | 11.8(2.9) | 0.76/N.A. | 0.81/N.A. | 16 |
| KI | 30-4.20 | 70581/11756 | 99.4(99.6) | 14.2(56.5) | 11.6(2.4) | 0.67/N.A. | 0.77/N.A. | 16 |
| Au + Cs | 30-4.15 | 59495/11727 | 95.3(81.1) | 9.2(38.3) | 13.5(2.4) | 1.45/0.45 | 0.63/0.96 | 11 |
| Pt + Cs | 30-4.10 | 169432/12180 | 97.0(87.0) | 11.7(52.7) | 17.1(2.1) | 0.93/N.A. | 0.80/N.A. | 18 |
| Au + PtCs | 30-4.30 | 88254/9310 | 83.5(55.2) | 10.8(45.6) | 13.8(2.0) | 1.12/N.A. | 0.76/N.A. | 18 |
| K₂IrCl₆ | 30-5.50 | 16564/4665 | 86.3(85.8) | 5.6(42.7) | 19.5(2.2) | 0.67/N.A. | 0.88/N.A. | 11 |
| W | 30-5.65 | 18150/4753 | 95.2(95.1) | 7.6(55.6) | 14.7(2.7) | 0.65/N.A. | 0.81/N.A. | 7 |
| Zn SAD | 30-4.15 | 112098/12165 | 99.2(98.6) | 15.5(60.3) | 13.0(2.7) | N.A./1.06 | N.A./0.84 | 7 |
| Hg SAD | 30-4.20 | 45494/17212 | 73.1(38.7) | 9.1(29.9) | 7.4(2.2) | N.A./0.84 | N.A./0.87 | 12 |

Overall MIRAS figure of merit^{d} (12.00-4.00 Å): 0.64/0.71 (acentric/centric)
Reflections used in refinement (12.00-3.80 Å) 14484/775 (overall/test set)
R_{cry}^{e} = 32.22% R_{free}^{f} = 32.93%
<B> = 43.68 Å² (zinc), <B> = 143.10 Å² (ordered protomer), <B> = 258.44 Å² (disordered protomer)
Values in the brackets are in the last resolution bin.
Wavelength: 1.28 Å for Zn SAD, 1.00 Å for all others.
^{a}R_{sym} = Σ|I − <I>|/ΣI, where I is the observed intensity of symmetry-related reflections.
^{b}Ph.P (phasing power) = Fₕ/E, where Fₕ is the rms isomorphous/anomalous difference and E is the rms residual lack-of-closure.
^{c}R_{c}(iso) = Σ(||F_{PH} − F_{P}| − |F_{H(calc)}||)/Σ(|F_{PH} − F_{P}|), where F_{PH} and F_{P} are structure factors for derivative and native data respectively. R_{c}(iso) is valid for centric reflections only. R_{c}(ano) = Σ(||ΔF_{PH(obs)}−| − |ΔF_{PH(cacl)}||)/Σ|ΔF_{PH(obs)}|, where ΔF_{PH(obs)} and F_{PH(calc)} are the observed and calculated structure factor differences between Bijvoet pairs, respectively.
^{d}Figure of merit = weighted mean value of the cosine of phase error.
^{e}R_{cry} = Σ(||F_{obs}| − |F_{cacl}||)/Σ(|F_{obs}|), where F_{obs} and F_{calc} are the observed and calculated native structure factors, respectively.
^{f}R_{free} is the same as R_{cry} but calculated with 5% of the reflections excluded from structure refinement.
Abbreviations:
Au, KAu(CN)₂;
Pt, K₂PtCl₄;
Cs, CsCl;
Hg, ethyl mercury phosphate;
AuThio, AuThiomalate;
W, (NH₄)₂WS₄;
SAD, single wavelength anomalous dispersion;
MIRAS, multiple isomorphous replacement and anomalous scattering.

### Overall YiiP Structure

The physiological YiiP homodimer is arranged around a two-fold crystallographic axis oriented perpendicular to the membrane plane (FIG. 1, and see FIG. 2 of Lu, et al. (2007)). Two bands of aromatic residues on the protein surface suggest the boundaries of the membrane-embedded region. The carboxyl terminal domains (CTDs) protrude into the cytoplasm and juxtapose each other in parallel to form the major dimerization contact. At the CTD and transmembrane domain (TMD) juncture, intracellular loops form another dimerization contact, from which two TMDs swing outwards and plunge into the membrane with a 60-degree crossing angle. Viewed from the membrane plane, this dimeric structure exhibits a Y-shaped architecture with each arm formed by a TMD while the bulk of the Y-stem is provided by the associated CTDs. Given this orientation within the membrane, the void space observed between two TMDs is likely to be filled with phospholipids in vivo. Viewed from extracellular side down the two-fold axis (FIG. 1b), the lower protein density between TMDs is consistent with a distinctive constriction of electron density at the dimer interface of a YiiP projection map obtained in the native E. coli lipid bilayer (Wei et al., J. Biol. Chem. 279:39251 (2004)).

Residues from 1 to 211 of YiiP are folded into the TMD. Adjacent helix pairs in TM1-3 and TM4-6 all align in an antiparallel orientation. TM1-3 and TM 4-6 are joined together to form a compact six-helix-bundle by three additional pairs of antiparallel interactions, TM1-TM4, TM2-TM5 and TM3-TM6. Interdigitations of helices in YiiP all fall into the “knobs-into-holes” type of contact and the crossing angles between helices are within the optimal range. A lack of helix-breaking proline residues in the middle of transmembrane helices suggests a rather limited conformational flexibility in the TMD. Threading across the membrane six times, TMs are linked together by three extracellular loops, EL1-3, and two intracellular loops, IL1-2. An additional intracellular loop IL3 connects TM6 to the CTD. IL1 extends toward the dimer interface and forms a dimerization contact with IL3 from the neighboring subunit. Related by the two-fold symmetry, IL3 and IL1 of the neighboring subunit form another dimerization contact. IL2 makes a connection between TM4 and TM5 with only four residues from position 141 to 144. The TM arrangements in the crystal structure are consistent with the YiiP topology established in the native membrane by site-directed labeling (Wei et al., J. Biol. Chem. 280:33716 (2005)).

The length of TM5 is conspicuously short, accounting for three and half helical turns from residue V147 to M159. This short helix is largely sequestered in the center of the six-helix bundle, thereby giving rise to one extracellular and one intracellular cavity on either side of the membrane. Surrounded by extended TMs and ELs, the extracellular cavity is accessible from the bulk solvent and exposed to the membrane outer leaflet. This cavity spans nearly half of the membrane thickness and anchors a Zn²⁺ ion near the bottom. The intracellular cavity is confined between the TMD and CTD. The extended IL1 and IL3 partially obstruct lateral solvent accessibility to the cavity along the cytoplasmic face of the membrane, while the short IL2 makes room for full solvent access from the distal side of the dimer interface. The dome of the intracellular cavity is capped by three highly conserved residues at the amino-end of TM5, V147, R148 and A149. Directly underneath the dome lie the conserved R11 from TM1, E79 from TM3, E200 from TM6 and a variable Q145 from IL2. The two cavities point towards each other within the membrane but no connecting channel exists between them.

Residues from 212 to 300 of CTD are folded into an open α-β domain with two α-helices (H1-2) aligned on one side and a three-stranded mixed β-sheet (S1-3) on the other side (FIG. 1 and see Figure S3 of Lu, et al. (2007)). A hairpin loop connects S1 and S2, bringing a short edge of the β-sheet close to IL1 and the amino end of TM1. S2, H2 and S3 form a right-handed βαβ motif with the two β-strands and the connecting α-helix aligned approximately in parallel.

The CTD exhibits an overall structural similarity with the copper metallochaperone Hah1 (Wernimont et al., Nat. Struct. Biol. 7:766 (2000)), which contains two pap motifs linked together by a hairpin loop corresponding to the S1-S2 connection in the CTD. Although there is a lack of sequence homology between CTD and HahI, which suggests that they arose independently from convergent evolution, to a first approximation, the topologies of the CTD αβ-βαβ and the Hah1 βαβ-βαβ folds are identical except that the first β-strand in Hah1 loops out as IL3 in YiiP. The αβ-βα structural core of CTD from H1 to H2 can be superimposed onto the equivalent portion of Hah1 with a root-mean-square deviation of 1.8 Å for 42 common Cα positions.

In YiiP, two opposing faces of twisted 1-sheets form the dimer interface while their opposite faces are shielded from the solvent by H1 and H2. The 1-sheet-stacking involved in CTD dimerization is distinct from the helix-helix contact involved in the docking of Cu⁺-loaded-Hah1 onto its target domain (Wernimont et al., Nat. Struct. Biol. 7:766 (2000)). All known structures of metallochaperones and their target domains share a common metallochaperone-like fold (Rosenzweig et al., Curr. Opin. Chem. Biol. 4:140 (2000); Finney et al., Science 300:931 (2003)), although their protein sequences are poorly conserved. The fold of CTD places it into the same structural category as a possible Zn²⁺ receiving domain, while the solvent-exposed helix-surface in CTD may afford a docking site for a putative Zn²⁺ metallochaperone.

### Zinc Binding Sites

Anomalous difference Fourier maps of native crystals were computed using experimental phases and diffraction data collected at the zinc edge. Four strong anomalous peaks indicate the presence of four Zn²⁺-populated sites (designated as Z1, Z2, Z3 and Z4) in each protomer (FIGS. 1 and 4, Lu, et al. (2007)). Calorimetric titrations of EDTA pre-treated YiiP yielded 2.6 Zn²⁺ stoichiometry units per YiiP protomer, corresponding to two Zn⁺-binding sites with an overall dissociation constant (K_{d}) of 0.24 μM, and a low affinity component (K_{d}=145 μM) (Wei et al, J. Biol. Chem. 280:33716 (2005)). The free Zn²⁺ concentration in the crystallization solution is buffered by citrate within the micromolar range (T. E. Furia, Handbook of Food Additives (CRC press, ed. 2, 1980)), thus only the two high affinity sites (K_{d}=0.24 μM) may have been mostly saturated to become visible in electron density maps. Anomalous peak heights from site Z1 to Z4 increase progressively from 4.6, 5.8 to 9.6 and 9.6 σ, revealing a rank order of Zn²⁺ occupancy consistent with Z1 and Z2 as being EDTA-chelatable and Z3 and Z4 as EDTA-resistant. The EDTA-resistant sites did not respond to calorimetric titrations, but they are likely to exist because prolonged EDTA-chelation denatured YiiP (Chao et al., J. Biol. Chem. 279:17173 (2004)).

The Zn²⁺ in site-Z1 is tetracoordinated by highly conserved D45, D49 from TM2, and H153, D157 from TM5. All these residues are essential for Zn²⁺ transport activity (Wei et al., J. Biol. Chem. 281:23492 (2006)). The tetrahedral coordination is a preferred geometry for Zn²⁺ binding. Consistently, metal binding to cysteine substitutes of D49 and D157 is selective for Zn²⁺ and its isomorphous Cd²⁺, but discriminative against Ca²⁺, Mg⁺, Ni²⁺, Co²⁺ and Mn²⁺, all of which favor different coordination geometries (Wei et al., J. Biol. Chem. 280:33716 (2005); Wei et al., J. Biol. Chem. 281:23492 (2006)). Site-Z1 is located near the bottom of the extracellular cavity and exposed to aliphatic lipid chains. Hydrophobic mismatch between packing lipids and the irregular cavity surface may create water-filled packing defects in the lipid matrix between two YiiP protomers. The two Z1 sites in a YiiP homodimer face towards each other but are separated by 35 Å. Disulfide cross-linking between sites Z1 was observed, although the extent of inter-subunit crosslinking was marginal (˜10%) as compared to the intra-subunit D49C-D157C cross-linking (Wei et al., J. Biol. Chem. 281: 23492 (2006)). The inter-subunit cross-link could be interpreted either as a proximity of two D49/D157 sites across the dimer interface or as false positive. The YiiP structure supports the latter.

The Zn²⁺ in site Z2 binds to the intracellular loop that connects TM2 and TM3 (IL1). This loop is semi-conserved and harbors many potential Zn²⁺ ligating residues. Side chains in this region are not well resolved, but the primary Zn²⁺ coordination shell appears to involve D68, S72 and H75. A water molecule or another coordination residue may complete the tetrahedral coordinate geometry. Site-Z2 is involved in subunit dimerization. Site-Z2 is adjacent to a cluster of highly conserved residues at the dimer interface, including S72 and F73 from IL1, K77 and L81 from the amino-end of TM3, and L205, L206, D207 from IL3 of the neighboring subunit. These residues make direct hydrogen bonds and Van der Waals interactions across the dimer interface.

Located within a cleft between two CTDs, sites Z3 and Z4 appear to be bridged by the highly conserved D285 via a bidentate coordination. The two Zn²⁺ ions align nearly perpendicular to the long axis of the β-sheet, thereby straddling all three β-strands of one subunit and coordinating residues from H2 of the neighboring subunit. Unambiguous placement of side chains was not feasible in the β-sheet region, but it is evident that the binuclear Zn²⁺ binding establishes a coordination network at least involving H232 from S1, H283 and D285 from S3, and H261 from H2 of the neighboring subunit. Furthermore, a two-fold related binuclear Zn²⁺ cluster is located on the opposite side of the CTD dimer interface. The positioning of two Zn²⁺ clusters and their resistance to EDTA chelation suggest a structural role that they play in strengthening the dimerization contact.

### Interpretation of Existing Mutagenesis Data.

The structure of YiiP provides a model for rationalizing mutagenic results from CzcD and ZitB (Anton et al., J. Bacteriol. 186:7499 (2004)). In TM1, a CzcD E31K mutation abolished the transport activity. The YiiP equivalent of CzcD E31 is a membrane-embedded K27, which seems to be stabilized by D45 of site-Z1. In CzcD, a H49 is in place of YiiP D45 which is incapable of stabilizing the positive charge on CzcD E31K. In TM2, mutations of CzcD H49, CzcD D53, ZitB H53 and ZitB D57 resulted in functionless proteins, because their YiiP equivalents (D45 and D49) contribute to site-Z1. In TM4, ZitB N135 is required for function, and its YiiP equivalent (T128) wedges between TM1 and TM5 into a hydrophobic pocket near site-Z1. In TM5, mutations of CzcD E154, CzcD D158, ZitB H159 and ZitB D163 abolished transport activity, and these residues in YiiP (H153 and D157) contribute to site-Z1. Near the amino-end of TM6, a strictly conserved YiiP D179 is involved in crystal contacts, obscuring its functional implications. In addition, ZitB E214A, CzcD H237R and CzcD H280 impaired transport activity. Their YiiP equivalents are all involved in dimerization contacts. The emerging pattern of structure-function correlation is the clustering of loss-of-function mutations around site-Z1 and the dimer interface. Although two TMDs in the YiiP structure swing out as separated transmembrane units, dimerization seems essential for YiiP function.

### Mechanistic Implications

Zn²⁺ rivals Mg²⁺ among the most densely charged cations. Water coordination can diffuse dense charges on Zn²⁺, thereby reducing the energetic cost of Zn²⁺ diffusion within two cavities that collectively penetrate more than two thirds of the membrane thickness from opposite membrane surfaces. Similar water-filled cavities have been observed in the transmembrane domain of the potassium channel KcsA (Doyle et al., Science 280:69 (1998)) and the sodium/proton antiporter NhaA (Hunte et al., Nature 435:1197 (2005)). The tetrahedral Zn²⁺ binding site (site-Z1) near the bottom of the extracellular cavity is separated from a cluster of conserved residues located near the dome of the intracellular cavity. Among them., a highly conserved R11 can act as a Zn²⁺ ligand when its guanidinium group is unprotonated (Di Costanzo et al., Proteins 65:637 (2006)). R11 and its neighboring Zn²⁺-ligating residues, probably including conserved E79 and E200, contribute to Zn²⁺ binding site-Z2. As proposed in the following scheme, Zn²⁺ binding to site-Z2 (Z2-Zn²⁺) triggers a protein conformational change that breaches the thin protein barrier between intracellular and extracellular cavities, leading to the movement of Zn²⁺ from intracellular cavity site-Z2 to extracellular cavity site-Z1.

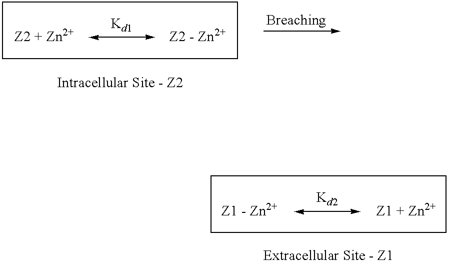

Breaching the physical barrier between site-Z1 and Z2 may be made possible by unwinding one or two helical turns at the amino-end of TM5 without bending or significant tilting of TMs within a rigid structural framework of TMD. The absence of Zn²⁺ anomalous signals at site-Z2 is consistent with the low-affinity binding component (K_{d1}=145 μM) observed previously. On the other hand, a K_{d2} of 0.24 μM has been attributed to site-Z1, giving rise to an estimate of 604-fold affinity difference between site-Z1 and Z2. (Wei et al., J. Biol. Chem. 280: 33716 (2005).) This steep thermodynamic gradient between two narrowly spaced Zn²⁺ binding sites would drive an almost irreversible movement of Zn²⁺ from site-Z2 to Z1, which is situated near the carboxyl end of TM5. The negative helix dipole moment of TM5, in combination with a rich density of negative charges from D45, D49 and D157, act as an electrostatic sink to attract the highly charged Zn²⁺ across a breaching point between the two cavities. Zn²⁺ movement down a steep thermodynamic gradient would offset the energetic cost of its membrane crossing, while securing the Zn²⁺ into a low dielectric environment of site-Z1 would in turn have significant structural consequences, such as refolding of TM5 to occlude the inter-cavity connection as observed in the current x-ray structure.

The release of Zn²⁺ from the tetrahedral site-Z may be facilitated by H⁺ displacement, as suggested by stoichiometric coupling between Cd²⁺ binding and YiiP deprotonation (Chao et al., J. Biol. Chem. 279:17173 (2004)). Further, Zn²⁺ transport by the homologous ZitB is coupled obligatorily to proton antiport with a 1:1 zinc-to-proton ratio (Chao et al., J. Biol. Chem. 279:12043 (2004)). In this respect, H153 and R11 in YiiP serve as proton acceptors at site-Z1 and Z2, respectively. There is a significant difference in proton-binding affinities between H153 and R11, which drives a proton movement from site-Z1 to site-Z2 in favor of the higher affinity binding of R11. Protonation/deprotonation controls the ionization state of site-Z2 and Z1, switching off/on Zn²⁺ binding so that Zn²⁺ and H⁺ can move in opposite directions. A 1:1 Zn²⁺-for-H⁺ stoichiometric exchange results in a net charge moving against the transmembrane potential in vivo.

The estimated K_{d1} value (K_{d1}=145 μM) for the intracellular-facing site-Z2 is consistent with the observed Michaelis-Menten constant (Kₘ=310 μM) of Zn²⁺ transport by YiiP (Wei et al., J. Biol. Chem. 280:33716 (2005)). The low-affinity can be effective for Zn²⁺ binding in vivo most likely because YiiP acquires Zn²⁺ from a putative Zn²⁺-loaded metallochaperone. Superimposition of known Hah1 and CTD dimeric structures allowed docking of a Hah1 monomer onto the CTD surface. The docked metallochaperone fits snugly between TMD and CTD with the putative Zn²⁺ transfer site pointing directly into the intracellular cavity. Many mammalian CDFs (ZnTs) have a long IL2 that harbors eukaryotic-specific histidine-rich motifs (Paulsen et al., J. Membr. Biol. 156:99 (1997)). These additional ZnT residues are positioned proximal to site-P and involved in Zn²⁺ transfer.

Compounds which Modulate the Activity of ZnT-8

Sequence alignment of YiiP and ZnT-8 is given in FIG. 1 of Lu, et al. (2007) as is the putative secondary structure prediction. Inputting the YiiP structure coordinates (Appendix I), YiiP-ZnT-8 sequence alignment and the ZnT-8 secondary structure prediction into the software program MODELLER yielded the homology model of ZnT-8. Based on the homology model, compounds that interact with ZnT-8 are provided by methods described above. It has been established that (1) ZnT-8 can be over-expressed in a number of cell lines; and (2) over-expression of ZnT-8 can increase insulin secretion from the host cells (F. Chimienti et al., J. Cell. Sci. 119, 4199 (2006)). Candidate drug compounds are applied to the cell lines to test their effects on insulin secretion. The compounds that produce desired effects (such as a significant increase of insulin secretion) serve as the drugs leads for further optimizations by methods described above.

### Site Z1 and Site Z2

The tetrahedral coordination geometry of site-Z1 confers metal selectivity of zinc transport. This selective Zn²⁺ binding site is located at the extracellular lipid-headgroup region of the membrane, reminiscent of the positioning of selectivity filters for K⁺ in the potassium channel KcsA (Doyle et al., Science 280:69 (1998)) and for glycerol in the quaglyceroporin GlpF (Fu et al., Science 290:481 (2000)). On the other hand, the lipid exposure of site-Z1 represents a novel feature distinguishing YiiP from all known membrane channels and transporters that move cations along a sealed protein-lined pathway (Doyle et al., Science 280:69 (1998); Hunte et al., Nature 435:1197 (2005); Miyazawa et al., Nature 423:949 (2003); Chang et al., Science 282:2220 (1998); Toyoshima et al., Nature 405:647 (2000); Lunin of al., Nature 440:833 (2006); Eshaghi et al., Science 313:354 (2006); Yamashita et al., Nature 437:215 (2005)). The proposed site-Z2 has eluded molecular identification due to its low Zn²⁺ binding affinity, which however will dominate the kinetic response to Zn²⁺ concentrations in vitro. The observed kinetic behavior of YiiP can be approximated by a single-site, alternating-access model (Chao et al., J. Biol. Chem. 279:12043 (2004)), but such a single-site-based model will have difficulties in explaining a difference of more than three orders of magnitude between the Kₘ (Kₘ=310 μM) of YiiP transport and K_{d2} (K_{d2}=0.24 μM) of Zn²⁺-binding to site-Z1 (Wei et al., J. Biol. Chem. 281:23492 (2006)). Without wishing to be bound by a mechanism, it is believed that large affinity differences between site-Z1 and Z2 can impose reversely orientated Zn²⁺/H⁺ affinity gradients to drive a stoichiometric Zn²⁺/H⁺ exchange between site-Z1 and site-Z2. Conformational changes associated with each step in Zn²⁺/H⁺ antiport would reshape the zinc coordination geometry during the transport cycle.

APPENDIX I
PART A

| REMARK | YiiP protomer-A coordinates | | | |
|---|---|---|---|---|
| REMARK | Written by O version 8.0.5 | | | |
| REMARK | Fri Feb 2 11:16:17 2007 | | | |
| CRYST1 | 106.660 110.839 130.662 90.00 90.00 90.00 | | | |
| ORIGX1 | 1.000000 | 0.000000 | 0.000000 | 0.00000 |
| ORIGX2 | 0.000000 | 1.000000 | 0.000000 | 0.00000 |
| ORIGX3 | 0.000000 | 0.000000 | 1.000000 | 0.00000 |
| SCALE1 | 0.009376 | 0.000000 | 0.000000 | 0.00000 |
| SCALE2 | 0.000000 | 0.009022 | 0.000000 | 0.00000 |
| SCALE3 | 0.000000 | 0.000000 | 0.007653 | 0.00000 |

| | | | | | | | | | | | |
|---|---|---|---|---|---|---|---|---|---|---|---|
| ATOM | 1 | N | TYR | A | 5 | 13.894 | −17.285 | 48.917 | 1.00 | 100.00 | 7 |
| ATOM | 2 | CA | TYR | A | 5 | 14.385 | −15.897 | 49.183 | 1.00 | 100.00 | 6 |
| ATOM | 3 | CB | TYR | A | 5 | 13.808 | −15.369 | 50.525 | 1.00 | 100.00 | 6 |
| ATOM | 4 | CG | TYR | A | 5 | 14.730 | −15.425 | 51.768 | 1.00 | 100.00 | 6 |
| ATOM | 5 | CD1 | TYR | A | 5 | 14.906 | −16.618 | 52.512 | 1.00 | 100.00 | 6 |
| ATOM | 6 | CE1 | TYR | A | 5 | 15.754 | −16.654 | 53.648 | 1.00 | 100.00 | 6 |
| ATOM | 7 | CZ | TYR | A | 5 | 16.419 | −15.480 | 54.052 | 1.00 | 100.00 | 6 |
| ATOM | 8 | OH | TYR | A | 5 | 17.246 | −15.493 | 55.156 | 1.00 | 100.00 | 8 |
| ATOM | 9 | CE2 | TYR | A | 5 | 16.252 | −14.287 | 53.344 | 1.00 | 100.00 | 6 |
| ATOM | 10 | CD2 | TYR | A | 5 | 15.409 | −14.266 | 52.212 | 1.00 | 100.00 | 6 |
| ATOM | 11 | C | TYR | A | 5 | 15.927 | −15.759 | 49.116 | 1.00 | 100.00 | 6 |
| ATOM | 12 | O | TYR | A | 5 | 16.430 | −14.792 | 48.538 | 1.00 | 100.00 | 8 |
| ATOM | 13 | N | GLY | A | 6 | 16.651 | −16.741 | 49.679 | 1.00 | 100.00 | 7 |
| ATOM | 14 | CA | GLY | A | 6 | 18.096 | −16.635 | 49.981 | 1.00 | 100.00 | 6 |
| ATOM | 15 | C | GLY | A | 6 | 19.004 | −17.810 | 49.657 | 1.00 | 100.00 | 6 |
| ATOM | 16 | O | GLY | A | 6 | 20.139 | −17.880 | 50.134 | 1.00 | 100.00 | 8 |
| ATOM | 17 | N | ARG | A | 7 | 18.480 | −18.733 | 48.857 | 1.00 | 100.00 | 7 |
| ATOM | 18 | CA | ARG | A | 7 | 19.261 | −19.760 | 48.155 | 1.00 | 100.00 | 6 |
| ATOM | 19 | CB | ARG | A | 7 | 18.289 | −20.748 | 47.477 | 1.00 | 100.00 | 6 |
| ATOM | 20 | CG | ARG | A | 7 | 18.902 | −22.073 | 47.011 | 1.00 | 100.00 | 6 |
| ATOM | 21 | CD | ARG | A | 7 | 19.410 | −22.896 | 48.190 | 1.00 | 100.00 | 6 |
| ATOM | 22 | NE | ARG | A | 7 | 20.336 | −23.944 | 47.766 | 1.00 | 100.00 | 7 |
| ATOM | 23 | CZ | ARG | A | 7 | 21.222 | −24.539 | 48.566 | 1.00 | 100.00 | 6 |
| ATOM | 24 | NH1 | ARG | A | 7 | 21.321 | −24.189 | 49.849 | 1.00 | 100.00 | 7 |
| ATOM | 25 | NH2 | ARG | A | 7 | 22.019 | −25.487 | 48.078 | 1.00 | 100.00 | 7 |
| ATOM | 26 | C | ARG | A | 7 | 20.185 | −19.098 | 47.103 | 1.00 | 100.00 | 6 |
| ATOM | 27 | O | ARG | A | 7 | 21.383 | −19.439 | 46.960 | 1.00 | 100.00 | 8 |
| ATOM | 28 | N | LEU | A | 8 | 19.593 | −18.155 | 46.370 | 1.00 | 100.00 | 7 |
| ATOM | 29 | CA | LEU | A | 8 | 20.310 | −17.277 | 45.456 | 1.00 | 100.00 | 6 |
| ATOM | 30 | CB | LEU | A | 8 | 19.803 | −17.442 | 44.005 | 1.00 | 100.00 | 6 |
| ATOM | 31 | CG | LEU | A | 8 | 19.859 | −18.752 | 43.191 | 1.00 | 100.00 | 6 |
| ATOM | 32 | CD1 | LEU | A | 8 | 21.239 | −19.436 | 43.244 | 1.00 | 100.00 | 6 |
| ATOM | 33 | CD2 | LEU | A | 8 | 18.734 | −19.716 | 43.587 | 1.00 | 100.00 | 6 |
| ATOM | 34 | C | LEU | A | 8 | 20.171 | −15.812 | 45.923 | 1.00 | 100.00 | 6 |
| ATOM | 35 | O | LEU | A | 8 | 21.130 | −15.241 | 46.454 | 1.00 | 100.00 | 8 |
| ATOM | 36 | N | VAL | A | 9 | 18.963 | −15.245 | 45.779 | 1.00 | 100.00 | 7 |
| ATOM | 37 | CA | VAL | A | 9 | 18.723 | −13.781 | 45.847 | 1.00 | 100.00 | 6 |
| ATOM | 38 | CB | VAL | A | 9 | 17.380 | −13.394 | 45.064 | 1.00 | 100.00 | 6 |
| ATOM | 39 | CG1 | VAL | A | 9 | 16.145 | −14.100 | 45.639 | 1.00 | 100.00 | 6 |
| ATOM | 40 | CG2 | VAL | A | 9 | 17.180 | −11.876 | 44.926 | 1.00 | 100.00 | 6 |
| ATOM | 41 | C | VAL | A | 9 | 18.930 | −13.063 | 47.234 | 1.00 | 100.00 | 6 |
| ATOM | 42 | O | VAL | A | 9 | 19.016 | −11.829 | 47.276 | 1.00 | 100.00 | 8 |
| ATOM | 43 | N | SER | A | 10 | 19.063 | −13.823 | 48.332 | 1.00 | 100.00 | 7 |
| ATOM | 44 | CA | SER | A | 10 | 19.336 | −13.244 | 49.683 | 1.00 | 100.00 | 6 |
| ATOM | 45 | CB | SER | A | 10 | 18.017 | −12.984 | 50.457 | 1.00 | 100.00 | 6 |
| ATOM | 46 | OG | SER | A | 10 | 18.193 | −12.305 | 51.701 | 1.00 | 100.00 | 8 |
| ATOM | 47 | C | SER | A | 10 | 20.399 | −13.996 | 50.556 | 1.00 | 100.00 | 6 |
| ATOM | 48 | O | SER | A | 10 | 20.713 | −15.176 | 50.310 | 1.00 | 100.00 | 8 |
| ATOM | 49 | N | ARG | A | 11 | 20.916 | −13.292 | 51.579 | 1.00 | 100.00 | 7 |
| ATOM | 50 | CA | ARG | A | 11 | 22.102 | −13.674 | 52.365 | 1.00 | 100.00 | 6 |
| ATOM | 51 | CB | ARG | A | 11 | 22.273 | −12.742 | 53.573 | 1.00 | 100.00 | 6 |
| ATOM | 52 | CG | ARG | A | 11 | 23.079 | −11.500 | 53.305 | 1.00 | 100.00 | 6 |
| ATOM | 53 | CD | ARG | A | 11 | 22.876 | −10.448 | 54.374 | 1.00 | 100.00 | 6 |
| ATOM | 54 | NE | ARG | A | 11 | 21.612 | −9.712 | 54.196 | 1.00 | 100.00 | 7 |
| ATOM | 55 | CZ | ARG | A | 11 | 21.048 | −8.871 | 55.083 | 1.00 | 100.00 | 6 |
| ATOM | 56 | NH1 | ARG | A | 11 | 21.633 | −8.635 | 56.250 | 1.00 | 100.00 | 7 |
| ATOM | 57 | NH2 | ARG | A | 11 | 19.887 | −8.258 | 54.810 | 1.00 | 100.00 | 7 |
| ATOM | 58 | C | ARG | A | 11 | 22.149 | −15.122 | 52.815 | 1.00 | 100.00 | 6 |
| ATOM | 59 | O | ARG | A | 11 | 23.182 | −15.588 | 53.272 | 1.00 | 100.00 | 8 |
| ATOM | 60 | N | ALA | A | 12 | 21.043 | −15.840 | 52.658 | 1.00 | 100.00 | 7 |
| ATOM | 61 | CA | ALA | A | 12 | 20.903 | −17.159 | 53.263 | 1.00 | 100.00 | 6 |
| ATOM | 62 | CB | ALA | A | 12 | 19.643 | −17.869 | 52.760 | 1.00 | 100.00 | 6 |
| ATOM | 63 | C | ALA | A | 12 | 22.129 | −18.030 | 53.065 | 1.00 | 100.00 | 6 |
| ATOM | 64 | O | ALA | A | 12 | 22.788 | −18.444 | 54.025 | 1.00 | 100.00 | 8 |
| ATOM | 65 | N | ALA | A | 13 | 22.445 | −18.298 | 51.812 | 1.00 | 100.00 | 7 |
| ATOM | 66 | CA | ALA | A | 13 | 23.551 | −19.191 | 51.523 | 1.00 | 100.00 | 6 |
| ATOM | 67 | CB | ALA | A | 13 | 23.095 | −20.300 | 50.572 | 1.00 | 100.00 | 6 |
| ATOM | 68 | C | ALA | A | 13 | 24.714 | −18.410 | 50.932 | 1.00 | 100.00 | 6 |
| ATOM | 69 | O | ALA | A | 13 | 25.865 | −18.515 | 51.389 | 1.00 | 100.00 | 8 |
| ATOM | 70 | N | ILE | A | 14 | 24.383 | −17.632 | 49.905 | 1.00 | 100.00 | 7 |
| ATOM | 71 | CA | ILE | A | 14 | 25.328 | −16.773 | 49.222 | 1.00 | 100.00 | 6 |
| ATOM | 72 | CB | ILE | A | 14 | 24.584 | −15.761 | 48.296 | 1.00 | 100.00 | 6 |
| ATOM | 73 | CG1 | ILE | A | 14 | 25.472 | −14.568 | 47.909 | 1.00 | 100.00 | 6 |
| ATOM | 74 | CD1 | ILE | A | 14 | 26.273 | −14.791 | 46.649 | 1.00 | 100.00 | 6 |
| ATOM | 75 | CG2 | ILE | A | 14 | 23.282 | −15.301 | 48.935 | 1.00 | 100.00 | 6 |
| ATOM | 76 | C | ILE | A | 14 | 26.237 | −16.092 | 50.241 | 1.00 | 100.00 | 6 |
| ATOM | 77 | O | ILE | A | 14 | 27.460 | −16.163 | 50.124 | 1.00 | 100.00 | 8 |
| ATOM | 78 | N | ALA | A | 15 | 25.632 | −15.484 | 51.259 | 1.00 | 100.00 | 7 |
| ATOM | 79 | CA | ALA | A | 15 | 26.381 | −14.793 | 52.298 | 1.00 | 100.00 | 6 |
| ATOM | 80 | CB | ALA | A | 15 | 25.545 | −13.698 | 52.927 | 1.00 | 100.00 | 6 |
| ATOM | 81 | C | ALA | A | 15 | 26.905 | −15.752 | 53.358 | 1.00 | 100.00 | 6 |
| ATOM | 82 | O | ALA | A | 15 | 27.642 | −15.343 | 54.253 | 1.00 | 100.00 | 8 |
| ATOM | 83 | N | ALA | A | 16 | 26.556 | −17.029 | 53.240 | 1.00 | 100.00 | 7 |
| ATOM | 84 | CA | ALA | A | 16 | 27.004 | −18.005 | 54.214 | 1.00 | 100.00 | 6 |
| ATOM | 85 | CB | ALA | A | 16 | 26.041 | −19.192 | 54.287 | 1.00 | 100.00 | 6 |
| ATOM | 86 | C | ALA | A | 16 | 28.428 | −18.469 | 53.947 | 1.00 | 100.00 | 6 |
| ATOM | 87 | O | ALA | A | 16 | 29.140 | −18.823 | 54.868 | 1.00 | 100.00 | 8 |
| ATOM | 88 | N | THR | A | 17 | 28.867 | −18.423 | 52.701 | 1.00 | 100.00 | 7 |
| ATOM | 89 | CA | THR | A | 17 | 30.028 | −19.222 | 52.310 | 1.00 | 100.00 | 6 |
| ATOM | 90 | CB | THR | A | 17 | 29.641 | −20.201 | 51.176 | 1.00 | 100.00 | 6 |
| ATOM | 91 | OG1 | THR | A | 17 | 30.819 | −20.809 | 50.631 | 1.00 | 100.00 | 8 |
| ATOM | 92 | CG2 | THR | A | 17 | 28.894 | −19.478 | 50.069 | 1.00 | 100.00 | 6 |
| ATOM | 93 | C | THR | A | 17 | 31.365 | −18.544 | 51.966 | 1.00 | 100.00 | 6 |
| ATOM | 94 | O | THR | A | 17 | 32.403 | −19.002 | 52.417 | 1.00 | 100.00 | 8 |
| ATOM | 95 | N | ALA | A | 18 | 31.340 | −17.499 | 51.144 | 1.00 | 100.00 | 7 |
| ATOM | 96 | CA | ALA | A | 18 | 32.559 | −16.892 | 50.587 | 1.00 | 100.00 | 6 |
| ATOM | 97 | CB | ALA | A | 18 | 32.256 | −15.555 | 49.965 | 1.00 | 100.00 | 6 |
| ATOM | 98 | C | ALA | A | 18 | 33.709 | −16.773 | 51.575 | 1.00 | 100.00 | 6 |
| ATOM | 99 | O | ALA | A | 18 | 34.466 | −17.724 | 51.744 | 1.00 | 100.00 | 8 |
| ATOM | 100 | N | MET | A | 19 | 33.848 | −15.619 | 52.225 | 1.00 | 100.00 | 7 |
| ATOM | 101 | CA | MET | A | 19 | 34.843 | −15.490 | 53.298 | 1.00 | 100.00 | 6 |
| ATOM | 102 | CB | MET | A | 19 | 35.075 | −14.022 | 53.707 | 1.00 | 100.00 | 6 |
| ATOM | 103 | CG | MET | A | 19 | 36.182 | −13.866 | 54.787 | 1.00 | 100.00 | 6 |
| ATOM | 104 | SD | MET | A | 19 | 37.239 | −12.391 | 54.779 | 1.00 | 100.00 | 16 |
| ATOM | 105 | CE | MET | A | 19 | 37.324 | −12.072 | 53.018 | 1.00 | 100.00 | 6 |
| ATOM | 106 | C | MET | A | 19 | 34.503 | −16.394 | 54.510 | 1.00 | 100.00 | 6 |
| ATOM | 107 | O | MET | A | 19 | 34.865 | −16.108 | 55.670 | 1.00 | 100.00 | 8 |
| ATOM | 108 | N | ALA | A | 20 | 33.791 | −17.481 | 54.216 | 1.00 | 100.00 | 7 |
| ATOM | 109 | CA | ALA | A | 20 | 33.554 | −18.558 | 55.163 | 1.00 | 100.00 | 6 |
| ATOM | 110 | CB | ALA | A | 20 | 32.073 | −18.685 | 55.476 | 1.00 | 100.00 | 6 |
| ATOM | 111 | C | ALA | A | 20 | 34.077 | −19.814 | 54.494 | 1.00 | 100.00 | 6 |
| ATOM | 112 | O | ALA | A | 20 | 33.587 | −20.921 | 54.737 | 1.00 | 100.00 | 8 |
| ATOM | 113 | N | SER | A | 21 | 35.070 | −19.609 | 53.632 | 1.00 | 100.00 | 7 |
| ATOM | 114 | CA | SER | A | 21 | 35.663 | −20.667 | 52.845 | 1.00 | 100.00 | 6 |
| ATOM | 115 | CB | SER | A | 21 | 34.611 | −21.683 | 52.404 | 1.00 | 100.00 | 6 |
| ATOM | 116 | OG | SER | A | 21 | 33.448 | −21.023 | 51.948 | 1.00 | 100.00 | 8 |
| ATOM | 117 | C | SER | A | 21 | 36.358 | −20.098 | 51.636 | 1.00 | 100.00 | 6 |
| ATOM | 118 | O | SER | A | 21 | 36.802 | −20.843 | 50.771 | 1.00 | 100.00 | 8 |
| ATOM | 119 | N | LEU | A | 22 | 36.434 | −18.777 | 51.547 | 1.00 | 100.00 | 7 |
| ATOM | 120 | CA | LEU | A | 22 | 37.374 | −18.189 | 50.612 | 1.00 | 100.00 | 6 |
| ATOM | 121 | CB | LEU | A | 22 | 37.146 | −16.682 | 50.401 | 1.00 | 100.00 | 6 |
| ATOM | 122 | CG | LEU | A | 22 | 38.156 | −15.690 | 49.741 | 1.00 | 100.00 | 6 |
| ATOM | 123 | CD1 | LEU | A | 22 | 38.870 | −14.817 | 50.760 | 1.00 | 100.00 | 6 |
| ATOM | 124 | CD2 | LEU | A | 22 | 39.190 | −16.283 | 48.783 | 1.00 | 100.00 | 6 |
| ATOM | 125 | C | LEU | A | 22 | 38.667 | −18.421 | 51.314 | 1.00 | 100.00 | 6 |
| ATOM | 126 | O | LEU | A | 22 | 39.716 | −18.579 | 50.696 | 1.00 | 100.00 | 8 |
| ATOM | 127 | N | LEU | A | 23 | 38.575 | −18.480 | 52.629 | 1.00 | 100.00 | 7 |
| ATOM | 128 | CA | LEU | A | 23 | 39.768 | −18.547 | 53.401 | 1.00 | 100.00 | 6 |
| ATOM | 129 | CB | LEU | A | 23 | 39.713 | −17.503 | 54.496 | 1.00 | 100.00 | 6 |
| ATOM | 130 | CG | LEU | A | 23 | 39.796 | −16.098 | 53.903 | 1.00 | 100.00 | 6 |
| ATOM | 131 | CD1 | LEU | A | 23 | 39.425 | −15.051 | 54.907 | 1.00 | 100.00 | 6 |
| ATOM | 132 | CD2 | LEU | A | 23 | 41.192 | −15.836 | 53.352 | 1.00 | 100.00 | 6 |
| ATOM | 133 | C | LEU | A | 23 | 40.004 | −19.940 | 53.918 | 1.00 | 100.00 | 6 |
| ATOM | 134 | O | LEU | A | 23 | 41.157 | −20.341 | 54.134 | 1.00 | 100.00 | 8 |
| ATOM | 135 | N | LEU | A | 24 | 38.917 | −20.691 | 54.066 | 1.00 | 100.00 | 7 |
| ATOM | 136 | CA | LEU | A | 24 | 39.009 | −22.094 | 54.473 | 1.00 | 100.00 | 6 |
| ATOM | 137 | CB | LEU | A | 24 | 37.624 | −22.665 | 54.794 | 1.00 | 100.00 | 6 |
| ATOM | 138 | CG | LEU | A | 24 | 37.046 | −22.447 | 56.196 | 1.00 | 100.00 | 6 |
| ATOM | 139 | CD1 | LEU | A | 24 | 36.772 | −20.971 | 56.448 | 1.00 | 100.00 | 6 |
| ATOM | 140 | CD2 | LEU | A | 24 | 35.770 | −23.278 | 56.392 | 1.00 | 100.00 | 6 |
| ATOM | 141 | C | LEU | A | 24 | 39.727 | −22.982 | 53.442 | 1.00 | 100.00 | 6 |
| ATOM | 142 | O | LEU | A | 24 | 40.228 | −24.060 | 53.792 | 1.00 | 100.00 | 8 |
| ATOM | 143 | N | LEU | A | 25 | 39.772 | −22.528 | 52.185 | 1.00 | 100.00 | 7 |
| ATOM | 144 | CA | LEU | A | 25 | 40.438 | −23.271 | 51.100 | 1.00 | 100.00 | 6 |
| ATOM | 145 | CB | LEU | A | 25 | 39.436 | −23.655 | 49.986 | 1.00 | 100.00 | 6 |
| ATOM | 146 | CG | LEU | A | 25 | 39.900 | −24.441 | 48.741 | 1.00 | 100.00 | 6 |
| ATOM | 147 | CD1 | LEU | A | 25 | 40.184 | −25.923 | 49.048 | 1.00 | 100.00 | 6 |
| ATOM | 148 | CD2 | LEU | A | 25 | 38.886 | −24.304 | 47.600 | 1.00 | 100.00 | 6 |
| ATOM | 149 | C | LEU | A | 25 | 41.623 | −22.488 | 50.527 | 1.00 | 100.00 | 6 |
| ATOM | 150 | O | LEU | A | 25 | 42.787 | −22.862 | 50.743 | 1.00 | 100.00 | 8 |
| ATOM | 151 | N | ILE | A | 26 | 41.323 | −21.415 | 49.793 | 1.00 | 100.00 | 7 |
| ATOM | 152 | CA | ILE | A | 26 | 42.372 | −20.560 | 49.253 | 1.00 | 100.00 | 6 |
| ATOM | 153 | CB | ILE | A | 26 | 41.912 | −19.720 | 48.025 | 1.00 | 100.00 | 6 |
| ATOM | 154 | CG1 | ILE | A | 26 | 42.264 | −20.486 | 46.734 | 1.00 | 100.00 | 6 |
| ATOM | 155 | CD1 | ILE | A | 26 | 42.411 | −19.652 | 45.471 | 1.00 | 100.00 | 6 |
| ATOM | 156 | CG2 | ILE | A | 26 | 42.521 | −18.320 | 48.055 | 1.00 | 100.00 | 6 |
| ATOM | 157 | C | ILE | A | 26 | 43.018 | −19.761 | 50.383 | 1.00 | 100.00 | 6 |
| ATOM | 158 | O | ILE | A | 26 | 42.371 | −18.975 | 51.080 | 1.00 | 100.00 | 8 |
| ATOM | 159 | N | LYS | A | 27 | 44.307 | −20.021 | 50.563 | 1.00 | 100.00 | 7 |
| ATOM | 160 | CA | LYS | A | 27 | 45.066 | −19.528 | 51.694 | 1.00 | 100.00 | 6 |
| ATOM | 161 | CB | LYS | A | 27 | 45.199 | −18.002 | 51.654 | 1.00 | 100.00 | 6 |
| ATOM | 162 | CG | LYS | A | 27 | 46.650 | −17.519 | 51.664 | 1.00 | 100.00 | 6 |
| ATOM | 163 | CD | LYS | A | 27 | 47.592 | −18.401 | 50.819 | 1.00 | 100.00 | 6 |
| ATOM | 164 | CE | LYS | A | 27 | 49.040 | −17.996 | 51.023 | 1.00 | 100.00 | 6 |
| ATOM | 165 | NZ | LYS | A | 27 | 49.972 | −19.054 | 50.605 | 1.00 | 100.00 | 7 |
| ATOM | 166 | C | LYS | A | 27 | 44.496 | −20.060 | 53.010 | 1.00 | 100.00 | 6 |
| ATOM | 167 | O | LYS | A | 27 | 44.314 | −19.325 | 53.983 | 1.00 | 100.00 | 8 |
| ATOM | 168 | N | ILE | A | 28 | 44.165 | −21.350 | 52.981 | 1.00 | 100.00 | 7 |
| ATOM | 169 | CA | ILE | A | 28 | 44.272 | −22.212 | 54.148 | 1.00 | 100.00 | 6 |
| ATOM | 170 | CB | ILE | A | 28 | 43.224 | −23.362 | 54.168 | 1.00 | 100.00 | 6 |
| ATOM | 171 | CG1 | ILE | A | 28 | 43.108 | −23.976 | 55.570 | 1.00 | 100.00 | 6 |
| ATOM | 172 | CD1 | ILE | A | 28 | 42.180 | −23.229 | 56.512 | 1.00 | 100.00 | 6 |
| ATOM | 173 | CG2 | ILE | A | 28 | 43.549 | −24.465 | 53.152 | 1.00 | 100.00 | 6 |
| ATOM | 174 | C | ILE | A | 28 | 45.680 | −22.786 | 54.047 | 1.00 | 100.00 | 6 |
| ATOM | 175 | O | ILE | A | 28 | 46.297 | −23.145 | 55.055 | 1.00 | 100.00 | 8 |
| ATOM | 176 | N | PHE | A | 29 | 46.165 | −22.866 | 52.806 | 1.00 | 100.00 | 7 |
| ATOM | 177 | CA | PHE | A | 29 | 47.527 | −23.264 | 52.495 | 1.00 | 100.00 | 6 |
| ATOM | 178 | CB | PHE | A | 29 | 47.759 | −24.746 | 52.803 | 1.00 | 100.00 | 6 |
| ATOM | 179 | CG | PHE | A | 29 | 49.183 | −25.083 | 53.178 | 1.00 | 100.00 | 6 |
| ATOM | 180 | CD1 | PHE | A | 29 | 49.689 | −24.740 | 54.431 | 1.00 | 100.00 | 6 |
| ATOM | 181 | CE1 | PHE | A | 29 | 51.002 | −25.058 | 54.784 | 1.00 | 100.00 | 6 |
| ATOM | 182 | CZ | PHE | A | 29 | 51.821 | −25.736 | 53.882 | 1.00 | 100.00 | 6 |
| ATOM | 183 | CE2 | PHE | A | 29 | 51.327 | −26.088 | 52.630 | 1.00 | 100.00 | 6 |
| ATOM | 184 | CD2 | PHE | A | 29 | 50.010 | −25.763 | 52.286 | 1.00 | 100.00 | 6 |
| ATOM | 185 | C | PHE | A | 29 | 47.789 | −22.997 | 51.031 | 1.00 | 100.00 | 6 |
| ATOM | 186 | O | PHE | A | 29 | 46.905 | −23.165 | 50.185 | 1.00 | 100.00 | 8 |
| ATOM | 187 | N | ALA | A | 30 | 49.015 | −22.564 | 50.754 | 1.00 | 100.00 | 7 |
| ATOM | 188 | CA | ALA | A | 30 | 49.513 | −22.397 | 49.396 | 1.00 | 100.00 | 6 |
| ATOM | 189 | CB | ALA | A | 30 | 48.807 | −21.217 | 48.712 | 1.00 | 100.00 | 6 |
| ATOM | 190 | C | ALA | A | 30 | 51.050 | −22.245 | 49.340 | 1.00 | 100.00 | 6 |
| ATOM | 191 | O | ALA | A | 30 | 51.597 | −21.772 | 48.342 | 1.00 | 100.00 | 8 |
| ATOM | 192 | N | TRP | A | 31 | 51.745 | −22.669 | 50.396 | 1.00 | 100.00 | 7 |
| ATOM | 193 | CA | TRP | A | 31 | 53.186 | −22.442 | 50.498 | 1.00 | 100.00 | 6 |
| ATOM | 194 | CB | TRP | A | 31 | 53.466 | −20.973 | 50.856 | 1.00 | 100.00 | 6 |
| ATOM | 195 | CG | TRP | A | 31 | 53.321 | −20.619 | 52.314 | 1.00 | 100.00 | 6 |
| ATOM | 196 | CD1 | TRP | A | 31 | 54.305 | −20.159 | 53.143 | 1.00 | 100.00 | 6 |
| ATOM | 197 | NE1 | TRP | A | 31 | 53.803 | −19.940 | 54.404 | 1.00 | 100.00 | 7 |
| ATOM | 198 | CE2 | TRP | A | 31 | 52.471 | −20.259 | 54.415 | 1.00 | 100.00 | 6 |
| ATOM | 199 | CD2 | TRP | A | 31 | 52.128 | −20.690 | 53.113 | 1.00 | 100.00 | 6 |
| ATOM | 200 | CE3 | TRP | A | 31 | 50.805 | −21.078 | 52.857 | 1.00 | 100.00 | 6 |
| ATOM | 201 | CZ3 | TRP | A | 31 | 49.882 | −21.026 | 53.891 | 1.00 | 100.00 | 6 |
| ATOM | 202 | CH2 | TRP | A | 31 | 50.254 | −20.597 | 55.177 | 1.00 | 100.00 | 6 |
| ATOM | 203 | CZ2 | TRP | A | 31 | 51.537 | −20.205 | 55.458 | 1.00 | 100.00 | 6 |
| ATOM | 204 | C | TRP | A | 31 | 53.892 | −23.375 | 51.479 | 1.00 | 100.00 | 6 |
| ATOM | 205 | O | TRP | A | 31 | 53.407 | −23.618 | 52.580 | 1.00 | 100.00 | 8 |
| ATOM | 206 | N | TRP | A | 32 | 55.044 | −23.891 | 51.065 | 1.00 | 100.00 | 7 |
| ATOM | 207 | CA | TRP | A | 32 | 55.890 | −24.716 | 51.927 | 1.00 | 100.00 | 6 |
| ATOM | 208 | CB | TRP | A | 32 | 55.650 | −26.218 | 51.674 | 1.00 | 100.00 | 6 |
| ATOM | 209 | CG | TRP | A | 32 | 55.723 | −26.679 | 50.219 | 1.00 | 100.00 | 6 |
| ATOM | 210 | CD1 | TRP | A | 32 | 56.372 | −26.060 | 49.183 | 1.00 | 100.00 | 6 |
| ATOM | 211 | NE1 | TRP | A | 32 | 56.225 | −26.786 | 48.025 | 1.00 | 100.00 | 7 |
| ATOM | 212 | CE2 | TRP | A | 32 | 55.485 | −27.908 | 48.294 | 1.00 | 100.00 | 6 |
| ATOM | 213 | CD2 | TRP | A | 32 | 55.155 | −27.879 | 49.669 | 1.00 | 100.00 | 6 |
| ATOM | 214 | CE3 | TRP | A | 32 | 54.393 | −28.928 | 50.203 | 1.00 | 100.00 | 6 |
| ATOM | 215 | CZ3 | TRP | A | 32 | 53.990 | −29.959 | 49.356 | 1.00 | 100.00 | 6 |
| ATOM | 216 | CH2 | TRP | A | 32 | 54.335 | −29.957 | 47.992 | 1.00 | 100.00 | 6 |
| ATOM | 217 | CZ2 | TRP | A | 32 | 55.079 | −28.944 | 47.444 | 1.00 | 100.00 | 6 |
| ATOM | 218 | C | TRP | A | 32 | 57.371 | −24.343 | 51.767 | 1.00 | 100.00 | 6 |
| ATOM | 219 | O | TRP | A | 32 | 58.216 | −25.196 | 51.494 | 1.00 | 100.00 | 8 |
| ATOM | 220 | N | TYR | A | 33 | 57.677 | −23.062 | 51.955 | 1.00 | 100.00 | 7 |
| ATOM | 221 | CA | TYR | A | 33 | 59.005 | −22.528 | 51.651 | 1.00 | 100.00 | 6 |
| ATOM | 222 | CB | TYR | A | 33 | 58.917 | −21.043 | 51.294 | 1.00 | 100.00 | 6 |
| ATOM | 223 | CG | TYR | A | 33 | 58.219 | −20.788 | 49.980 | 1.00 | 100.00 | 6 |
| ATOM | 224 | CD1 | TYR | A | 33 | 58.941 | −20.698 | 48.791 | 1.00 | 100.00 | 6 |
| ATOM | 225 | CE1 | TYR | A | 33 | 58.301 | −20.465 | 47.571 | 1.00 | 100.00 | 6 |
| ATOM | 226 | CZ | TYR | A | 33 | 56.921 | −20.322 | 47.537 | 1.00 | 100.00 | 6 |
| ATOM | 227 | OH | TYR | A | 33 | 56.276 | −20.091 | 46.337 | 1.00 | 100.00 | 8 |
| ATOM | 228 | CE2 | TYR | A | 33 | 56.184 | −20.412 | 48.709 | 1.00 | 100.00 | 6 |
| ATOM | 229 | CD2 | TYR | A | 33 | 56.836 | −20.643 | 49.922 | 1.00 | 100.00 | 6 |
| ATOM | 230 | C | TYR | A | 33 | 60.061 | −22.785 | 52.731 | 1.00 | 100.00 | 6 |
| ATOM | 231 | O | TYR | A | 33 | 60.577 | −23.896 | 52.825 | 1.00 | 100.00 | 8 |
| ATOM | 232 | N | THR | A | 34 | 60.369 | −21.763 | 53.534 | 1.00 | 100.00 | 7 |
| ATOM | 233 | CA | THR | A | 34 | 61.488 | −21.796 | 54.498 | 1.00 | 100.00 | 6 |
| ATOM | 234 | CB | THR | A | 34 | 61.745 | −20.393 | 55.135 | 1.00 | 100.00 | 6 |
| ATOM | 235 | OG1 | THR | A | 34 | 61.603 | −19.369 | 54.141 | 1.00 | 100.00 | 8 |
| ATOM | 236 | CG2 | THR | A | 34 | 63.146 | −20.311 | 55.740 | 1.00 | 100.00 | 6 |
| ATOM | 237 | C | THR | A | 34 | 61.350 | −22.873 | 55.594 | 1.00 | 100.00 | 6 |
| ATOM | 238 | O | THR | A | 34 | 60.937 | −22.592 | 56.727 | 1.00 | 100.00 | 8 |
| ATOM | 239 | N | GLY | A | 35 | 61.719 | −24.102 | 55.234 | 1.00 | 100.00 | 7 |
| ATOM | 240 | CA | GLY | A | 35 | 61.644 | −25.268 | 56.119 | 1.00 | 100.00 | 6 |
| ATOM | 241 | C | GLY | A | 35 | 62.070 | −26.514 | 55.360 | 1.00 | 100.00 | 6 |
| ATOM | 242 | O | GLY | A | 35 | 63.121 | −27.098 | 55.644 | 1.00 | 100.00 | 8 |
| ATOM | 243 | N | SER | A | 36 | 61.238 | −26.918 | 54.400 | 1.00 | 100.00 | 7 |
| ATOM | 244 | CA | SER | A | 36 | 61.590 | −27.937 | 53.412 | 1.00 | 100.00 | 6 |
| ATOM | 245 | CB | SER | A | 36 | 60.543 | −29.055 | 53.386 | 1.00 | 100.00 | 6 |
| ATOM | 246 | OG | SER | A | 36 | 60.957 | −30.134 | 52.568 | 1.00 | 100.00 | 8 |
| ATOM | 247 | C | SER | A | 36 | 61.697 | −27.244 | 52.050 | 1.00 | 100.00 | 6 |
| ATOM | 248 | O | SER | A | 36 | 60.718 | −26.676 | 51.560 | 1.00 | 100.00 | 8 |
| ATOM | 249 | N | VAL | A | 37 | 62.891 | −27.298 | 51.454 | 1.00 | 100.00 | 7 |
| ATOM | 250 | CA | VAL | A | 37 | 63.278 | −26.457 | 50.300 | 1.00 | 100.00 | 6 |
| ATOM | 251 | CB | VAL | A | 37 | 62.390 | −26.692 | 49.030 | 1.00 | 100.00 | 6 |
| ATOM | 252 | CG1 | VAL | A | 37 | 62.927 | −25.910 | 47.836 | 1.00 | 100.00 | 6 |
| ATOM | 253 | CG2 | VAL | A | 37 | 62.309 | −28.176 | 48.688 | 1.00 | 100.00 | 6 |
| ATOM | 254 | C | VAL | A | 37 | 63.326 | −24.977 | 50.733 | 1.00 | 100.00 | 6 |
| ATOM | 255 | O | VAL | A | 37 | 62.351 | −24.236 | 50.578 | 1.00 | 100.00 | 8 |
| ATOM | 256 | N | SER | A | 38 | 64.478 | −24.570 | 51.273 | 1.00 | 100.00 | 7 |
| ATOM | 257 | CA | SER | A | 38 | 64.635 | −23.296 | 51.995 | 1.00 | 100.00 | 6 |
| ATOM | 258 | CB | SER | A | 38 | 65.706 | −23.431 | 53.095 | 1.00 | 100.00 | 6 |
| ATOM | 259 | OG | SER | A | 38 | 65.293 | −24.291 | 54.145 | 1.00 | 100.00 | 8 |
| ATOM | 260 | C | SER | A | 38 | 64.938 | −22.064 | 51.126 | 1.00 | 100.00 | 6 |
| ATOM | 261 | O | SER | A | 38 | 65.968 | −21.409 | 51.309 | 1.00 | 100.00 | 8 |
| ATOM | 262 | N | ILE | A | 39 | 64.044 | −21.744 | 50.194 | 1.00 | 100.00 | 7 |
| ATOM | 263 | CA | ILE | A | 39 | 64.109 | −20.455 | 49.489 | 1.00 | 100.00 | 6 |
| ATOM | 264 | CB | ILE | A | 39 | 63.757 | −20.560 | 47.968 | 1.00 | 100.00 | 6 |
| ATOM | 265 | CG1 | ILE | A | 39 | 62.484 | −21.384 | 47.732 | 1.00 | 100.00 | 6 |
| ATOM | 266 | CD1 | ILE | A | 39 | 61.907 | −21.254 | 46.326 | 1.00 | 100.00 | 6 |
| ATOM | 267 | CG2 | ILE | A | 39 | 64.932 | −21.146 | 47.189 | 1.00 | 100.00 | 6 |
| ATOM | 268 | C | ILE | A | 39 | 63.241 | −19.411 | 50.212 | 1.00 | 100.00 | 6 |
| ATOM | 269 | O | ILE | A | 39 | 62.142 | −19.729 | 50.681 | 1.00 | 100.00 | 8 |
| ATOM | 270 | N | LEU | A | 40 | 63.744 | −18.179 | 50.304 | 1.00 | 100.00 | 7 |
| ATOM | 271 | CA | LEU | A | 40 | 63.143 | −17.122 | 51.141 | 1.00 | 100.00 | 6 |
| ATOM | 272 | CB | LEU | A | 40 | 64.049 | −15.885 | 51.186 | 1.00 | 100.00 | 6 |
| ATOM | 273 | CG | LEU | A | 40 | 65.082 | −15.806 | 52.311 | 1.00 | 100.00 | 6 |
| ATOM | 274 | CD1 | LEU | A | 40 | 66.191 | −14.843 | 51.936 | 1.00 | 100.00 | 6 |
| ATOM | 275 | CD2 | LEU | A | 40 | 64.430 | −15.390 | 53.622 | 1.00 | 100.00 | 6 |
| ATOM | 276 | C | LEU | A | 40 | 61.704 | −16.698 | 50.803 | 1.00 | 100.00 | 6 |
| ATOM | 277 | O | LEU | A | 40 | 61.358 | −16.452 | 49.642 | 1.00 | 100.00 | 8 |
| ATOM | 278 | N | ALA | A | 41 | 60.881 | −16.614 | 51.847 | 1.00 | 100.00 | 7 |
| ATOM | 279 | CA | ALA | A | 41 | 59.506 | −16.131 | 51.745 | 1.00 | 100.00 | 6 |
| ATOM | 280 | CB | ALA | A | 41 | 58.531 | −17.299 | 51.686 | 1.00 | 100.00 | 6 |
| ATOM | 281 | C | ALA | A | 41 | 59.197 | −15.213 | 52.932 | 1.00 | 100.00 | 6 |
| ATOM | 282 | O | ALA | A | 41 | 58.950 | −15.676 | 54.056 | 1.00 | 100.00 | 8 |
| ATOM | 283 | N | ALA | A | 42 | 59.219 | −13.908 | 52.669 | 1.00 | 100.00 | 7 |
| ATOM | 284 | CA | ALA | A | 42 | 59.111 | −12.896 | 53.723 | 1.00 | 100.00 | 6 |
| ATOM | 285 | CB | ALA | A | 42 | 60.089 | −11.746 | 53.449 | 1.00 | 100.00 | 6 |
| ATOM | 286 | C | ALA | A | 42 | 57.686 | −12.363 | 53.938 | 1.00 | 100.00 | 6 |
| ATOM | 287 | O | ALA | A | 42 | 57.487 | −11.391 | 54.674 | 1.00 | 100.00 | 8 |
| ATOM | 288 | N | LEU | A | 43 | 56.706 | −13.009 | 53.304 | 1.00 | 100.00 | 7 |
| ATOM | 289 | CA | LEU | A | 43 | 55.295 | −12.614 | 53.405 | 1.00 | 100.00 | 6 |
| ATOM | 290 | CB | LEU | A | 43 | 54.717 | −12.304 | 52.000 | 1.00 | 100.00 | 6 |
| ATOM | 291 | CG | LEU | A | 43 | 53.517 | −11.360 | 51.760 | 1.00 | 100.00 | 6 |
| ATOM | 292 | CD1 | LEU | A | 43 | 53.875 | −9.889 | 51.987 | 1.00 | 100.00 | 6 |
| ATOM | 293 | CD2 | LEU | A | 43 | 52.927 | −11.538 | 50.355 | 1.00 | 100.00 | 6 |
| ATOM | 294 | C | LEU | A | 43 | 54.501 | −13.723 | 54.110 | 1.00 | 100.00 | 6 |
| ATOM | 295 | O | LEU | A | 43 | 54.447 | −14.862 | 53.627 | 1.00 | 100.00 | 8 |
| ATOM | 296 | N | VAL | A | 44 | 53.916 | −13.404 | 55.264 | 1.00 | 100.00 | 7 |
| ATOM | 297 | CA | VAL | A | 44 | 53.050 | −14.363 | 55.952 | 1.00 | 100.00 | 6 |
| ATOM | 298 | CB | VAL | A | 44 | 53.695 | −14.954 | 57.214 | 1.00 | 100.00 | 6 |
| ATOM | 299 | CG1 | VAL | A | 44 | 52.839 | −16.105 | 57.751 | 1.00 | 100.00 | 6 |
| ATOM | 300 | CG2 | VAL | A | 44 | 55.102 | −15.445 | 56.905 | 1.00 | 100.00 | 6 |
| ATOM | 301 | C | VAL | A | 44 | 51.678 | −13.773 | 56.249 | 1.00 | 100.00 | 6 |
| ATOM | 302 | O | VAL | A | 44 | 51.260 | −13.643 | 57.396 | 1.00 | 100.00 | 8 |
| ATOM | 303 | N | ASP | A | 45 | 50.988 | −13.407 | 55.180 | 1.00 | 100.00 | 7 |
| ATOM | 304 | CA | ASP | A | 45 | 49.596 | −13.005 | 55.261 | 1.00 | 100.00 | 6 |
| ATOM | 305 | CB | ASP | A | 45 | 49.370 | −11.659 | 54.565 | 1.00 | 100.00 | 6 |
| ATOM | 306 | CG | ASP | A | 45 | 47.904 | −11.364 | 54.329 | 1.00 | 100.00 | 6 |
| ATOM | 307 | OD1 | ASP | A | 45 | 47.066 | −11.748 | 55.170 | 1.00 | 100.00 | 8 |
| ATOM | 308 | OD2 | ASP | A | 45 | 47.587 | −10.764 | 53.288 | 1.00 | 100.00 | 8 |
| ATOM | 309 | C | ASP | A | 45 | 48.702 | −14.111 | 54.690 | 1.00 | 100.00 | 6 |
| ATOM | 310 | O | ASP | A | 45 | 47.975 | −13.933 | 53.699 | 1.00 | 100.00 | 8 |
| ATOM | 311 | N | SER | A | 46 | 48.798 | −15.273 | 55.320 | 1.00 | 100.00 | 7 |
| ATOM | 312 | CA | SER | A | 46 | 47.868 | −16.358 | 55.095 | 1.00 | 100.00 | 6 |
| ATOM | 313 | CB | SER | A | 46 | 48.637 | −17.632 | 54.745 | 1.00 | 100.00 | 6 |
| ATOM | 314 | OG | SER | A | 46 | 47.765 | −18.733 | 54.562 | 1.00 | 100.00 | 8 |
| ATOM | 315 | C | SER | A | 46 | 47.216 | −16.486 | 56.446 | 1.00 | 100.00 | 6 |
| ATOM | 316 | O | SER | A | 46 | 46.002 | −16.660 | 56.580 | 1.00 | 100.00 | 8 |
| ATOM | 317 | N | LEU | A | 47 | 48.084 | −16.349 | 57.440 | 1.00 | 100.00 | 7 |
| ATOM | 318 | CA | LEU | A | 47 | 47.747 | −16.432 | 58.830 | 1.00 | 100.00 | 6 |
| ATOM | 319 | CB | LEU | A | 47 | 48.997 | −16.889 | 59.587 | 1.00 | 100.00 | 6 |
| ATOM | 320 | CG | LEU | A | 47 | 49.123 | −16.957 | 61.117 | 1.00 | 100.00 | 6 |
| ATOM | 321 | CD1 | LEU | A | 47 | 48.050 | −17.807 | 61.830 | 1.00 | 100.00 | 6 |
| ATOM | 322 | CD2 | LEU | A | 47 | 50.521 | −17.473 | 61.438 | 1.00 | 100.00 | 6 |
| ATOM | 323 | C | LEU | A | 47 | 47.259 | −15.060 | 59.286 | 1.00 | 100.00 | 6 |
| ATOM | 324 | O | LEU | A | 47 | 46.504 | −14.937 | 60.256 | 1.00 | 100.00 | 8 |
| ATOM | 325 | N | VAL | A | 48 | 47.697 | −14.032 | 58.570 | 1.00 | 100.00 | 7 |
| ATOM | 326 | CA | VAL | A | 48 | 47.161 | −12.702 | 58.768 | 1.00 | 100.00 | 6 |
| ATOM | 327 | CB | VAL | A | 48 | 48.145 | −11.602 | 58.270 | 1.00 | 100.00 | 6 |
| ATOM | 328 | CG1 | VAL | A | 48 | 47.483 | −10.230 | 58.184 | 1.00 | 100.00 | 6 |
| ATOM | 329 | CG2 | VAL | A | 48 | 49.329 | −11.511 | 59.192 | 1.00 | 100.00 | 6 |
| ATOM | 330 | C | VAL | A | 48 | 45.790 | −12.655 | 58.090 | 1.00 | 100.00 | 6 |
| ATOM | 331 | O | VAL | A | 48 | 44.911 | −11.889 | 58.491 | 1.00 | 100.00 | 8 |
| ATOM | 332 | N | ASP | A | 49 | 45.587 | −13.498 | 57.084 | 1.00 | 100.00 | 7 |
| ATOM | 333 | CA | ASP | A | 49 | 44.262 | −13.579 | 56.474 | 1.00 | 100.00 | 6 |
| ATOM | 334 | CB | ASP | A | 49 | 44.342 | −13.589 | 54.944 | 1.00 | 100.00 | 6 |
| ATOM | 335 | CG | ASP | A | 49 | 44.300 | −12.180 | 54.348 | 1.00 | 100.00 | 6 |
| ATOM | 336 | OD1 | ASP | A | 49 | 43.630 | −11.284 | 54.949 | 1.00 | 100.00 | 8 |
| ATOM | 337 | OD2 | ASP | A | 49 | 44.938 | −11.984 | 53.280 | 1.00 | 100.00 | 8 |
| ATOM | 338 | C | ASP | A | 49 | 43.420 | −14.727 | 57.025 | 1.00 | 100.00 | 6 |
| ATOM | 339 | O | ASP | A | 49 | 42.199 | −14.752 | 56.836 | 1.00 | 100.00 | 8 |
| ATOM | 340 | N | ILE | A | 50 | 44.069 | −15.653 | 57.727 | 1.00 | 100.00 | 7 |
| ATOM | 341 | CA | ILE | A | 50 | 43.343 | −16.716 | 58.404 | 1.00 | 100.00 | 6 |
| ATOM | 342 | CB | ILE | A | 50 | 44.237 | −17.926 | 58.707 | 1.00 | 100.00 | 6 |
| ATOM | 343 | CG1 | ILE | A | 50 | 43.482 | −19.217 | 58.377 | 1.00 | 100.00 | 6 |
| ATOM | 344 | CD1 | ILE | A | 50 | 44.349 | −20.359 | 57.895 | 1.00 | 100.00 | 6 |
| ATOM | 345 | CG2 | ILE | A | 50 | 44.734 | −17.895 | 60.160 | 1.00 | 100.00 | 6 |
| ATOM | 346 | C | ILE | A | 50 | 42.680 | −16.171 | 59.668 | 1.00 | 100.00 | 6 |
| ATOM | 347 | O | ILE | A | 50 | 41.686 | −16.720 | 60.158 | 1.00 | 100.00 | 8 |
| ATOM | 348 | N | GLY | A | 51 | 43.242 | −15.080 | 60.184 | 1.00 | 100.00 | 7 |
| ATOM | 349 | CA | GLY | A | 51 | 42.574 | −14.285 | 61.202 | 1.00 | 100.00 | 6 |
| ATOM | 350 | C | GLY | A | 51 | 41.254 | −13.840 | 60.615 | 1.00 | 100.00 | 6 |
| ATOM | 351 | O | GLY | A | 51 | 40.206 | −14.060 | 61.208 | 1.00 | 100.00 | 8 |
| ATOM | 352 | N | ALA | A | 52 | 41.328 | −13.268 | 59.413 | 1.00 | 100.00 | 7 |
| ATOM | 353 | CA | ALA | A | 52 | 40.170 | −12.765 | 58.663 | 1.00 | 100.00 | 6 |
| ATOM | 354 | CB | ALA | A | 52 | 40.628 | −12.092 | 57.326 | 1.00 | 100.00 | 6 |
| ATOM | 355 | C | ALA | A | 52 | 39.094 | −13.821 | 58.396 | 1.00 | 100.00 | 6 |
| ATOM | 356 | O | ALA | A | 52 | 37.901 | −13.502 | 58.341 | 1.00 | 100.00 | 8 |
| ATOM | 357 | N | SER | A | 53 | 39.511 | −15.072 | 58.234 | 1.00 | 100.00 | 7 |
| ATOM | 358 | CA | SER | A | 53 | 38.573 | −16.138 | 57.911 | 1.00 | 100.00 | 6 |
| ATOM | 359 | CB | SER | A | 53 | 39.309 | −17.404 | 57.491 | 1.00 | 100.00 | 6 |
| ATOM | 360 | OG | SER | A | 53 | 38.410 | −18.332 | 56.902 | 1.00 | 100.00 | 8 |
| ATOM | 361 | C | SER | A | 53 | 37.715 | −16.452 | 59.105 | 1.00 | 100.00 | 6 |
| ATOM | 362 | O | SER | A | 53 | 36.534 | −16.085 | 59.159 | 1.00 | 100.00 | 8 |
| ATOM | 363 | N | LEU | A | 54 | 38.335 | −17.137 | 60.058 | 1.00 | 100.00 | 7 |
| ATOM | 364 | CA | LEU | A | 54 | 37.682 | −17.495 | 61.283 | 1.00 | 100.00 | 6 |
| ATOM | 365 | CB | LEU | A | 54 | 38.704 | −18.056 | 62.261 | 1.00 | 100.00 | 6 |
| ATOM | 366 | CG | LEU | A | 54 | 38.763 | −19.589 | 62.306 | 1.00 | 100.00 | 6 |
| ATOM | 367 | CD1 | LEU | A | 54 | 39.135 | −20.199 | 60.952 | 1.00 | 100.00 | 6 |
| ATOM | 368 | CD2 | LEU | A | 54 | 39.697 | −20.086 | 63.441 | 1.00 | 100.00 | 6 |
| ATOM | 369 | C | LEU | A | 54 | 36.930 | −16.298 | 61.851 | 1.00 | 100.00 | 6 |
| ATOM | 370 | O | LEU | A | 54 | 35.796 | −16.439 | 62.313 | 1.00 | 100.00 | 8 |
| ATOM | 371 | N | THR | A | 55 | 37.552 | −15.122 | 61.779 | 1.00 | 100.00 | 7 |
| ATOM | 372 | CA | THR | A | 55 | 36.871 | −13.858 | 62.056 | 1.00 | 100.00 | 6 |
| ATOM | 373 | CB | THR | A | 55 | 37.751 | −12.643 | 61.659 | 1.00 | 100.00 | 6 |
| ATOM | 374 | OG1 | THR | A | 55 | 38.918 | −12.620 | 62.491 | 1.00 | 100.00 | 8 |
| ATOM | 375 | CG2 | THR | A | 55 | 36.987 | −11.306 | 61.781 | 1.00 | 100.00 | 6 |
| ATOM | 376 | C | THR | A | 55 | 35.557 | −13.803 | 61.294 | 1.00 | 100.00 | 6 |
| ATOM | 377 | O | THR | A | 55 | 34.508 | −14.192 | 61.809 | 1.00 | 100.00 | 8 |
| ATOM | 378 | N | ASN | A | 56 | 35.627 | −13.359 | 60.048 | 1.00 | 100.00 | 7 |
| ATOM | 379 | CA | ASN | A | 56 | 34.426 | −13.116 | 59.307 | 1.00 | 100.00 | 6 |
| ATOM | 380 | CB | ASN | A | 56 | 34.720 | −12.644 | 57.889 | 1.00 | 100.00 | 6 |
| ATOM | 381 | CG | ASN | A | 56 | 33.928 | −11.394 | 57.529 | 1.00 | 100.00 | 6 |
| ATOM | 382 | OD1 | ASN | A | 56 | 33.636 | −10.573 | 58.405 | 1.00 | 100.00 | 8 |
| ATOM | 383 | ND2 | ASN | A | 56 | 33.574 | −11.240 | 56.248 | 1.00 | 100.00 | 7 |
| ATOM | 384 | C | ASN | A | 56 | 33.515 | −14.324 | 59.310 | 1.00 | 100.00 | 6 |
| ATOM | 385 | O | ASN | A | 56 | 32.302 | −14.168 | 59.433 | 1.00 | 100.00 | 8 |
| ATOM | 386 | N | LEU | A | 57 | 34.087 | −15.520 | 59.220 | 1.00 | 100.00 | 7 |
| ATOM | 387 | CA | LEU | A | 57 | 33.267 | −16.710 | 59.252 | 1.00 | 100.00 | 6 |
| ATOM | 388 | CB | LEU | A | 57 | 34.114 | −17.971 | 59.281 | 1.00 | 100.00 | 6 |
| ATOM | 389 | CG | LEU | A | 57 | 33.315 | −19.258 | 59.531 | 1.00 | 100.00 | 6 |
| ATOM | 390 | CD1 | LEU | A | 57 | 33.586 | −20.314 | 58.474 | 1.00 | 100.00 | 6 |
| ATOM | 391 | CD2 | LEU | A | 57 | 33.554 | −19.826 | 60.930 | 1.00 | 100.00 | 6 |
| ATOM | 392 | C | LEU | A | 57 | 32.325 | −16.667 | 60.444 | 1.00 | 100.00 | 6 |
| ATOM | 393 | O | LEU | A | 57 | 31.103 | −16.569 | 60.284 | 1.00 | 100.00 | 8 |
| ATOM | 394 | N | LEU | A | 58 | 32.898 | −16.713 | 61.638 | 1.00 | 100.00 | 7 |
| ATOM | 395 | CA | LEU | A | 58 | 32.098 | −16.776 | 62.853 | 1.00 | 100.00 | 6 |
| ATOM | 396 | CB | LEU | A | 58 | 32.995 | −16.815 | 64.075 | 1.00 | 100.00 | 6 |
| ATOM | 397 | CG | LEU | A | 58 | 33.553 | −18.225 | 64.237 | 1.00 | 100.00 | 6 |
| ATOM | 398 | CD1 | LEU | A | 58 | 34.855 | −18.265 | 65.078 | 1.00 | 100.00 | 6 |
| ATOM | 399 | CD2 | LEU | A | 58 | 32.441 | −19.147 | 64.798 | 1.00 | 100.00 | 6 |
| ATOM | 400 | C | LEU | A | 58 | 31.186 | −15.593 | 62.959 | 1.00 | 100.00 | 6 |
| ATOM | 401 | O | LEU | A | 58 | 30.027 | −15.716 | 63.334 | 1.00 | 100.00 | 8 |
| ATOM | 402 | N | VAL | A | 59 | 31.728 | −14.443 | 62.602 | 1.00 | 100.00 | 7 |
| ATOM | 403 | CA | VAL | A | 59 | 30.993 | −13.212 | 62.686 | 1.00 | 100.00 | 6 |
| ATOM | 404 | CB | VAL | A | 59 | 31.880 | −12.026 | 62.324 | 1.00 | 100.00 | 6 |
| ATOM | 405 | CG1 | VAL | A | 59 | 31.083 | −10.726 | 62.393 | 1.00 | 100.00 | 6 |
| ATOM | 406 | CG2 | VAL | A | 59 | 33.087 | −11.983 | 63.268 | 1.00 | 100.00 | 6 |
| ATOM | 407 | C | VAL | A | 59 | 29.747 | −13.252 | 61.820 | 1.00 | 100.00 | 6 |
| ATOM | 408 | O | VAL | A | 59 | 28.715 | −12.753 | 62.226 | 1.00 | 100.00 | 8 |
| ATOM | 409 | N | VAL | A | 60 | 29.816 | −13.861 | 60.649 | 1.00 | 100.00 | 7 |
| ATOM | 410 | CA | VAL | A | 60 | 28.618 | −13.909 | 59.841 | 1.00 | 100.00 | 6 |
| ATOM | 411 | CB | VAL | A | 60 | 28.915 | −14.020 | 58.360 | 1.00 | 100.00 | 6 |
| ATOM | 412 | CG1 | VAL | A | 60 | 29.603 | −12.752 | 57.886 | 1.00 | 100.00 | 6 |
| ATOM | 413 | CG2 | VAL | A | 60 | 29.745 | −15.246 | 58.066 | 1.00 | 100.00 | 6 |
| ATOM | 414 | C | VAL | A | 60 | 27.688 | −15.001 | 60.321 | 1.00 | 100.00 | 6 |
| ATOM | 415 | O | VAL | A | 60 | 26.466 | −14.875 | 60.241 | 1.00 | 100.00 | 8 |
| ATOM | 416 | N | ARG | A | 61 | 28.277 | −16.060 | 60.852 | 1.00 | 100.00 | 7 |
| ATOM | 417 | CA | ARG | A | 61 | 27.510 | −17.070 | 61.554 | 1.00 | 100.00 | 6 |
| ATOM | 418 | CB | ARG | A | 61 | 28.359 | −18.328 | 61.792 | 1.00 | 100.00 | 6 |
| ATOM | 419 | CG | ARG | A | 61 | 28.161 | −19.437 | 60.759 | 1.00 | 100.00 | 6 |
| ATOM | 420 | CD | ARG | A | 61 | 28.843 | −20.745 | 61.179 | 1.00 | 100.00 | 6 |
| ATOM | 421 | NE | ARG | A | 61 | 29.074 | −21.638 | 60.030 | 1.00 | 100.00 | 7 |
| ATOM | 422 | CZ | ARG | A | 61 | 30.039 | −22.573 | 59.949 | 1.00 | 100.00 | 6 |
| ATOM | 423 | NH1 | ARG | A | 61 | 30.897 | −22.771 | 60.958 | 1.00 | 100.00 | 7 |
| ATOM | 424 | NH2 | ARG | A | 61 | 30.156 | −23.323 | 58.844 | 1.00 | 100.00 | 7 |
| ATOM | 425 | C | ARG | A | 61 | 26.961 | −16.517 | 62.883 | 1.00 | 100.00 | 6 |
| ATOM | 426 | O | ARG | A | 61 | 26.760 | −17.256 | 63.849 | 1.00 | 100.00 | 8 |
| ATOM | 427 | N | TYR | A | 62 | 26.722 | −15.212 | 62.927 | 1.00 | 100.00 | 7 |
| ATOM | 428 | CA | TYR | A | 62 | 26.207 | −14.539 | 64.114 | 1.00 | 100.00 | 6 |
| ATOM | 429 | CB | TYR | A | 62 | 27.352 | −14.042 | 65.001 | 1.00 | 100.00 | 6 |
| ATOM | 430 | CG | TYR | A | 62 | 26.922 | −13.342 | 66.273 | 1.00 | 100.00 | 6 |
| ATOM | 431 | CD1 | TYR | A | 62 | 27.584 | −12.195 | 66.747 | 1.00 | 100.00 | 6 |
| ATOM | 432 | CE1 | TYR | A | 62 | 27.172 | −11.558 | 67.939 | 1.00 | 100.00 | 6 |
| ATOM | 433 | CZ | TYR | A | 62 | 26.073 | −12.087 | 68.667 | 1.00 | 100.00 | 6 |
| ATOM | 434 | OH | TYR | A | 62 | 25.573 | −11.549 | 69.860 | 1.00 | 100.00 | 8 |
| ATOM | 435 | CE2 | TYR | A | 62 | 25.432 | −13.219 | 68.203 | 1.00 | 100.00 | 6 |
| ATOM | 436 | CD2 | TYR | A | 62 | 25.859 | −13.837 | 67.015 | 1.00 | 100.00 | 6 |
| ATOM | 437 | C | TYR | A | 62 | 25.425 | −13.371 | 63.588 | 1.00 | 100.00 | 6 |
| ATOM | 438 | O | TYR | A | 62 | 24.499 | −12.883 | 64.218 | 1.00 | 100.00 | 8 |
| ATOM | 439 | N | SER | A | 63 | 25.827 | −12.920 | 62.406 | 1.00 | 100.00 | 7 |
| ATOM | 440 | CA | SER | A | 63 | 25.074 | −11.942 | 61.656 | 1.00 | 100.00 | 6 |
| ATOM | 441 | CB | SER | A | 63 | 25.895 | −11.424 | 60.475 | 1.00 | 100.00 | 6 |
| ATOM | 442 | OG | SER | A | 63 | 26.892 | −10.520 | 60.911 | 1.00 | 100.00 | 8 |
| ATOM | 443 | C | SER | A | 63 | 23.878 | −12.691 | 61.145 | 1.00 | 100.00 | 6 |
| ATOM | 444 | O | SER | A | 63 | 23.411 | −12.449 | 60.025 | 1.00 | 100.00 | 8 |
| ATOM | 445 | N | LEU | A | 64 | 23.387 | −13.601 | 61.986 | 1.00 | 100.00 | 7 |
| ATOM | 446 | CA | LEU | A | 64 | 22.539 | −14.651 | 61.509 | 1.00 | 100.00 | 6 |
| ATOM | 447 | CB | LEU | A | 64 | 23.303 | −15.412 | 60.434 | 1.00 | 100.00 | 6 |
| ATOM | 448 | CG | LEU | A | 64 | 22.427 | −16.085 | 59.382 | 1.00 | 100.00 | 6 |
| ATOM | 449 | CD1 | LEU | A | 64 | 21.454 | −15.085 | 58.684 | 1.00 | 100.00 | 6 |
| ATOM | 450 | CD2 | LEU | A | 64 | 23.320 | −16.806 | 58.372 | 1.00 | 100.00 | 6 |
| ATOM | 451 | C | LEU | A | 64 | 22.060 | −15.645 | 62.551 | 1.00 | 100.00 | 6 |
| ATOM | 452 | O | LEU | A | 64 | 22.619 | −16.726 | 62.664 | 1.00 | 100.00 | 8 |
| ATOM | 453 | N | GLN | A | 65 | 21.035 | −15.267 | 63.308 | 1.00 | 100.00 | 7 |
| ATOM | 454 | CA | GLN | A | 65 | 20.158 | −16.190 | 64.025 | 1.00 | 100.00 | 6 |
| ATOM | 455 | CB | GLN | A | 65 | 20.629 | −16.434 | 65.434 | 1.00 | 100.00 | 6 |
| ATOM | 456 | CG | GLN | A | 65 | 21.675 | −17.473 | 65.546 | 1.00 | 100.00 | 6 |
| ATOM | 457 | CD | GLN | A | 65 | 23.069 | −16.874 | 65.689 | 1.00 | 100.00 | 6 |
| ATOM | 458 | OE1 | GLN | A | 65 | 23.828 | −17.274 | 66.578 | 1.00 | 100.00 | 8 |
| ATOM | 459 | NE2 | GLN | A | 65 | 23.412 | −15.905 | 64.827 | 1.00 | 100.00 | 7 |
| ATOM | 460 | C | GLN | A | 65 | 18.946 | −15.347 | 64.121 | 1.00 | 100.00 | 6 |
| ATOM | 461 | O | GLN | A | 65 | 18.898 | −14.323 | 63.461 | 1.00 | 100.00 | 8 |
| ATOM | 462 | N | PRO | A | 66 | 17.956 | −15.746 | 64.937 | 1.00 | 100.00 | 7 |
| ATOM | 463 | CA | PRO | A | 66 | 17.027 | −14.694 | 65.375 | 1.00 | 100.00 | 6 |
| ATOM | 464 | CB | PRO | A | 66 | 15.874 | −15.446 | 66.045 | 1.00 | 100.00 | 6 |
| ATOM | 465 | CG | PRO | A | 66 | 16.129 | −16.894 | 65.783 | 1.00 | 100.00 | 6 |
| ATOM | 466 | CD | PRO | A | 66 | 17.592 | −17.066 | 65.466 | 1.00 | 100.00 | 6 |
| ATOM | 467 | C | PRO | A | 66 | 17.779 | −13.788 | 66.349 | 1.00 | 100.00 | 6 |
| ATOM | 468 | O | PRO | A | 66 | 17.993 | −12.628 | 66.007 | 1.00 | 100.00 | 8 |
| ATOM | 469 | N | ALA | A | 67 | 18.215 | −14.302 | 67.513 | 1.00 | 100.00 | 7 |
| ATOM | 470 | CA | ALA | A | 67 | 19.143 | −13.553 | 68.415 | 1.00 | 100.00 | 6 |
| ATOM | 471 | CB | ALA | A | 67 | 18.523 | −12.252 | 68.836 | 1.00 | 100.00 | 6 |
| ATOM | 472 | C | ALA | A | 67 | 19.679 | −14.321 | 69.655 | 1.00 | 100.00 | 6 |
| ATOM | 473 | O | ALA | A | 67 | 19.608 | −15.559 | 69.694 | 1.00 | 100.00 | 8 |
| ATOM | 474 | N | ASP | A | 68 | 20.266 | −13.597 | 70.628 | 1.00 | 100.00 | 7 |
| ATOM | 475 | CA | ASP | A | 68 | 20.293 | −14.055 | 72.035 | 1.00 | 100.00 | 6 |
| ATOM | 476 | CB | ASP | A | 68 | 21.467 | −13.458 | 72.849 | 1.00 | 100.00 | 6 |
| ATOM | 477 | CG | ASP | A | 68 | 22.851 | −13.874 | 72.310 | 1.00 | 100.00 | 6 |
| ATOM | 478 | OD1 | ASP | A | 68 | 22.932 | −14.752 | 71.427 | 1.00 | 100.00 | 8 |
| ATOM | 479 | OD2 | ASP | A | 68 | 23.873 | −13.311 | 72.758 | 1.00 | 100.00 | 8 |
| ATOM | 480 | C | ASP | A | 68 | 18.927 | −13.559 | 72.494 | 1.00 | 100.00 | 6 |
| ATOM | 481 | O | ASP | A | 68 | 18.760 | −12.994 | 73.573 | 1.00 | 100.00 | 8 |
| ATOM | 482 | N | ASP | A | 69 | 17.959 | −13.895 | 71.641 | 1.00 | 100.00 | 7 |
| ATOM | 483 | CA | ASP | A | 69 | 16.754 | −13.139 | 71.311 | 1.00 | 100.00 | 6 |
| ATOM | 484 | CB | ASP | A | 69 | 15.654 | −14.105 | 70.890 | 1.00 | 100.00 | 6 |
| ATOM | 485 | CG | ASP | A | 69 | 15.860 | −14.618 | 69.472 | 1.00 | 100.00 | 6 |
| ATOM | 486 | OD1 | ASP | A | 69 | 15.933 | −13.790 | 68.524 | 1.00 | 100.00 | 8 |
| ATOM | 487 | OD2 | ASP | A | 69 | 15.950 | −15.855 | 69.315 | 1.00 | 100.00 | 8 |
| ATOM | 488 | C | ASP | A | 69 | 16.260 | −12.101 | 72.301 | 1.00 | 100.00 | 6 |
| ATOM | 489 | O | ASP | A | 69 | 15.828 | −10.992 | 71.929 | 1.00 | 100.00 | 8 |
| ATOM | 490 | N | ASN | A | 70 | 16.342 | −12.476 | 73.562 | 1.00 | 100.00 | 7 |
| ATOM | 491 | CA | ASN | A | 70 | 16.010 | −11.607 | 74.665 | 1.00 | 100.00 | 6 |
| ATOM | 492 | CB | ASN | A | 70 | 16.036 | −12.444 | 75.925 | 1.00 | 100.00 | 6 |
| ATOM | 493 | CG | ASN | A | 70 | 15.690 | −13.884 | 75.631 | 1.00 | 100.00 | 6 |
| ATOM | 494 | OD1 | ASN | A | 70 | 14.553 | −14.317 | 75.878 | 1.00 | 100.00 | 8 |
| ATOM | 495 | ND2 | ASN | A | 70 | 16.645 | −14.623 | 75.024 | 1.00 | 100.00 | 7 |
| ATOM | 496 | C | ASN | A | 70 | 16.994 | −10.455 | 74.739 | 1.00 | 100.00 | 6 |
| ATOM | 497 | O | ASN | A | 70 | 16.588 | −9.295 | 74.632 | 1.00 | 100.00 | 8 |
| ATOM | 498 | N | HIS | A | 71 | 18.282 | −10.783 | 74.885 | 1.00 | 100.00 | 7 |
| ATOM | 499 | CA | HIS | A | 71 | 19.354 | −9.779 | 74.922 | 1.00 | 100.00 | 6 |
| ATOM | 500 | CB | HIS | A | 71 | 20.592 | −10.359 | 75.593 | 1.00 | 100.00 | 6 |
| ATOM | 501 | CG | HIS | A | 71 | 20.307 | −10.885 | 76.951 | 1.00 | 100.00 | 6 |
| ATOM | 502 | ND1 | HIS | A | 71 | 20.226 | −12.234 | 77.219 | 1.00 | 100.00 | 7 |
| ATOM | 503 | CE1 | HIS | A | 71 | 19.913 | −12.407 | 78.496 | 1.00 | 100.00 | 6 |
| ATOM | 504 | NE2 | HIS | A | 71 | 19.769 | −11.218 | 79.059 | 1.00 | 100.00 | 7 |
| ATOM | 505 | CD2 | HIS | A | 71 | 19.997 | −10.247 | 78.107 | 1.00 | 100.00 | 6 |
| ATOM | 506 | C | HIS | A | 71 | 19.654 | −9.221 | 73.522 | 1.00 | 100.00 | 6 |
| ATOM | 507 | O | HIS | A | 71 | 19.434 | −8.034 | 73.234 | 1.00 | 100.00 | 8 |
| ATOM | 508 | N | SER | A | 72 | 20.126 | −10.071 | 72.630 | 1.00 | 100.00 | 7 |
| ATOM | 509 | CA | SER | A | 72 | 20.156 | −9.645 | 71.282 | 1.00 | 100.00 | 6 |
| ATOM | 510 | CB | SER | A | 72 | 21.202 | −10.456 | 70.553 | 1.00 | 100.00 | 6 |
| ATOM | 511 | OG | SER | A | 72 | 22.459 | −10.289 | 71.199 | 1.00 | 100.00 | 8 |
| ATOM | 512 | C | SER | A | 72 | 18.719 | −9.773 | 70.741 | 1.00 | 100.00 | 6 |
| ATOM | 513 | O | SER | A | 72 | 18.290 | −10.892 | 70.455 | 1.00 | 100.00 | 8 |
| ATOM | 514 | N | PHE | A | 73 | 17.966 | −8.652 | 70.679 | 1.00 | 100.00 | 7 |
| ATOM | 515 | CA | PHE | A | 73 | 16.590 | −8.639 | 70.147 | 1.00 | 100.00 | 6 |
| ATOM | 516 | CB | PHE | A | 73 | 16.140 | −7.242 | 69.818 | 1.00 | 100.00 | 6 |
| ATOM | 517 | CG | PHE | A | 73 | 16.198 | −6.999 | 68.338 | 1.00 | 100.00 | 6 |
| ATOM | 518 | CD1 | PHE | A | 73 | 17.280 | −6.341 | 67.771 | 1.00 | 100.00 | 6 |
| ATOM | 519 | CE1 | PHE | A | 73 | 17.366 | −6.176 | 66.371 | 1.00 | 100.00 | 6 |
| ATOM | 520 | CZ | PHE | A | 73 | 16.392 | −6.723 | 65.530 | 1.00 | 100.00 | 6 |
| ATOM | 521 | CE2 | PHE | A | 73 | 15.347 | −7.443 | 66.084 | 1.00 | 100.00 | 6 |
| ATOM | 522 | CD2 | PHE | A | 73 | 15.248 | −7.583 | 67.479 | 1.00 | 100.00 | 6 |
| ATOM | 523 | C | PHE | A | 73 | 16.516 | −9.354 | 68.765 | 1.00 | 100.00 | 6 |
| ATOM | 524 | O | PHE | A | 73 | 15.511 | −10.012 | 68.477 | 1.00 | 100.00 | 8 |
| ATOM | 525 | N | GLY | A | 74 | 17.536 | −9.155 | 67.899 | 1.00 | 100.00 | 7 |
| ATOM | 526 | CA | GLY | A | 74 | 17.547 | −9.627 | 66.484 | 1.00 | 100.00 | 6 |
| ATOM | 527 | C | GLY | A | 74 | 18.675 | −9.122 | 65.564 | 1.00 | 100.00 | 6 |
| ATOM | 528 | O | GLY | A | 74 | 18.385 | −8.407 | 64.601 | 1.00 | 100.00 | 8 |
| ATOM | 529 | N | HIS | A | 75 | 19.926 | −9.581 | 65.837 | 1.00 | 100.00 | 7 |
| ATOM | 530 | CA | HIS | A | 75 | 21.283 | −9.215 | 65.234 | 1.00 | 100.00 | 6 |
| ATOM | 531 | CB | HIS | A | 75 | 22.398 | −9.687 | 66.183 | 1.00 | 100.00 | 6 |
| ATOM | 532 | CG | HIS | A | 75 | 22.181 | −11.066 | 66.776 | 1.00 | 100.00 | 6 |
| ATOM | 533 | ND1 | HIS | A | 75 | 21.792 | −12.161 | 66.031 | 1.00 | 100.00 | 7 |
| ATOM | 534 | CE1 | HIS | A | 75 | 21.691 | −13.216 | 66.819 | 1.00 | 100.00 | 6 |
| ATOM | 535 | NE2 | HIS | A | 75 | 22.015 | −12.852 | 68.046 | 1.00 | 100.00 | 7 |
| ATOM | 536 | CD2 | HIS | A | 75 | 22.330 | −11.518 | 68.047 | 1.00 | 100.00 | 6 |
| ATOM | 537 | C | HIS | A | 75 | 21.767 | −9.703 | 63.871 | 1.00 | 100.00 | 6 |
| ATOM | 538 | O | HIS | A | 75 | 21.220 | −10.591 | 63.241 | 1.00 | 100.00 | 8 |
| ATOM | 539 | N | GLY | A | 76 | 22.901 | −9.172 | 63.489 | 1.00 | 100.00 | 7 |
| ATOM | 540 | CA | GLY | A | 76 | 23.350 | −9.334 | 62.132 | 1.00 | 100.00 | 6 |
| ATOM | 541 | C | GLY | A | 76 | 23.928 | −8.011 | 61.651 | 1.00 | 100.00 | 6 |
| ATOM | 542 | O | GLY | A | 76 | 24.875 | −7.963 | 60.842 | 1.00 | 100.00 | 8 |
| ATOM | 543 | N | LYS | A | 77 | 23.329 | −6.923 | 62.141 | 1.00 | 100.00 | 7 |
| ATOM | 544 | CA | LYS | A | 77 | 24.032 | −5.641 | 62.321 | 1.00 | 100.00 | 6 |
| ATOM | 545 | CB | LYS | A | 77 | 23.468 | −4.981 | 63.586 | 1.00 | 100.00 | 6 |
| ATOM | 546 | CG | LYS | A | 77 | 22.729 | −3.699 | 63.338 | 1.00 | 100.00 | 6 |
| ATOM | 547 | CD | LYS | A | 77 | 23.718 | −2.557 | 63.083 | 1.00 | 100.00 | 6 |
| ATOM | 548 | CE | LYS | A | 77 | 22.976 | −1.230 | 63.018 | 1.00 | 100.00 | 6 |
| ATOM | 549 | NZ | LYS | A | 77 | 22.188 | −0.998 | 64.274 | 1.00 | 100.00 | 7 |
| ATOM | 550 | C | LYS | A | 77 | 25.530 | −5.877 | 62.548 | 1.00 | 100.00 | 6 |
| ATOM | 551 | O | LYS | A | 77 | 26.395 | −5.106 | 62.122 | 1.00 | 100.00 | 8 |
| ATOM | 552 | N | ALA | A | 78 | 25.778 | −6.953 | 63.290 | 1.00 | 100.00 | 7 |
| ATOM | 553 | CA | ALA | A | 78 | 27.059 | −7.551 | 63.514 | 1.00 | 100.00 | 6 |
| ATOM | 554 | CB | ALA | A | 78 | 26.834 | −9.026 | 63.807 | 1.00 | 100.00 | 6 |
| ATOM | 555 | C | ALA | A | 78 | 28.028 | −7.380 | 62.346 | 1.00 | 100.00 | 6 |
| ATOM | 556 | O | ALA | A | 78 | 29.176 | −6.975 | 62.512 | 1.00 | 100.00 | 8 |
| ATOM | 557 | N | GLU | A | 79 | 27.582 | −7.694 | 61.151 | 1.00 | 100.00 | 7 |
| ATOM | 558 | CA | GLU | A | 79 | 28.517 | −7.664 | 60.091 | 1.00 | 100.00 | 6 |
| ATOM | 559 | CB | GLU | A | 79 | 27.939 | −8.289 | 58.846 | 1.00 | 100.00 | 6 |
| ATOM | 560 | CG | GLU | A | 79 | 26.543 | −7.869 | 58.432 | 1.00 | 100.00 | 6 |
| ATOM | 561 | CD | GLU | A | 79 | 25.944 | −8.854 | 57.407 | 1.00 | 100.00 | 6 |
| ATOM | 562 | OE1 | GLU | A | 79 | 26.611 | −9.888 | 57.078 | 1.00 | 100.00 | 8 |
| ATOM | 563 | OE2 | GLU | A | 79 | 24.798 | −8.595 | 56.939 | 1.00 | 100.00 | 8 |
| ATOM | 564 | C | GLU | A | 79 | 28.925 | −6.251 | 59.875 | 1.00 | 100.00 | 6 |
| ATOM | 565 | O | GLU | A | 79 | 30.087 | −5.955 | 59.893 | 1.00 | 100.00 | 8 |
| ATOM | 566 | N | SER | A | 80 | 27.954 | −5.369 | 59.715 | 1.00 | 100.00 | 7 |
| ATOM | 567 | CA | SER | A | 80 | 28.236 | −3.945 | 59.474 | 1.00 | 100.00 | 6 |
| ATOM | 568 | CB | SER | A | 80 | 26.954 | −3.051 | 59.634 | 1.00 | 100.00 | 6 |
| ATOM | 569 | OG | SER | A | 80 | 26.167 | −2.822 | 58.418 | 1.00 | 100.00 | 8 |
| ATOM | 570 | C | SER | A | 80 | 29.359 | −3.492 | 60.395 | 1.00 | 100.00 | 6 |
| ATOM | 571 | O | SER | A | 80 | 30.276 | −2.808 | 59.961 | 1.00 | 100.00 | 8 |
| ATOM | 572 | N | LEU | A | 81 | 29.262 | −3.893 | 61.662 | 1.00 | 100.00 | 7 |
| ATOM | 573 | CA | LEU | A | 81 | 30.363 | −3.803 | 62.612 | 1.00 | 100.00 | 6 |
| ATOM | 574 | CB | LEU | A | 81 | 29.948 | −4.496 | 63.944 | 1.00 | 100.00 | 6 |
| ATOM | 575 | CG | LEU | A | 81 | 30.844 | −4.901 | 65.159 | 1.00 | 100.00 | 6 |
| ATOM | 576 | CD1 | LEU | A | 81 | 30.159 | −5.886 | 66.126 | 1.00 | 100.00 | 6 |
| ATOM | 577 | CD2 | LEU | A | 81 | 32.252 | −5.494 | 64.853 | 1.00 | 100.00 | 6 |
| ATOM | 578 | C | LEU | A | 81 | 31.672 | −4.403 | 61.979 | 1.00 | 100.00 | 6 |
| ATOM | 579 | O | LEU | A | 81 | 32.645 | −3.677 | 61.631 | 1.00 | 100.00 | 8 |
| ATOM | 580 | N | ALA | A | 82 | 31.680 | −5.723 | 61.802 | 1.00 | 100.00 | 7 |
| ATOM | 581 | CA | ALA | A | 82 | 32.860 | −6.415 | 61.310 | 1.00 | 100.00 | 6 |
| ATOM | 582 | CB | ALA | A | 82 | 32.647 | −7.899 | 61.388 | 1.00 | 100.00 | 6 |
| ATOM | 583 | C | ALA | A | 82 | 33.126 | −5.993 | 59.879 | 1.00 | 100.00 | 6 |
| ATOM | 584 | O | ALA | A | 82 | 33.206 | −6.816 | 58.966 | 1.00 | 100.00 | 8 |
| ATOM | 585 | N | ALA | A | 83 | 33.225 | −4.698 | 59.667 | 1.00 | 100.00 | 7 |
| ATOM | 586 | CA | ALA | A | 83 | 33.419 | −4.198 | 58.343 | 1.00 | 100.00 | 6 |
| ATOM | 587 | CB | ALA | A | 83 | 32.103 | −3.859 | 57.691 | 1.00 | 100.00 | 6 |
| ATOM | 588 | C | ALA | A | 83 | 34.160 | −2.979 | 58.696 | 1.00 | 100.00 | 6 |
| ATOM | 589 | O | ALA | A | 83 | 35.209 | −2.713 | 58.137 | 1.00 | 100.00 | 8 |
| ATOM | 590 | N | LEU | A | 84 | 33.643 | −2.279 | 59.695 | 1.00 | 100.00 | 7 |
| ATOM | 591 | CA | LEU | A | 84 | 34.218 | −1.025 | 60.101 | 1.00 | 100.00 | 6 |
| ATOM | 592 | CB | LEU | A | 84 | 33.534 | −0.519 | 61.358 | 1.00 | 100.00 | 6 |
| ATOM | 593 | CG | LEU | A | 84 | 34.222 | 0.704 | 61.961 | 1.00 | 100.00 | 6 |
| ATOM | 594 | CD1 | LEU | A | 84 | 33.209 | 1.793 | 62.259 | 1.00 | 100.00 | 6 |
| ATOM | 595 | CD2 | LEU | A | 84 | 35.081 | 0.335 | 63.211 | 1.00 | 100.00 | 6 |
| ATOM | 596 | C | LEU | A | 84 | 35.696 | −1.231 | 60.342 | 1.00 | 100.00 | 6 |
| ATOM | 597 | O | LEU | A | 84 | 36.540 | −0.413 | 59.929 | 1.00 | 100.00 | 8 |
| ATOM | 598 | N | ALA | A | 85 | 35.995 | −2.346 | 61.003 | 1.00 | 100.00 | 7 |
| ATOM | 599 | CA | ALA | A | 85 | 37.365 | −2.680 | 61.374 | 1.00 | 100.00 | 6 |
| ATOM | 600 | CB | ALA | A | 85 | 37.370 | −3.933 | 62.240 | 1.00 | 100.00 | 6 |
| ATOM | 601 | C | ALA | A | 85 | 38.195 | −2.889 | 60.126 | 1.00 | 100.00 | 6 |
| ATOM | 602 | O | ALA | A | 85 | 38.924 | −2.012 | 59.677 | 1.00 | 100.00 | 8 |
| ATOM | 603 | N | GLN | A | 86 | 38.052 | −4.083 | 59.593 | 1.00 | 100.00 | 7 |
| ATOM | 604 | CA | GLN | A | 86 | 38.439 | −4.414 | 58.248 | 1.00 | 100.00 | 6 |
| ATOM | 605 | CB | GLN | A | 86 | 37.271 | −5.130 | 57.567 | 1.00 | 100.00 | 6 |
| ATOM | 606 | CG | GLN | A | 86 | 36.358 | −5.832 | 58.573 | 1.00 | 100.00 | 6 |
| ATOM | 607 | CD | GLN | A | 86 | 36.984 | −7.094 | 59.156 | 1.00 | 100.00 | 6 |
| ATOM | 608 | OE1 | GLN | A | 86 | 37.360 | −8.006 | 58.401 | 1.00 | 100.00 | 8 |
| ATOM | 609 | NE2 | GLN | A | 86 | 37.099 | −7.160 | 60.498 | 1.00 | 100.00 | 7 |
| ATOM | 610 | C | GLN | A | 86 | 38.816 | −3.195 | 57.435 | 1.00 | 100.00 | 6 |
| ATOM | 611 | O | GLN | A | 86 | 39.901 | −3.128 | 56.874 | 1.00 | 100.00 | 8 |
| ATOM | 612 | N | SER | A | 87 | 37.921 | −2.223 | 57.378 | 1.00 | 100.00 | 7 |
| ATOM | 613 | CA | SER | A | 87 | 38.113 | −1.093 | 56.489 | 1.00 | 100.00 | 6 |
| ATOM | 614 | CB | SER | A | 87 | 36.782 | −0.436 | 56.210 | 1.00 | 100.00 | 6 |
| ATOM | 615 | OG | SER | A | 87 | 36.190 | −0.051 | 57.442 | 1.00 | 100.00 | 8 |
| ATOM | 616 | C | SER | A | 87 | 39.047 | −0.043 | 57.063 | 1.00 | 100.00 | 6 |
| ATOM | 617 | O | SER | A | 87 | 40.267 | −0.230 | 57.093 | 1.00 | 100.00 | 8 |
| ATOM | 618 | N | MET | A | 88 | 38.441 | 1.069 | 57.491 | 1.00 | 100.00 | 7 |
| ATOM | 619 | CA | MET | A | 88 | 39.133 | 2.226 | 58.077 | 1.00 | 100.00 | 6 |
| ATOM | 620 | CB | MET | A | 88 | 38.200 | 3.003 | 59.057 | 1.00 | 100.00 | 6 |
| ATOM | 621 | CG | MET | A | 88 | 37.226 | 4.057 | 58.389 | 1.00 | 100.00 | 6 |
| ATOM | 622 | SD | MET | A | 88 | 36.070 | 5.005 | 59.468 | 1.00 | 100.00 | 16 |
| ATOM | 623 | CE | MET | A | 88 | 37.218 | 5.931 | 60.553 | 1.00 | 100.00 | 6 |
| ATOM | 624 | C | MET | A | 88 | 40.423 | 1.775 | 58.766 | 1.00 | 100.00 | 6 |
| ATOM | 625 | O | MET | A | 88 | 41.530 | 2.181 | 58.376 | 1.00 | 100.00 | 8 |
| ATOM | 626 | N | PHE | A | 89 | 40.264 | 0.905 | 59.762 | 1.00 | 100.00 | 7 |
| ATOM | 627 | CA | PHE | A | 89 | 41.400 | 0.342 | 60.462 | 1.00 | 100.00 | 6 |
| ATOM | 628 | CB | PHE | A | 89 | 41.181 | 0.251 | 62.008 | 1.00 | 100.00 | 6 |
| ATOM | 629 | CG | PHE | A | 89 | 40.122 | 1.232 | 62.581 | 1.00 | 100.00 | 6 |
| ATOM | 630 | CD1 | PHE | A | 89 | 39.058 | 0.746 | 63.387 | 1.00 | 100.00 | 6 |
| ATOM | 631 | CE1 | PHE | A | 89 | 38.068 | 1.624 | 63.924 | 1.00 | 100.00 | 6 |
| ATOM | 632 | CZ | PHE | A | 89 | 38.137 | 3.015 | 63.655 | 1.00 | 100.00 | 6 |
| ATOM | 633 | CE2 | PHE | A | 89 | 39.204 | 3.525 | 62.853 | 1.00 | 100.00 | 6 |
| ATOM | 634 | CD2 | PHE | A | 89 | 40.191 | 2.629 | 62.328 | 1.00 | 100.00 | 6 |
| ATOM | 635 | C | PHE | A | 89 | 41.676 | −1.028 | 59.849 | 1.00 | 100.00 | 6 |
| ATOM | 636 | O | PHE | A | 89 | 40.829 | −1.594 | 59.161 | 1.00 | 100.00 | 8 |
| ATOM | 637 | N | ILE | A | 90 | 42.889 | −1.522 | 60.088 | 1.00 | 100.00 | 7 |
| ATOM | 638 | CA | ILE | A | 90 | 43.346 | −2.898 | 59.735 | 1.00 | 100.00 | 6 |
| ATOM | 639 | CB | ILE | A | 90 | 42.801 | −3.990 | 60.827 | 1.00 | 100.00 | 6 |
| ATOM | 640 | CG1 | ILE | A | 90 | 42.763 | −3.374 | 62.238 | 1.00 | 100.00 | 6 |
| ATOM | 641 | CD1 | ILE | A | 90 | 42.084 | −4.207 | 63.282 | 1.00 | 100.00 | 6 |
| ATOM | 642 | CG2 | ILE | A | 90 | 43.666 | −5.252 | 60.907 | 1.00 | 100.00 | 6 |
| ATOM | 643 | C | ILE | A | 90 | 43.300 | −3.223 | 58.160 | 1.00 | 100.00 | 6 |
| ATOM | 644 | O | ILE | A | 90 | 43.750 | −4.293 | 57.692 | 1.00 | 100.00 | 8 |
| ATOM | 645 | N | SER | A | 91 | 42.792 | −2.266 | 57.373 | 1.00 | 100.00 | 7 |
| ATOM | 646 | CA | SER | A | 91 | 42.987 | −2.188 | 55.920 | 1.00 | 100.00 | 6 |
| ATOM | 647 | CB | SER | A | 91 | 42.036 | −3.094 | 55.137 | 1.00 | 100.00 | 6 |
| ATOM | 648 | OG | SER | A | 91 | 42.125 | −2.880 | 53.734 | 1.00 | 100.00 | 8 |
| ATOM | 649 | C | SER | A | 91 | 42.666 | −0.764 | 55.631 | 1.00 | 100.00 | 6 |
| ATOM | 650 | O | SER | A | 91 | 42.371 | −0.017 | 56.549 | 1.00 | 100.00 | 8 |
| ATOM | 651 | N | GLY | A | 92 | 42.701 | −0.365 | 54.370 | 1.00 | 100.00 | 7 |
| ATOM | 652 | CA | GLY | A | 92 | 42.500 | 1.049 | 54.051 | 1.00 | 100.00 | 6 |
| ATOM | 653 | C | GLY | A | 92 | 43.275 | 1.858 | 55.067 | 1.00 | 100.00 | 6 |
| ATOM | 654 | O | GLY | A | 92 | 42.827 | 2.911 | 55.544 | 1.00 | 100.00 | 8 |
| ATOM | 655 | N | SER | A | 93 | 44.447 | 1.309 | 55.381 | 1.00 | 100.00 | 7 |
| ATOM | 656 | CA | SER | A | 93 | 45.343 | 1.740 | 56.434 | 1.00 | 100.00 | 6 |
| ATOM | 657 | CB | SER | A | 93 | 44.616 | 1.814 | 57.773 | 1.00 | 100.00 | 6 |
| ATOM | 658 | OG | SER | A | 93 | 43.638 | 0.794 | 57.869 | 1.00 | 100.00 | 8 |
| ATOM | 659 | C | SER | A | 93 | 46.450 | 0.688 | 56.468 | 1.00 | 100.00 | 6 |
| ATOM | 660 | O | SER | A | 93 | 47.605 | 0.985 | 56.806 | 1.00 | 100.00 | 8 |
| ATOM | 661 | N | ALA | A | 94 | 46.081 | −0.546 | 56.106 | 1.00 | 100.00 | 7 |
| ATOM | 662 | CA | ALA | A | 94 | 47.051 | −1.571 | 55.726 | 1.00 | 100.00 | 6 |
| ATOM | 663 | CB | ALA | A | 94 | 46.352 | −2.894 | 55.459 | 1.00 | 100.00 | 6 |
| ATOM | 664 | C | ALA | A | 94 | 47.736 | −1.053 | 54.465 | 1.00 | 100.00 | 6 |
| ATOM | 665 | O | ALA | A | 94 | 48.717 | −1.613 | 53.968 | 1.00 | 100.00 | 8 |
| ATOM | 666 | N | LEU | A | 95 | 47.184 | 0.044 | 53.966 | 1.00 | 100.00 | 7 |
| ATOM | 667 | CA | LEU | A | 95 | 47.726 | 0.770 | 52.851 | 1.00 | 100.00 | 6 |
| ATOM | 668 | CB | LEU | A | 95 | 46.693 | 1.795 | 52.378 | 1.00 | 100.00 | 6 |
| ATOM | 669 | CG | LEU | A | 95 | 46.556 | 3.167 | 53.048 | 1.00 | 100.00 | 6 |
| ATOM | 670 | CD1 | LEU | A | 95 | 47.540 | 4.147 | 52.445 | 1.00 | 100.00 | 6 |
| ATOM | 671 | CD2 | LEU | A | 95 | 45.149 | 3.700 | 52.887 | 1.00 | 100.00 | 6 |
| ATOM | 672 | C | LEU | A | 95 | 49.001 | 1.482 | 53.249 | 1.00 | 100.00 | 6 |
| ATOM | 673 | O | LEU | A | 95 | 49.930 | 1.594 | 52.456 | 1.00 | 100.00 | 8 |
| ATOM | 674 | N | PHE | A | 96 | 49.031 | 1.959 | 54.485 | 1.00 | 100.00 | 7 |
| ATOM | 675 | CA | PHE | A | 96 | 50.069 | 2.880 | 54.921 | 1.00 | 100.00 | 6 |
| ATOM | 676 | CB | PHE | A | 96 | 49.568 | 3.749 | 56.072 | 1.00 | 100.00 | 6 |
| ATOM | 677 | CG | PHE | A | 96 | 48.706 | 4.883 | 55.626 | 1.00 | 100.00 | 6 |
| ATOM | 678 | CD1 | PHE | A | 96 | 49.241 | 5.927 | 54.884 | 1.00 | 100.00 | 6 |
| ATOM | 679 | CE1 | PHE | A | 96 | 48.443 | 6.980 | 54.463 | 1.00 | 100.00 | 6 |
| ATOM | 680 | CZ | PHE | A | 96 | 47.092 | 7.000 | 54.787 | 1.00 | 100.00 | 6 |
| ATOM | 681 | CE2 | PHE | A | 96 | 46.546 | 5.963 | 55.529 | 1.00 | 100.00 | 6 |
| ATOM | 682 | CD2 | PHE | A | 96 | 47.356 | 4.911 | 55.947 | 1.00 | 100.00 | 6 |
| ATOM | 683 | C | PHE | A | 96 | 51.442 | 2.269 | 55.237 | 1.00 | 100.00 | 6 |
| ATOM | 684 | O | PHE | A | 96 | 52.409 | 3.005 | 55.510 | 1.00 | 100.00 | 8 |
| ATOM | 685 | N | LEU | A | 97 | 51.540 | 0.937 | 55.197 | 1.00 | 100.00 | 7 |
| ATOM | 686 | CA | LEU | A | 97 | 52.862 | 0.296 | 55.084 | 1.00 | 100.00 | 6 |
| ATOM | 687 | CB | LEU | A | 97 | 52.914 | −1.134 | 55.694 | 1.00 | 100.00 | 6 |
| ATOM | 688 | CG | LEU | A | 97 | 53.402 | −1.300 | 57.166 | 1.00 | 100.00 | 6 |
| ATOM | 689 | CD1 | LEU | A | 97 | 52.371 | −0.858 | 58.235 | 1.00 | 100.00 | 6 |
| ATOM | 690 | CD2 | LEU | A | 97 | 53.882 | −2.725 | 57.475 | 1.00 | 100.00 | 6 |
| ATOM | 691 | C | LEU | A | 97 | 53.337 | 0.410 | 53.611 | 1.00 | 100.00 | 6 |
| ATOM | 692 | O | LEU | A | 97 | 54.286 | −0.264 | 53.190 | 1.00 | 100.00 | 8 |
| ATOM | 693 | N | PHE | A | 98 | 52.597 | 1.231 | 52.845 | 1.00 | 100.00 | 7 |
| ATOM | 694 | CA | PHE | A | 98 | 53.151 | 2.166 | 51.844 | 1.00 | 100.00 | 6 |
| ATOM | 695 | CB | PHE | A | 98 | 54.053 | 1.520 | 50.795 | 1.00 | 100.00 | 6 |
| ATOM | 696 | CG | PHE | A | 98 | 55.506 | 1.775 | 51.052 | 1.00 | 100.00 | 6 |
| ATOM | 697 | CD1 | PHE | A | 98 | 56.458 | 0.783 | 50.847 | 1.00 | 100.00 | 6 |
| ATOM | 698 | CE1 | PHE | A | 98 | 57.806 | 1.027 | 51.110 | 1.00 | 100.00 | 6 |
| ATOM | 699 | CZ | PHE | A | 98 | 58.200 | 2.269 | 51.606 | 1.00 | 100.00 | 6 |
| ATOM | 700 | CE2 | PHE | A | 98 | 57.249 | 3.263 | 51.830 | 1.00 | 100.00 | 6 |
| ATOM | 701 | CD2 | PHE | A | 98 | 55.916 | 3.011 | 51.558 | 1.00 | 100.00 | 6 |
| ATOM | 702 | C | PHE | A | 98 | 52.204 | 3.194 | 51.227 | 1.00 | 100.00 | 6 |
| ATOM | 703 | O | PHE | A | 98 | 51.452 | 2.884 | 50.305 | 1.00 | 100.00 | 8 |
| ATOM | 704 | N | LEU | A | 99 | 52.259 | 4.410 | 51.769 | 1.00 | 100.00 | 7 |
| ATOM | 705 | CA | LEU | A | 99 | 51.605 | 5.564 | 51.171 | 1.00 | 100.00 | 6 |
| ATOM | 706 | CB | LEU | A | 99 | 51.417 | 6.696 | 52.188 | 1.00 | 100.00 | 6 |
| ATOM | 707 | CG | LEU | A | 99 | 50.841 | 8.077 | 51.802 | 1.00 | 100.00 | 6 |
| ATOM | 708 | CD1 | LEU | A | 99 | 51.937 | 9.105 | 51.598 | 1.00 | 100.00 | 6 |
| ATOM | 709 | CD2 | LEU | A | 99 | 49.869 | 8.072 | 50.610 | 1.00 | 100.00 | 6 |
| ATOM | 710 | C | LEU | A | 99 | 52.445 | 6.032 | 49.999 | 1.00 | 100.00 | 6 |
| ATOM | 711 | O | LEU | A | 99 | 51.907 | 6.229 | 48.910 | 1.00 | 100.00 | 8 |
| ATOM | 712 | N | THR | A | 100 | 53.751 | 6.221 | 50.236 | 1.00 | 100.00 | 7 |
| ATOM | 713 | CA | THR | A | 100 | 54.751 | 6.521 | 49.178 | 1.00 | 100.00 | 6 |
| ATOM | 714 | CB | THR | A | 100 | 54.807 | 8.039 | 48.776 | 1.00 | 100.00 | 6 |
| ATOM | 715 | OG1 | THR | A | 100 | 53.538 | 8.463 | 48.259 | 1.00 | 100.00 | 8 |
| ATOM | 716 | CG2 | THR | A | 100 | 55.894 | 8.302 | 47.718 | 1.00 | 100.00 | 6 |
| ATOM | 717 | C | THR | A | 100 | 56.154 | 6.073 | 49.589 | 1.00 | 100.00 | 6 |
| ATOM | 718 | O | THR | A | 100 | 56.639 | 5.037 | 49.131 | 1.00 | 100.00 | 8 |
| ATOM | 719 | N | GLY | A | 101 | 56.790 | 6.875 | 50.441 | 1.00 | 100.00 | 7 |
| ATOM | 720 | CA | GLY | A | 101 | 58.140 | 6.624 | 50.926 | 1.00 | 100.00 | 6 |
| ATOM | 721 | C | GLY | A | 101 | 59.147 | 6.315 | 49.836 | 1.00 | 100.00 | 6 |
| ATOM | 722 | O | GLY | A | 101 | 59.498 | 7.191 | 49.043 | 1.00 | 100.00 | 8 |
| ATOM | 723 | N | ILE | A | 102 | 59.582 | 5.052 | 49.813 | 1.00 | 100.00 | 7 |
| ATOM | 724 | CA | ILE | A | 102 | 60.629 | 4.529 | 48.919 | 1.00 | 100.00 | 6 |
| ATOM | 725 | CB | ILE | A | 102 | 60.789 | 2.966 | 49.097 | 1.00 | 100.00 | 6 |
| ATOM | 726 | CG1 | ILE | A | 102 | 61.527 | 2.651 | 50.408 | 1.00 | 100.00 | 6 |
| ATOM | 727 | CD1 | ILE | A | 102 | 61.577 | 1.168 | 50.780 | 1.00 | 100.00 | 6 |
| ATOM | 728 | CG2 | ILE | A | 102 | 61.516 | 2.316 | 47.925 | 1.00 | 100.00 | 6 |
| ATOM | 729 | C | ILE | A | 102 | 60.426 | 4.965 | 47.457 | 1.00 | 100.00 | 6 |
| ATOM | 730 | O | ILE | A | 102 | 59.811 | 4.256 | 46.657 | 1.00 | 100.00 | 8 |
| ATOM | 731 | N | GLN | A | 103 | 60.948 | 6.148 | 47.133 | 1.00 | 100.00 | 7 |
| ATOM | 732 | CA | GLN | A | 103 | 60.812 | 6.735 | 45.798 | 1.00 | 100.00 | 6 |
| ATOM | 733 | CB | GLN | A | 103 | 59.574 | 7.637 | 45.721 | 1.00 | 100.00 | 6 |
| ATOM | 734 | CG | GLN | A | 103 | 59.175 | 8.032 | 44.294 | 1.00 | 100.00 | 6 |
| ATOM | 735 | CD | GLN | A | 103 | 58.180 | 9.179 | 44.236 | 1.00 | 100.00 | 6 |
| ATOM | 736 | OE1 | GLN | A | 103 | 57.571 | 9.547 | 45.243 | 1.00 | 100.00 | 8 |
| ATOM | 737 | NE2 | GLN | A | 103 | 58.011 | 9.751 | 43.047 | 1.00 | 100.00 | 7 |
| ATOM | 738 | C | GLN | A | 103 | 62.051 | 7.523 | 45.372 | 1.00 | 100.00 | 6 |
| ATOM | 739 | O | GLN | A | 103 | 62.392 | 7.550 | 44.187 | 1.00 | 100.00 | 8 |
| ATOM | 740 | N | HIS | A | 104 | 62.726 | 8.145 | 46.337 | 1.00 | 100.00 | 7 |
| ATOM | 741 | CA | HIS | A | 104 | 63.766 | 9.126 | 46.026 | 1.00 | 100.00 | 6 |
| ATOM | 742 | CB | HIS | A | 104 | 63.421 | 10.488 | 46.639 | 1.00 | 100.00 | 6 |
| ATOM | 743 | CG | HIS | A | 104 | 62.222 | 11.136 | 46.019 | 1.00 | 100.00 | 6 |
| ATOM | 744 | ND1 | HIS | A | 104 | 62.175 | 11.501 | 44.691 | 1.00 | 100.00 | 7 |
| ATOM | 745 | CE1 | HIS | A | 104 | 61.001 | 12.044 | 44.425 | 1.00 | 100.00 | 6 |
| ATOM | 746 | NE2 | HIS | A | 104 | 60.285 | 12.048 | 45.535 | 1.00 | 100.00 | 7 |
| ATOM | 747 | CD2 | HIS | A | 104 | 61.025 | 11.484 | 46.546 | 1.00 | 100.00 | 6 |
| ATOM | 748 | C | HIS | A | 104 | 65.209 | 8.723 | 46.355 | 1.00 | 100.00 | 6 |
| ATOM | 749 | O | HIS | A | 104 | 66.089 | 8.852 | 45.499 | 1.00 | 100.00 | 8 |
| ATOM | 750 | N | LEU | A | 105 | 65.455 | 8.247 | 47.576 | 1.00 | 100.00 | 7 |
| ATOM | 751 | CA | LEU | A | 105 | 66.815 | 7.871 | 47.992 | 1.00 | 100.00 | 6 |
| ATOM | 752 | CB | LEU | A | 105 | 66.878 | 7.628 | 49.506 | 1.00 | 100.00 | 6 |
| ATOM | 753 | CG | LEU | A | 105 | 66.997 | 8.844 | 50.433 | 1.00 | 100.00 | 6 |
| ATOM | 754 | CD1 | LEU | A | 105 | 66.907 | 8.395 | 51.879 | 1.00 | 100.00 | 6 |
| ATOM | 755 | CD2 | LEU | A | 105 | 68.288 | 9.639 | 50.204 | 1.00 | 100.00 | 6 |
| ATOM | 756 | C | LEU | A | 105 | 67.360 | 6.659 | 47.218 | 1.00 | 100.00 | 6 |
| ATOM | 757 | O | LEU | A | 105 | 66.640 | 6.064 | 46.412 | 1.00 | 100.00 | 8 |
| ATOM | 758 | N | ILE | A | 106 | 68.632 | 6.314 | 47.451 | 1.00 | 100.00 | 7 |
| ATOM | 759 | CA | ILE | A | 106 | 69.262 | 5.127 | 46.834 | 1.00 | 100.00 | 6 |
| ATOM | 760 | CB | ILE | A | 106 | 70.841 | 5.096 | 46.996 | 1.00 | 100.00 | 6 |
| ATOM | 761 | CG1 | ILE | A | 106 | 71.470 | 6.472 | 46.714 | 1.00 | 100.00 | 6 |
| ATOM | 762 | CD1 | ILE | A | 106 | 72.955 | 6.584 | 47.068 | 1.00 | 100.00 | 6 |
| ATOM | 763 | CG2 | ILE | A | 106 | 71.475 | 4.030 | 46.081 | 1.00 | 100.00 | 6 |
| ATOM | 764 | C | ILE | A | 106 | 68.594 | 3.852 | 47.390 | 1.00 | 100.00 | 6 |
| ATOM | 765 | O | ILE | A | 106 | 69.212 | 3.053 | 48.108 | 1.00 | 100.00 | 8 |
| ATOM | 766 | N | SER | A | 107 | 67.314 | 3.692 | 47.056 | 1.00 | 100.00 | 7 |
| ATOM | 767 | CA | SER | A | 107 | 66.501 | 2.590 | 47.545 | 1.00 | 100.00 | 6 |
| ATOM | 768 | CB | SER | A | 107 | 65.655 | 3.032 | 48.751 | 1.00 | 100.00 | 6 |
| ATOM | 769 | OG | SER | A | 107 | 65.403 | 1.955 | 49.635 | 1.00 | 100.00 | 8 |
| ATOM | 770 | C | SER | A | 107 | 65.653 | 2.017 | 46.396 | 1.00 | 100.00 | 6 |
| ATOM | 771 | O | SER | A | 107 | 65.891 | 0.882 | 45.979 | 1.00 | 100.00 | 8 |
| ATOM | 772 | N | PRO | A | 108 | 64.681 | 2.797 | 45.866 | 1.00 | 100.00 | 7 |
| ATOM | 773 | CA | PRO | A | 108 | 63.958 | 2.304 | 44.693 | 1.00 | 100.00 | 6 |
| ATOM | 774 | CB | PRO | A | 108 | 62.673 | 3.129 | 44.710 | 1.00 | 100.00 | 6 |
| ATOM | 775 | CG | PRO | A | 108 | 63.092 | 4.413 | 45.287 | 1.00 | 100.00 | 6 |
| ATOM | 776 | CD | PRO | A | 108 | 64.177 | 4.120 | 46.286 | 1.00 | 100.00 | 6 |
| ATOM | 777 | C | PRO | A | 108 | 64.720 | 2.563 | 43.395 | 1.00 | 100.00 | 6 |
| ATOM | 778 | O | PRO | A | 108 | 64.690 | 1.727 | 42.494 | 1.00 | 100.00 | 8 |
| ATOM | 779 | N | THR | A | 109 | 65.387 | 3.718 | 43.315 | 1.00 | 100.00 | 7 |
| ATOM | 780 | CA | THR | A | 109 | 66.197 | 4.122 | 42.156 | 1.00 | 100.00 | 6 |
| ATOM | 781 | CB | THR | A | 109 | 66.558 | 5.640 | 42.225 | 1.00 | 100.00 | 6 |
| ATOM | 782 | OG1 | THR | A | 109 | 66.875 | 6.008 | 43.574 | 1.00 | 100.00 | 8 |
| ATOM | 783 | CG2 | THR | A | 109 | 65.392 | 6.500 | 41.728 | 1.00 | 100.00 | 6 |
| ATOM | 784 | C | THR | A | 109 | 67.445 | 3.212 | 41.999 | 1.00 | 100.00 | 6 |
| ATOM | 785 | O | THR | A | 109 | 67.700 | 2.386 | 42.882 | 1.00 | 100.00 | 8 |
| ATOM | 786 | N | PRO | A | 110 | 68.232 | 3.378 | 40.901 | 1.00 | 100.00 | 7 |
| ATOM | 787 | CA | PRO | A | 110 | 69.210 | 2.423 | 40.357 | 1.00 | 100.00 | 6 |
| ATOM | 788 | CB | PRO | A | 110 | 70.418 | 3.323 | 40.067 | 1.00 | 100.00 | 6 |
| ATOM | 789 | CG | PRO | A | 110 | 69.778 | 4.681 | 39.702 | 1.00 | 100.00 | 6 |
| ATOM | 790 | CD | PRO | A | 110 | 68.303 | 4.619 | 40.106 | 1.00 | 100.00 | 6 |
| ATOM | 791 | C | PRO | A | 110 | 69.622 | 1.135 | 41.119 | 1.00 | 100.00 | 6 |
| ATOM | 792 | O | PRO | A | 110 | 69.677 | 0.072 | 40.489 | 1.00 | 100.00 | 8 |
| ATOM | 793 | N | MET | A | 111 | 69.893 | 1.207 | 42.426 | 1.00 | 100.00 | 7 |
| ATOM | 794 | CA | MET | A | 111 | 70.590 | 0.102 | 43.125 | 1.00 | 100.00 | 6 |
| ATOM | 795 | CB | MET | A | 111 | 71.869 | 0.617 | 43.813 | 1.00 | 100.00 | 6 |
| ATOM | 796 | CG | MET | A | 111 | 72.971 | 1.082 | 42.851 | 1.00 | 100.00 | 6 |
| ATOM | 797 | SD | MET | A | 111 | 73.841 | −0.245 | 41.979 | 1.00 | 100.00 | 16 |
| ATOM | 798 | CE | MET | A | 111 | 72.927 | −0.376 | 40.441 | 1.00 | 100.00 | 6 |
| ATOM | 799 | C | MET | A | 111 | 69.807 | −0.864 | 44.062 | 1.00 | 100.00 | 6 |
| ATOM | 800 | O | MET | A | 111 | 69.835 | −2.077 | 43.834 | 1.00 | 100.00 | 8 |
| ATOM | 801 | N | THR | A | 112 | 69.125 | −0.345 | 45.089 | 1.00 | 100.00 | 7 |
| ATOM | 802 | CA | THR | A | 112 | 68.648 | −1.185 | 46.216 | 1.00 | 100.00 | 6 |
| ATOM | 803 | CB | THR | A | 112 | 68.447 | −0.353 | 47.522 | 1.00 | 100.00 | 6 |
| ATOM | 804 | OG1 | THR | A | 112 | 69.712 | 0.148 | 47.973 | 1.00 | 100.00 | 8 |
| ATOM | 805 | CG2 | THR | A | 112 | 67.833 | −1.195 | 48.637 | 1.00 | 100.00 | 6 |
| ATOM | 806 | C | THR | A | 112 | 67.434 | −2.097 | 45.960 | 1.00 | 100.00 | 6 |
| ATOM | 807 | O | THR | A | 112 | 67.428 | −3.246 | 46.407 | 1.00 | 100.00 | 8 |
| ATOM | 808 | N | ASP | A | 113 | 66.419 | −1.607 | 45.258 | 1.00 | 100.00 | 7 |
| ATOM | 809 | CA | ASP | A | 113 | 65.211 | −2.415 | 45.047 | 1.00 | 100.00 | 6 |
| ATOM | 810 | CB | ASP | A | 113 | 63.949 | −1.671 | 45.504 | 1.00 | 100.00 | 6 |
| ATOM | 811 | CG | ASP | A | 113 | 63.619 | −1.924 | 46.973 | 1.00 | 100.00 | 6 |
| ATOM | 812 | OD1 | ASP | A | 113 | 62.417 | −1.916 | 47.328 | 1.00 | 100.00 | 8 |
| ATOM | 813 | OD2 | ASP | A | 113 | 64.558 | −2.137 | 47.772 | 1.00 | 100.00 | 8 |
| ATOM | 814 | C | ASP | A | 113 | 65.007 | −3.045 | 43.658 | 1.00 | 100.00 | 6 |
| ATOM | 815 | O | ASP | A | 113 | 64.390 | −4.107 | 43.565 | 1.00 | 100.00 | 8 |
| ATOM | 816 | N | PRO | A | 114 | 65.510 | −2.406 | 42.581 | 1.00 | 100.00 | 7 |
| ATOM | 817 | CA | PRO | A | 114 | 65.347 | −3.025 | 41.263 | 1.00 | 100.00 | 6 |
| ATOM | 818 | CB | PRO | A | 114 | 65.409 | −1.827 | 40.314 | 1.00 | 100.00 | 6 |
| ATOM | 819 | CG | PRO | A | 114 | 66.317 | −0.869 | 40.997 | 1.00 | 100.00 | 6 |
| ATOM | 820 | CD | PRO | A | 114 | 66.219 | −1.117 | 42.487 | 1.00 | 100.00 | 6 |
| ATOM | 821 | C | PRO | A | 114 | 66.449 | −4.040 | 40.931 | 1.00 | 100.00 | 6 |
| ATOM | 822 | O | PRO | A | 114 | 66.933 | −4.088 | 39.795 | 1.00 | 100.00 | 8 |
| ATOM | 823 | N | GLY | A | 115 | 66.828 | −4.844 | 41.921 | 1.00 | 100.00 | 7 |
| ATOM | 824 | CA | GLY | A | 115 | 67.865 | −5.855 | 41.752 | 1.00 | 100.00 | 6 |
| ATOM | 825 | C | GLY | A | 115 | 67.575 | −7.127 | 42.523 | 1.00 | 100.00 | 6 |
| ATOM | 826 | O | GLY | A | 115 | 67.433 | −8.200 | 41.929 | 1.00 | 100.00 | 8 |
| ATOM | 827 | N | VAL | A | 116 | 67.480 | −6.998 | 43.848 | 1.00 | 100.00 | 7 |
| ATOM | 828 | CA | VAL | A | 116 | 67.290 | −8.145 | 44.754 | 1.00 | 100.00 | 6 |
| ATOM | 829 | CB | VAL | A | 116 | 67.617 | −7.802 | 46.255 | 1.00 | 100.00 | 6 |
| ATOM | 830 | CG1 | VAL | A | 116 | 69.126 | −7.720 | 46.484 | 1.00 | 100.00 | 6 |
| ATOM | 831 | CG2 | VAL | A | 116 | 66.919 | −6.518 | 46.712 | 1.00 | 100.00 | 6 |
| ATOM | 832 | C | VAL | A | 116 | 65.907 | −8.803 | 44.643 | 1.00 | 100.00 | 6 |
| ATOM | 833 | O | VAL | A | 116 | 64.873 | −8.134 | 44.746 | 1.00 | 100.00 | 8 |
| ATOM | 834 | N | GLY | A | 117 | 65.909 | −10.118 | 44.425 | 1.00 | 100.00 | 7 |
| ATOM | 835 | CA | GLY | A | 117 | 64.683 | −10.907 | 44.336 | 1.00 | 100.00 | 6 |
| ATOM | 836 | C | GLY | A | 117 | 64.393 | −11.437 | 42.944 | 1.00 | 100.00 | 6 |
| ATOM | 837 | O | GLY | A | 117 | 63.348 | −11.135 | 42.368 | 1.00 | 100.00 | 8 |
| ATOM | 838 | N | VAL | A | 118 | 65.320 | −12.226 | 42.404 | 1.00 | 100.00 | 7 |
| ATOM | 839 | CA | VAL | A | 118 | 65.135 | −12.884 | 41.102 | 1.00 | 100.00 | 6 |
| ATOM | 840 | CB | VAL | A | 118 | 66.418 | −12.745 | 40.193 | 1.00 | 100.00 | 6 |
| ATOM | 841 | CG1 | VAL | A | 118 | 67.536 | −13.697 | 40.627 | 1.00 | 100.00 | 6 |
| ATOM | 842 | CG2 | VAL | A | 118 | 66.082 | −12.927 | 38.713 | 1.00 | 100.00 | 6 |
| ATOM | 843 | C | VAL | A | 118 | 64.659 | −14.346 | 41.286 | 1.00 | 100.00 | 6 |
| ATOM | 844 | O | VAL | A | 118 | 64.607 | −15.125 | 40.326 | 1.00 | 100.00 | 8 |
| ATOM | 845 | N | ILE | A | 119 | 64.291 | −14.686 | 42.527 | 1.00 | 100.00 | 7 |
| ATOM | 846 | CA | ILE | A | 119 | 63.851 | −16.041 | 42.915 | 1.00 | 100.00 | 6 |
| ATOM | 847 | CB | ILE | A | 119 | 64.605 | −16.561 | 44.192 | 1.00 | 100.00 | 6 |
| ATOM | 848 | CG1 | ILE | A | 119 | 64.721 | −15.462 | 45.262 | 1.00 | 100.00 | 6 |
| ATOM | 849 | CD1 | ILE | A | 119 | 65.240 | −15.942 | 46.612 | 1.00 | 100.00 | 6 |
| ATOM | 850 | CG2 | ILE | A | 119 | 65.981 | −17.119 | 43.820 | 1.00 | 100.00 | 6 |
| ATOM | 851 | C | ILE | A | 119 | 62.331 | −16.146 | 43.124 | 1.00 | 100.00 | 6 |
| ATOM | 852 | O | ILE | A | 119 | 61.861 | −16.854 | 44.019 | 1.00 | 100.00 | 8 |
| ATOM | 853 | N | VAL | A | 120 | 61.575 | −15.459 | 42.271 | 1.00 | 100.00 | 7 |
| ATOM | 854 | CA | VAL | A | 120 | 60.131 | −15.297 | 42.453 | 1.00 | 100.00 | 6 |
| ATOM | 855 | CB | VAL | A | 120 | 59.629 | −13.959 | 41.826 | 1.00 | 100.00 | 6 |
| ATOM | 856 | CG1 | VAL | A | 120 | 58.124 | −13.968 | 41.598 | 1.00 | 100.00 | 6 |
| ATOM | 857 | CG2 | VAL | A | 120 | 60.022 | −12.783 | 42.708 | 1.00 | 100.00 | 6 |
| ATOM | 858 | C | VAL | A | 120 | 59.290 | −16.498 | 41.992 | 1.00 | 100.00 | 6 |
| ATOM | 859 | O | VAL | A | 120 | 59.036 | −16.688 | 40.797 | 1.00 | 100.00 | 8 |
| ATOM | 860 | N | THR | A | 121 | 58.881 | −17.309 | 42.966 | 1.00 | 100.00 | 7 |
| ATOM | 861 | CA | THR | A | 121 | 57.826 | −18.310 | 42.781 | 1.00 | 100.00 | 6 |
| ATOM | 862 | CB | THR | A | 121 | 58.232 | −19.705 | 43.339 | 1.00 | 100.00 | 6 |
| ATOM | 863 | OG1 | THR | A | 121 | 59.650 | −19.885 | 43.229 | 1.00 | 100.00 | 8 |
| ATOM | 864 | CG2 | THR | A | 121 | 57.517 | −20.828 | 42.580 | 1.00 | 100.00 | 6 |
| ATOM | 865 | C | THR | A | 121 | 56.556 | −17.780 | 43.475 | 1.00 | 100.00 | 6 |
| ATOM | 866 | O | THR | A | 121 | 55.680 | −18.544 | 43.894 | 1.00 | 100.00 | 8 |
| ATOM | 867 | N | ILE | A | 122 | 56.482 | −16.452 | 43.589 | 1.00 | 100.00 | 7 |
| ATOM | 868 | CA | ILE | A | 122 | 55.334 | −15.740 | 44.157 | 1.00 | 100.00 | 6 |
| ATOM | 869 | CB | ILE | A | 122 | 55.686 | −14.249 | 44.462 | 1.00 | 100.00 | 6 |
| ATOM | 870 | CG1 | ILE | A | 122 | 57.087 | −14.104 | 45.101 | 1.00 | 100.00 | 6 |
| ATOM | 871 | CD1 | ILE | A | 122 | 57.306 | −14.817 | 46.447 | 1.00 | 100.00 | 6 |
| ATOM | 872 | CG2 | ILE | A | 122 | 54.591 | −13.573 | 45.290 | 1.00 | 100.00 | 6 |
| ATOM | 873 | C | ILE | A | 122 | 54.167 | −15.811 | 43.175 | 1.00 | 100.00 | 6 |
| ATOM | 874 | O | ILE | A | 122 | 53.007 | −15.631 | 43.549 | 1.00 | 100.00 | 8 |
| ATOM | 875 | N | VAL | A | 123 | 54.497 | −16.086 | 41.916 | 1.00 | 100.00 | 7 |
| ATOM | 876 | CA | VAL | A | 123 | 53.514 | −16.350 | 40.872 | 1.00 | 100.00 | 6 |
| ATOM | 877 | CB | VAL | A | 123 | 54.176 | −16.456 | 39.471 | 1.00 | 100.00 | 6 |
| ATOM | 878 | CG1 | VAL | A | 123 | 53.253 | −15.887 | 38.392 | 1.00 | 100.00 | 6 |
| ATOM | 879 | CG2 | VAL | A | 123 | 55.519 | −15.736 | 39.445 | 1.00 | 100.00 | 6 |
| ATOM | 880 | C | VAL | A | 123 | 52.746 | −17.643 | 41.180 | 1.00 | 100.00 | 6 |
| ATOM | 881 | O | VAL | A | 123 | 51.788 | −17.983 | 40.483 | 1.00 | 100.00 | 8 |
| ATOM | 882 | N | ALA | A | 124 | 53.169 | −18.352 | 42.230 | 1.00 | 100.00 | 7 |
| ATOM | 883 | CA | ALA | A | 124 | 52.484 | −19.559 | 42.697 | 1.00 | 100.00 | 6 |
| ATOM | 884 | CB | ALA | A | 124 | 53.133 | −20.091 | 43.962 | 1.00 | 100.00 | 6 |
| ATOM | 885 | C | ALA | A | 124 | 51.014 | −19.269 | 42.941 | 1.00 | 100.00 | 6 |
| ATOM | 886 | O | ALA | A | 124 | 50.158 | −20.106 | 42.661 | 1.00 | 100.00 | 8 |
| ATOM | 887 | N | LEU | A | 125 | 50.736 | −18.074 | 43.458 | 1.00 | 100.00 | 7 |
| ATOM | 888 | CA | LEU | A | 125 | 49.369 | −17.614 | 43.656 | 1.00 | 100.00 | 6 |
| ATOM | 889 | CB | LEU | A | 125 | 49.203 | −16.948 | 45.024 | 1.00 | 100.00 | 6 |
| ATOM | 890 | CG | LEU | A | 125 | 47.898 | −17.194 | 45.793 | 1.00 | 100.00 | 6 |
| ATOM | 891 | CD1 | LEU | A | 125 | 47.621 | −18.684 | 46.021 | 1.00 | 100.00 | 6 |
| ATOM | 892 | CD2 | LEU | A | 125 | 47.924 | −16.461 | 47.128 | 1.00 | 100.00 | 6 |
| ATOM | 893 | C | LEU | A | 125 | 48.990 | −16.669 | 42.532 | 1.00 | 100.00 | 6 |
| ATOM | 894 | O | LEU | A | 125 | 49.222 | −16.991 | 41.369 | 1.00 | 100.00 | 8 |
| ATOM | 895 | N | ILE | A | 126 | 48.425 | −15.509 | 42.873 | 1.00 | 100.00 | 7 |
| ATOM | 896 | CA | ILE | A | 126 | 47.800 | −14.606 | 41.893 | 1.00 | 100.00 | 6 |
| ATOM | 897 | CB | ILE | A | 126 | 48.835 | −13.939 | 40.941 | 1.00 | 100.00 | 6 |
| ATOM | 898 | CG1 | ILE | A | 126 | 50.029 | −13.395 | 41.728 | 1.00 | 100.00 | 6 |
| ATOM | 899 | CD1 | ILE | A | 126 | 49.690 | −12.326 | 42.744 | 1.00 | 100.00 | 6 |
| ATOM | 900 | CG2 | ILE | A | 126 | 48.197 | −12.829 | 40.113 | 1.00 | 100.00 | 6 |
| ATOM | 901 | C | ILE | A | 126 | 46.708 | −15.362 | 41.122 | 1.00 | 100.00 | 6 |
| ATOM | 902 | O | ILE | A | 126 | 45.916 | −14.770 | 40.387 | 1.00 | 100.00 | 8 |
| ATOM | 903 | N | CYS | A | 127 | 46.690 | −16.681 | 41.312 | 1.00 | 100.00 | 7 |
| ATOM | 904 | CA | CYS | A | 127 | 45.592 | −17.548 | 40.901 | 1.00 | 100.00 | 6 |
| ATOM | 905 | CB | CYS | A | 127 | 46.012 | −19.012 | 41.028 | 1.00 | 100.00 | 6 |
| ATOM | 906 | SG | CYS | A | 127 | 46.278 | −19.540 | 42.747 | 1.00 | 100.00 | 16 |
| ATOM | 907 | C | CYS | A | 127 | 44.399 | −17.285 | 41.817 | 1.00 | 100.00 | 6 |
| ATOM | 908 | O | CYS | A | 127 | 43.253 | −17.279 | 41.376 | 1.00 | 100.00 | 8 |
| ATOM | 909 | N | THR | A | 128 | 44.697 | −17.060 | 43.095 | 1.00 | 100.00 | 7 |
| ATOM | 910 | CA | THR | A | 128 | 43.715 | −16.732 | 44.119 | 1.00 | 100.00 | 6 |
| ATOM | 911 | CB | THR | A | 128 | 44.431 | −16.202 | 45.360 | 1.00 | 100.00 | 6 |
| ATOM | 912 | OG1 | THR | A | 128 | 44.863 | −17.317 | 46.140 | 1.00 | 100.00 | 8 |
| ATOM | 913 | CG2 | THR | A | 128 | 43.531 | −15.315 | 46.201 | 1.00 | 100.00 | 6 |
| ATOM | 914 | C | THR | A | 128 | 42.618 | −15.775 | 43.661 | 1.00 | 100.00 | 6 |
| ATOM | 915 | O | THR | A | 128 | 41.486 | −15.864 | 44.128 | 1.00 | 100.00 | 8 |
| ATOM | 916 | N | ILE | A | 129 | 42.959 | −14.877 | 42.742 | 1.00 | 100.00 | 7 |
| ATOM | 917 | CA | ILE | A | 129 | 41.983 | −14.033 | 42.059 | 1.00 | 100.00 | 6 |
| ATOM | 918 | CB | ILE | A | 129 | 42.585 | −13.426 | 40.772 | 1.00 | 100.00 | 6 |
| ATOM | 919 | CG1 | ILE | A | 129 | 43.660 | −12.393 | 41.121 | 1.00 | 100.00 | 6 |
| ATOM | 920 | CD1 | ILE | A | 129 | 43.146 | −11.154 | 41.851 | 1.00 | 100.00 | 6 |
| ATOM | 921 | CG2 | ILE | A | 129 | 41.510 | −12.793 | 39.887 | 1.00 | 100.00 | 6 |
| ATOM | 922 | C | ILE | A | 129 | 40.702 | −14.803 | 41.738 | 1.00 | 100.00 | 6 |
| ATOM | 923 | O | ILE | A | 129 | 39.635 | −14.211 | 41.591 | 1.00 | 100.00 | 8 |
| ATOM | 924 | N | ILE | A | 130 | 40.819 | −16.123 | 41.643 | 1.00 | 100.00 | 7 |
| ATOM | 925 | CA | ILE | A | 130 | 39.663 | −17.002 | 41.494 | 1.00 | 100.00 | 6 |
| ATOM | 926 | CB | ILE | A | 130 | 40.089 | −18.508 | 41.318 | 1.00 | 100.00 | 6 |
| ATOM | 927 | CG1 | ILE | A | 130 | 38.871 | −19.440 | 41.178 | 1.00 | 100.00 | 6 |
| ATOM | 928 | CD1 | ILE | A | 130 | 38.261 | −19.522 | 39.768 | 1.00 | 100.00 | 6 |
| ATOM | 929 | CG2 | ILE | A | 130 | 41.018 | −18.975 | 42.446 | 1.00 | 100.00 | 6 |
| ATOM | 930 | C | ILE | A | 130 | 38.665 | −16.816 | 42.648 | 1.00 | 100.00 | 6 |
| ATOM | 931 | O | ILE | A | 130 | 37.463 | −16.640 | 42.419 | 1.00 | 100.00 | 8 |
| ATOM | 932 | N | LEU | A | 131 | 39.167 | −16.826 | 43.880 | 1.00 | 100.00 | 7 |
| ATOM | 933 | CA | LEU | A | 131 | 38.302 | −16.723 | 45.047 | 1.00 | 100.00 | 6 |
| ATOM | 934 | CB | LEU | A | 131 | 38.756 | −17.700 | 46.138 | 1.00 | 100.00 | 6 |
| ATOM | 935 | CG | LEU | A | 131 | 38.185 | −19.131 | 46.070 | 1.00 | 100.00 | 6 |
| ATOM | 936 | CD1 | LEU | A | 131 | 38.869 | −20.013 | 45.021 | 1.00 | 100.00 | 6 |
| ATOM | 937 | CD2 | LEU | A | 131 | 38.225 | −19.827 | 47.431 | 1.00 | 100.00 | 6 |
| ATOM | 938 | C | LEU | A | 131 | 38.145 | −15.285 | 45.547 | 1.00 | 100.00 | 6 |
| ATOM | 939 | O | LEU | A | 131 | 37.712 | −15.030 | 46.665 | 1.00 | 100.00 | 8 |
| ATOM | 940 | N | VAL | A | 132 | 38.502 | −14.347 | 44.683 | 1.00 | 100.00 | 7 |
| ATOM | 941 | CA | VAL | A | 132 | 38.111 | −12.954 | 44.830 | 1.00 | 100.00 | 6 |
| ATOM | 942 | CB | VAL | A | 132 | 39.252 | −12.009 | 44.414 | 1.00 | 100.00 | 6 |
| ATOM | 943 | CG1 | VAL | A | 132 | 38.765 | −10.566 | 44.295 | 1.00 | 100.00 | 6 |
| ATOM | 944 | CG2 | VAL | A | 132 | 40.400 | −12.115 | 45.398 | 1.00 | 100.00 | 6 |
| ATOM | 945 | C | VAL | A | 132 | 36.926 | −12.760 | 43.901 | 1.00 | 100.00 | 6 |
| ATOM | 946 | O | VAL | A | 132 | 35.912 | −12.177 | 44.270 | 1.00 | 100.00 | 8 |
| ATOM | 947 | N | SER | A | 133 | 37.067 | −13.280 | 42.688 | 1.00 | 100.00 | 7 |
| ATOM | 948 | CA | SER | A | 133 | 35.997 | −13.264 | 41.714 | 1.00 | 100.00 | 6 |
| ATOM | 949 | CB | SER | A | 133 | 36.548 | −13.510 | 40.302 | 1.00 | 100.00 | 6 |
| ATOM | 950 | OG | SER | A | 133 | 37.122 | −12.331 | 39.750 | 1.00 | 100.00 | 8 |
| ATOM | 951 | C | SER | A | 133 | 34.905 | −14.271 | 42.071 | 1.00 | 100.00 | 6 |
| ATOM | 952 | O | SER | A | 133 | 33.967 | −14.468 | 41.311 | 1.00 | 100.00 | 8 |
| ATOM | 953 | N | PHE | A | 134 | 35.038 | −14.915 | 43.221 | 1.00 | 100.00 | 7 |
| ATOM | 954 | CA | PHE | A | 134 | 33.966 | −15.728 | 43.757 | 1.00 | 100.00 | 6 |
| ATOM | 955 | CB | PHE | A | 134 | 34.516 | −17.031 | 44.327 | 1.00 | 100.00 | 6 |
| ATOM | 956 | CG | PHE | A | 134 | 33.545 | −17.790 | 45.194 | 1.00 | 100.00 | 6 |
| ATOM | 957 | CD1 | PHE | A | 134 | 32.204 | −17.890 | 44.861 | 1.00 | 100.00 | 6 |
| ATOM | 958 | CE1 | PHE | A | 134 | 31.324 | −18.599 | 45.668 | 1.00 | 100.00 | 6 |
| ATOM | 959 | CZ | PHE | A | 134 | 31.786 | −19.240 | 46.808 | 1.00 | 100.00 | 6 |
| ATOM | 960 | CE2 | PHE | A | 134 | 33.122 | −19.161 | 47.142 | 1.00 | 100.00 | 6 |
| ATOM | 961 | CD2 | PHE | A | 134 | 33.994 | −18.441 | 46.334 | 1.00 | 100.00 | 6 |
| ATOM | 962 | C | PHE | A | 134 | 33.298 | −14.886 | 44.815 | 1.00 | 100.00 | 6 |
| ATOM | 963 | O | PHE | A | 134 | 32.070 | −14.880 | 44.946 | 1.00 | 100.00 | 8 |
| ATOM | 964 | N | GLN | A | 135 | 34.125 | −14.159 | 45.555 | 1.00 | 100.00 | 7 |
| ATOM | 965 | CA | GLN | A | 135 | 33.644 | −13.132 | 46.459 | 1.00 | 100.00 | 6 |
| ATOM | 966 | CB | GLN | A | 135 | 34.799 | −12.533 | 47.259 | 1.00 | 100.00 | 6 |
| ATOM | 967 | CG | GLN | A | 135 | 35.195 | −13.343 | 48.498 | 1.00 | 100.00 | 6 |
| ATOM | 968 | CD | GLN | A | 135 | 36.078 | −12.565 | 49.488 | 1.00 | 100.00 | 6 |
| ATOM | 969 | OE1 | GLN | A | 135 | 37.242 | −12.255 | 49.192 | 1.00 | 100.00 | 8 |
| ATOM | 970 | NE2 | GLN | A | 135 | 35.526 | −12.262 | 50.674 | 1.00 | 100.00 | 7 |
| ATOM | 971 | C | GLN | A | 135 | 32.951 | −12.052 | 45.648 | 1.00 | 100.00 | 6 |
| ATOM | 972 | O | GLN | A | 135 | 31.998 | −11.412 | 46.101 | 1.00 | 100.00 | 8 |
| ATOM | 973 | N | ARG | A | 136 | 33.430 | −11.865 | 44.429 | 1.00 | 100.00 | 7 |
| ATOM | 974 | CA | ARG | A | 136 | 32.782 | −10.958 | 43.518 | 1.00 | 100.00 | 6 |
| ATOM | 975 | CB | ARG | A | 136 | 33.583 | −10.825 | 42.217 | 1.00 | 100.00 | 6 |
| ATOM | 976 | CG | ARG | A | 136 | 34.734 | −9.779 | 42.216 | 1.00 | 100.00 | 6 |
| ATOM | 977 | CD | ARG | A | 136 | 34.245 | −8.305 | 42.319 | 1.00 | 100.00 | 6 |
| ATOM | 978 | NE | ARG | A | 136 | 33.319 | −7.870 | 41.254 | 1.00 | 100.00 | 7 |
| ATOM | 979 | CZ | ARG | A | 136 | 32.469 | −6.839 | 41.348 | 1.00 | 100.00 | 6 |
| ATOM | 980 | NH1 | ARG | A | 136 | 32.396 | −6.107 | 42.466 | 1.00 | 100.00 | 7 |
| ATOM | 981 | NH2 | ARG | A | 136 | 31.675 | −6.543 | 40.321 | 1.00 | 100.00 | 7 |
| ATOM | 982 | C | ARG | A | 136 | 31.351 | −11.413 | 43.228 | 1.00 | 100.00 | 6 |
| ATOM | 983 | O | ARG | A | 136 | 30.456 | −10.589 | 43.153 | 1.00 | 100.00 | 8 |
| ATOM | 984 | N | TRP | A | 137 | 31.134 | −12.718 | 43.080 | 1.00 | 100.00 | 7 |
| ATOM | 985 | CA | TRP | A | 137 | 29.803 | −13.229 | 42.745 | 1.00 | 100.00 | 6 |
| ATOM | 986 | CB | TRP | A | 137 | 29.839 | −14.724 | 42.411 | 1.00 | 100.00 | 6 |
| ATOM | 987 | CG | TRP | A | 137 | 28.497 | −15.446 | 42.267 | 1.00 | 100.00 | 6 |
| ATOM | 988 | CD1 | TRP | A | 137 | 28.180 | −16.658 | 42.808 | 1.00 | 100.00 | 6 |
| ATOM | 989 | NE1 | TRP | A | 137 | 26.895 | −17.019 | 42.469 | 1.00 | 100.00 | 7 |
| ATOM | 990 | CE2 | TRP | A | 137 | 26.340 | −16.035 | 41.690 | 1.00 | 100.00 | 6 |
| ATOM | 991 | CD2 | TRP | A | 137 | 27.321 | −15.023 | 41.529 | 1.00 | 100.00 | 6 |
| ATOM | 992 | CE3 | TRP | A | 137 | 26.998 | −13.890 | 40.756 | 1.00 | 100.00 | 6 |
| ATOM | 993 | CZ3 | TRP | A | 137 | 25.701 | −13.808 | 40.167 | 1.00 | 100.00 | 6 |
| ATOM | 994 | CH2 | TRP | A | 137 | 24.755 | −14.834 | 40.350 | 1.00 | 100.00 | 6 |
| ATOM | 995 | CZ2 | TRP | A | 137 | 25.049 | −15.950 | 41.102 | 1.00 | 100.00 | 6 |
| ATOM | 996 | C | TRP | A | 137 | 28.872 | −12.950 | 43.887 | 1.00 | 100.00 | 6 |
| ATOM | 997 | O | TRP | A | 137 | 27.700 | −12.650 | 43.681 | 1.00 | 100.00 | 8 |
| ATOM | 998 | N | VAL | A | 138 | 29.406 | −13.007 | 45.095 | 1.00 | 100.00 | 7 |
| ATOM | 999 | CA | VAL | A | 138 | 28.601 | −12.707 | 46.259 | 1.00 | 100.00 | 6 |
| ATOM | 1000 | CB | VAL | A | 138 | 29.403 | −12.859 | 47.537 | 1.00 | 100.00 | 6 |
| ATOM | 1001 | CG1 | VAL | A | 138 | 28.553 | −12.509 | 48.732 | 1.00 | 100.00 | 6 |
| ATOM | 1002 | CG2 | VAL | A | 138 | 29.888 | −14.295 | 47.640 | 1.00 | 100.00 | 6 |
| ATOM | 1003 | C | VAL | A | 138 | 27.919 | −11.349 | 46.141 | 1.00 | 100.00 | 6 |
| ATOM | 1004 | O | VAL | A | 138 | 26.692 | −11.276 | 46.198 | 1.00 | 100.00 | 8 |
| ATOM | 1005 | N | VAL | A | 139 | 28.712 | −10.302 | 45.915 | 1.00 | 100.00 | 7 |
| ATOM | 1006 | CA | VAL | A | 139 | 28.186 | −8.950 | 45.729 | 1.00 | 100.00 | 6 |
| ATOM | 1007 | CB | VAL | A | 139 | 28.802 | −8.199 | 44.510 | 1.00 | 100.00 | 6 |
| ATOM | 1008 | CG1 | VAL | A | 139 | 28.348 | −8.807 | 43.163 | 1.00 | 100.00 | 6 |
| ATOM | 1009 | CG2 | VAL | A | 139 | 28.431 | −6.706 | 44.551 | 1.00 | 100.00 | 6 |
| ATOM | 1010 | C | VAL | A | 139 | 26.679 | −8.928 | 45.579 | 1.00 | 100.00 | 6 |
| ATOM | 1011 | O | VAL | A | 139 | 25.966 | −8.738 | 46.544 | 1.00 | 100.00 | 8 |
| ATOM | 1012 | N | ARG | A | 140 | 26.189 | −9.112 | 44.367 | 1.00 | 100.00 | 7 |
| ATOM | 1013 | CA | ARG | A | 140 | 24.775 | −8.943 | 44.151 | 1.00 | 100.00 | 6 |
| ATOM | 1014 | CB | ARG | A | 140 | 24.465 | −7.651 | 43.339 | 1.00 | 100.00 | 6 |
| ATOM | 1015 | CG | ARG | A | 140 | 22.949 | −7.352 | 42.955 | 1.00 | 100.00 | 6 |
| ATOM | 1016 | CD | ARG | A | 140 | 21.913 | −7.523 | 44.115 | 1.00 | 100.00 | 6 |
| ATOM | 1017 | NE | ARG | A | 140 | 20.675 | −8.195 | 43.672 | 1.00 | 100.00 | 7 |
| ATOM | 1018 | CZ | ARG | A | 140 | 19.702 | −8.642 | 44.475 | 1.00 | 100.00 | 6 |
| ATOM | 1019 | NH1 | ARG | A | 140 | 19.774 | −8.492 | 45.801 | 1.00 | 100.00 | 7 |
| ATOM | 1020 | NH2 | ARG | A | 140 | 18.642 | −9.242 | 43.939 | 1.00 | 100.00 | 7 |
| ATOM | 1021 | C | ARG | A | 140 | 24.155 | −10.210 | 43.582 | 1.00 | 100.00 | 6 |
| ATOM | 1022 | O | ARG | A | 140 | 23.422 | −10.182 | 42.581 | 1.00 | 100.00 | 8 |
| ATOM | 1023 | N | ARG | A | 141 | 24.469 | −11.335 | 44.212 | 1.00 | 100.00 | 7 |
| ATOM | 1024 | CA | ARG | A | 141 | 23.456 | −12.366 | 44.301 | 1.00 | 100.00 | 6 |
| ATOM | 1025 | CB | ARG | A | 141 | 24.031 | −13.783 | 44.183 | 1.00 | 100.00 | 6 |
| ATOM | 1026 | CG | ARG | A | 141 | 23.026 | −14.885 | 43.723 | 1.00 | 100.00 | 6 |
| ATOM | 1027 | CD | ARG | A | 141 | 22.196 | −14.557 | 42.445 | 1.00 | 100.00 | 6 |
| ATOM | 1028 | NE | ARG | A | 141 | 20.805 | −14.144 | 42.730 | 1.00 | 100.00 | 7 |
| ATOM | 1029 | CZ | ARG | A | 141 | 19.769 | −14.242 | 41.882 | 1.00 | 100.00 | 6 |
| ATOM | 1030 | NH1 | ARG | A | 141 | 19.927 | −14.754 | 40.659 | 1.00 | 100.00 | 7 |
| ATOM | 1031 | NH2 | ARG | A | 141 | 18.558 | −13.834 | 42.261 | 1.00 | 100.00 | 7 |
| ATOM | 1032 | C | ARG | A | 141 | 22.900 | −11.987 | 45.670 | 1.00 | 100.00 | 6 |
| ATOM | 1033 | O | ARG | A | 141 | 21.696 | −12.081 | 45.944 | 1.00 | 100.00 | 8 |
| ATOM | 1034 | N | THR | A | 142 | 23.818 | −11.506 | 46.501 | 1.00 | 100.00 | 7 |
| ATOM | 1035 | CA | THR | A | 142 | 23.513 | −10.528 | 47.523 | 1.00 | 100.00 | 6 |
| ATOM | 1036 | CB | THR | A | 142 | 22.416 | −10.927 | 48.483 | 1.00 | 100.00 | 6 |
| ATOM | 1037 | OG1 | THR | A | 142 | 21.979 | −9.743 | 49.146 | 1.00 | 100.00 | 8 |
| ATOM | 1038 | CG2 | THR | A | 142 | 22.940 | −11.886 | 49.526 | 1.00 | 100.00 | 6 |
| ATOM | 1039 | C | THR | A | 142 | 24.727 | −10.251 | 48.346 | 1.00 | 100.00 | 6 |
| ATOM | 1040 | O | THR | A | 142 | 25.581 | −11.117 | 48.522 | 1.00 | 100.00 | 8 |
| ATOM | 1041 | N | GLN | A | 143 | 24.789 | −9.025 | 48.845 | 1.00 | 100.00 | 7 |
| ATOM | 1042 | CA | GLN | A | 143 | 25.818 | −8.622 | 49.772 | 1.00 | 100.00 | 6 |
| ATOM | 1043 | CB | GLN | A | 143 | 25.769 | −7.114 | 50.010 | 1.00 | 100.00 | 6 |
| ATOM | 1044 | CG | GLN | A | 143 | 24.397 | −6.515 | 49.928 | 1.00 | 100.00 | 6 |
| ATOM | 1045 | CD | GLN | A | 143 | 23.884 | −6.509 | 48.505 | 1.00 | 100.00 | 6 |
| ATOM | 1046 | OE1 | GLN | A | 143 | 23.161 | −7.414 | 48.092 | 1.00 | 100.00 | 8 |
| ATOM | 1047 | NE2 | GLN | A | 143 | 24.289 | −5.505 | 47.732 | 1.00 | 100.00 | 7 |
| ATOM | 1048 | C | GLN | A | 143 | 25.564 | −9.370 | 51.055 | 1.00 | 100.00 | 6 |
| ATOM | 1049 | O | GLN | A | 143 | 24.397 | −9.572 | 51.428 | 1.00 | 100.00 | 8 |
| ATOM | 1050 | N | SER | A | 144 | 26.647 | −9.829 | 51.699 | 1.00 | 100.00 | 7 |
| ATOM | 1051 | CA | SER | A | 144 | 26.609 | −10.209 | 53.125 | 1.00 | 100.00 | 6 |
| ATOM | 1052 | CB | SER | A | 144 | 27.871 | −10.965 | 53.550 | 1.00 | 100.00 | 6 |
| ATOM | 1053 | OG | SER | A | 144 | 28.949 | −10.071 | 53.803 | 1.00 | 100.00 | 8 |
| ATOM | 1054 | C | SER | A | 144 | 26.539 | −8.864 | 53.847 | 1.00 | 100.00 | 6 |
| ATOM | 1055 | O | SER | A | 144 | 27.481 | −8.467 | 54.573 | 1.00 | 100.00 | 8 |
| ATOM | 1056 | N | GLN | A | 145 | 25.403 | −8.181 | 53.636 | 1.00 | 100.00 | 7 |
| ATOM | 1057 | CA | GLN | A | 145 | 25.370 | −6.702 | 53.605 | 1.00 | 100.00 | 6 |
| ATOM | 1058 | CB | GLN | A | 145 | 24.482 | −6.065 | 54.742 | 1.00 | 100.00 | 6 |
| ATOM | 1059 | CG | GLN | A | 145 | 22.945 | −5.886 | 54.318 | 1.00 | 100.00 | 6 |
| ATOM | 1060 | CD | GLN | A | 145 | 21.942 | −5.523 | 55.450 | 1.00 | 100.00 | 6 |
| ATOM | 1061 | OE1 | GLN | A | 145 | 21.815 | −6.240 | 56.450 | 1.00 | 100.00 | 8 |
| ATOM | 1062 | NE2 | GLN | A | 145 | 21.194 | −4.428 | 55.247 | 1.00 | 100.00 | 7 |
| ATOM | 1063 | C | GLN | A | 145 | 26.832 | −6.189 | 53.431 | 1.00 | 100.00 | 6 |
| ATOM | 1064 | O | GLN | A | 145 | 27.516 | −5.759 | 54.379 | 1.00 | 100.00 | 8 |
| ATOM | 1065 | N | ALA | A | 146 | 27.311 | −6.374 | 52.200 | 1.00 | 100.00 | 7 |
| ATOM | 1066 | CA | ALA | A | 146 | 28.624 | −5.953 | 51.799 | 1.00 | 100.00 | 6 |
| ATOM | 1067 | CB | ALA | A | 146 | 28.575 | −4.467 | 51.347 | 1.00 | 100.00 | 6 |
| ATOM | 1068 | C | ALA | A | 146 | 29.683 | −6.195 | 52.892 | 1.00 | 100.00 | 6 |
| ATOM | 1069 | O | ALA | A | 146 | 30.640 | −5.448 | 53.027 | 1.00 | 100.00 | 8 |
| ATOM | 1070 | N | VAL | A | 147 | 29.525 | −7.245 | 53.672 | 1.00 | 100.00 | 7 |
| ATOM | 1071 | CA | VAL | A | 147 | 30.492 | −7.476 | 54.710 | 1.00 | 100.00 | 6 |
| ATOM | 1072 | CB | VAL | A | 147 | 29.814 | −7.965 | 55.933 | 1.00 | 100.00 | 6 |
| ATOM | 1073 | CG1 | VAL | A | 147 | 30.693 | −8.940 | 56.688 | 1.00 | 100.00 | 6 |
| ATOM | 1074 | CG2 | VAL | A | 147 | 29.456 | −6.776 | 56.750 | 1.00 | 100.00 | 6 |
| ATOM | 1075 | C | VAL | A | 147 | 31.514 | −8.445 | 54.214 | 1.00 | 100.00 | 6 |
| ATOM | 1076 | O | VAL | A | 147 | 32.667 | −8.432 | 54.636 | 1.00 | 100.00 | 8 |
| ATOM | 1077 | N | ARG | A | 148 | 31.067 | −9.283 | 53.295 | 1.00 | 100.00 | 7 |
| ATOM | 1078 | CA | ARG | A | 148 | 31.972 | −10.035 | 52.479 | 1.00 | 100.00 | 6 |
| ATOM | 1079 | CB | ARG | A | 148 | 31.229 | −10.855 | 51.422 | 1.00 | 100.00 | 6 |
| ATOM | 1080 | CG | ARG | A | 148 | 30.178 | −11.848 | 51.932 | 1.00 | 100.00 | 6 |
| ATOM | 1081 | CD | ARG | A | 148 | 30.728 | −13.198 | 52.481 | 1.00 | 100.00 | 6 |
| ATOM | 1082 | NE | ARG | A | 148 | 29.981 | −14.330 | 51.909 | 1.00 | 100.00 | 7 |
| ATOM | 1083 | CZ | ARG | A | 148 | 29.816 | −15.542 | 52.446 | 1.00 | 100.00 | 6 |
| ATOM | 1084 | NH1 | ARG | A | 148 | 30.311 | −15.867 | 53.631 | 1.00 | 100.00 | 7 |
| ATOM | 1085 | NH2 | ARG | A | 148 | 29.115 | −16.442 | 51.776 | 1.00 | 100.00 | 7 |
| ATOM | 1086 | C | ARG | A | 148 | 32.835 | −9.009 | 51.785 | 1.00 | 100.00 | 6 |
| ATOM | 1087 | O | ARG | A | 148 | 34.036 | −9.228 | 51.624 | 1.00 | 100.00 | 8 |
| ATOM | 1088 | N | ALA | A | 149 | 32.230 | −7.876 | 51.413 | 1.00 | 100.00 | 7 |
| ATOM | 1089 | CA | ALA | A | 149 | 32.904 | −6.856 | 50.602 | 1.00 | 100.00 | 6 |
| ATOM | 1090 | CB | ALA | A | 149 | 31.956 | −5.784 | 50.173 | 1.00 | 100.00 | 6 |
| ATOM | 1091 | C | ALA | A | 149 | 34.137 | −6.261 | 51.261 | 1.00 | 100.00 | 6 |
| ATOM | 1092 | O | ALA | A | 149 | 34.670 | −5.244 | 50.804 | 1.00 | 100.00 | 8 |
| ATOM | 1093 | N | ASP | A | 150 | 34.589 | −6.903 | 52.335 | 1.00 | 100.00 | 7 |
| ATOM | 1094 | CA | ASP | A | 150 | 35.940 | −6.697 | 52.821 | 1.00 | 100.00 | 6 |
| ATOM | 1095 | CB | ASP | A | 150 | 36.133 | −7.316 | 54.212 | 1.00 | 100.00 | 6 |
| ATOM | 1096 | CG | ASP | A | 150 | 36.755 | −8.696 | 54.165 | 1.00 | 100.00 | 6 |
| ATOM | 1097 | OD1 | ASP | A | 150 | 36.509 | −9.442 | 53.178 | 1.00 | 100.00 | 8 |
| ATOM | 1098 | OD2 | ASP | A | 150 | 37.498 | −9.025 | 55.125 | 1.00 | 100.00 | 8 |
| ATOM | 1099 | C | ASP | A | 150 | 36.879 | −7.285 | 51.764 | 1.00 | 100.00 | 6 |
| ATOM | 1100 | O | ASP | A | 150 | 37.904 | −6.702 | 51.455 | 1.00 | 100.00 | 8 |
| ATOM | 1101 | N | MET | A | 151 | 36.502 | −8.434 | 51.209 | 1.00 | 100.00 | 7 |
| ATOM | 1102 | CA | MET | A | 151 | 37.076 | −8.960 | 49.975 | 1.00 | 100.00 | 6 |
| ATOM | 1103 | CB | MET | A | 151 | 35.946 | −9.295 | 49.002 | 1.00 | 100.00 | 6 |
| ATOM | 1104 | CG | MET | A | 151 | 36.371 | −9.393 | 47.546 | 1.00 | 100.00 | 6 |
| ATOM | 1105 | SD | MET | A | 151 | 35.231 | −8.556 | 46.431 | 1.00 | 100.00 | 16 |
| ATOM | 1106 | CE | MET | A | 151 | 36.387 | −8.093 | 45.151 | 1.00 | 100.00 | 6 |
| ATOM | 1107 | C | MET | A | 151 | 38.057 | −8.019 | 49.273 | 1.00 | 100.00 | 6 |
| ATOM | 1108 | O | MET | A | 151 | 39.196 | −8.402 | 49.012 | 1.00 | 100.00 | 8 |
| ATOM | 1109 | N | LEU | A | 152 | 37.606 | −6.802 | 48.951 | 1.00 | 100.00 | 7 |
| ATOM | 1110 | CA | LEU | A | 152 | 38.451 | −5.826 | 48.267 | 1.00 | 100.00 | 6 |
| ATOM | 1111 | CB | LEU | A | 152 | 37.729 | −4.474 | 48.072 | 1.00 | 100.00 | 6 |
| ATOM | 1112 | CG | LEU | A | 152 | 37.149 | −4.009 | 46.711 | 1.00 | 100.00 | 6 |
| ATOM | 1113 | CD1 | LEU | A | 152 | 35.925 | −4.802 | 46.307 | 1.00 | 100.00 | 6 |
| ATOM | 1114 | CD2 | LEU | A | 152 | 36.807 | −2.501 | 46.646 | 1.00 | 100.00 | 6 |
| ATOM | 1115 | C | LEU | A | 152 | 39.805 | −5.684 | 48.986 | 1.00 | 100.00 | 6 |
| ATOM | 1116 | O | LEU | A | 152 | 40.743 | −5.112 | 48.445 | 1.00 | 100.00 | 8 |
| ATOM | 1117 | N | HIS | A | 153 | 39.891 | −6.217 | 50.205 | 1.00 | 100.00 | 7 |
| ATOM | 1118 | CA | HIS | A | 153 | 41.152 | −6.391 | 50.917 | 1.00 | 100.00 | 6 |
| ATOM | 1119 | CB | HIS | A | 153 | 40.907 | −7.050 | 52.275 | 1.00 | 100.00 | 6 |
| ATOM | 1120 | CG | HIS | A | 153 | 42.149 | −7.366 | 53.068 | 1.00 | 100.00 | 6 |
| ATOM | 1121 | ND1 | HIS | A | 153 | 42.282 | −7.039 | 54.406 | 1.00 | 100.00 | 7 |
| ATOM | 1122 | CE1 | HIS | A | 153 | 43.450 | −7.463 | 54.856 | 1.00 | 100.00 | 6 |
| ATOM | 1123 | NE2 | HIS | A | 153 | 44.080 | −8.063 | 53.861 | 1.00 | 100.00 | 7 |
| ATOM | 1124 | CD2 | HIS | A | 153 | 43.283 | −8.030 | 52.737 | 1.00 | 100.00 | 6 |
| ATOM | 1125 | C | HIS | A | 153 | 41.976 | −7.289 | 50.049 | 1.00 | 100.00 | 6 |
| ATOM | 1126 | O | HIS | A | 153 | 43.100 | −6.960 | 49.744 | 1.00 | 100.00 | 8 |
| ATOM | 1127 | N | TYR | A | 154 | 41.400 | −8.408 | 49.634 | 1.00 | 100.00 | 7 |
| ATOM | 1128 | CA | TYR | A | 154 | 42.066 | −9.318 | 48.722 | 1.00 | 100.00 | 6 |
| ATOM | 1129 | CB | TYR | A | 154 | 41.333 | −10.647 | 48.668 | 1.00 | 100.00 | 6 |
| ATOM | 1130 | CG | TYR | A | 154 | 41.185 | −11.199 | 50.033 | 1.00 | 100.00 | 6 |
| ATOM | 1131 | CD1 | TYR | A | 154 | 40.325 | −10.596 | 50.925 | 1.00 | 100.00 | 6 |
| ATOM | 1132 | CE1 | TYR | A | 154 | 40.187 | −11.059 | 52.210 | 1.00 | 100.00 | 6 |
| ATOM | 1133 | CZ | TYR | A | 154 | 40.917 | −12.157 | 52.638 | 1.00 | 100.00 | 6 |
| ATOM | 1134 | OH | TYR | A | 154 | 40.740 | −12.589 | 53.954 | 1.00 | 100.00 | 8 |
| ATOM | 1135 | CE2 | TYR | A | 154 | 41.805 | −12.780 | 51.753 | 1.00 | 100.00 | 6 |
| ATOM | 1136 | CD2 | TYR | A | 154 | 41.936 | −12.287 | 50.459 | 1.00 | 100.00 | 6 |
| ATOM | 1137 | C | TYR | A | 154 | 42.190 | −8.706 | 47.347 | 1.00 | 100.00 | 6 |
| ATOM | 1138 | O | TYR | A | 154 | 43.236 | −8.828 | 46.709 | 1.00 | 100.00 | 8 |
| ATOM | 1139 | N | GLN | A | 155 | 41.148 | −8.015 | 46.894 | 1.00 | 100.00 | 7 |
| ATOM | 1140 | CA | GLN | A | 155 | 41.221 | −7.349 | 45.590 | 1.00 | 100.00 | 6 |
| ATOM | 1141 | CB | GLN | A | 155 | 39.909 | −6.620 | 45.266 | 1.00 | 100.00 | 6 |
| ATOM | 1142 | CG | GLN | A | 155 | 39.644 | −6.459 | 43.759 | 1.00 | 100.00 | 6 |
| ATOM | 1143 | CD | GLN | A | 155 | 38.443 | −5.571 | 43.430 | 1.00 | 100.00 | 6 |
| ATOM | 1144 | OE1 | GLN | A | 155 | 38.252 | −4.502 | 44.024 | 1.00 | 100.00 | 8 |
| ATOM | 1145 | NE2 | GLN | A | 155 | 37.642 | −6.005 | 42.452 | 1.00 | 100.00 | 7 |
| ATOM | 1146 | C | GLN | A | 155 | 42.436 | −6.403 | 45.528 | 1.00 | 100.00 | 6 |
| ATOM | 1147 | O | GLN | A | 155 | 42.829 | −5.932 | 44.459 | 1.00 | 100.00 | 8 |
| ATOM | 1148 | N | SER | A | 156 | 43.029 | −6.161 | 46.692 | 1.00 | 100.00 | 7 |
| ATOM | 1149 | CA | SER | A | 156 | 44.203 | −5.319 | 46.824 | 1.00 | 100.00 | 6 |
| ATOM | 1150 | CB | SER | A | 156 | 43.814 | −4.004 | 47.483 | 1.00 | 100.00 | 6 |
| ATOM | 1151 | OG | SER | A | 156 | 42.785 | −3.351 | 46.774 | 1.00 | 100.00 | 8 |
| ATOM | 1152 | C | SER | A | 156 | 45.287 | −6.030 | 47.640 | 1.00 | 100.00 | 6 |
| ATOM | 1153 | O | SER | A | 156 | 46.390 | −5.517 | 47.840 | 1.00 | 100.00 | 8 |
| ATOM | 1154 | N | ASP | A | 157 | 44.954 | −7.217 | 48.121 | 1.00 | 100.00 | 7 |
| ATOM | 1155 | CA | ASP | A | 157 | 45.922 | −8.073 | 48.767 | 1.00 | 100.00 | 6 |
| ATOM | 1156 | CB | ASP | A | 157 | 45.320 | −8.732 | 49.997 | 1.00 | 100.00 | 6 |
| ATOM | 1157 | CG | ASP | A | 157 | 46.281 | −8.797 | 51.144 | 1.00 | 100.00 | 6 |
| ATOM | 1158 | OD1 | ASP | A | 157 | 47.307 | −8.095 | 51.115 | 1.00 | 100.00 | 8 |
| ATOM | 1159 | OD2 | ASP | A | 157 | 46.001 | −9.551 | 52.090 | 1.00 | 100.00 | 8 |
| ATOM | 1160 | C | ASP | A | 157 | 46.319 | −9.124 | 47.760 | 1.00 | 100.00 | 6 |
| ATOM | 1161 | O | ASP | A | 157 | 47.177 | −9.950 | 48.034 | 1.00 | 100.00 | 8 |
| ATOM | 1162 | N | VAL | A | 158 | 45.639 | −9.115 | 46.616 | 1.00 | 100.00 | 7 |
| ATOM | 1163 | CA | VAL | A | 158 | 46.126 | −9.751 | 45.403 | 1.00 | 100.00 | 6 |
| ATOM | 1164 | CB | VAL | A | 158 | 45.181 | −10.842 | 44.842 | 1.00 | 100.00 | 6 |
| ATOM | 1165 | CG1 | VAL | A | 158 | 45.942 | −11.735 | 43.883 | 1.00 | 100.00 | 6 |
| ATOM | 1166 | CG2 | VAL | A | 158 | 44.605 | −11.697 | 45.954 | 1.00 | 100.00 | 6 |
| ATOM | 1167 | C | VAL | A | 158 | 46.315 | −8.602 | 44.422 | 1.00 | 100.00 | 6 |
| ATOM | 1168 | O | VAL | A | 158 | 45.693 | −8.538 | 43.362 | 1.00 | 100.00 | 8 |
| ATOM | 1169 | N | MET | A | 159 | 47.168 | −7.670 | 44.834 | 1.00 | 100.00 | 7 |
| ATOM | 1170 | CA | MET | A | 159 | 47.546 | −6.530 | 44.029 | 1.00 | 100.00 | 6 |
| ATOM | 1171 | CB | MET | A | 159 | 47.048 | −5.249 | 44.673 | 1.00 | 100.00 | 6 |
| ATOM | 1172 | CG | MET | A | 159 | 46.413 | −4.290 | 43.713 | 1.00 | 100.00 | 6 |
| ATOM | 1173 | SD | MET | A | 159 | 45.091 | −5.082 | 42.810 | 1.00 | 100.00 | 16 |
| ATOM | 1174 | CE | MET | A | 159 | 44.121 | −3.645 | 42.343 | 1.00 | 100.00 | 6 |
| ATOM | 1175 | C | MET | A | 159 | 49.058 | −6.503 | 43.903 | 1.00 | 100.00 | 6 |
| ATOM | 1176 | O | MET | A | 159 | 49.712 | −5.501 | 44.200 | 1.00 | 100.00 | 8 |
| ATOM | 1177 | N | MET | A | 160 | 49.606 | −7.638 | 43.491 | 1.00 | 100.00 | 7 |
| ATOM | 1178 | CA | MET | A | 160 | 50.976 | −7.707 | 43.040 | 1.00 | 100.00 | 6 |
| ATOM | 1179 | CB | MET | A | 160 | 51.458 | −9.154 | 43.003 | 1.00 | 100.00 | 6 |
| ATOM | 1180 | CG | MET | A | 160 | 51.917 | −9.702 | 44.337 | 1.00 | 100.00 | 6 |
| ATOM | 1181 | SD | MET | A | 160 | 50.576 | −10.041 | 45.485 | 1.00 | 100.00 | 16 |
| ATOM | 1182 | CE | MET | A | 160 | 51.477 | −10.643 | 46.922 | 1.00 | 100.00 | 6 |
| ATOM | 1183 | C | MET | A | 160 | 50.986 | −7.120 | 41.644 | 1.00 | 100.00 | 6 |
| ATOM | 1184 | O | MET | A | 160 | 50.968 | −7.854 | 40.656 | 1.00 | 100.00 | 8 |
| ATOM | 1185 | N | ASN | A | 161 | 50.964 | −5.790 | 41.576 | 1.00 | 100.00 | 7 |
| ATOM | 1186 | CA | ASN | A | 161 | 51.031 | −5.057 | 40.305 | 1.00 | 100.00 | 6 |
| ATOM | 1187 | CB | ASN | A | 161 | 49.984 | −3.937 | 40.256 | 1.00 | 100.00 | 6 |
| ATOM | 1188 | CG | ASN | A | 161 | 48.569 | −4.458 | 40.013 | 1.00 | 100.00 | 6 |
| ATOM | 1189 | OD1 | ASN | A | 161 | 48.321 | −5.231 | 39.084 | 1.00 | 100.00 | 8 |
| ATOM | 1190 | ND2 | ASN | A | 161 | 47.630 | −4.007 | 40.836 | 1.00 | 100.00 | 7 |
| ATOM | 1191 | C | ASN | A | 161 | 52.438 | −4.507 | 40.057 | 1.00 | 100.00 | 6 |
| ATOM | 1192 | O | ASN | A | 161 | 52.737 | −3.937 | 38.996 | 1.00 | 100.00 | 8 |
| ATOM | 1193 | N | GLY | A | 162 | 53.288 | −4.669 | 41.065 | 1.00 | 100.00 | 7 |
| ATOM | 1194 | CA | GLY | A | 162 | 54.720 | −4.549 | 40.890 | 1.00 | 100.00 | 6 |
| ATOM | 1195 | C | GLY | A | 162 | 55.229 | −5.934 | 40.550 | 1.00 | 100.00 | 6 |
| ATOM | 1196 | O | GLY | A | 162 | 55.817 | −6.141 | 39.484 | 1.00 | 100.00 | 8 |
| ATOM | 1197 | N | ALA | A | 163 | 54.971 | −6.884 | 41.452 | 1.00 | 100.00 | 7 |
| ATOM | 1198 | CA | ALA | A | 163 | 55.381 | −8.278 | 41.271 | 1.00 | 100.00 | 6 |
| ATOM | 1199 | CB | ALA | A | 163 | 55.161 | −9.073 | 42.554 | 1.00 | 100.00 | 6 |
| ATOM | 1200 | C | ALA | A | 163 | 54.659 | −8.932 | 40.093 | 1.00 | 100.00 | 6 |
| ATOM | 1201 | O | ALA | A | 163 | 53.435 | −8.867 | 39.995 | 1.00 | 100.00 | 8 |
| ATOM | 1202 | N | ILE | A | 164 | 55.438 | −9.555 | 39.205 | 1.00 | 100.00 | 7 |
| ATOM | 1203 | CA | ILE | A | 164 | 54.946 | −10.186 | 37.967 | 1.00 | 100.00 | 6 |
| ATOM | 1204 | CB | ILE | A | 164 | 53.955 | −11.368 | 38.244 | 1.00 | 100.00 | 6 |
| ATOM | 1205 | CG1 | ILE | A | 164 | 54.438 | −12.201 | 39.438 | 1.00 | 100.00 | 6 |
| ATOM | 1206 | CD1 | ILE | A | 164 | 53.341 | −12.648 | 40.378 | 1.00 | 100.00 | 6 |
| ATOM | 1207 | CG2 | ILE | A | 164 | 53.813 | −12.276 | 37.016 | 1.00 | 100.00 | 6 |
| ATOM | 1208 | C | ILE | A | 164 | 54.377 | −9.130 | 37.006 | 1.00 | 100.00 | 6 |
| ATOM | 1209 | O | ILE | A | 164 | 53.625 | −9.442 | 36.082 | 1.00 | 100.00 | 8 |
| ATOM | 1210 | N | LEU | A | 165 | 54.761 | −7.878 | 37.241 | 1.00 | 100.00 | 7 |
| ATOM | 1211 | CA | LEU | A | 165 | 54.437 | −6.771 | 36.356 | 1.00 | 100.00 | 6 |
| ATOM | 1212 | CB | LEU | A | 165 | 53.071 | −6.177 | 36.705 | 1.00 | 100.00 | 6 |
| ATOM | 1213 | CG | LEU | A | 165 | 52.209 | −5.485 | 35.634 | 1.00 | 100.00 | 6 |
| ATOM | 1214 | CD1 | LEU | A | 165 | 52.701 | −4.078 | 35.293 | 1.00 | 100.00 | 6 |
| ATOM | 1215 | CD2 | LEU | A | 165 | 52.036 | −6.341 | 34.371 | 1.00 | 100.00 | 6 |
| ATOM | 1216 | C | LEU | A | 165 | 55.545 | −5.732 | 36.477 | 1.00 | 100.00 | 6 |
| ATOM | 1217 | O | LEU | A | 165 | 55.345 | −4.637 | 37.005 | 1.00 | 100.00 | 8 |
| ATOM | 1218 | N | LEU | A | 166 | 56.722 | −6.109 | 35.991 | 1.00 | 100.00 | 7 |
| ATOM | 1219 | CA | LEU | A | 166 | 57.921 | −5.283 | 36.082 | 1.00 | 100.00 | 6 |
| ATOM | 1220 | CB | LEU | A | 166 | 59.155 | −6.154 | 36.368 | 1.00 | 100.00 | 6 |
| ATOM | 1221 | CG | LEU | A | 166 | 59.215 | −7.609 | 35.876 | 1.00 | 100.00 | 6 |
| ATOM | 1222 | CD1 | LEU | A | 166 | 59.382 | −7.726 | 34.365 | 1.00 | 100.00 | 6 |
| ATOM | 1223 | CD2 | LEU | A | 166 | 60.332 | −8.348 | 36.578 | 1.00 | 100.00 | 6 |
| ATOM | 1224 | C | LEU | A | 166 | 58.151 | −4.442 | 34.832 | 1.00 | 100.00 | 6 |
| ATOM | 1225 | O | LEU | A | 166 | 57.817 | −4.852 | 33.720 | 1.00 | 100.00 | 8 |
| ATOM | 1226 | N | ALA | A | 167 | 58.716 | −3.256 | 35.034 | 1.00 | 100.00 | 7 |
| ATOM | 1227 | CA | ALA | A | 167 | 59.180 | −2.426 | 33.934 | 1.00 | 100.00 | 6 |
| ATOM | 1228 | CB | ALA | A | 167 | 58.922 | −0.954 | 34.228 | 1.00 | 100.00 | 6 |
| ATOM | 1229 | C | ALA | A | 167 | 60.670 | −2.701 | 33.704 | 1.00 | 100.00 | 6 |
| ATOM | 1230 | O | ALA | A | 167 | 61.510 | −1.799 | 33.766 | 1.00 | 100.00 | 8 |
| ATOM | 1231 | N | LEU | A | 168 | 60.975 | −3.970 | 33.439 | 1.00 | 100.00 | 7 |
| ATOM | 1232 | CA | LEU | A | 168 | 62.342 | −4.448 | 33.246 | 1.00 | 100.00 | 6 |
| ATOM | 1233 | CB | LEU | A | 168 | 62.427 | −5.937 | 33.617 | 1.00 | 100.00 | 6 |
| ATOM | 1234 | CG | LEU | A | 168 | 63.528 | −6.854 | 33.072 | 1.00 | 100.00 | 6 |
| ATOM | 1235 | CD1 | LEU | A | 168 | 64.878 | −6.561 | 33.710 | 1.00 | 100.00 | 6 |
| ATOM | 1236 | CD2 | LEU | A | 168 | 63.140 | −8.308 | 33.284 | 1.00 | 100.00 | 6 |
| ATOM | 1237 | C | LEU | A | 168 | 62.851 | −4.207 | 31.823 | 1.00 | 100.00 | 6 |
| ATOM | 1238 | O | LEU | A | 168 | 62.354 | −4.796 | 30.860 | 1.00 | 100.00 | 8 |
| ATOM | 1239 | N | GLY | A | 169 | 63.843 | −3.329 | 31.711 | 1.00 | 100.00 | 7 |
| ATOM | 1240 | CA | GLY | A | 169 | 64.528 | −3.072 | 30.448 | 1.00 | 100.00 | 6 |
| ATOM | 1241 | C | GLY | A | 169 | 63.674 | −2.473 | 29.347 | 1.00 | 100.00 | 6 |
| ATOM | 1242 | O | GLY | A | 169 | 63.695 | −2.956 | 28.214 | 1.00 | 100.00 | 8 |
| ATOM | 1243 | N | LEU | A | 170 | 62.925 | −1.423 | 29.679 | 1.00 | 100.00 | 7 |
| ATOM | 1244 | CA | LEU | A | 170 | 62.117 | −0.703 | 28.690 | 1.00 | 100.00 | 6 |
| ATOM | 1245 | CB | LEU | A | 170 | 60.666 | −1.190 | 28.696 | 1.00 | 100.00 | 6 |
| ATOM | 1246 | CG | LEU | A | 170 | 60.257 | −2.179 | 27.607 | 1.00 | 100.00 | 6 |
| ATOM | 1247 | CD1 | LEU | A | 170 | 60.458 | −3.616 | 28.063 | 1.00 | 100.00 | 6 |
| ATOM | 1248 | CD2 | LEU | A | 170 | 58.811 | −1.926 | 27.248 | 1.00 | 100.00 | 6 |
| ATOM | 1249 | C | LEU | A | 170 | 62.164 | 0.820 | 28.823 | 1.00 | 100.00 | 6 |
| ATOM | 1250 | O | LEU | A | 170 | 62.469 | 1.515 | 27.852 | 1.00 | 100.00 | 8 |
| ATOM | 1251 | N | SER | A | 171 | 61.850 | 1.338 | 30.011 | 1.00 | 100.00 | 7 |
| ATOM | 1252 | CA | SER | A | 171 | 61.853 | 2.789 | 30.239 | 1.00 | 100.00 | 6 |
| ATOM | 1253 | CB | SER | A | 171 | 60.521 | 3.425 | 29.804 | 1.00 | 100.00 | 6 |
| ATOM | 1254 | OG | SER | A | 171 | 60.402 | 3.473 | 28.389 | 1.00 | 100.00 | 8 |
| ATOM | 1255 | C | SER | A | 171 | 62.219 | 3.201 | 31.673 | 1.00 | 100.00 | 6 |
| ATOM | 1256 | O | SER | A | 171 | 63.140 | 3.998 | 31.869 | 1.00 | 100.00 | 8 |
| ATOM | 1257 | N | TRP | A | 172 | 61.505 | 2.667 | 32.664 | 1.00 | 100.00 | 7 |
| ATOM | 1258 | CA | TRP | A | 172 | 61.759 | 3.009 | 34.068 | 1.00 | 100.00 | 6 |
| ATOM | 1259 | CB | TRP | A | 172 | 60.453 | 3.018 | 34.882 | 1.00 | 100.00 | 6 |
| ATOM | 1260 | CG | TRP | A | 172 | 59.526 | 4.173 | 34.555 | 1.00 | 100.00 | 6 |
| ATOM | 1261 | CD1 | TRP | A | 172 | 59.647 | 5.470 | 34.973 | 1.00 | 100.00 | 6 |
| ATOM | 1262 | NE1 | TRP | A | 172 | 58.616 | 6.230 | 34.476 | 1.00 | 100.00 | 7 |
| ATOM | 1263 | CE2 | TRP | A | 172 | 57.800 | 5.430 | 33.721 | 1.00 | 100.00 | 6 |
| ATOM | 1264 | CD2 | TRP | A | 172 | 58.340 | 4.124 | 33.750 | 1.00 | 100.00 | 6 |
| ATOM | 1265 | CE3 | TRP | A | 172 | 57.684 | 3.105 | 33.049 | 1.00 | 100.00 | 6 |
| ATOM | 1266 | CZ3 | TRP | A | 172 | 56.526 | 3.418 | 32.349 | 1.00 | 100.00 | 6 |
| ATOM | 1267 | CH2 | TRP | A | 172 | 56.015 | 4.728 | 32.340 | 1.00 | 100.00 | 6 |
| ATOM | 1268 | CZ2 | TRP | A | 172 | 56.636 | 5.744 | 33.018 | 1.00 | 100.00 | 6 |
| ATOM | 1269 | C | TRP | A | 172 | 62.805 | 2.076 | 34.693 | 1.00 | 100.00 | 6 |
| ATOM | 1270 | O | TRP | A | 172 | 62.595 | 0.861 | 34.773 | 1.00 | 100.00 | 8 |
| ATOM | 1271 | N | TYR | A | 173 | 63.928 | 2.659 | 35.120 | 1.00 | 100.00 | 7 |
| ATOM | 1272 | CA | TYR | A | 173 | 65.060 | 1.912 | 35.685 | 1.00 | 100.00 | 6 |
| ATOM | 1273 | CB | TYR | A | 173 | 66.268 | 2.841 | 35.912 | 1.00 | 100.00 | 6 |
| ATOM | 1274 | CG | TYR | A | 173 | 67.610 | 2.138 | 36.062 | 1.00 | 100.00 | 6 |
| ATOM | 1275 | CD1 | TYR | A | 173 | 67.874 | 1.308 | 37.155 | 1.00 | 100.00 | 6 |
| ATOM | 1276 | CE1 | TYR | A | 173 | 69.101 | 0.665 | 37.294 | 1.00 | 100.00 | 6 |
| ATOM | 1277 | CZ | TYR | A | 173 | 70.087 | 0.859 | 36.343 | 1.00 | 100.00 | 6 |
| ATOM | 1278 | OH | TYR | A | 173 | 71.301 | 0.226 | 36.485 | 1.00 | 100.00 | 8 |
| ATOM | 1279 | CE2 | TYR | A | 173 | 69.856 | 1.684 | 35.252 | 1.00 | 100.00 | 6 |
| ATOM | 1280 | CD2 | TYR | A | 173 | 68.622 | 2.321 | 35.119 | 1.00 | 100.00 | 6 |
| ATOM | 1281 | C | TYR | A | 173 | 64.666 | 1.226 | 36.992 | 1.00 | 100.00 | 6 |
| ATOM | 1282 | O | TYR | A | 173 | 64.627 | −0.003 | 37.075 | 1.00 | 100.00 | 8 |
| ATOM | 1283 | N | GLY | A | 174 | 64.378 | 2.034 | 38.007 | 1.00 | 100.00 | 7 |
| ATOM | 1284 | CA | GLY | A | 174 | 63.959 | 1.529 | 39.307 | 1.00 | 100.00 | 6 |
| ATOM | 1285 | C | GLY | A | 174 | 62.657 | 2.151 | 39.768 | 1.00 | 100.00 | 6 |
| ATOM | 1286 | O | GLY | A | 174 | 62.233 | 1.947 | 40.909 | 1.00 | 100.00 | 8 |
| ATOM | 1287 | N | TRP | A | 175 | 62.024 | 2.910 | 38.874 | 1.00 | 100.00 | 7 |
| ATOM | 1288 | CA | TRP | A | 175 | 60.738 | 3.545 | 39.153 | 1.00 | 100.00 | 6 |
| ATOM | 1289 | CB | TRP | A | 175 | 60.608 | 4.868 | 38.371 | 1.00 | 100.00 | 6 |
| ATOM | 1290 | CG | TRP | A | 175 | 61.519 | 5.988 | 38.856 | 1.00 | 100.00 | 6 |
| ATOM | 1291 | CD1 | TRP | A | 175 | 61.452 | 6.639 | 40.057 | 1.00 | 100.00 | 6 |
| ATOM | 1292 | NE1 | TRP | A | 175 | 62.435 | 7.597 | 40.137 | 1.00 | 100.00 | 7 |
| ATOM | 1293 | CE2 | TRP | A | 175 | 63.158 | 7.591 | 38.975 | 1.00 | 100.00 | 6 |
| ATOM | 1294 | CD2 | TRP | A | 175 | 62.609 | 6.592 | 38.139 | 1.00 | 100.00 | 6 |
| ATOM | 1295 | CE3 | TRP | A | 175 | 63.178 | 6.381 | 36.875 | 1.00 | 100.00 | 6 |
| ATOM | 1296 | CZ3 | TRP | A | 175 | 64.264 | 7.166 | 36.491 | 1.00 | 100.00 | 6 |
| ATOM | 1297 | CH2 | TRP | A | 175 | 64.785 | 8.151 | 37.347 | 1.00 | 100.00 | 6 |
| ATOM | 1298 | CZ2 | TRP | A | 175 | 64.248 | 8.378 | 38.589 | 1.00 | 100.00 | 6 |
| ATOM | 1299 | C | TRP | A | 175 | 59.556 | 2.593 | 38.867 | 1.00 | 100.00 | 6 |
| ATOM | 1300 | O | TRP | A | 175 | 58.475 | 3.033 | 38.466 | 1.00 | 100.00 | 8 |
| ATOM | 1301 | N | HIS | A | 176 | 59.775 | 1.293 | 39.092 | 1.00 | 100.00 | 7 |
| ATOM | 1302 | CA | HIS | A | 176 | 58.764 | 0.248 | 38.855 | 1.00 | 100.00 | 6 |
| ATOM | 1303 | CB | HIS | A | 176 | 59.425 | −1.135 | 38.740 | 1.00 | 100.00 | 6 |
| ATOM | 1304 | CG | HIS | A | 176 | 60.023 | −1.635 | 40.022 | 1.00 | 100.00 | 6 |
| ATOM | 1305 | ND1 | HIS | A | 176 | 61.343 | −1.427 | 40.359 | 1.00 | 100.00 | 7 |
| ATOM | 1306 | CE1 | HIS | A | 176 | 61.586 | −1.976 | 41.536 | 1.00 | 100.00 | 6 |
| ATOM | 1307 | NE2 | HIS | A | 176 | 60.472 | −2.535 | 41.974 | 1.00 | 100.00 | 7 |
| ATOM | 1308 | CD2 | HIS | A | 176 | 59.480 | −2.337 | 41.045 | 1.00 | 100.00 | 6 |
| ATOM | 1309 | C | HIS | A | 176 | 57.675 | 0.221 | 39.928 | 1.00 | 100.00 | 6 |
| ATOM | 1310 | O | HIS | A | 176 | 56.546 | −0.207 | 39.674 | 1.00 | 100.00 | 8 |
| ATOM | 1311 | N | ARG | A | 177 | 58.031 | 0.664 | 41.129 | 1.00 | 100.00 | 7 |
| ATOM | 1312 | CA | ARG | A | 177 | 57.098 | 0.708 | 42.241 | 1.00 | 100.00 | 6 |
| ATOM | 1313 | CB | ARG | A | 177 | 57.611 | −0.136 | 43.417 | 1.00 | 100.00 | 6 |
| ATOM | 1314 | CG | ARG | A | 177 | 58.917 | 0.320 | 44.065 | 1.00 | 100.00 | 6 |
| ATOM | 1315 | CD | ARG | A | 177 | 59.594 | −0.827 | 44.818 | 1.00 | 100.00 | 6 |
| ATOM | 1316 | NE | ARG | A | 177 | 58.639 | −1.661 | 45.549 | 1.00 | 100.00 | 7 |
| ATOM | 1317 | CZ | ARG | A | 177 | 58.893 | −2.883 | 46.010 | 1.00 | 100.00 | 6 |
| ATOM | 1318 | NH1 | ARG | A | 177 | 60.083 | −3.443 | 45.828 | 1.00 | 100.00 | 7 |
| ATOM | 1319 | NH2 | ARG | A | 177 | 57.947 | −3.551 | 46.656 | 1.00 | 100.00 | 7 |
| ATOM | 1320 | C | ARG | A | 177 | 56.774 | 2.143 | 42.656 | 1.00 | 100.00 | 6 |
| ATOM | 1321 | O | ARG | A | 177 | 55.777 | 2.390 | 43.334 | 1.00 | 100.00 | 8 |
| ATOM | 1322 | N | ALA | A | 178 | 57.614 | 3.083 | 42.220 | 1.00 | 100.00 | 7 |
| ATOM | 1323 | CA | ALA | A | 178 | 57.396 | 4.515 | 42.441 | 1.00 | 100.00 | 6 |
| ATOM | 1324 | CB | ALA | A | 178 | 58.541 | 5.319 | 41.858 | 1.00 | 100.00 | 6 |
| ATOM | 1325 | C | ALA | A | 178 | 56.074 | 4.952 | 41.829 | 1.00 | 100.00 | 6 |
| ATOM | 1326 | O | ALA | A | 178 | 55.506 | 5.973 | 42.209 | 1.00 | 100.00 | 8 |
| ATOM | 1327 | N | ASP | A | 179 | 55.615 | 4.172 | 40.859 | 1.00 | 100.00 | 7 |
| ATOM | 1328 | CA | ASP | A | 179 | 54.267 | 4.259 | 40.331 | 1.00 | 100.00 | 6 |
| ATOM | 1329 | CB | ASP | A | 179 | 54.233 | 5.112 | 39.063 | 1.00 | 100.00 | 6 |
| ATOM | 1330 | CG | ASP | A | 179 | 52.908 | 5.825 | 38.873 | 1.00 | 100.00 | 6 |
| ATOM | 1331 | OD1 | ASP | A | 179 | 52.606 | 6.738 | 39.670 | 1.00 | 100.00 | 8 |
| ATOM | 1332 | OD2 | ASP | A | 179 | 52.176 | 5.484 | 37.919 | 1.00 | 100.00 | 8 |
| ATOM | 1333 | C | ASP | A | 179 | 53.857 | 2.825 | 40.040 | 1.00 | 100.00 | 6 |
| ATOM | 1334 | O | ASP | A | 179 | 54.647 | 1.904 | 40.263 | 1.00 | 100.00 | 8 |
| ATOM | 1335 | N | ALA | A | 180 | 52.634 | 2.630 | 39.548 | 1.00 | 100.00 | 7 |
| ATOM | 1336 | CA | ALA | A | 180 | 52.056 | 1.292 | 39.374 | 1.00 | 100.00 | 6 |
| ATOM | 1337 | CB | ALA | A | 180 | 52.581 | 0.621 | 38.100 | 1.00 | 100.00 | 6 |
| ATOM | 1338 | C | ALA | A | 180 | 52.303 | 0.418 | 40.608 | 1.00 | 100.00 | 6 |
| ATOM | 1339 | O | ALA | A | 180 | 52.389 | −0.810 | 40.510 | 1.00 | 100.00 | 8 |
| ATOM | 1340 | N | LEU | A | 181 | 52.434 | 1.085 | 41.759 | 1.00 | 100.00 | 7 |
| ATOM | 1341 | CA | LEU | A | 181 | 52.557 | 0.464 | 43.083 | 1.00 | 100.00 | 6 |
| ATOM | 1342 | CB | LEU | A | 181 | 53.891 | −0.278 | 43.226 | 1.00 | 100.00 | 6 |
| ATOM | 1343 | CG | LEU | A | 181 | 54.030 | −1.363 | 44.305 | 1.00 | 100.00 | 6 |
| ATOM | 1344 | CD1 | LEU | A | 181 | 54.842 | −2.546 | 43.790 | 1.00 | 100.00 | 6 |
| ATOM | 1345 | CD2 | LEU | A | 181 | 54.628 | −0.827 | 45.607 | 1.00 | 100.00 | 6 |
| ATOM | 1346 | C | LEU | A | 181 | 52.399 | 1.530 | 44.178 | 1.00 | 100.00 | 6 |
| ATOM | 1347 | O | LEU | A | 181 | 52.190 | 1.214 | 45.352 | 1.00 | 100.00 | 8 |
| ATOM | 1348 | N | PHE | A | 182 | 52.493 | 2.794 | 43.778 | 1.00 | 100.00 | 7 |
| ATOM | 1349 | CA | PHE | A | 182 | 52.301 | 3.924 | 44.685 | 1.00 | 100.00 | 6 |
| ATOM | 1350 | CB | PHE | A | 182 | 53.213 | 5.088 | 44.265 | 1.00 | 100.00 | 6 |
| ATOM | 1351 | CG | PHE | A | 182 | 52.555 | 6.444 | 44.288 | 1.00 | 100.00 | 6 |
| ATOM | 1352 | CD1 | PHE | A | 182 | 52.410 | 7.150 | 45.479 | 1.00 | 100.00 | 6 |
| ATOM | 1353 | CE1 | PHE | A | 182 | 51.812 | 8.409 | 45.495 | 1.00 | 100.00 | 6 |
| ATOM | 1354 | CZ | PHE | A | 182 | 51.366 | 8.980 | 44.308 | 1.00 | 100.00 | 6 |
| ATOM | 1355 | CE2 | PHE | A | 182 | 51.514 | 8.291 | 43.110 | 1.00 | 100.00 | 6 |
| ATOM | 1356 | CD2 | PHE | A | 182 | 52.112 | 7.032 | 43.105 | 1.00 | 100.00 | 6 |
| ATOM | 1357 | C | PHE | A | 182 | 50.827 | 4.334 | 44.789 | 1.00 | 100.00 | 6 |
| ATOM | 1358 | O | PHE | A | 182 | 50.322 | 4.576 | 45.886 | 1.00 | 100.00 | 8 |
| ATOM | 1359 | N | ALA | A | 183 | 50.148 | 4.407 | 43.645 | 1.00 | 100.00 | 7 |
| ATOM | 1360 | CA | ALA | A | 183 | 48.710 | 4.675 | 43.602 | 1.00 | 100.00 | 6 |
| ATOM | 1361 | CB | ALA | A | 183 | 48.288 | 5.138 | 42.210 | 1.00 | 100.00 | 6 |
| ATOM | 1362 | C | ALA | A | 183 | 47.933 | 3.433 | 44.011 | 1.00 | 100.00 | 6 |
| ATOM | 1363 | O | ALA | A | 183 | 46.735 | 3.502 | 44.272 | 1.00 | 100.00 | 8 |
| ATOM | 1364 | N | LEU | A | 184 | 48.638 | 2.304 | 44.067 | 1.00 | 100.00 | 7 |
| ATOM | 1365 | CA | LEU | A | 184 | 48.086 | 1.021 | 44.482 | 1.00 | 100.00 | 6 |
| ATOM | 1366 | CB | LEU | A | 184 | 49.216 | 0.040 | 44.812 | 1.00 | 100.00 | 6 |
| ATOM | 1367 | CG | LEU | A | 184 | 48.890 | −1.446 | 44.988 | 1.00 | 100.00 | 6 |
| ATOM | 1368 | CD1 | LEU | A | 184 | 48.964 | −2.155 | 43.649 | 1.00 | 100.00 | 6 |
| ATOM | 1369 | CD2 | LEU | A | 184 | 49.834 | −2.102 | 45.998 | 1.00 | 100.00 | 6 |
| ATOM | 1370 | C | LEU | A | 184 | 47.177 | 1.170 | 45.691 | 1.00 | 100.00 | 6 |
| ATOM | 1371 | O | LEU | A | 184 | 46.116 | 0.573 | 45.741 | 1.00 | 100.00 | 8 |
| ATOM | 1372 | N | GLY | A | 185 | 47.592 | 1.964 | 46.667 | 1.00 | 100.00 | 7 |
| ATOM | 1373 | CA | GLY | A | 185 | 46.780 | 2.149 | 47.853 | 1.00 | 100.00 | 6 |
| ATOM | 1374 | C | GLY | A | 185 | 45.887 | 3.351 | 47.717 | 1.00 | 100.00 | 6 |
| ATOM | 1375 | O | GLY | A | 185 | 44.673 | 3.267 | 47.899 | 1.00 | 100.00 | 8 |
| ATOM | 1376 | N | ILE | A | 186 | 46.514 | 4.464 | 47.361 | 1.00 | 100.00 | 7 |
| ATOM | 1377 | CA | ILE | A | 186 | 45.902 | 5.778 | 47.441 | 1.00 | 100.00 | 6 |
| ATOM | 1378 | CB | ILE | A | 186 | 46.773 | 6.849 | 46.709 | 1.00 | 100.00 | 6 |
| ATOM | 1379 | CG1 | ILE | A | 186 | 46.773 | 8.174 | 47.484 | 1.00 | 100.00 | 6 |
| ATOM | 1380 | CD1 | ILE | A | 186 | 48.115 | 8.911 | 47.481 | 1.00 | 100.00 | 6 |
| ATOM | 1381 | CG2 | ILE | A | 186 | 46.363 | 7.016 | 45.239 | 1.00 | 100.00 | 6 |
| ATOM | 1382 | C | ILE | A | 186 | 44.440 | 5.769 | 46.995 | 1.00 | 100.00 | 6 |
| ATOM | 1383 | O | ILE | A | 186 | 43.567 | 6.239 | 47.718 | 1.00 | 100.00 | 8 |
| ATOM | 1384 | N | GLY | A | 187 | 44.176 | 5.182 | 45.834 | 1.00 | 100.00 | 7 |
| ATOM | 1385 | CA | GLY | A | 187 | 42.828 | 5.173 | 45.258 | 1.00 | 100.00 | 6 |
| ATOM | 1386 | C | GLY | A | 187 | 42.152 | 3.808 | 45.185 | 1.00 | 100.00 | 6 |
| ATOM | 1387 | O | GLY | A | 187 | 41.203 | 3.609 | 44.399 | 1.00 | 100.00 | 8 |
| ATOM | 1388 | N | ILE | A | 188 | 42.653 | 2.863 | 45.984 | 1.00 | 100.00 | 7 |
| ATOM | 1389 | CA | ILE | A | 188 | 42.053 | 1.532 | 46.094 | 1.00 | 100.00 | 6 |
| ATOM | 1390 | CB | ILE | A | 188 | 42.603 | 0.506 | 45.009 | 1.00 | 100.00 | 6 |
| ATOM | 1391 | CG1 | ILE | A | 188 | 41.464 | −0.206 | 44.241 | 1.00 | 100.00 | 6 |
| ATOM | 1392 | CD1 | ILE | A | 188 | 41.122 | 0.390 | 42.876 | 1.00 | 100.00 | 6 |
| ATOM | 1393 | CG2 | ILE | A | 188 | 43.587 | −0.496 | 45.613 | 1.00 | 100.00 | 6 |
| ATOM | 1394 | C | ILE | A | 188 | 42.263 | 1.097 | 47.537 | 1.00 | 100.00 | 6 |
| ATOM | 1395 | O | ILE | A | 188 | 42.334 | −0.088 | 47.859 | 1.00 | 100.00 | 8 |
| ATOM | 1396 | N | TYR | A | 189 | 42.353 | 2.092 | 48.405 | 1.00 | 100.00 | 7 |
| ATOM | 1397 | CA | TYR | A | 189 | 42.380 | 1.830 | 49.813 | 1.00 | 100.00 | 6 |
| ATOM | 1398 | CB | TYR | A | 189 | 43.794 | 1.606 | 50.288 | 1.00 | 100.00 | 6 |
| ATOM | 1399 | CG | TYR | A | 189 | 44.177 | 0.158 | 50.257 | 1.00 | 100.00 | 6 |
| ATOM | 1400 | CD1 | TYR | A | 189 | 44.771 | −0.397 | 49.128 | 1.00 | 100.00 | 6 |
| ATOM | 1401 | CE1 | TYR | A | 189 | 45.130 | −1.737 | 49.094 | 1.00 | 100.00 | 6 |
| ATOM | 1402 | CZ | TYR | A | 189 | 44.892 | −2.551 | 50.203 | 1.00 | 100.00 | 6 |
| ATOM | 1403 | OH | TYR | A | 189 | 45.258 | −3.889 | 50.164 | 1.00 | 100.00 | 8 |
| ATOM | 1404 | CE2 | TYR | A | 189 | 44.289 | −2.020 | 51.344 | 1.00 | 100.00 | 6 |
| ATOM | 1405 | CD2 | TYR | A | 189 | 43.936 | −0.668 | 51.360 | 1.00 | 100.00 | 6 |
| ATOM | 1406 | C | TYR | A | 189 | 41.745 | 2.941 | 50.569 | 1.00 | 100.00 | 6 |
| ATOM | 1407 | O | TYR | A | 189 | 40.687 | 2.757 | 51.161 | 1.00 | 100.00 | 8 |
| ATOM | 1408 | N | ILE | A | 190 | 42.390 | 4.099 | 50.554 | 1.00 | 100.00 | 7 |
| ATOM | 1409 | CA | ILE | A | 190 | 41.795 | 5.262 | 51.174 | 1.00 | 100.00 | 6 |
| ATOM | 1410 | CB | ILE | A | 190 | 42.624 | 6.561 | 50.945 | 1.00 | 100.00 | 6 |
| ATOM | 1411 | CG1 | ILE | A | 190 | 43.603 | 6.764 | 52.106 | 1.00 | 100.00 | 6 |
| ATOM | 1412 | CD1 | ILE | A | 190 | 44.281 | 8.129 | 52.135 | 1.00 | 100.00 | 6 |
| ATOM | 1413 | CG2 | ILE | A | 190 | 41.712 | 7.811 | 50.786 | 1.00 | 100.00 | 6 |
| ATOM | 1414 | C | ILE | A | 190 | 40.353 | 5.370 | 50.678 | 1.00 | 100.00 | 6 |
| ATOM | 1415 | O | ILE | A | 190 | 39.415 | 5.296 | 51.483 | 1.00 | 100.00 | 8 |
| ATOM | 1416 | N | LEU | A | 191 | 40.171 | 5.495 | 49.360 | 1.00 | 100.00 | 7 |
| ATOM | 1417 | CA | LEU | A | 191 | 38.814 | 5.576 | 48.822 | 1.00 | 100.00 | 6 |
| ATOM | 1418 | CB | LEU | A | 191 | 38.741 | 6.217 | 47.427 | 1.00 | 100.00 | 6 |
| ATOM | 1419 | CG | LEU | A | 191 | 38.104 | 7.615 | 47.462 | 1.00 | 100.00 | 6 |
| ATOM | 1420 | CD1 | LEU | A | 191 | 39.142 | 8.682 | 47.847 | 1.00 | 100.00 | 6 |
| ATOM | 1421 | CD2 | LEU | A | 191 | 37.403 | 7.957 | 46.148 | 1.00 | 100.00 | 6 |
| ATOM | 1422 | C | LEU | A | 191 | 38.115 | 4.227 | 48.878 | 1.00 | 100.00 | 6 |
| ATOM | 1423 | O | LEU | A | 191 | 36.894 | 4.158 | 48.791 | 1.00 | 100.00 | 8 |
| ATOM | 1424 | N | TYR | A | 192 | 38.877 | 3.162 | 49.070 | 1.00 | 100.00 | 7 |
| ATOM | 1425 | CA | TYR | A | 192 | 38.256 | 1.882 | 49.286 | 1.00 | 100.00 | 6 |
| ATOM | 1426 | CB | TYR | A | 192 | 39.200 | 0.786 | 48.813 | 1.00 | 100.00 | 6 |
| ATOM | 1427 | CG | TYR | A | 192 | 39.111 | −0.551 | 49.505 | 1.00 | 100.00 | 6 |
| ATOM | 1428 | CD1 | TYR | A | 192 | 37.874 | −1.174 | 49.745 | 1.00 | 100.00 | 6 |
| ATOM | 1429 | CE1 | TYR | A | 192 | 37.808 | −2.423 | 50.380 | 1.00 | 100.00 | 6 |
| ATOM | 1430 | CZ | TYR | A | 192 | 38.998 | −3.072 | 50.755 | 1.00 | 100.00 | 6 |
| ATOM | 1431 | OH | TYR | A | 192 | 38.958 | −4.306 | 51.375 | 1.00 | 100.00 | 8 |
| ATOM | 1432 | CE2 | TYR | A | 192 | 40.238 | −2.480 | 50.508 | 1.00 | 100.00 | 6 |
| ATOM | 1433 | CD2 | TYR | A | 192 | 40.284 | −1.226 | 49.882 | 1.00 | 100.00 | 6 |
| ATOM | 1434 | C | TYR | A | 192 | 37.781 | 1.749 | 50.738 | 1.00 | 100.00 | 6 |
| ATOM | 1435 | O | TYR | A | 192 | 36.767 | 2.316 | 51.111 | 1.00 | 100.00 | 8 |
| ATOM | 1436 | N | SER | A | 193 | 38.518 | 1.029 | 51.560 | 1.00 | 100.00 | 7 |
| ATOM | 1437 | CA | SER | A | 193 | 38.073 | 0.727 | 52.903 | 1.00 | 100.00 | 6 |
| ATOM | 1438 | CB | SER | A | 193 | 39.246 | 0.202 | 53.726 | 1.00 | 100.00 | 6 |
| ATOM | 1439 | OG | SER | A | 193 | 39.720 | −1.066 | 53.304 | 1.00 | 100.00 | 8 |
| ATOM | 1440 | C | SER | A | 193 | 37.589 | 1.985 | 53.576 | 1.00 | 100.00 | 6 |
| ATOM | 1441 | O | SER | A | 193 | 36.416 | 2.101 | 53.941 | 1.00 | 100.00 | 8 |
| ATOM | 1442 | N | ALA | A | 194 | 38.536 | 2.920 | 53.713 | 1.00 | 100.00 | 7 |
| ATOM | 1443 | CA | ALA | A | 194 | 38.390 | 4.166 | 54.465 | 1.00 | 100.00 | 6 |
| ATOM | 1444 | CB | ALA | A | 194 | 39.772 | 4.849 | 54.688 | 1.00 | 100.00 | 6 |
| ATOM | 1445 | C | ALA | A | 194 | 37.381 | 5.115 | 53.811 | 1.00 | 100.00 | 6 |
| ATOM | 1446 | O | ALA | A | 194 | 37.545 | 6.341 | 53.829 | 1.00 | 100.00 | 8 |
| ATOM | 1447 | N | LEU | A | 195 | 36.376 | 4.511 | 53.184 | 1.00 | 100.00 | 7 |
| ATOM | 1448 | CA | LEU | A | 195 | 35.061 | 5.101 | 53.021 | 1.00 | 100.00 | 6 |
| ATOM | 1449 | CB | LEU | A | 195 | 34.864 | 5.806 | 51.654 | 1.00 | 100.00 | 6 |
| ATOM | 1450 | CG | LEU | A | 195 | 33.436 | 6.339 | 51.273 | 1.00 | 100.00 | 6 |
| ATOM | 1451 | CD1 | LEU | A | 195 | 33.210 | 7.833 | 51.639 | 1.00 | 100.00 | 6 |
| ATOM | 1452 | CD2 | LEU | A | 195 | 32.969 | 6.081 | 49.791 | 1.00 | 100.00 | 6 |
| ATOM | 1453 | C | LEU | A | 195 | 34.133 | 3.921 | 53.107 | 1.00 | 100.00 | 6 |
| ATOM | 1454 | O | LEU | A | 195 | 33.329 | 3.823 | 54.033 | 1.00 | 100.00 | 8 |
| ATOM | 1455 | N | ARG | A | 196 | 34.300 | 3.013 | 52.138 | 1.00 | 100.00 | 7 |
| ATOM | 1456 | CA | ARG | A | 196 | 33.257 | 2.065 | 51.736 | 1.00 | 100.00 | 6 |
| ATOM | 1457 | CB | ARG | A | 196 | 33.772 | 1.047 | 50.693 | 1.00 | 100.00 | 6 |
| ATOM | 1458 | CG | ARG | A | 196 | 32.940 | −0.271 | 50.677 | 1.00 | 100.00 | 6 |
| ATOM | 1459 | CD | ARG | A | 196 | 33.316 | −1.275 | 49.567 | 1.00 | 100.00 | 6 |
| ATOM | 1460 | NE | ARG | A | 196 | 32.403 | −2.441 | 49.551 | 1.00 | 100.00 | 7 |
| ATOM | 1461 | CZ | ARG | A | 196 | 31.252 | −2.510 | 48.862 | 1.00 | 100.00 | 6 |
| ATOM | 1462 | NH1 | ARG | A | 196 | 30.836 | −1.481 | 48.105 | 1.00 | 100.00 | 7 |
| ATOM | 1463 | NH2 | ARG | A | 196 | 30.504 | −3.614 | 48.921 | 1.00 | 100.00 | 7 |
| ATOM | 1464 | C | ARG | A | 196 | 32.787 | 1.310 | 52.925 | 1.00 | 100.00 | 6 |
| ATOM | 1465 | O | ARG | A | 196 | 31.634 | 1.408 | 53.384 | 1.00 | 100.00 | 8 |
| ATOM | 1466 | N | MET | A | 197 | 33.731 | 0.539 | 53.405 | 1.00 | 100.00 | 7 |
| ATOM | 1467 | CA | MET | A | 197 | 33.477 | −0.311 | 54.480 | 1.00 | 100.00 | 6 |
| ATOM | 1468 | CB | MET | A | 197 | 34.645 | −1.269 | 54.593 | 1.00 | 100.00 | 6 |
| ATOM | 1469 | CG | MET | A | 197 | 35.069 | −1.885 | 53.247 | 1.00 | 100.00 | 6 |
| ATOM | 1470 | SD | MET | A | 197 | 33.994 | −3.236 | 52.674 | 1.00 | 100.00 | 16 |
| ATOM | 1471 | CE | MET | A | 197 | 33.958 | −4.261 | 54.190 | 1.00 | 100.00 | 6 |
| ATOM | 1472 | C | MET | A | 197 | 33.339 | 0.618 | 55.677 | 1.00 | 100.00 | 6 |
| ATOM | 1473 | O | MET | A | 197 | 32.528 | 0.355 | 56.568 | 1.00 | 100.00 | 8 |
| ATOM | 1474 | N | GLY | A | 198 | 34.085 | 1.734 | 55.657 | 1.00 | 100.00 | 7 |
| ATOM | 1475 | CA | GLY | A | 198 | 34.049 | 2.740 | 56.740 | 1.00 | 100.00 | 6 |
| ATOM | 1476 | C | GLY | A | 198 | 32.775 | 3.552 | 56.683 | 1.00 | 100.00 | 6 |
| ATOM | 1477 | O | GLY | A | 198 | 32.734 | 4.710 | 57.065 | 1.00 | 100.00 | 8 |
| ATOM | 1478 | N | TYR | A | 199 | 31.734 | 2.930 | 56.169 | 1.00 | 100.00 | 7 |
| ATOM | 1479 | CA | TYR | A | 199 | 30.508 | 3.608 | 56.001 | 1.00 | 100.00 | 6 |
| ATOM | 1480 | CB | TYR | A | 199 | 30.420 | 4.228 | 54.640 | 1.00 | 100.00 | 6 |
| ATOM | 1481 | CG | TYR | A | 199 | 30.260 | 5.679 | 54.852 | 1.00 | 100.00 | 6 |
| ATOM | 1482 | CD1 | TYR | A | 199 | 31.386 | 6.507 | 55.043 | 1.00 | 100.00 | 6 |
| ATOM | 1483 | CE1 | TYR | A | 199 | 31.228 | 7.897 | 55.278 | 1.00 | 100.00 | 6 |
| ATOM | 1484 | CZ | TYR | A | 199 | 29.920 | 8.443 | 55.352 | 1.00 | 100.00 | 6 |
| ATOM | 1485 | OH | TYR | A | 199 | 29.738 | 9.798 | 55.579 | 1.00 | 100.00 | 8 |
| ATOM | 1486 | CE2 | TYR | A | 199 | 28.791 | 7.613 | 55.198 | 1.00 | 100.00 | 6 |
| ATOM | 1487 | CD2 | TYR | A | 199 | 28.971 | 6.240 | 54.960 | 1.00 | 100.00 | 6 |
| ATOM | 1488 | C | TYR | A | 199 | 29.290 | 2.801 | 56.310 | 1.00 | 100.00 | 6 |
| ATOM | 1489 | O | TYR | A | 199 | 28.520 | 3.191 | 57.202 | 1.00 | 100.00 | 8 |
| ATOM | 1490 | N | GLU | A | 200 | 29.100 | 1.692 | 55.576 | 1.00 | 100.00 | 7 |
| ATOM | 1491 | CA | GLU | A | 200 | 28.086 | 0.663 | 55.953 | 1.00 | 100.00 | 6 |
| ATOM | 1492 | CB | GLU | A | 200 | 28.271 | −0.676 | 55.149 | 1.00 | 100.00 | 6 |
| ATOM | 1493 | CG | GLU | A | 200 | 29.055 | −1.869 | 55.879 | 1.00 | 100.00 | 6 |
| ATOM | 1494 | CD | GLU | A | 200 | 28.661 | −3.315 | 55.422 | 1.00 | 100.00 | 6 |
| ATOM | 1495 | OE1 | GLU | A | 200 | 27.908 | −4.026 | 56.139 | 1.00 | 100.00 | 8 |
| ATOM | 1496 | OE2 | GLU | A | 200 | 29.118 | −3.751 | 54.348 | 1.00 | 100.00 | 8 |
| ATOM | 1497 | C | GLU | A | 200 | 28.269 | 0.490 | 57.469 | 1.00 | 100.00 | 6 |
| ATOM | 1498 | O | GLU | A | 200 | 27.299 | 0.369 | 58.252 | 1.00 | 100.00 | 8 |
| ATOM | 1499 | N | ALA | A | 201 | 29.570 | 0.528 | 57.800 | 1.00 | 100.00 | 7 |
| ATOM | 1500 | CA | ALA | A | 201 | 30.160 | 0.564 | 59.113 | 1.00 | 100.00 | 6 |
| ATOM | 1501 | CB | ALA | A | 201 | 31.654 | 0.873 | 59.003 | 1.00 | 100.00 | 6 |
| ATOM | 1502 | C | ALA | A | 201 | 29.509 | 1.646 | 59.897 | 1.00 | 100.00 | 6 |
| ATOM | 1503 | O | ALA | A | 201 | 28.951 | 1.379 | 60.952 | 1.00 | 100.00 | 8 |
| ATOM | 1504 | N | VAL | A | 202 | 29.590 | 2.875 | 59.405 | 1.00 | 100.00 | 7 |
| ATOM | 1505 | CA | VAL | A | 202 | 29.096 | 3.961 | 60.220 | 1.00 | 100.00 | 6 |
| ATOM | 1506 | CB | VAL | A | 202 | 29.711 | 5.285 | 59.838 | 1.00 | 100.00 | 6 |
| ATOM | 1507 | CG1 | VAL | A | 202 | 30.817 | 5.663 | 60.861 | 1.00 | 100.00 | 6 |
| ATOM | 1508 | CG2 | VAL | A | 202 | 30.232 | 5.214 | 58.410 | 1.00 | 100.00 | 6 |
| ATOM | 1509 | C | VAL | A | 202 | 27.585 | 3.999 | 60.237 | 1.00 | 100.00 | 6 |
| ATOM | 1510 | O | VAL | A | 202 | 27.004 | 4.717 | 61.035 | 1.00 | 100.00 | 8 |
| ATOM | 1511 | N | GLN | A | 203 | 26.966 | 3.180 | 59.389 | 1.00 | 100.00 | 7 |
| ATOM | 1512 | CA | GLN | A | 203 | 25.531 | 2.954 | 59.463 | 1.00 | 100.00 | 6 |
| ATOM | 1513 | CB | GLN | A | 203 | 24.910 | 3.148 | 58.102 | 1.00 | 100.00 | 6 |
| ATOM | 1514 | CG | GLN | A | 203 | 24.560 | 4.645 | 57.833 | 1.00 | 100.00 | 6 |
| ATOM | 1515 | CD | GLN | A | 203 | 25.766 | 5.637 | 57.696 | 1.00 | 100.00 | 6 |
| ATOM | 1516 | OE1 | GLN | A | 203 | 25.602 | 6.851 | 57.946 | 1.00 | 100.00 | 8 |
| ATOM | 1517 | NE2 | GLN | A | 203 | 26.943 | 5.137 | 57.272 | 1.00 | 100.00 | 7 |
| ATOM | 1518 | C | GLN | A | 203 | 25.203 | 1.627 | 60.150 | 1.00 | 100.00 | 6 |
| ATOM | 1519 | O | GLN | A | 203 | 24.119 | 1.058 | 60.026 | 1.00 | 100.00 | 8 |
| ATOM | 1520 | N | SER | A | 204 | 26.238 | 1.162 | 60.850 | 1.00 | 100.00 | 7 |
| ATOM | 1521 | CA | SER | A | 204 | 26.168 | 0.515 | 62.175 | 1.00 | 100.00 | 6 |
| ATOM | 1522 | CB | SER | A | 204 | 27.605 | 0.350 | 62.807 | 1.00 | 100.00 | 6 |
| ATOM | 1523 | OG | SER | A | 204 | 27.978 | −0.940 | 63.337 | 1.00 | 100.00 | 8 |
| ATOM | 1524 | C | SER | A | 204 | 25.321 | 1.497 | 63.019 | 1.00 | 100.00 | 6 |
| ATOM | 1525 | O | SER | A | 204 | 24.635 | 1.094 | 63.952 | 1.00 | 100.00 | 8 |
| ATOM | 1526 | N | LEU | A | 205 | 25.373 | 2.791 | 62.718 | 1.00 | 100.00 | 7 |
| ATOM | 1527 | CA | LEU | A | 205 | 24.304 | 3.648 | 63.194 | 1.00 | 100.00 | 6 |
| ATOM | 1528 | CB | LEU | A | 205 | 24.739 | 5.088 | 63.507 | 1.00 | 100.00 | 6 |
| ATOM | 1529 | CG | LEU | A | 205 | 25.570 | 5.882 | 62.491 | 1.00 | 100.00 | 6 |
| ATOM | 1530 | CD1 | LEU | A | 205 | 24.777 | 6.272 | 61.229 | 1.00 | 100.00 | 6 |
| ATOM | 1531 | CD2 | LEU | A | 205 | 26.158 | 7.109 | 63.132 | 1.00 | 100.00 | 6 |
| ATOM | 1532 | C | LEU | A | 205 | 23.151 | 3.525 | 62.177 | 1.00 | 100.00 | 6 |
| ATOM | 1533 | O | LEU | A | 205 | 23.308 | 3.731 | 60.951 | 1.00 | 100.00 | 8 |
| ATOM | 1534 | N | LEU | A | 206 | 22.014 | 3.098 | 62.737 | 1.00 | 100.00 | 7 |
| ATOM | 1535 | CA | LEU | A | 206 | 20.803 | 2.776 | 62.008 | 1.00 | 100.00 | 6 |
| ATOM | 1536 | CB | LEU | A | 206 | 19.689 | 2.304 | 62.909 | 1.00 | 100.00 | 6 |
| ATOM | 1537 | CG | LEU | A | 206 | 19.910 | 1.314 | 64.017 | 1.00 | 100.00 | 6 |
| ATOM | 1538 | CD1 | LEU | A | 206 | 19.075 | 1.786 | 65.198 | 1.00 | 100.00 | 6 |
| ATOM | 1539 | CD2 | LEU | A | 206 | 19.555 | −0.079 | 63.473 | 1.00 | 100.00 | 6 |
| ATOM | 1540 | C | LEU | A | 206 | 20.393 | 4.096 | 61.594 | 1.00 | 100.00 | 6 |
| ATOM | 1541 | O | LEU | A | 206 | 20.301 | 5.023 | 62.422 | 1.00 | 100.00 | 8 |
| ATOM | 1542 | N | ASP | A | 207 | 20.120 | 4.151 | 60.306 | 1.00 | 100.00 | 7 |
| ATOM | 1543 | CA | ASP | A | 207 | 19.949 | 5.376 | 59.587 | 1.00 | 100.00 | 6 |
| ATOM | 1544 | CB | ASP | A | 207 | 21.220 | 6.251 | 59.706 | 1.00 | 100.00 | 6 |
| ATOM | 1545 | CG | ASP | A | 207 | 21.125 | 7.344 | 60.802 | 1.00 | 100.00 | 6 |
| ATOM | 1546 | OD1 | ASP | A | 207 | 20.215 | 7.321 | 61.695 | 1.00 | 100.00 | 8 |
| ATOM | 1547 | OD2 | ASP | A | 207 | 22.006 | 8.244 | 60.730 | 1.00 | 100.00 | 8 |
| ATOM | 1548 | C | ASP | A | 207 | 19.832 | 4.931 | 58.167 | 1.00 | 100.00 | 6 |
| ATOM | 1549 | O | ASP | A | 207 | 19.647 | 3.739 | 57.869 | 1.00 | 100.00 | 8 |
| ATOM | 1550 | N | ARG | A | 208 | 20.000 | 5.920 | 57.302 | 1.00 | 100.00 | 7 |
| ATOM | 1551 | CA | ARG | A | 208 | 19.895 | 5.763 | 55.870 | 1.00 | 100.00 | 6 |
| ATOM | 1552 | CB | ARG | A | 208 | 21.111 | 4.989 | 55.320 | 1.00 | 100.00 | 6 |
| ATOM | 1553 | CG | ARG | A | 208 | 22.458 | 5.687 | 55.600 | 1.00 | 100.00 | 6 |
| ATOM | 1554 | CD | ARG | A | 208 | 22.735 | 6.895 | 54.659 | 1.00 | 100.00 | 6 |
| ATOM | 1555 | NE | ARG | A | 208 | 23.400 | 8.020 | 55.342 | 1.00 | 100.00 | 7 |
| ATOM | 1556 | CZ | ARG | A | 208 | 23.892 | 9.103 | 54.733 | 1.00 | 100.00 | 6 |
| ATOM | 1557 | NH1 | ARG | A | 208 | 23.827 | 9.233 | 53.404 | 1.00 | 100.00 | 7 |
| ATOM | 1558 | NH2 | ARG | A | 208 | 24.463 | 10.060 | 55.465 | 1.00 | 100.00 | 7 |
| ATOM | 1559 | C | ARG | A | 208 | 18.546 | 5.116 | 55.572 | 1.00 | 100.00 | 6 |
| ATOM | 1560 | O | ARG | A | 208 | 18.360 | 4.489 | 54.507 | 1.00 | 100.00 | 8 |
| ATOM | 1561 | N | ALA | A | 209 | 17.621 | 5.330 | 56.532 | 1.00 | 100.00 | 7 |
| ATOM | 1562 | CA | ALA | A | 209 | 16.291 | 4.677 | 56.618 | 1.00 | 100.00 | 6 |
| ATOM | 1563 | CB | ALA | A | 209 | 15.081 | 5.721 | 56.765 | 1.00 | 100.00 | 6 |
| ATOM | 1564 | C | ALA | A | 209 | 16.109 | 3.693 | 55.463 | 1.00 | 100.00 | 6 |
| ATOM | 1565 | O | ALA | A | 209 | 16.048 | 2.489 | 55.672 | 1.00 | 100.00 | 8 |
| ATOM | 1566 | N | LEU | A | 210 | 16.036 | 4.218 | 54.254 | 1.00 | 100.00 | 7 |
| ATOM | 1567 | CA | LEU | A | 210 | 16.621 | 3.544 | 53.135 | 1.00 | 100.00 | 6 |
| ATOM | 1568 | CB | LEU | A | 210 | 15.679 | 2.493 | 52.508 | 1.00 | 100.00 | 6 |
| ATOM | 1569 | CG | LEU | A | 210 | 15.896 | 1.053 | 53.054 | 1.00 | 100.00 | 6 |
| ATOM | 1570 | CD1 | LEU | A | 210 | 14.593 | 0.276 | 53.366 | 1.00 | 100.00 | 6 |
| ATOM | 1571 | CD2 | LEU | A | 210 | 16.880 | 0.169 | 52.225 | 1.00 | 100.00 | 6 |
| ATOM | 1572 | C | LEU | A | 210 | 17.059 | 4.648 | 52.185 | 1.00 | 100.00 | 6 |
| ATOM | 1573 | O | LEU | A | 210 | 16.891 | 5.851 | 52.470 | 1.00 | 100.00 | 8 |
| ATOM | 1574 | N | PRO | A | 211 | 17.744 | 4.245 | 51.115 | 1.00 | 100.00 | 7 |
| ATOM | 1575 | CA | PRO | A | 211 | 17.734 | 4.980 | 49.861 | 1.00 | 100.00 | 6 |
| ATOM | 1576 | CB | PRO | A | 211 | 18.189 | 3.942 | 48.824 | 1.00 | 100.00 | 6 |
| ATOM | 1577 | CG | PRO | A | 211 | 18.482 | 2.615 | 49.634 | 1.00 | 100.00 | 6 |
| ATOM | 1578 | CD | PRO | A | 211 | 18.654 | 3.082 | 51.063 | 1.00 | 100.00 | 6 |
| ATOM | 1579 | C | PRO | A | 211 | 16.350 | 5.434 | 49.501 | 1.00 | 100.00 | 6 |
| ATOM | 1580 | O | PRO | A | 211 | 15.374 | 4.664 | 49.510 | 1.00 | 100.00 | 8 |
| ATOM | 1581 | N | ASP | A | 212 | 16.314 | 6.715 | 49.209 | 1.00 | 100.00 | 7 |
| ATOM | 1582 | CA | ASP | A | 212 | 15.173 | 7.359 | 48.657 | 1.00 | 100.00 | 6 |
| ATOM | 1583 | CB | ASP | A | 212 | 15.525 | 8.815 | 48.284 | 1.00 | 100.00 | 6 |
| ATOM | 1584 | CG | ASP | A | 212 | 16.453 | 9.494 | 49.315 | 1.00 | 100.00 | 6 |
| ATOM | 1585 | OD1 | ASP | A | 212 | 16.164 | 10.645 | 49.747 | 1.00 | 100.00 | 8 |
| ATOM | 1586 | OD2 | ASP | A | 212 | 17.478 | 8.872 | 49.690 | 1.00 | 100.00 | 8 |
| ATOM | 1587 | C | ASP | A | 212 | 14.820 | 6.515 | 47.451 | 1.00 | 100.00 | 6 |
| ATOM | 1588 | O | ASP | A | 212 | 15.340 | 6.703 | 46.362 | 1.00 | 100.00 | 8 |
| ATOM | 1589 | N | GLU | A | 213 | 13.962 | 5.540 | 47.666 | 1.00 | 100.00 | 7 |
| ATOM | 1590 | CA | GLU | A | 213 | 13.701 | 4.590 | 46.633 | 1.00 | 100.00 | 6 |
| ATOM | 1591 | CB | GLU | A | 213 | 14.991 | 3.817 | 46.311 | 1.00 | 100.00 | 6 |
| ATOM | 1592 | CG | GLU | A | 213 | 14.861 | 2.718 | 45.234 | 1.00 | 100.00 | 6 |
| ATOM | 1593 | CD | GLU | A | 213 | 14.348 | 3.248 | 43.890 | 1.00 | 100.00 | 6 |
| ATOM | 1594 | OE1 | GLU | A | 213 | 15.156 | 3.860 | 43.151 | 1.00 | 100.00 | 8 |
| ATOM | 1595 | OE2 | GLU | A | 213 | 13.141 | 3.047 | 43.574 | 1.00 | 100.00 | 8 |
| ATOM | 1596 | C | GLU | A | 213 | 12.627 | 3.665 | 47.141 | 1.00 | 100.00 | 6 |
| ATOM | 1597 | O | GLU | A | 213 | 11.445 | 3.919 | 46.969 | 1.00 | 100.00 | 8 |
| ATOM | 1598 | N | GLU | A | 214 | 13.048 | 2.580 | 47.775 | 1.00 | 100.00 | 7 |
| ATOM | 1599 | CA | GLU | A | 214 | 12.112 | 1.713 | 48.459 | 1.00 | 100.00 | 6 |
| ATOM | 1600 | CB | GLU | A | 214 | 12.817 | 0.509 | 49.130 | 1.00 | 100.00 | 6 |
| ATOM | 1601 | CG | GLU | A | 214 | 13.936 | −0.212 | 48.304 | 1.00 | 100.00 | 6 |
| ATOM | 1602 | CD | GLU | A | 214 | 15.360 | 0.041 | 48.858 | 1.00 | 100.00 | 6 |
| ATOM | 1603 | OE1 | GLU | A | 214 | 15.827 | 1.209 | 48.834 | 1.00 | 100.00 | 8 |
| ATOM | 1604 | OE2 | GLU | A | 214 | 16.010 | −0.932 | 49.330 | 1.00 | 100.00 | 8 |
| ATOM | 1605 | C | GLU | A | 214 | 11.448 | 2.640 | 49.471 | 1.00 | 100.00 | 6 |
| ATOM | 1606 | O | GLU | A | 214 | 10.354 | 2.375 | 49.937 | 1.00 | 100.00 | 8 |
| ATOM | 1607 | N | ARG | A | 215 | 12.134 | 3.735 | 49.790 | 1.00 | 100.00 | 7 |
| ATOM | 1608 | CA | ARG | A | 215 | 11.483 | 4.841 | 50.402 | 1.00 | 100.00 | 6 |
| ATOM | 1609 | CB | ARG | A | 215 | 12.383 | 6.063 | 50.409 | 1.00 | 100.00 | 6 |
| ATOM | 1610 | CG | ARG | A | 215 | 11.863 | 7.263 | 51.253 | 1.00 | 100.00 | 6 |
| ATOM | 1611 | CD | ARG | A | 215 | 12.361 | 7.262 | 52.735 | 1.00 | 100.00 | 6 |
| ATOM | 1612 | NE | ARG | A | 215 | 13.824 | 7.407 | 52.860 | 1.00 | 100.00 | 7 |
| ATOM | 1613 | CZ | ARG | A | 215 | 14.457 | 8.509 | 53.265 | 1.00 | 100.00 | 6 |
| ATOM | 1614 | NH1 | ARG | A | 215 | 13.765 | 9.594 | 53.614 | 1.00 | 100.00 | 7 |
| ATOM | 1615 | NH2 | ARG | A | 215 | 15.787 | 8.516 | 53.320 | 1.00 | 100.00 | 7 |
| ATOM | 1616 | C | ARG | A | 215 | 10.288 | 5.049 | 49.501 | 1.00 | 100.00 | 6 |
| ATOM | 1617 | O | ARG | A | 215 | 9.202 | 4.585 | 49.828 | 1.00 | 100.00 | 8 |
| ATOM | 1618 | N | GLN | A | 216 | 10.489 | 5.675 | 48.342 | 1.00 | 100.00 | 7 |
| ATOM | 1619 | CA | GLN | A | 216 | 9.378 | 5.981 | 47.402 | 1.00 | 100.00 | 6 |
| ATOM | 1620 | CB | GLN | A | 216 | 9.972 | 6.477 | 46.058 | 1.00 | 100.00 | 6 |
| ATOM | 1621 | CG | GLN | A | 216 | 9.014 | 7.294 | 45.163 | 1.00 | 100.00 | 6 |
| ATOM | 1622 | CD | GLN | A | 216 | 8.484 | 8.535 | 45.863 | 1.00 | 100.00 | 6 |
| ATOM | 1623 | OE1 | GLN | A | 216 | 9.141 | 9.051 | 46.775 | 1.00 | 100.00 | 8 |
| ATOM | 1624 | NE2 | GLN | A | 216 | 7.298 | 9.024 | 45.443 | 1.00 | 100.00 | 7 |
| ATOM | 1625 | C | GLN | A | 216 | 8.305 | 4.839 | 47.199 | 1.00 | 100.00 | 6 |
| ATOM | 1626 | O | GLN | A | 216 | 7.100 | 5.006 | 47.477 | 1.00 | 100.00 | 8 |
| ATOM | 1627 | N | GLU | A | 217 | 8.775 | 3.692 | 46.714 | 1.00 | 100.00 | 7 |
| ATOM | 1628 | CA | GLU | A | 217 | 7.981 | 2.492 | 46.643 | 1.00 | 100.00 | 6 |
| ATOM | 1629 | CB | GLU | A | 217 | 8.887 | 1.243 | 46.433 | 1.00 | 100.00 | 6 |
| ATOM | 1630 | CG | GLU | A | 217 | 9.797 | 1.294 | 45.129 | 1.00 | 100.00 | 6 |
| ATOM | 1631 | CD | GLU | A | 217 | 10.807 | 0.103 | 44.909 | 1.00 | 100.00 | 6 |
| ATOM | 1632 | OE1 | GLU | A | 217 | 10.742 | −0.907 | 45.616 | 1.00 | 100.00 | 8 |
| ATOM | 1633 | OE2 | GLU | A | 217 | 11.674 | 0.156 | 44.001 | 1.00 | 100.00 | 8 |
| ATOM | 1634 | C | GLU | A | 217 | 7.179 | 2.476 | 47.948 | 1.00 | 100.00 | 6 |
| ATOM | 1635 | O | GLU | A | 217 | 6.025 | 2.840 | 47.931 | 1.00 | 100.00 | 8 |
| ATOM | 1636 | N | ILE | A | 218 | 7.801 | 2.164 | 49.087 | 1.00 | 100.00 | 7 |
| ATOM | 1637 | CA | ILE | A | 218 | 7.046 | 1.967 | 50.349 | 1.00 | 100.00 | 6 |
| ATOM | 1638 | CB | ILE | A | 218 | 7.888 | 2.050 | 51.665 | 1.00 | 100.00 | 6 |
| ATOM | 1639 | CG1 | ILE | A | 218 | 8.834 | 0.869 | 51.773 | 1.00 | 100.00 | 6 |
| ATOM | 1640 | CD1 | ILE | A | 218 | 9.773 | 0.971 | 52.892 | 1.00 | 100.00 | 6 |
| ATOM | 1641 | CG2 | ILE | A | 218 | 6.987 | 1.986 | 52.898 | 1.00 | 100.00 | 6 |
| ATOM | 1642 | C | ILE | A | 218 | 5.933 | 2.946 | 50.459 | 1.00 | 100.00 | 6 |
| ATOM | 1643 | O | ILE | A | 218 | 4.796 | 2.564 | 50.598 | 1.00 | 100.00 | 8 |
| ATOM | 1644 | N | ILE | A | 219 | 6.263 | 4.217 | 50.382 | 1.00 | 100.00 | 7 |
| ATOM | 1645 | CA | ILE | A | 219 | 5.250 | 5.206 | 50.524 | 1.00 | 100.00 | 6 |
| ATOM | 1646 | CB | ILE | A | 219 | 5.814 | 6.641 | 50.328 | 1.00 | 100.00 | 6 |
| ATOM | 1647 | CG1 | ILE | A | 219 | 4.756 | 7.714 | 50.675 | 1.00 | 100.00 | 6 |
| ATOM | 1648 | CD1 | ILE | A | 219 | 4.744 | 8.207 | 52.152 | 1.00 | 100.00 | 6 |
| ATOM | 1649 | CG2 | ILE | A | 219 | 6.367 | 6.843 | 48.929 | 1.00 | 100.00 | 6 |
| ATOM | 1650 | C | ILE | A | 219 | 4.128 | 4.858 | 49.545 | 1.00 | 100.00 | 6 |
| ATOM | 1651 | O | ILE | A | 219 | 2.985 | 4.572 | 49.953 | 1.00 | 100.00 | 8 |
| ATOM | 1652 | N | ASP | A | 220 | 4.482 | 4.813 | 48.261 | 1.00 | 100.00 | 7 |
| ATOM | 1653 | CA | ASP | A | 220 | 3.497 | 4.627 | 47.177 | 1.00 | 100.00 | 6 |
| ATOM | 1654 | CB | ASP | A | 220 | 4.195 | 4.521 | 45.816 | 1.00 | 100.00 | 6 |
| ATOM | 1655 | CG | ASP | A | 220 | 4.530 | 5.866 | 45.229 | 1.00 | 100.00 | 6 |
| ATOM | 1656 | OD1 | ASP | A | 220 | 3.567 | 6.658 | 44.919 | 1.00 | 100.00 | 8 |
| ATOM | 1657 | OD2 | ASP | A | 220 | 5.764 | 6.095 | 45.082 | 1.00 | 100.00 | 8 |
| ATOM | 1658 | C | ASP | A | 220 | 2.615 | 3.407 | 47.340 | 1.00 | 100.00 | 6 |
| ATOM | 1659 | O | ASP | A | 220 | 1.481 | 3.394 | 46.877 | 1.00 | 100.00 | 8 |
| ATOM | 1660 | N | ILE | A | 221 | 3.163 | 2.366 | 47.951 | 1.00 | 100.00 | 7 |
| ATOM | 1661 | CA | ILE | A | 221 | 2.418 | 1.155 | 48.120 | 1.00 | 100.00 | 6 |
| ATOM | 1662 | CB | ILE | A | 221 | 3.305 | 0.020 | 48.523 | 1.00 | 100.00 | 6 |
| ATOM | 1663 | CG1 | ILE | A | 221 | 4.260 | −0.267 | 47.399 | 1.00 | 100.00 | 6 |
| ATOM | 1664 | CD1 | ILE | A | 221 | 5.648 | −0.436 | 47.906 | 1.00 | 100.00 | 6 |
| ATOM | 1665 | CG2 | ILE | A | 221 | 2.510 | −1.218 | 48.718 | 1.00 | 100.00 | 6 |
| ATOM | 1666 | C | ILE | A | 221 | 1.403 | 1.451 | 49.180 | 1.00 | 100.00 | 6 |
| ATOM | 1667 | O | ILE | A | 221 | 0.238 | 1.118 | 49.011 | 1.00 | 100.00 | 8 |
| ATOM | 1668 | N | VAL | A | 222 | 1.828 | 2.126 | 50.240 | 1.00 | 100.00 | 7 |
| ATOM | 1669 | CA | VAL | A | 222 | 0.929 | 2.409 | 51.334 | 1.00 | 100.00 | 6 |
| ATOM | 1670 | CB | VAL | A | 222 | 1.684 | 2.758 | 52.600 | 1.00 | 100.00 | 6 |
| ATOM | 1671 | CG1 | VAL | A | 222 | 0.803 | 2.693 | 53.778 | 1.00 | 100.00 | 6 |
| ATOM | 1672 | CG2 | VAL | A | 222 | 2.694 | 1.751 | 52.816 | 1.00 | 100.00 | 6 |
| ATOM | 1673 | C | VAL | A | 222 | −0.106 | 3.479 | 50.942 | 1.00 | 100.00 | 6 |
| ATOM | 1674 | O | VAL | A | 222 | −1.281 | 3.416 | 51.353 | 1.00 | 100.00 | 8 |
| ATOM | 1675 | N | THR | A | 223 | 0.288 | 4.427 | 50.102 | 1.00 | 100.00 | 7 |
| ATOM | 1676 | CA | THR | A | 223 | −0.603 | 5.538 | 49.728 | 1.00 | 100.00 | 6 |
| ATOM | 1677 | CB | THR | A | 223 | 0.191 | 6.578 | 48.934 | 1.00 | 100.00 | 6 |
| ATOM | 1678 | OG1 | THR | A | 223 | 1.554 | 6.616 | 49.394 | 1.00 | 100.00 | 8 |
| ATOM | 1679 | CG2 | THR | A | 223 | −0.467 | 7.946 | 49.037 | 1.00 | 100.00 | 6 |
| ATOM | 1680 | C | THR | A | 223 | −1.776 | 5.152 | 48.835 | 1.00 | 100.00 | 6 |
| ATOM | 1681 | O | THR | A | 223 | −2.486 | 6.012 | 48.352 | 1.00 | 100.00 | 8 |
| ATOM | 1682 | N | SER | A | 224 | −1.972 | 3.867 | 48.602 | 1.00 | 100.00 | 7 |
| ATOM | 1683 | CA | SER | A | 224 | −2.707 | 3.461 | 47.432 | 1.00 | 100.00 | 6 |
| ATOM | 1684 | CB | SER | A | 224 | −1.712 | 3.005 | 46.385 | 1.00 | 100.00 | 6 |
| ATOM | 1685 | OG | SER | A | 224 | −0.826 | 2.068 | 46.971 | 1.00 | 100.00 | 8 |
| ATOM | 1686 | C | SER | A | 224 | −3.708 | 2.355 | 47.696 | 1.00 | 100.00 | 6 |
| ATOM | 1687 | O | SER | A | 224 | −4.217 | 1.728 | 46.771 | 1.00 | 100.00 | 8 |
| ATOM | 1688 | N | TRP | A | 225 | −4.022 | 2.118 | 48.950 | 1.00 | 100.00 | 7 |
| ATOM | 1689 | CA | TRP | A | 225 | −4.913 | 1.029 | 49.247 | 1.00 | 100.00 | 6 |
| ATOM | 1690 | CB | TRP | A | 225 | −4.398 | 0.320 | 50.476 | 1.00 | 100.00 | 6 |
| ATOM | 1691 | CG | TRP | A | 225 | −3.696 | −0.782 | 49.995 | 1.00 | 100.00 | 6 |
| ATOM | 1692 | CD1 | TRP | A | 225 | −2.858 | −0.775 | 48.947 | 1.00 | 100.00 | 6 |
| ATOM | 1693 | NE1 | TRP | A | 225 | −2.387 | −2.036 | 48.710 | 1.00 | 100.00 | 7 |
| ATOM | 1694 | CE2 | TRP | A | 225 | −2.954 | −2.890 | 49.613 | 1.00 | 100.00 | 6 |
| ATOM | 1695 | CD2 | TRP | A | 225 | −3.796 | −2.127 | 50.430 | 1.00 | 100.00 | 6 |
| ATOM | 1696 | CE3 | TRP | A | 225 | −4.487 | −2.759 | 51.440 | 1.00 | 100.00 | 6 |
| ATOM | 1697 | CZ3 | TRP | A | 225 | −4.326 | −4.096 | 51.597 | 1.00 | 100.00 | 6 |
| ATOM | 1698 | CH2 | TRP | A | 225 | −3.487 | −4.839 | 50.781 | 1.00 | 100.00 | 6 |
| ATOM | 1699 | CZ2 | TRP | A | 225 | −2.785 | −4.258 | 49.783 | 1.00 | 100.00 | 6 |
| ATOM | 1700 | C | TRP | A | 225 | −6.401 | 1.374 | 49.312 | 1.00 | 100.00 | 6 |
| ATOM | 1701 | O | TRP | A | 225 | −6.813 | 2.372 | 48.729 | 1.00 | 100.00 | 8 |
| ATOM | 1702 | N | PRO | A | 226 | −7.230 | 0.479 | 49.890 | 1.00 | 100.00 | 7 |
| ATOM | 1703 | CA | PRO | A | 226 | −8.386 | 0.883 | 50.693 | 1.00 | 100.00 | 6 |
| ATOM | 1704 | CB | PRO | A | 226 | −9.049 | −0.453 | 51.038 | 1.00 | 100.00 | 6 |
| ATOM | 1705 | CG | PRO | A | 226 | −7.983 | −1.481 | 50.858 | 1.00 | 100.00 | 6 |
| ATOM | 1706 | CD | PRO | A | 226 | −7.209 | −0.981 | 49.692 | 1.00 | 100.00 | 6 |
| ATOM | 1707 | C | PRO | A | 226 | −8.008 | 1.611 | 52.006 | 1.00 | 100.00 | 6 |
| ATOM | 1708 | O | PRO | A | 226 | −8.879 | 2.235 | 52.609 | 1.00 | 100.00 | 8 |
| ATOM | 1709 | N | GLY | A | 227 | −6.732 | 1.524 | 52.421 | 1.00 | 100.00 | 7 |
| ATOM | 1710 | CA | GLY | A | 227 | −6.181 | 2.096 | 53.684 | 1.00 | 100.00 | 6 |
| ATOM | 1711 | C | GLY | A | 227 | −5.598 | 3.473 | 53.464 | 1.00 | 100.00 | 6 |
| ATOM | 1712 | O | GLY | A | 227 | −4.430 | 3.778 | 53.740 | 1.00 | 100.00 | 8 |
| ATOM | 1713 | N | VAL | A | 228 | −6.480 | 4.312 | 52.964 | 1.00 | 100.00 | 7 |
| ATOM | 1714 | CA | VAL | A | 228 | −6.095 | 5.511 | 52.287 | 1.00 | 100.00 | 6 |
| ATOM | 1715 | CB | VAL | A | 228 | −7.130 | 5.930 | 51.156 | 1.00 | 100.00 | 6 |
| ATOM | 1716 | CG1 | VAL | A | 228 | −6.429 | 6.622 | 49.915 | 1.00 | 100.00 | 6 |
| ATOM | 1717 | CG2 | VAL | A | 228 | −7.984 | 4.733 | 50.685 | 1.00 | 100.00 | 6 |
| ATOM | 1718 | C | VAL | A | 228 | −5.943 | 6.594 | 53.298 | 1.00 | 100.00 | 6 |
| ATOM | 1719 | O | VAL | A | 228 | −5.550 | 6.334 | 54.430 | 1.00 | 100.00 | 8 |
| ATOM | 1720 | N | SER | A | 229 | −6.336 | 7.794 | 52.878 | 1.00 | 100.00 | 7 |
| ATOM | 1721 | CA | SER | A | 229 | −5.649 | 8.996 | 53.282 | 1.00 | 100.00 | 6 |
| ATOM | 1722 | CB | SER | A | 229 | −6.484 | 10.280 | 53.102 | 1.00 | 100.00 | 6 |
| ATOM | 1723 | OG | SER | A | 229 | −5.656 | 11.418 | 52.801 | 1.00 | 100.00 | 8 |
| ATOM | 1724 | C | SER | A | 229 | −5.341 | 8.728 | 54.697 | 1.00 | 100.00 | 6 |
| ATOM | 1725 | O | SER | A | 229 | −6.271 | 8.507 | 55.487 | 1.00 | 100.00 | 8 |
| ATOM | 1726 | N | GLY | A | 230 | −4.030 | 8.652 | 54.966 | 1.00 | 100.00 | 7 |
| ATOM | 1727 | CA | GLY | A | 230 | −3.504 | 8.446 | 56.305 | 1.00 | 100.00 | 6 |
| ATOM | 1728 | C | GLY | A | 230 | −2.153 | 7.816 | 56.342 | 1.00 | 100.00 | 6 |
| ATOM | 1729 | O | GLY | A | 230 | −1.938 | 6.926 | 57.150 | 1.00 | 100.00 | 8 |
| ATOM | 1730 | N | ALA | A | 231 | −1.276 | 8.260 | 55.438 | 1.00 | 100.00 | 7 |
| ATOM | 1731 | CA | ALA | A | 231 | 0.156 | 7.970 | 55.512 | 1.00 | 100.00 | 6 |
| ATOM | 1732 | CB | ALA | A | 231 | 0.793 | 8.115 | 54.175 | 1.00 | 100.00 | 6 |
| ATOM | 1733 | C | ALA | A | 231 | 0.767 | 8.982 | 56.443 | 1.00 | 100.00 | 6 |
| ATOM | 1734 | O | ALA | A | 231 | 0.719 | 10.177 | 56.160 | 1.00 | 100.00 | 8 |
| ATOM | 1735 | N | HIS | A | 232 | 1.318 | 8.523 | 57.566 | 1.00 | 100.00 | 7 |
| ATOM | 1736 | CA | HIS | A | 232 | 2.033 | 9.454 | 58.453 | 1.00 | 100.00 | 6 |
| ATOM | 1737 | CB | HIS | A | 232 | 1.166 | 10.235 | 59.560 | 1.00 | 100.00 | 6 |
| ATOM | 1738 | CG | HIS | A | 232 | 1.143 | 9.691 | 60.982 | 1.00 | 100.00 | 6 |
| ATOM | 1739 | ND1 | HIS | A | 232 | −0.029 | 9.587 | 61.695 | 1.00 | 100.00 | 7 |
| ATOM | 1740 | CE1 | HIS | A | 232 | 0.213 | 9.152 | 62.913 | 1.00 | 100.00 | 6 |
| ATOM | 1741 | NE2 | HIS | A | 232 | 1.513 | 9.029 | 63.046 | 1.00 | 100.00 | 7 |
| ATOM | 1742 | CD2 | HIS | A | 232 | 2.120 | 9.371 | 61.859 | 1.00 | 100.00 | 6 |
| ATOM | 1743 | C | HIS | A | 232 | 3.563 | 9.316 | 58.595 | 1.00 | 100.00 | 6 |
| ATOM | 1744 | O | HIS | A | 232 | 4.296 | 10.147 | 58.032 | 1.00 | 100.00 | 8 |
| ATOM | 1745 | N | ASP | A | 233 | 4.093 | 8.261 | 59.207 | 1.00 | 100.00 | 7 |
| ATOM | 1746 | CA | ASP | A | 233 | 5.548 | 8.180 | 59.011 | 1.00 | 100.00 | 6 |
| ATOM | 1747 | CB | ASP | A | 233 | 6.253 | 9.501 | 59.476 | 1.00 | 100.00 | 6 |
| ATOM | 1748 | CG | ASP | A | 233 | 6.878 | 9.413 | 60.883 | 1.00 | 100.00 | 6 |
| ATOM | 1749 | OD1 | ASP | A | 233 | 6.321 | 10.097 | 61.797 | 1.00 | 100.00 | 8 |
| ATOM | 1750 | OD2 | ASP | A | 233 | 7.941 | 8.701 | 61.050 | 1.00 | 100.00 | 8 |
| ATOM | 1751 | C | ASP | A | 233 | 6.446 | 6.871 | 59.080 | 1.00 | 100.00 | 6 |
| ATOM | 1752 | O | ASP | A | 233 | 6.300 | 5.967 | 59.928 | 1.00 | 100.00 | 8 |
| ATOM | 1753 | N | LEU | A | 234 | 7.447 | 6.900 | 58.202 | 1.00 | 100.00 | 7 |
| ATOM | 1754 | CA | LEU | A | 234 | 7.895 | 5.778 | 57.440 | 1.00 | 100.00 | 6 |
| ATOM | 1755 | CB | LEU | A | 234 | 8.359 | 6.306 | 56.076 | 1.00 | 100.00 | 6 |
| ATOM | 1756 | CG | LEU | A | 234 | 9.141 | 7.660 | 55.996 | 1.00 | 100.00 | 6 |
| ATOM | 1757 | CD1 | LEU | A | 234 | 8.464 | 8.822 | 56.704 | 1.00 | 100.00 | 6 |
| ATOM | 1758 | CD2 | LEU | A | 234 | 10.565 | 7.644 | 56.493 | 1.00 | 100.00 | 6 |
| ATOM | 1759 | C | LEU | A | 234 | 9.035 | 5.055 | 58.081 | 1.00 | 100.00 | 6 |
| ATOM | 1760 | O | LEU | A | 234 | 9.330 | 3.943 | 57.640 | 1.00 | 100.00 | 8 |
| ATOM | 1761 | N | ARG | A | 235 | 9.663 | 5.666 | 59.104 | 1.00 | 100.00 | 7 |
| ATOM | 1762 | CA | ARG | A | 235 | 11.122 | 5.413 | 59.466 | 1.00 | 100.00 | 6 |
| ATOM | 1763 | CB | ARG | A | 235 | 11.392 | 5.833 | 60.935 | 1.00 | 100.00 | 6 |
| ATOM | 1764 | CG | ARG | A | 235 | 12.915 | 5.853 | 61.387 | 1.00 | 100.00 | 6 |
| ATOM | 1765 | CD | ARG | A | 235 | 13.066 | 5.167 | 62.804 | 1.00 | 100.00 | 6 |
| ATOM | 1766 | NE | ARG | A | 235 | 14.419 | 4.777 | 63.267 | 1.00 | 100.00 | 7 |
| ATOM | 1767 | CZ | ARG | A | 235 | 14.964 | 3.561 | 63.208 | 1.00 | 100.00 | 6 |
| ATOM | 1768 | NH1 | ARG | A | 235 | 14.341 | 2.534 | 62.653 | 1.00 | 100.00 | 7 |
| ATOM | 1769 | NH2 | ARG | A | 235 | 16.169 | 3.378 | 63.698 | 1.00 | 100.00 | 7 |
| ATOM | 1770 | C | ARG | A | 235 | 11.804 | 4.030 | 59.122 | 1.00 | 100.00 | 6 |
| ATOM | 1771 | O | ARG | A | 235 | 11.150 | 2.956 | 59.181 | 1.00 | 100.00 | 8 |
| ATOM | 1772 | N | THR | A | 236 | 13.105 | 4.045 | 58.806 | 1.00 | 100.00 | 7 |
| ATOM | 1773 | CA | THR | A | 236 | 13.694 | 2.814 | 58.280 | 1.00 | 100.00 | 6 |
| ATOM | 1774 | CB | THR | A | 236 | 13.560 | 2.916 | 56.791 | 1.00 | 100.00 | 6 |
| ATOM | 1775 | OG1 | THR | A | 236 | 12.877 | 4.145 | 56.493 | 1.00 | 100.00 | 8 |
| ATOM | 1776 | CG2 | THR | A | 236 | 12.847 | 1.701 | 56.226 | 1.00 | 100.00 | 6 |
| ATOM | 1777 | C | THR | A | 236 | 15.165 | 2.466 | 58.694 | 1.00 | 100.00 | 6 |
| ATOM | 1778 | O | THR | A | 236 | 15.854 | 3.337 | 59.254 | 1.00 | 100.00 | 8 |
| ATOM | 1779 | N | ARG | A | 237 | 15.639 | 1.223 | 58.420 | 1.00 | 100.00 | 7 |
| ATOM | 1780 | CA | ARG | A | 237 | 17.076 | 0.790 | 58.665 | 1.00 | 100.00 | 6 |
| ATOM | 1781 | CB | ARG | A | 237 | 17.359 | 0.804 | 60.172 | 1.00 | 100.00 | 6 |
| ATOM | 1782 | CG | ARG | A | 237 | 16.065 | 0.698 | 61.013 | 1.00 | 100.00 | 6 |
| ATOM | 1783 | CD | ARG | A | 237 | 16.333 | 0.835 | 62.509 | 1.00 | 100.00 | 6 |
| ATOM | 1784 | NE | ARG | A | 237 | 16.726 | −0.425 | 63.162 | 1.00 | 100.00 | 7 |
| ATOM | 1785 | CZ | ARG | A | 237 | 15.900 | −1.227 | 63.847 | 1.00 | 100.00 | 6 |
| ATOM | 1786 | NH1 | ARG | A | 237 | 14.598 | −0.916 | 63.996 | 1.00 | 100.00 | 7 |
| ATOM | 1787 | NH2 | ARG | A | 237 | 16.375 | −2.360 | 64.372 | 1.00 | 100.00 | 7 |
| ATOM | 1788 | C | ARG | A | 237 | 17.541 | −0.570 | 58.006 | 1.00 | 100.00 | 6 |
| ATOM | 1789 | O | ARG | A | 237 | 16.762 | −1.161 | 57.247 | 1.00 | 100.00 | 8 |
| ATOM | 1790 | N | GLN | A | 238 | 18.771 | −1.058 | 58.310 | 1.00 | 100.00 | 7 |
| ATOM | 1791 | CA | GLN | A | 238 | 19.401 | −2.360 | 57.753 | 1.00 | 100.00 | 6 |
| ATOM | 1792 | CB | GLN | A | 238 | 20.938 | −2.385 | 57.990 | 1.00 | 100.00 | 6 |
| ATOM | 1793 | CG | GLN | A | 238 | 21.453 | −3.078 | 59.403 | 1.00 | 100.00 | 6 |
| ATOM | 1794 | CD | GLN | A | 238 | 21.792 | −4.651 | 59.413 | 1.00 | 100.00 | 6 |
| ATOM | 1795 | OE1 | GLN | A | 238 | 22.746 | −5.128 | 58.733 | 1.00 | 100.00 | 8 |
| ATOM | 1796 | NE2 | GLN | A | 238 | 21.034 | −5.419 | 60.256 | 1.00 | 100.00 | 7 |
| ATOM | 1797 | C | GLN | A | 238 | 18.895 | −3.858 | 58.092 | 1.00 | 100.00 | 6 |
| ATOM | 1798 | O | GLN | A | 236 | 18.599 | −4.213 | 59.292 | 1.00 | 100.00 | 8 |
| ATOM | 1799 | N | SER | A | 239 | 18.952 | −4.728 | 57.040 | 1.00 | 100.00 | 7 |
| ATOM | 1800 | CA | SER | A | 239 | 18.443 | −6.167 | 56.971 | 1.00 | 100.00 | 6 |
| ATOM | 1801 | CB | SER | A | 239 | 19.072 | −7.067 | 58.059 | 1.00 | 100.00 | 6 |
| ATOM | 1802 | OG | SER | A | 239 | 20.297 | −7.590 | 57.582 | 1.00 | 100.00 | 8 |
| ATOM | 1803 | C | SER | A | 239 | 16.877 | −6.377 | 56.822 | 1.00 | 100.00 | 6 |
| ATOM | 1804 | O | SER | A | 239 | 16.362 | −7.520 | 56.945 | 1.00 | 100.00 | 8 |
| ATOM | 1805 | N | GLY | A | 240 | 16.173 | −5.281 | 56.483 | 1.00 | 100.00 | 7 |
| ATOM | 1806 | CA | GLY | A | 240 | 14.758 | −5.151 | 56.659 | 1.00 | 100.00 | 6 |
| ATOM | 1807 | C | GLY | A | 240 | 14.511 | −3.763 | 57.221 | 1.00 | 100.00 | 6 |
| ATOM | 1808 | O | GLY | A | 240 | 14.737 | −2.803 | 56.484 | 1.00 | 100.00 | 8 |
| ATOM | 1809 | N | PRO | A | 241 | 14.138 | −3.657 | 58.554 | 1.00 | 100.00 | 7 |
| ATOM | 1810 | CA | PRO | A | 241 | 13.315 | −2.621 | 59.271 | 1.00 | 100.00 | 6 |
| ATOM | 1811 | CB | PRO | A | 241 | 14.015 | −2.501 | 60.661 | 1.00 | 100.00 | 6 |
| ATOM | 1812 | CG | PRO | A | 241 | 14.379 | −3.978 | 61.016 | 1.00 | 100.00 | 6 |
| ATOM | 1813 | CD | PRO | A | 241 | 14.586 | −4.663 | 59.567 | 1.00 | 100.00 | 6 |
| ATOM | 1814 | C | PRO | A | 241 | 12.802 | −1.278 | 58.658 | 1.00 | 100.00 | 6 |
| ATOM | 1815 | O | PRO | A | 241 | 13.531 | −0.275 | 58.528 | 1.00 | 100.00 | 8 |
| ATOM | 1816 | N | THR | A | 242 | 11.510 | −1.359 | 58.322 | 1.00 | 100.00 | 7 |
| ATOM | 1817 | CA | THR | A | 242 | 10.576 | −0.263 | 58.094 | 1.00 | 100.00 | 6 |
| ATOM | 1818 | CB | THR | A | 242 | 9.710 | −0.578 | 56.857 | 1.00 | 100.00 | 6 |
| ATOM | 1819 | OG1 | THR | A | 242 | 10.222 | −1.165 | 55.832 | 1.00 | 100.00 | 8 |
| ATOM | 1820 | CG2 | THR | A | 242 | 8.974 | 0.656 | 56.322 | 1.00 | 100.00 | 6 |
| ATOM | 1821 | C | THR | A | 242 | 9.604 | −0.235 | 59.274 | 1.00 | 100.00 | 6 |
| ATOM | 1822 | O | THR | A | 242 | 9.724 | −1.020 | 60.217 | 1.00 | 100.00 | 8 |
| ATOM | 1823 | N | ARG | A | 243 | 8.601 | 0.619 | 59.194 | 1.00 | 100.00 | 7 |
| ATOM | 1824 | CA | ARG | A | 243 | 7.593 | 0.685 | 60.213 | 1.00 | 100.00 | 6 |
| ATOM | 1825 | CB | ARG | A | 243 | 8.254 | 1.001 | 61.549 | 1.00 | 100.00 | 6 |
| ATOM | 1826 | CG | ARG | A | 243 | 8.748 | 2.468 | 61.643 | 1.00 | 100.00 | 6 |
| ATOM | 1827 | CD | ARG | A | 243 | 9.319 | 2.741 | 62.990 | 1.00 | 100.00 | 6 |
| ATOM | 1828 | NE | ARG | A | 243 | 10.454 | 1.839 | 63.156 | 1.00 | 100.00 | 7 |
| ATOM | 1829 | CZ | ARG | A | 243 | 11.245 | 1.724 | 64.241 | 1.00 | 100.00 | 6 |
| ATOM | 1830 | NH1 | ARG | A | 243 | 11.032 | 2.468 | 65.339 | 1.00 | 100.00 | 7 |
| ATOM | 1831 | NH2 | ARG | A | 243 | 12.271 | 0.842 | 64.229 | 1.00 | 100.00 | 7 |
| ATOM | 1832 | C | ARG | A | 243 | 6.724 | 1.871 | 59.879 | 1.00 | 100.00 | 6 |
| ATOM | 1833 | O | ARG | A | 243 | 7.244 | 2.896 | 59.383 | 1.00 | 100.00 | 8 |
| ATOM | 1834 | N | PHE | A | 244 | 5.421 | 1.773 | 60.175 | 1.00 | 100.00 | 7 |
| ATOM | 1835 | CA | PHE | A | 244 | 4.677 | 2.997 | 60.562 | 1.00 | 100.00 | 6 |
| ATOM | 1836 | CB | PHE | A | 244 | 5.193 | 4.158 | 59.766 | 1.00 | 100.00 | 6 |
| ATOM | 1837 | CG | PHE | A | 244 | 4.599 | 4.210 | 58.484 | 1.00 | 100.00 | 6 |
| ATOM | 1838 | CD1 | PHE | A | 244 | 3.535 | 5.048 | 58.261 | 1.00 | 100.00 | 6 |
| ATOM | 1839 | CE1 | PHE | A | 244 | 2.937 | 5.061 | 57.061 | 1.00 | 100.00 | 6 |
| ATOM | 1840 | CZ | PHE | A | 244 | 3.403 | 4.201 | 56.074 | 1.00 | 100.00 | 6 |
| ATOM | 1841 | CE2 | PHE | A | 244 | 4.471 | 3.337 | 56.335 | 1.00 | 100.00 | 6 |
| ATOM | 1842 | CD2 | PHE | A | 244 | 5.028 | 3.340 | 57.524 | 1.00 | 100.00 | 6 |
| ATOM | 1843 | C | PHE | A | 244 | 3.135 | 3.161 | 60.555 | 1.00 | 100.00 | 6 |
| ATOM | 1844 | O | PHE | A | 244 | 2.339 | 2.267 | 60.243 | 1.00 | 100.00 | 8 |
| ATOM | 1845 | N | ILE | A | 245 | 2.773 | 4.402 | 60.864 | 1.00 | 100.00 | 7 |
| ATOM | 1846 | CA | ILE | A | 245 | 1.466 | 4.758 | 61.323 | 1.00 | 100.00 | 6 |
| ATOM | 1847 | CB | ILE | A | 245 | 1.559 | 6.032 | 62.259 | 1.00 | 100.00 | 6 |
| ATOM | 1848 | CG1 | ILE | A | 245 | 2.887 | 6.121 | 63.039 | 1.00 | 100.00 | 6 |
| ATOM | 1849 | CD1 | ILE | A | 245 | 2.850 | 7.053 | 64.285 | 1.00 | 100.00 | 6 |
| ATOM | 1850 | CG2 | ILE | A | 245 | 0.418 | 6.085 | 63.232 | 1.00 | 100.00 | 6 |
| ATOM | 1851 | C | ILE | A | 245 | 0.644 | 5.020 | 60.057 | 1.00 | 100.00 | 6 |
| ATOM | 1852 | O | ILE | A | 245 | 1.259 | 5.300 | 59.026 | 1.00 | 100.00 | 8 |
| ATOM | 1853 | N | GLN | A | 246 | −0.708 | 4.915 | 60.137 | 1.00 | 100.00 | 7 |
| ATOM | 1854 | CA | GLN | A | 246 | −1.672 | 5.285 | 59.063 | 1.00 | 100.00 | 6 |
| ATOM | 1855 | CB | GLN | A | 246 | −1.237 | 4.620 | 57.774 | 1.00 | 100.00 | 6 |
| ATOM | 1856 | CG | GLN | A | 246 | −0.699 | 3.185 | 58.028 | 1.00 | 100.00 | 6 |
| ATOM | 1857 | CD | GLN | A | 246 | −1.236 | 2.126 | 57.087 | 1.00 | 100.00 | 6 |
| ATOM | 1858 | OE1 | GLN | A | 246 | −2.435 | 1.840 | 57.078 | 1.00 | 100.00 | 8 |
| ATOM | 1859 | NE2 | GLN | A | 246 | −0.339 | 1.509 | 56.307 | 1.00 | 100.00 | 7 |
| ATOM | 1860 | C | GLN | A | 246 | −3.010 | 4.678 | 59.274 | 1.00 | 100.00 | 6 |
| ATOM | 1861 | O | GLN | A | 246 | −3.052 | 3.495 | 59.407 | 1.00 | 100.00 | 8 |
| ATOM | 1862 | N | ILE | A | 247 | −4.096 | 5.433 | 59.321 | 1.00 | 100.00 | 7 |
| ATOM | 1863 | CA | ILE | A | 247 | −5.415 | 4.993 | 58.675 | 1.00 | 100.00 | 6 |
| ATOM | 1864 | CB | ILE | A | 247 | −6.529 | 4.004 | 59.439 | 1.00 | 100.00 | 6 |
| ATOM | 1865 | CG1 | ILE | A | 247 | −6.936 | 2.797 | 58.538 | 1.00 | 100.00 | 6 |
| ATOM | 1866 | CD1 | ILE | A | 247 | −7.498 | 1.549 | 59.245 | 1.00 | 100.00 | 6 |
| ATOM | 1867 | CG2 | ILE | A | 247 | −7.826 | 4.736 | 59.935 | 1.00 | 100.00 | 6 |
| ATOM | 1868 | C | ILE | A | 247 | −5.952 | 6.312 | 58.249 | 1.00 | 100.00 | 6 |
| ATOM | 1869 | O | ILE | A | 247 | −5.134 | 7.155 | 57.873 | 1.00 | 100.00 | 8 |
| ATOM | 1870 | N | HIS | A | 248 | −7.253 | 6.548 | 58.392 | 1.00 | 100.00 | 7 |
| ATOM | 1871 | CA | HIS | A | 248 | −7.891 | 7.498 | 57.511 | 1.00 | 100.00 | 6 |
| ATOM | 1872 | CB | HIS | A | 248 | −9.146 | 6.879 | 57.002 | 1.00 | 100.00 | 6 |
| ATOM | 1873 | CG | HIS | A | 248 | −8.868 | 5.640 | 56.227 | 1.00 | 100.00 | 6 |
| ATOM | 1874 | ND1 | HIS | A | 248 | −9.359 | 5.424 | 54.957 | 1.00 | 100.00 | 7 |
| ATOM | 1875 | CE1 | HIS | A | 248 | −8.912 | 4.264 | 54.509 | 1.00 | 100.00 | 6 |
| ATOM | 1876 | NE2 | HIS | A | 248 | −8.118 | 3.739 | 55.429 | 1.00 | 100.00 | 7 |
| ATOM | 1877 | CD2 | HIS | A | 248 | −8.068 | 4.584 | 56.509 | 1.00 | 100.00 | 6 |
| ATOM | 1878 | C | HIS | A | 248 | −8.014 | 8.944 | 57.925 | 1.00 | 100.00 | 6 |
| ATOM | 1879 | O | HIS | A | 248 | −8.574 | 9.274 | 58.938 | 1.00 | 100.00 | 8 |
| ATOM | 1880 | N | LEU | A | 249 | −7.429 | 9.797 | 57.101 | 1.00 | 100.00 | 7 |
| ATOM | 1881 | CA | LEU | A | 249 | −7.145 | 11.165 | 57.478 | 1.00 | 100.00 | 6 |
| ATOM | 1882 | CB | LEU | A | 249 | −5.628 | 11.564 | 57.187 | 1.00 | 100.00 | 6 |
| ATOM | 1883 | CG | LEU | A | 249 | −4.248 | 10.976 | 57.787 | 1.00 | 100.00 | 6 |
| ATOM | 1884 | CD1 | LEU | A | 249 | −2.968 | 11.271 | 56.955 | 1.00 | 100.00 | 6 |
| ATOM | 1885 | CD2 | LEU | A | 249 | −3.897 | 11.261 | 59.276 | 1.00 | 100.00 | 6 |
| ATOM | 1886 | C | LEU | A | 249 | −8.187 | 11.997 | 56.750 | 1.00 | 100.00 | 6 |
| ATOM | 1887 | O | LEU | A | 249 | −7.979 | 13.185 | 56.497 | 1.00 | 100.00 | 8 |
| ATOM | 1888 | N | GLU | A | 250 | −9.296 | 11.321 | 56.399 | 1.00 | 100.00 | 7 |
| ATOM | 1889 | CA | GLU | A | 250 | −10.588 | 11.939 | 55.927 | 1.00 | 100.00 | 6 |
| ATOM | 1890 | CB | GLU | A | 250 | −11.018 | 11.513 | 54.504 | 1.00 | 100.00 | 6 |
| ATOM | 1891 | CG | GLU | A | 250 | −11.617 | 10.122 | 54.380 | 1.00 | 100.00 | 6 |
| ATOM | 1892 | CD | GLU | A | 250 | −10.631 | 9.124 | 53.788 | 1.00 | 100.00 | 6 |
| ATOM | 1893 | OE1 | GLU | A | 250 | −9.396 | 9.266 | 53.970 | 1.00 | 100.00 | 8 |
| ATOM | 1894 | OE2 | GLU | A | 250 | −11.101 | 8.184 | 53.125 | 1.00 | 100.00 | 8 |
| ATOM | 1895 | C | GLU | A | 250 | −11.754 | 11.707 | 56.901 | 1.00 | 100.00 | 6 |
| ATOM | 1896 | O | GLU | A | 250 | −12.124 | 12.583 | 57.671 | 1.00 | 100.00 | 8 |
| ATOM | 1897 | N | MET | A | 251 | −12.354 | 10.542 | 56.886 | 1.00 | 100.00 | 7 |
| ATOM | 1898 | CA | MET | A | 251 | −13.257 | 10.331 | 57.953 | 1.00 | 100.00 | 6 |
| ATOM | 1899 | CB | MET | A | 251 | −14.707 | 10.384 | 57.462 | 1.00 | 100.00 | 6 |
| ATOM | 1900 | CG | MET | A | 251 | −15.805 | 10.077 | 58.566 | 1.00 | 100.00 | 6 |
| ATOM | 1901 | SD | MET | A | 251 | −17.373 | 11.068 | 58.733 | 1.00 | 100.00 | 16 |
| ATOM | 1902 | CE | MET | A | 251 | −16.772 | 12.455 | 59.740 | 1.00 | 100.00 | 6 |
| ATOM | 1903 | C | MET | A | 251 | −12.910 | 9.110 | 58.772 | 1.00 | 100.00 | 6 |
| ATOM | 1904 | O | MET | A | 251 | −13.030 | 9.158 | 60.000 | 1.00 | 100.00 | 8 |
| ATOM | 1905 | N | GLU | A | 252 | −12.448 | 8.039 | 58.110 | 1.00 | 100.00 | 7 |
| ATOM | 1906 | CA | GLU | A | 252 | −12.136 | 6.746 | 58.774 | 1.00 | 100.00 | 6 |
| ATOM | 1907 | CB | GLU | A | 252 | −11.952 | 5.611 | 57.764 | 1.00 | 100.00 | 6 |
| ATOM | 1908 | CG | GLU | A | 252 | −12.573 | 5.858 | 56.337 | 1.00 | 100.00 | 6 |
| ATOM | 1909 | CD | GLU | A | 252 | −14.125 | 6.084 | 56.250 | 1.00 | 100.00 | 6 |
| ATOM | 1910 | OE1 | GLU | A | 252 | −14.863 | 5.907 | 57.249 | 1.00 | 100.00 | 8 |
| ATOM | 1911 | OE2 | GLU | A | 252 | −14.620 | 6.437 | 55.145 | 1.00 | 100.00 | 8 |
| ATOM | 1912 | C | GLU | A | 252 | −10.921 | 6.991 | 59.636 | 1.00 | 100.00 | 6 |
| ATOM | 1913 | O | GLU | A | 252 | −10.088 | 6.109 | 59.912 | 1.00 | 100.00 | 8 |
| ATOM | 1914 | N | ASP | A | 253 | −10.881 | 8.298 | 59.933 | 1.00 | 100.00 | 7 |
| ATOM | 1915 | CA | ASP | A | 253 | −10.199 | 9.099 | 60.983 | 1.00 | 100.00 | 6 |
| ATOM | 1916 | CB | ASP | A | 253 | −10.353 | 10.591 | 60.582 | 1.00 | 100.00 | 6 |
| ATOM | 1917 | CG | ASP | A | 253 | −9.193 | 11.474 | 61.043 | 1.00 | 100.00 | 6 |
| ATOM | 1918 | OD1 | ASP | A | 253 | −9.411 | 12.341 | 61.924 | 1.00 | 100.00 | 8 |
| ATOM | 1919 | OD2 | ASP | A | 253 | −8.083 | 11.328 | 60.498 | 1.00 | 100.00 | 8 |
| ATOM | 1920 | C | ASP | A | 253 | −10.803 | 8.899 | 62.405 | 1.00 | 100.00 | 6 |
| ATOM | 1921 | O | ASP | A | 253 | −10.893 | 9.846 | 63.216 | 1.00 | 100.00 | 8 |
| ATOM | 1922 | N | SER | A | 254 | −11.240 | 7.661 | 62.651 | 1.00 | 100.00 | 7 |
| ATOM | 1923 | CA | SER | A | 254 | −11.627 | 7.051 | 63.955 | 1.00 | 100.00 | 6 |
| ATOM | 1924 | CB | SER | A | 254 | −11.626 | 7.991 | 65.204 | 1.00 | 100.00 | 6 |
| ATOM | 1925 | OG | SER | A | 254 | −12.716 | 8.894 | 65.242 | 1.00 | 100.00 | 8 |
| ATOM | 1926 | C | SER | A | 254 | −12.910 | 6.262 | 63.736 | 1.00 | 100.00 | 6 |
| ATOM | 1927 | O | SER | A | 254 | −13.129 | 5.237 | 64.395 | 1.00 | 100.00 | 8 |
| ATOM | 1928 | N | LEU | A | 255 | −13.688 | 6.692 | 62.737 | 1.00 | 100.00 | 7 |
| ATOM | 1929 | CA | LEU | A | 255 | −14.922 | 6.016 | 62.378 | 1.00 | 100.00 | 6 |
| ATOM | 1930 | CB | LEU | A | 255 | −15.477 | 6.481 | 61.012 | 1.00 | 100.00 | 6 |
| ATOM | 1931 | CG | LEU | A | 255 | −16.764 | 5.810 | 60.463 | 1.00 | 100.00 | 6 |
| ATOM | 1932 | CD1 | LEU | A | 255 | −17.953 | 6.099 | 61.364 | 1.00 | 100.00 | 6 |
| ATOM | 1933 | CD2 | LEU | A | 255 | −17.110 | 6.172 | 59.008 | 1.00 | 100.00 | 6 |
| ATOM | 1934 | C | LEU | A | 255 | −14.798 | 4.492 | 62.398 | 1.00 | 100.00 | 6 |
| ATOM | 1935 | O | LEU | A | 255 | −15.680 | 3.840 | 62.972 | 1.00 | 100.00 | 8 |
| ATOM | 1936 | N | PRO | A | 256 | −13.724 | 3.920 | 61.779 | 1.00 | 100.00 | 7 |
| ATOM | 1937 | CA | PRO | A | 256 | −13.766 | 2.455 | 61.510 | 1.00 | 100.00 | 6 |
| ATOM | 1938 | CB | PRO | A | 256 | −12.669 | 2.241 | 60.432 | 1.00 | 100.00 | 6 |
| ATOM | 1939 | CG | PRO | A | 256 | −12.086 | 3.621 | 60.130 | 1.00 | 100.00 | 6 |
| ATOM | 1940 | CD | PRO | A | 256 | −12.476 | 4.525 | 61.265 | 1.00 | 100.00 | 6 |
| ATOM | 1941 | C | PRO | A | 256 | −13.626 | 1.476 | 62.711 | 1.00 | 100.00 | 6 |
| ATOM | 1942 | O | PRO | A | 256 | −13.786 | 1.881 | 63.874 | 1.00 | 100.00 | 8 |
| ATOM | 1943 | N | LEU | A | 257 | −13.351 | 0.200 | 62.411 | 1.00 | 100.00 | 7 |
| ATOM | 1944 | CA | LEU | A | 257 | −13.450 | −0.881 | 63.394 | 1.00 | 100.00 | 6 |
| ATOM | 1945 | CB | LEU | A | 257 | −14.829 | −1.499 | 63.304 | 1.00 | 100.00 | 6 |
| ATOM | 1946 | CG | LEU | A | 257 | −15.697 | −0.805 | 62.246 | 1.00 | 100.00 | 6 |
| ATOM | 1947 | CD1 | LEU | A | 257 | −16.589 | −1.810 | 61.527 | 1.00 | 100.00 | 6 |
| ATOM | 1948 | CD2 | LEU | A | 257 | −16.511 | 0.387 | 62.760 | 1.00 | 100.00 | 6 |
| ATOM | 1949 | C | LEU | A | 257 | −12.378 | −1.937 | 63.156 | 1.00 | 100.00 | 6 |
| ATOM | 1950 | O | LEU | A | 257 | −12.041 | −2.254 | 62.004 | 1.00 | 100.00 | 8 |
| ATOM | 1951 | N | VAL | A | 258 | −11.892 | −2.508 | 64.254 | 1.00 | 100.00 | 7 |
| ATOM | 1952 | CA | VAL | A | 258 | −10.528 | −3.037 | 64.307 | 1.00 | 100.00 | 6 |
| ATOM | 1953 | CB | VAL | A | 258 | −10.064 | −3.292 | 65.741 | 1.00 | 100.00 | 6 |
| ATOM | 1954 | CG1 | VAL | A | 258 | −8.523 | −3.402 | 65.833 | 1.00 | 100.00 | 6 |
| ATOM | 1955 | CG2 | VAL | A | 258 | −10.508 | −2.162 | 66.570 | 1.00 | 100.00 | 6 |
| ATOM | 1956 | C | VAL | A | 258 | −10.243 | −4.243 | 63.439 | 1.00 | 100.00 | 6 |
| ATOM | 1957 | O | VAL | A | 258 | −9.084 | −4.617 | 63.264 | 1.00 | 100.00 | 8 |
| ATOM | 1958 | N | GLN | A | 259 | −11.272 | −4.852 | 62.882 | 1.00 | 100.00 | 7 |
| ATOM | 1959 | CA | GLN | A | 259 | −11.037 | −5.684 | 61.721 | 1.00 | 100.00 | 6 |
| ATOM | 1960 | CB | GLN | A | 259 | −12.323 | −5.788 | 60.919 | 1.00 | 100.00 | 6 |
| ATOM | 1961 | CG | GLN | A | 259 | −13.573 | −6.275 | 61.696 | 1.00 | 100.00 | 6 |
| ATOM | 1962 | CD | GLN | A | 259 | −14.933 | −6.120 | 60.875 | 1.00 | 100.00 | 6 |
| ATOM | 1963 | OE1 | GLN | A | 259 | −14.938 | −5.629 | 59.726 | 1.00 | 100.00 | 8 |
| ATOM | 1964 | NE2 | GLN | A | 259 | −16.073 | −6.526 | 61.489 | 1.00 | 100.00 | 7 |
| ATOM | 1965 | C | GLN | A | 259 | −9.948 | −5.031 | 60.831 | 1.00 | 100.00 | 6 |
| ATOM | 1966 | O | GLN | A | 259 | −8.895 | −5.633 | 60.564 | 1.00 | 100.00 | 8 |
| ATOM | 1967 | N | ALA | A | 260 | −10.252 | −3.805 | 60.381 | 1.00 | 100.00 | 7 |
| ATOM | 1968 | CA | ALA | A | 260 | −9.315 | −2.845 | 59.747 | 1.00 | 100.00 | 6 |
| ATOM | 1969 | CB | ALA | A | 260 | −9.917 | −1.458 | 59.811 | 1.00 | 100.00 | 6 |
| ATOM | 1970 | C | ALA | A | 260 | −7.877 | −2.813 | 60.295 | 1.00 | 100.00 | 6 |
| ATOM | 1971 | O | ALA | A | 260 | −7.119 | −1.823 | 60.134 | 1.00 | 100.00 | 8 |
| ATOM | 1972 | N | HIS | A | 261 | −7.554 | −3.900 | 60.987 | 1.00 | 100.00 | 7 |
| ATOM | 1973 | CA | HIS | A | 261 | −6.191 | −4.295 | 61.241 | 1.00 | 100.00 | 6 |
| ATOM | 1974 | CB | HIS | A | 261 | −6.107 | −5.489 | 62.210 | 1.00 | 100.00 | 6 |
| ATOM | 1975 | CG | HIS | A | 261 | −4.718 | −6.065 | 62.372 | 1.00 | 100.00 | 6 |
| ATOM | 1976 | ND1 | HIS | A | 261 | −4.417 | −7.011 | 63.327 | 1.00 | 100.00 | 7 |
| ATOM | 1977 | CE1 | HIS | A | 261 | −3.142 | −7.334 | 63.240 | 1.00 | 100.00 | 6 |
| ATOM | 1978 | NE2 | HIS | A | 261 | −2.594 | −6.616 | 62.281 | 1.00 | 100.00 | 7 |
| ATOM | 1979 | CD2 | HIS | A | 261 | −3.555 | −5.811 | 61.725 | 1.00 | 100.00 | 6 |
| ATOM | 1980 | C | HIS | A | 261 | −5.740 | −4.804 | 59.925 | 1.00 | 100.00 | 6 |
| ATOM | 1981 | O | HIS | A | 261 | −4.949 | −4.165 | 59.236 | 1.00 | 100.00 | 8 |
| ATOM | 1982 | N | MET | A | 262 | −6.267 | −5.973 | 59.575 | 1.00 | 100.00 | 7 |
| ATOM | 1983 | CA | MET | A | 262 | −5.691 | −6.739 | 58.484 | 1.00 | 100.00 | 6 |
| ATOM | 1984 | CB | MET | A | 262 | −6.574 | −7.959 | 58.085 | 1.00 | 100.00 | 6 |
| ATOM | 1985 | CG | MET | A | 262 | −7.507 | −7.851 | 56.841 | 1.00 | 100.00 | 6 |
| ATOM | 1986 | SD | MET | A | 262 | −9.275 | −7.527 | 57.087 | 1.00 | 100.00 | 16 |
| ATOM | 1987 | CE | MET | A | 262 | −9.267 | −5.755 | 57.363 | 1.00 | 100.00 | 6 |
| ATOM | 1988 | C | MET | A | 262 | −5.362 | −5.779 | 57.350 | 1.00 | 100.00 | 6 |
| ATOM | 1989 | O | MET | A | 262 | −4.450 | −6.022 | 56.574 | 1.00 | 100.00 | 8 |
| ATOM | 1990 | N | VAL | A | 263 | −6.077 | −4.654 | 57.349 | 1.00 | 100.00 | 7 |
| ATOM | 1991 | CA | VAL | A | 263 | −5.991 | −3.641 | 56.331 | 1.00 | 100.00 | 6 |
| ATOM | 1992 | CB | VAL | A | 263 | −7.086 | −2.621 | 56.542 | 1.00 | 100.00 | 6 |
| ATOM | 1993 | CG1 | VAL | A | 263 | −6.547 | −1.365 | 57.259 | 1.00 | 100.00 | 6 |
| ATOM | 1994 | CG2 | VAL | A | 263 | −7.750 | −2.321 | 55.196 | 1.00 | 100.00 | 6 |
| ATOM | 1995 | C | VAL | A | 263 | −4.614 | −3.017 | 56.336 | 1.00 | 100.00 | 6 |
| ATOM | 1996 | O | VAL | A | 263 | −3.918 | −3.005 | 55.341 | 1.00 | 100.00 | 8 |
| ATOM | 1997 | N | ALA | A | 264 | −4.205 | −2.511 | 57.474 | 1.00 | 100.00 | 7 |
| ATOM | 1998 | CA | ALA | A | 264 | −2.816 | −2.206 | 57.663 | 1.00 | 100.00 | 6 |
| ATOM | 1999 | CB | ALA | A | 264 | −2.625 | −1.742 | 59.074 | 1.00 | 100.00 | 6 |
| ATOM | 2000 | C | ALA | A | 264 | −1.988 | −3.472 | 57.365 | 1.00 | 100.00 | 6 |
| ATOM | 2001 | O | ALA | A | 264 | −1.109 | −3.469 | 56.532 | 1.00 | 100.00 | 8 |
| ATOM | 2002 | N | ASP | A | 265 | −2.332 | −4.566 | 58.026 | 1.00 | 100.00 | 7 |
| ATOM | 2003 | CA | ASP | A | 265 | −1.656 | −5.850 | 57.883 | 1.00 | 100.00 | 6 |
| ATOM | 2004 | CB | ASP | A | 265 | −2.337 | −6.892 | 58.799 | 1.00 | 100.00 | 6 |
| ATOM | 2005 | CG | ASP | A | 265 | −1.441 | −8.130 | 59.152 | 1.00 | 100.00 | 6 |
| ATOM | 2006 | OD1 | ASP | A | 265 | −1.652 | −8.688 | 60.276 | 1.00 | 100.00 | 8 |
| ATOM | 2007 | OD2 | ASP | A | 265 | −0.568 | −8.552 | 58.334 | 1.00 | 100.00 | 8 |
| ATOM | 2008 | C | ASP | A | 265 | −1.735 | −6.327 | 56.462 | 1.00 | 100.00 | 6 |
| ATOM | 2009 | O | ASP | A | 265 | −1.126 | −7.312 | 56.107 | 1.00 | 100.00 | 8 |
| ATOM | 2010 | N | GLN | A | 266 | −2.527 | −5.656 | 55.649 | 1.00 | 100.00 | 7 |
| ATOM | 2011 | CA | GLN | A | 266 | −2.529 | −5.954 | 54.226 | 1.00 | 100.00 | 6 |
| ATOM | 2012 | CB | GLN | A | 266 | −3.904 | −5.627 | 53.586 | 1.00 | 100.00 | 6 |
| ATOM | 2013 | CG | GLN | A | 266 | −5.033 | −6.763 | 53.655 | 1.00 | 100.00 | 6 |
| ATOM | 2014 | CD | GLN | A | 266 | −6.563 | −6.269 | 53.485 | 1.00 | 100.00 | 6 |
| ATOM | 2015 | OE1 | GLN | A | 266 | −6.876 | −5.068 | 53.284 | 1.00 | 100.00 | 8 |
| ATOM | 2016 | NE2 | GLN | A | 266 | −7.496 | −7.229 | 53.585 | 1.00 | 100.00 | 7 |
| ATOM | 2017 | C | GLN | A | 266 | −1.375 | −5.116 | 53.671 | 1.00 | 100.00 | 6 |
| ATOM | 2018 | O | GLN | A | 266 | −0.394 | −5.635 | 53.138 | 1.00 | 100.00 | 8 |
| ATOM | 2019 | N | VAL | A | 267 | −1.477 | −3.816 | 53.862 | 1.00 | 100.00 | 7 |
| ATOM | 2020 | CA | VAL | A | 267 | −0.375 | −2.948 | 53.610 | 1.00 | 100.00 | 6 |
| ATOM | 2021 | CB | VAL | A | 267 | −0.475 | −1.749 | 54.515 | 1.00 | 100.00 | 6 |
| ATOM | 2022 | CG1 | VAL | A | 267 | 0.790 | −0.896 | 54.419 | 1.00 | 100.00 | 6 |
| ATOM | 2023 | CG2 | VAL | A | 267 | −1.735 | −0.960 | 54.193 | 1.00 | 100.00 | 6 |
| ATOM | 2024 | C | VAL | A | 267 | 0.860 | −3.665 | 54.016 | 1.00 | 100.00 | 6 |
| ATOM | 2025 | O | VAL | A | 267 | 1.675 | −4.019 | 53.199 | 1.00 | 100.00 | 8 |
| ATOM | 2026 | N | GLU | A | 268 | 0.971 | −3.881 | 55.319 | 1.00 | 100.00 | 7 |
| ATOM | 2027 | CA | GLU | A | 268 | 2.166 | −4.475 | 55.906 | 1.00 | 100.00 | 6 |
| ATOM | 2028 | CB | GLU | A | 268 | 1.953 | −4.916 | 57.379 | 1.00 | 100.00 | 6 |
| ATOM | 2029 | CG | GLU | A | 268 | 1.582 | −3.780 | 58.391 | 1.00 | 100.00 | 6 |
| ATOM | 2030 | CD | GLU | A | 268 | 1.499 | −4.215 | 59.915 | 1.00 | 100.00 | 6 |
| ATOM | 2031 | OE1 | GLU | A | 268 | 1.370 | −5.436 | 60.228 | 1.00 | 100.00 | 8 |
| ATOM | 2032 | OE2 | GLU | A | 268 | 1.550 | −3.319 | 60.817 | 1.00 | 100.00 | 8 |
| ATOM | 2033 | C | GLU | A | 268 | 2.549 | −5.648 | 55.021 | 1.00 | 100.00 | 6 |
| ATOM | 2034 | O | GLU | A | 268 | 3.600 | −5.633 | 54.395 | 1.00 | 100.00 | 8 |
| ATOM | 2035 | N | GLN | A | 269 | 1.659 | −6.632 | 54.929 | 1.00 | 100.00 | 7 |
| ATOM | 2036 | CA | GLN | A | 269 | 1.860 | −7.770 | 54.059 | 1.00 | 100.00 | 6 |
| ATOM | 2037 | CB | GLN | A | 269 | 0.545 | −8.494 | 53.819 | 1.00 | 100.00 | 6 |
| ATOM | 2038 | CG | GLN | A | 269 | 0.616 | −9.643 | 52.780 | 1.00 | 100.00 | 6 |
| ATOM | 2039 | CD | GLN | A | 269 | 1.022 | −11.026 | 53.359 | 1.00 | 100.00 | 6 |
| ATOM | 2040 | OE1 | GLN | A | 269 | 1.307 | −11.150 | 54.563 | 1.00 | 100.00 | 8 |
| ATOM | 2041 | NE2 | GLN | A | 269 | 1.040 | −12.069 | 52.494 | 1.00 | 100.00 | 7 |
| ATOM | 2042 | C | GLN | A | 269 | 2.380 | −7.296 | 52.734 | 1.00 | 100.00 | 6 |
| ATOM | 2043 | O | GLN | A | 269 | 3.483 | −7.670 | 52.324 | 1.00 | 100.00 | 8 |
| ATOM | 2044 | N | ALA | A | 270 | 1.585 | −6.464 | 52.070 | 1.00 | 100.00 | 7 |
| ATOM | 2045 | CA | ALA | A | 270 | 1.917 | −6.056 | 50.708 | 1.00 | 100.00 | 6 |
| ATOM | 2046 | CB | ALA | A | 270 | 0.760 | −5.221 | 50.060 | 1.00 | 100.00 | 6 |
| ATOM | 2047 | C | ALA | A | 270 | 3.308 | −5.373 | 50.601 | 1.00 | 100.00 | 6 |
| ATOM | 2048 | O | ALA | A | 270 | 3.967 | −5.449 | 49.533 | 1.00 | 100.00 | 8 |
| ATOM | 2049 | N | ILE | A | 271 | 3.753 | −4.745 | 51.708 | 1.00 | 100.00 | 7 |
| ATOM | 2050 | CA | ILE | A | 271 | 5.174 | −4.452 | 51.862 | 1.00 | 100.00 | 6 |
| ATOM | 2051 | CB | ILE | A | 271 | 5.522 | −3.414 | 52.956 | 1.00 | 100.00 | 6 |
| ATOM | 2052 | CG1 | ILE | A | 271 | 4.348 | −2.504 | 53.280 | 1.00 | 100.00 | 6 |
| ATOM | 2053 | CD1 | ILE | A | 271 | 4.766 | −1.326 | 54.145 | 1.00 | 100.00 | 6 |
| ATOM | 2054 | CG2 | ILE | A | 271 | 6.712 | −2.563 | 52.529 | 1.00 | 100.00 | 6 |
| ATOM | 2055 | C | ILE | A | 271 | 5.866 | −5.819 | 52.059 | 1.00 | 100.00 | 6 |
| ATOM | 2056 | O | ILE | A | 271 | 6.636 | −6.081 | 52.993 | 1.00 | 100.00 | 8 |
| ATOM | 2057 | N | LEU | A | 272 | 5.504 | −6.722 | 51.157 | 1.00 | 100.00 | 7 |
| ATOM | 2058 | CA | LEU | A | 272 | 6.427 | −7.719 | 50.676 | 1.00 | 100.00 | 6 |
| ATOM | 2059 | CB | LEU | A | 272 | 5.787 | −8.508 | 49.518 | 1.00 | 100.00 | 6 |
| ATOM | 2060 | CG | LEU | A | 272 | 6.467 | −9.674 | 48.759 | 1.00 | 100.00 | 6 |
| ATOM | 2061 | CD1 | LEU | A | 272 | 5.607 | −9.952 | 47.519 | 1.00 | 100.00 | 6 |
| ATOM | 2062 | CD2 | LEU | A | 272 | 7.946 | −9.532 | 48.354 | 1.00 | 100.00 | 6 |
| ATOM | 2063 | C | LEU | A | 272 | 7.604 | −6.891 | 50.130 | 1.00 | 100.00 | 6 |
| ATOM | 2064 | O | LEU | A | 272 | 8.611 | −6.677 | 50.843 | 1.00 | 100.00 | 8 |
| ATOM | 2065 | N | ARG | A | 273 | 7.365 | −6.315 | 48.934 | 1.00 | 100.00 | 7 |
| ATOM | 2066 | CA | ARG | A | 273 | 8.348 | −6.083 | 47.880 | 1.00 | 100.00 | 6 |
| ATOM | 2067 | CB | ARG | A | 273 | 8.314 | −4.685 | 47.276 | 1.00 | 100.00 | 6 |
| ATOM | 2068 | CG | ARG | A | 273 | 8.798 | −4.703 | 45.827 | 1.00 | 100.00 | 6 |
| ATOM | 2069 | CD | ARG | A | 273 | 8.572 | −3.400 | 45.099 | 1.00 | 100.00 | 6 |
| ATOM | 2070 | NE | ARG | A | 273 | 7.139 | −3.131 | 44.952 | 1.00 | 100.00 | 7 |
| ATOM | 2071 | CZ | ARG | A | 273 | 6.595 | −2.099 | 44.296 | 1.00 | 100.00 | 6 |
| ATOM | 2072 | NH1 | ARG | A | 273 | 7.379 | −1.195 | 43.686 | 1.00 | 100.00 | 7 |
| ATOM | 2073 | NH2 | ARG | A | 273 | 5.250 | −1.980 | 44.252 | 1.00 | 100.00 | 7 |
| ATOM | 2074 | C | ARG | A | 273 | 9.732 | −6.522 | 48.235 | 1.00 | 100.00 | 6 |
| ATOM | 2075 | O | ARG | A | 273 | 10.367 | −7.151 | 47.423 | 1.00 | 100.00 | 8 |
| ATOM | 2076 | N | ARG | A | 274 | 10.196 | −6.227 | 49.443 | 1.00 | 100.00 | 7 |
| ATOM | 2077 | CA | ARG | A | 274 | 11.496 | −6.739 | 49.888 | 1.00 | 100.00 | 6 |
| ATOM | 2078 | CB | ARG | A | 274 | 12.142 | −5.852 | 50.965 | 1.00 | 100.00 | 6 |
| ATOM | 2079 | CG | ARG | A | 274 | 13.216 | −4.809 | 50.441 | 1.00 | 100.00 | 6 |
| ATOM | 2080 | CD | ARG | A | 274 | 12.763 | −3.304 | 50.599 | 1.00 | 100.00 | 6 |
| ATOM | 2081 | NE | ARG | A | 274 | 12.031 | −2.737 | 49.457 | 1.00 | 100.00 | 7 |
| ATOM | 2082 | CZ | ARG | A | 274 | 10.730 | −2.915 | 49.195 | 1.00 | 100.00 | 6 |
| ATOM | 2083 | NH1 | ARG | A | 274 | 9.945 | −3.661 | 49.969 | 1.00 | 100.00 | 7 |
| ATOM | 2084 | NH2 | ARG | A | 274 | 10.194 | −2.341 | 48.127 | 1.00 | 100.00 | 7 |
| ATOM | 2085 | C | ARG | A | 274 | 11.452 | −8.171 | 50.365 | 1.00 | 100.00 | 6 |
| ATOM | 2086 | O | ARG | A | 274 | 10.398 | −8.778 | 50.544 | 1.00 | 100.00 | 8 |
| ATOM | 2087 | N | PHE | A | 275 | 12.630 | −8.699 | 50.601 | 1.00 | 100.00 | 7 |
| ATOM | 2088 | CA | PHE | A | 275 | 12.732 | −10.112 | 50.791 | 1.00 | 100.00 | 6 |
| ATOM | 2089 | CB | PHE | A | 275 | 13.683 | −10.753 | 49.711 | 1.00 | 100.00 | 6 |
| ATOM | 2090 | CG | PHE | A | 275 | 15.132 | −10.094 | 49.567 | 1.00 | 100.00 | 6 |
| ATOM | 2091 | CD1 | PHE | A | 275 | 15.838 | −9.495 | 50.687 | 1.00 | 100.00 | 6 |
| ATOM | 2092 | CE1 | PHE | A | 275 | 17.192 | −8.915 | 50.511 | 1.00 | 100.00 | 6 |
| ATOM | 2093 | CZ | PHE | A | 275 | 17.835 | −8.959 | 49.218 | 1.00 | 100.00 | 6 |
| ATOM | 2094 | CE2 | PHE | A | 275 | 17.158 | −9.568 | 48.112 | 1.00 | 100.00 | 6 |
| ATOM | 2095 | CD2 | PHE | A | 275 | 15.824 | −10.141 | 48.292 | 1.00 | 100.00 | 6 |
| ATOM | 2096 | C | PHE | A | 275 | 12.984 | −10.638 | 52.247 | 1.00 | 100.00 | 6 |
| ATOM | 2097 | O | PHE | A | 275 | 13.643 | −11.682 | 52.409 | 1.00 | 100.00 | 8 |
| ATOM | 2098 | N | PRO | A | 276 | 12.444 | −9.970 | 53.319 | 1.00 | 100.00 | 7 |
| ATOM | 2099 | CA | PRO | A | 276 | 11.692 | −8.715 | 53.573 | 1.00 | 100.00 | 6 |
| ATOM | 2100 | CB | PRO | A | 276 | 10.510 | −9.246 | 54.402 | 1.00 | 100.00 | 6 |
| ATOM | 2101 | CG | PRO | A | 276 | 11.237 | −10.376 | 55.366 | 1.00 | 100.00 | 6 |
| ATOM | 2102 | CD | PRO | A | 276 | 12.530 | −10.756 | 54.590 | 1.00 | 100.00 | 6 |
| ATOM | 2103 | C | PRO | A | 276 | 12.407 | −7.655 | 54.466 | 1.00 | 100.00 | 6 |
| ATOM | 2104 | O | PRO | A | 276 | 13.655 | −7.586 | 54.555 | 1.00 | 100.00 | 8 |
| ATOM | 2105 | N | GLY | A | 277 | 11.572 | −6.840 | 55.108 | 1.00 | 100.00 | 7 |
| ATOM | 2106 | CA | GLY | A | 277 | 11.931 | −6.141 | 56.322 | 1.00 | 100.00 | 6 |
| ATOM | 2107 | C | GLY | A | 277 | 11.461 | −7.071 | 57.403 | 1.00 | 100.00 | 6 |
| ATOM | 2108 | O | GLY | A | 277 | 11.638 | −8.290 | 57.263 | 1.00 | 100.00 | 8 |
| ATOM | 2109 | N | SER | A | 278 | 10.851 | −6.512 | 58.461 | 1.00 | 100.00 | 7 |
| ATOM | 2110 | CA | SER | A | 278 | 10.245 | −7.330 | 59.564 | 1.00 | 100.00 | 6 |
| ATOM | 2111 | CB | SER | A | 278 | 10.288 | −6.587 | 60.935 | 1.00 | 100.00 | 6 |
| ATOM | 2112 | OG | SER | A | 278 | 11.123 | −5.419 | 60.915 | 1.00 | 100.00 | 8 |
| ATOM | 2113 | C | SER | A | 278 | 8.808 | −7.822 | 59.108 | 1.00 | 100.00 | 6 |
| ATOM | 2114 | O | SER | A | 278 | 8.716 | −8.491 | 58.059 | 1.00 | 100.00 | 8 |
| ATOM | 2115 | N | ASP | A | 279 | 7.732 | −7.570 | 59.899 | 1.00 | 100.00 | 7 |
| ATOM | 2116 | CA | ASP | A | 279 | 6.319 | −7.217 | 59.399 | 1.00 | 100.00 | 6 |
| ATOM | 2117 | CB | ASP | A | 279 | 5.124 | −8.071 | 60.031 | 1.00 | 100.00 | 6 |
| ATOM | 2118 | CG | ASP | A | 279 | 3.729 | −8.049 | 59.171 | 1.00 | 100.00 | 6 |
| ATOM | 2119 | OD1 | ASP | A | 279 | 3.626 | −7.525 | 58.002 | 1.00 | 100.00 | 8 |
| ATOM | 2120 | OD2 | ASP | A | 279 | 2.722 | −8.597 | 59.718 | 1.00 | 100.00 | 8 |
| ATOM | 2121 | C | ASP | A | 279 | 6.331 | −5.737 | 59.831 | 1.00 | 100.00 | 6 |
| ATOM | 2122 | O | ASP | A | 279 | 5.640 | −5.294 | 60.797 | 1.00 | 100.00 | 8 |
| ATOM | 2123 | N | VAL | A | 280 | 7.236 | −5.024 | 59.161 | 1.00 | 100.00 | 7 |
| ATOM | 2124 | CA | VAL | A | 280 | 7.795 | −3.836 | 59.732 | 1.00 | 100.00 | 6 |
| ATOM | 2125 | CB | VAL | A | 280 | 8.923 | −3.323 | 58.856 | 1.00 | 100.00 | 6 |
| ATOM | 2126 | CG1 | VAL | A | 280 | 10.259 | −3.734 | 59.418 | 1.00 | 100.00 | 6 |
| ATOM | 2127 | CG2 | VAL | A | 280 | 8.763 | −3.904 | 57.503 | 1.00 | 100.00 | 6 |
| ATOM | 2128 | C | VAL | A | 280 | 6.498 | −3.066 | 59.844 | 1.00 | 100.00 | 6 |
| ATOM | 2129 | O | VAL | A | 280 | 5.706 | −3.058 | 58.876 | 1.00 | 100.00 | 8 |
| ATOM | 2130 | N | ILE | A | 281 | 6.283 | −2.548 | 61.068 | 1.00 | 100.00 | 7 |
| ATOM | 2131 | CA | ILE | A | 281 | 4.981 | −2.480 | 61.793 | 1.00 | 100.00 | 6 |
| ATOM | 2132 | CB | ILE | A | 281 | 5.202 | −2.237 | 63.291 | 1.00 | 100.00 | 6 |
| ATOM | 2133 | CG1 | ILE | A | 281 | 6.565 | −2.730 | 63.777 | 1.00 | 100.00 | 6 |
| ATOM | 2134 | CD1 | ILE | A | 281 | 7.619 | −1.568 | 63.856 | 1.00 | 100.00 | 6 |
| ATOM | 2135 | CG2 | ILE | A | 281 | 3.968 | −2.552 | 64.119 | 1.00 | 100.00 | 6 |
| ATOM | 2136 | C | ILE | A | 281 | 4.126 | −1.285 | 61.530 | 1.00 | 100.00 | 6 |
| ATOM | 2137 | O | ILE | A | 281 | 4.622 | −0.162 | 61.625 | 1.00 | 100.00 | 8 |
| ATOM | 2138 | N | ILE | A | 282 | 2.834 | −1.495 | 61.305 | 1.00 | 100.00 | 7 |
| ATOM | 2139 | CA | ILE | A | 282 | 1.972 | −0.356 | 61.176 | 1.00 | 100.00 | 6 |
| ATOM | 2140 | CB | ILE | A | 282 | 0.949 | −0.460 | 60.056 | 1.00 | 100.00 | 6 |
| ATOM | 2141 | CG1 | ILE | A | 282 | 1.397 | 0.246 | 58.794 | 1.00 | 100.00 | 6 |
| ATOM | 2142 | CD1 | ILE | A | 282 | 2.722 | −0.076 | 58.313 | 1.00 | 100.00 | 6 |
| ATOM | 2143 | CG2 | ILE | A | 282 | −0.199 | 0.394 | 60.353 | 1.00 | 100.00 | 6 |
| ATOM | 2144 | C | ILE | A | 282 | 1.291 | −0.187 | 62.486 | 1.00 | 100.00 | 6 |
| ATOM | 2145 | O | ILE | A | 282 | 0.953 | −1.173 | 63.147 | 1.00 | 100.00 | 8 |
| ATOM | 2146 | N | HIS | A | 283 | 1.169 | 1.089 | 62.857 | 1.00 | 100.00 | 7 |
| ATOM | 2147 | CA | HIS | A | 283 | 0.378 | 1.597 | 63.951 | 1.00 | 100.00 | 6 |
| ATOM | 2148 | CB | HIS | A | 283 | 1.143 | 2.697 | 64.635 | 1.00 | 100.00 | 6 |
| ATOM | 2149 | CG | HIS | A | 283 | 0.290 | 3.633 | 65.423 | 1.00 | 100.00 | 6 |
| ATOM | 2150 | ND1 | HIS | A | 283 | −0.815 | 3.222 | 66.133 | 1.00 | 100.00 | 7 |
| ATOM | 2151 | CE1 | HIS | A | 283 | −1.356 | 4.263 | 66.750 | 1.00 | 100.00 | 6 |
| ATOM | 2152 | NE2 | HIS | A | 283 | −0.631 | 5.334 | 66.477 | 1.00 | 100.00 | 7 |
| ATOM | 2153 | CD2 | HIS | A | 283 | 0.409 | 4.964 | 65.655 | 1.00 | 100.00 | 6 |
| ATOM | 2154 | C | HIS | A | 283 | −0.639 | 2.242 | 63.142 | 1.00 | 100.00 | 6 |
| ATOM | 2155 | O | HIS | A | 283 | −0.290 | 2.975 | 62.245 | 1.00 | 100.00 | 8 |
| ATOM | 2156 | N | GLN | A | 284 | −1.895 | 1.950 | 63.414 | 1.00 | 100.00 | 7 |
| ATOM | 2157 | CA | GLN | A | 284 | −2.968 | 2.366 | 62.526 | 1.00 | 100.00 | 6 |
| ATOM | 2158 | CB | GLN | A | 284 | −3.983 | 1.267 | 62.320 | 1.00 | 100.00 | 6 |
| ATOM | 2159 | CG | GLN | A | 284 | −4.225 | 0.460 | 63.544 | 1.00 | 100.00 | 6 |
| ATOM | 2160 | CD | GLN | A | 284 | −3.300 | −0.708 | 63.561 | 1.00 | 100.00 | 6 |
| ATOM | 2161 | OE1 | GLN | A | 284 | −2.305 | −0.738 | 64.324 | 1.00 | 100.00 | 8 |
| ATOM | 2162 | NE2 | GLN | A | 284 | −3.562 | −1.665 | 62.654 | 1.00 | 100.00 | 7 |
| ATOM | 2163 | C | GLN | A | 284 | −3.672 | 3.487 | 63.145 | 1.00 | 100.00 | 6 |
| ATOM | 2164 | O | GLN | A | 284 | −4.548 | 3.268 | 63.974 | 1.00 | 100.00 | 8 |
| ATOM | 2165 | N | ASP | A | 285 | −3.297 | 4.690 | 62.723 | 1.00 | 100.00 | 7 |
| ATOM | 2266 | CA | ASP | A | 285 | −3.806 | 5.943 | 63.338 | 1.00 | 100.00 | 6 |
| ATOM | 2167 | CB | ASP | A | 285 | −2.709 | 7.056 | 63.454 | 1.00 | 100.00 | 6 |
| ATOM | 2168 | CG | ASP | A | 285 | −1.998 | 7.071 | 64.792 | 1.00 | 100.00 | 6 |
| ATOM | 2169 | OD1 | ASP | A | 285 | −2.483 | 6.475 | 65.754 | 1.00 | 100.00 | 8 |
| ATOM | 2170 | OD2 | ASP | A | 285 | −0.938 | 7.692 | 64.893 | 1.00 | 100.00 | 8 |
| ATOM | 2171 | C | ASP | A | 285 | −5.133 | 6.486 | 62.681 | 1.00 | 100.00 | 6 |
| ATOM | 2172 | O | ASP | A | 285 | −5.197 | 6.742 | 61.459 | 1.00 | 100.00 | 8 |
| ATOM | 2173 | N | PRO | A | 286 | −6.182 | 6.668 | 63.506 | 1.00 | 100.00 | 7 |
| ATOM | 2174 | CA | PRO | A | 286 | −7.417 | 7.209 | 63.091 | 1.00 | 100.00 | 6 |
| ATOM | 2175 | CB | PRO | A | 286 | −8.274 | 6.970 | 64.310 | 1.00 | 100.00 | 6 |
| ATOM | 2176 | CG | PRO | A | 286 | −7.361 | 7.122 | 65.423 | 1.00 | 100.00 | 6 |
| ATOM | 2177 | CD | PRO | A | 286 | −6.198 | 6.378 | 64.948 | 1.00 | 100.00 | 6 |
| ATOM | 2178 | C | PRO | A | 286 | −7.248 | 8.693 | 62.911 | 1.00 | 100.00 | 6 |
| ATOM | 2179 | O | PRO | A | 286 | −7.104 | 9.136 | 61.779 | 1.00 | 100.00 | 8 |
| ATOM | 2180 | N | CYS | A | 287 | −7.186 | 9.422 | 64.042 | 1.00 | 100.00 | 7 |
| ATOM | 2181 | CA | CYS | A | 287 | −7.521 | 10.886 | 64.138 | 1.00 | 100.00 | 6 |
| ATOM | 2182 | CB | CYS | A | 287 | −8.605 | 11.191 | 65.186 | 1.00 | 100.00 | 6 |
| ATOM | 2183 | SG | CYS | A | 287 | −9.523 | 12.700 | 64.780 | 1.00 | 100.00 | 16 |
| ATOM | 2184 | C | CYS | A | 287 | −6.449 | 12.003 | 64.141 | 1.00 | 100.00 | 6 |
| ATOM | 2185 | O | CYS | A | 287 | −5.587 | 12.160 | 65.041 | 1.00 | 100.00 | 8 |
| ATOM | 2186 | N | SER | A | 288 | −6.715 | 12.857 | 63.160 | 1.00 | 100.00 | 7 |
| ATOM | 2187 | CA | SER | A | 288 | −5.737 | 13.487 | 62.298 | 1.00 | 100.00 | 6 |
| ATOM | 2188 | CB | SER | A | 288 | −6.423 | 14.004 | 61.004 | 1.00 | 100.00 | 6 |
| ATOM | 2189 | OG | SER | A | 288 | −7.785 | 14.386 | 61.200 | 1.00 | 100.00 | 8 |
| ATOM | 2190 | C | SER | A | 288 | −4.883 | 14.575 | 62.912 | 1.00 | 100.00 | 6 |
| ATOM | 2191 | O | SER | A | 288 | −5.384 | 15.522 | 63.539 | 1.00 | 100.00 | 8 |
| ATOM | 2192 | N | VAL | A | 289 | −3.577 | 14.406 | 62.729 | 1.00 | 100.00 | 7 |
| ATOM | 2193 | CA | VAL | A | 289 | −2.662 | 15.529 | 62.687 | 1.00 | 100.00 | 6 |
| ATOM | 2194 | CB | VAL | A | 289 | −1.161 | 15.037 | 62.675 | 1.00 | 100.00 | 6 |
| ATOM | 2195 | CG1 | VAL | A | 289 | −0.221 | 16.181 | 62.977 | 1.00 | 100.00 | 6 |
| ATOM | 2196 | CG2 | VAL | A | 289 | −0.904 | 13.848 | 63.666 | 1.00 | 100.00 | 6 |
| ATOM | 2197 | C | VAL | A | 289 | −3.094 | 16.158 | 61.347 | 1.00 | 100.00 | 6 |
| ATOM | 2198 | O | VAL | A | 289 | −3.198 | 15.432 | 60.344 | 1.00 | 100.00 | 8 |
| ATOM | 2199 | N | VAL | A | 290 | −3.422 | 17.456 | 61.316 | 1.00 | 100.00 | 7 |
| ATOM | 2200 | CA | VAL | A | 290 | −3.992 | 18.042 | 60.067 | 1.00 | 100.00 | 6 |
| ATOM | 2201 | CB | VAL | A | 290 | −5.590 | 17.942 | 60.030 | 1.00 | 100.00 | 6 |
| ATOM | 2202 | CG1 | VAL | A | 290 | −6.278 | 19.218 | 60.570 | 1.00 | 100.00 | 6 |
| ATOM | 2203 | CG2 | VAL | A | 290 | −6.111 | 17.582 | 58.618 | 1.00 | 100.00 | 6 |
| ATOM | 2204 | C | VAL | A | 290 | −3.471 | 19.451 | 59.687 | 1.00 | 100.00 | 6 |
| ATOM | 2205 | O | VAL | A | 290 | −2.980 | 19.687 | 58.564 | 1.00 | 100.00 | 8 |
| ATOM | 2206 | ZN | HET | C | 12 | −1.141 | −7.724 | 63.361 | 1.00 | 40.00 | 30 |
| ATOM | 2207 | ZN | HET | C | 13 | 21.502 | 12.569 | 60.336 | 1.00 | 40.00 | 30 |
| ATOM | 2208 | ZN | HET | C | 16 | 0.777 | −9.468 | 66.128 | 1.00 | 40.00 | 30 |
| ATOM | 2209 | ZN | HET | C | 17 | 46.372 | −11.135 | 51.922 | 1.00 | 40.00 | 30 |
| END | | | | | | | | | | | |

APPENDIX I
PART B

| REMARK | YiiP protomer-B coordinates | | | | | |
|---|---|---|---|---|---|---|
| REMARK | Written by O version 8.0.5 | | | | | |
| REMARK | Fri Feb 2 11:18:22 2007 | | | | | |
| CRYST1 | 1.000 | 1.000 | 1.000 | 90.00 | 90.00 | 90.00 |

| | | | | |
|---|---|---|---|---|
| ORIGX1 | 1.000000 | 0.000000 | 0.000000 | 0.00000 |
| ORIGX2 | 0.000000 | 1.000000 | 0.000000 | 0.00000 |
| ORIGX3 | 0.000000 | 0.000000 | 1.000000 | 0.00000 |
| SCALE1 | 1.000000 | −0.000026 | −0.000026 | 0.00000 |
| SCALE2 | 0.000000 | 1.000000 | −0.000026 | 0.00000 |
| SCALE3 | 0.000000 | 0.000000 | 1.000000 | 0.00000 |

| | | | | | | | | | | | |
|---|---|---|---|---|---|---|---|---|---|---|---|
| ATOM | 1 | N | TYR | A | 5 | 13.896 | 17.288 | 81.745 | 0.00 | 0.00 | 7 |
| ATOM | 2 | CA | TYR | A | 5 | 14.387 | 15.900 | 81.479 | 0.00 | 0.00 | 6 |
| ATOM | 3 | CB | TYR | A | 5 | 13.810 | 15.372 | 80.137 | 0.00 | 0.00 | 6 |
| ATOM | 4 | CG | TYR | A | 5 | 14.732 | 15.428 | 78.894 | 0.00 | 0.00 | 6 |
| ATOM | 5 | CD1 | TYR | A | 5 | 14.908 | 16.621 | 78.150 | 0.00 | 0.00 | 6 |
| ATOM | 6 | CE1 | TYR | A | 5 | 15.755 | 16.657 | 77.014 | 0.00 | 0.00 | 6 |
| ATOM | 7 | CZ | TYR | A | 5 | 16.420 | 15.483 | 76.610 | 0.00 | 0.00 | 6 |
| ATOM | 8 | OH | TYR | A | 5 | 17.247 | 15.496 | 75.506 | 0.00 | 0.00 | 8 |
| ATOM | 9 | CE2 | TYR | A | 5 | 16.253 | 14.290 | 77.318 | 0.00 | 0.00 | 6 |
| ATOM | 10 | CD2 | TYR | A | 5 | 15.410 | 14.269 | 78.450 | 0.00 | 0.00 | 6 |
| ATOM | 11 | C | TYR | A | 5 | 15.929 | 15.762 | 81.546 | 0.00 | 0.00 | 6 |
| ATOM | 12 | O | TYR | A | 5 | 16.432 | 14.795 | 82.124 | 0.00 | 0.00 | 8 |
| ATOM | 13 | N | GLY | A | 6 | 16.653 | 16.744 | 80.983 | 0.00 | 0.00 | 7 |
| ATOM | 14 | CA | GLY | A | 6 | 18.098 | 16.638 | 80.681 | 0.00 | 0.00 | 6 |
| ATOM | 15 | C | GLY | A | 6 | 19.006 | 17.813 | 81.005 | 0.00 | 0.00 | 6 |
| ATOM | 16 | O | GLY | A | 6 | 20.141 | 17.883 | 80.528 | 0.00 | 0.00 | 8 |
| ATOM | 17 | N | ARG | A | 7 | 18.482 | 18.736 | 81.805 | 0.00 | 0.00 | 7 |
| ATOM | 18 | CA | ARG | A | 7 | 19.263 | 19.763 | 82.507 | 0.00 | 0.00 | 6 |
| ATOM | 19 | CB | ARG | A | 7 | 18.291 | 20.751 | 83.185 | 0.00 | 0.00 | 6 |
| ATOM | 20 | CG | ARG | A | 7 | 18.904 | 22.076 | 83.651 | 0.00 | 0.00 | 6 |
| ATOM | 21 | CD | ARG | A | 7 | 19.412 | 22.899 | 82.472 | 0.00 | 0.00 | 6 |
| ATOM | 22 | NE | ARG | A | 7 | 20.338 | 23.947 | 82.896 | 0.00 | 0.00 | 7 |
| ATOM | 23 | CZ | ARG | A | 7 | 21.224 | 24.542 | 82.096 | 0.00 | 0.00 | 6 |
| ATOM | 24 | NH1 | ARG | A | 7 | 21.323 | 24.192 | 80.813 | 0.00 | 0.00 | 7 |
| ATOM | 25 | NH2 | ARG | A | 7 | 22.021 | 25.490 | 82.584 | 0.00 | 0.00 | 7 |
| ATOM | 26 | C | ARG | A | 7 | 20.187 | 19.101 | 83.559 | 0.00 | 0.00 | 6 |
| ATOM | 27 | O | ARG | A | 7 | 21.385 | 19.442 | 83.702 | 0.00 | 0.00 | 8 |
| ATOM | 28 | N | LEU | A | 8 | 19.595 | 18.158 | 84.292 | 0.00 | 0.00 | 7 |
| ATOM | 29 | CA | LEU | A | 8 | 20.312 | 17.280 | 85.206 | 0.00 | 0.00 | 6 |
| ATOM | 30 | CB | LEU | A | 8 | 19.805 | 17.445 | 86.657 | 0.00 | 0.00 | 6 |
| ATOM | 31 | CG | LEU | A | 8 | 19.861 | 18.755 | 87.471 | 0.00 | 0.00 | 6 |
| ATOM | 32 | CD1 | LEU | A | 8 | 21.241 | 19.439 | 87.418 | 0.00 | 0.00 | 6 |
| ATOM | 33 | CD2 | LEU | A | 8 | 18.736 | 19.719 | 87.075 | 0.00 | 0.00 | 6 |
| ATOM | 34 | C | LEU | A | 8 | 20.173 | 15.815 | 84.739 | 0.00 | 0.00 | 6 |
| ATOM | 35 | O | LEU | A | 8 | 21.132 | 15.244 | 84.208 | 0.00 | 0.00 | 8 |
| ATOM | 36 | N | VAL | A | 9 | 18.965 | 15.248 | 84.883 | 0.00 | 0.00 | 7 |
| ATOM | 37 | CA | VAL | A | 9 | 18.725 | 13.784 | 84.815 | 0.00 | 0.00 | 6 |
| ATOM | 38 | CB | VAL | A | 9 | 17.382 | 13.397 | 85.598 | 0.00 | 0.00 | 6 |
| ATOM | 39 | CG1 | VAL | A | 9 | 16.147 | 14.103 | 85.023 | 0.00 | 0.00 | 6 |
| ATOM | 40 | CG2 | VAL | A | 9 | 17.182 | 11.879 | 85.736 | 0.00 | 0.00 | 6 |
| ATOM | 41 | C | VAL | A | 9 | 18.932 | 13.066 | 83.428 | 0.00 | 0.00 | 6 |
| ATOM | 42 | O | VAL | A | 9 | 19.018 | 11.832 | 83.386 | 0.00 | 0.00 | 8 |
| ATOM | 43 | N | SER | A | 10 | 19.065 | 13.826 | 82.330 | 0.00 | 0.00 | 7 |
| ATOM | 44 | CA | SER | A | 10 | 19.338 | 13.247 | 80.979 | 0.00 | 0.00 | 6 |
| ATOM | 45 | CB | SER | A | 10 | 18.018 | 12.987 | 80.205 | 0.00 | 0.00 | 6 |
| ATOM | 46 | OG | SER | A | 10 | 18.194 | 12.308 | 78.961 | 0.00 | 0.00 | 8 |
| ATOM | 47 | C | SER | A | 10 | 20.401 | 13.999 | 80.106 | 0.00 | 0.00 | 6 |
| ATOM | 48 | O | SER | A | 10 | 20.715 | 15.179 | 80.352 | 0.00 | 0.00 | 8 |
| ATOM | 49 | N | ARG | A | 11 | 20.917 | 13.295 | 79.083 | 0.00 | 0.00 | 7 |
| ATOM | 50 | CA | ARG | A | 11 | 22.103 | 13.677 | 78.297 | 0.00 | 0.00 | 6 |
| ATOM | 51 | CB | ARG | A | 11 | 22.274 | 12.745 | 77.089 | 0.00 | 0.00 | 6 |
| ATOM | 52 | CG | ARG | A | 11 | 23.080 | 11.503 | 77.357 | 0.00 | 0.00 | 6 |
| ATOM | 53 | CD | ARG | A | 11 | 22.877 | 10.451 | 76.288 | 0.00 | 0.00 | 6 |
| ATOM | 54 | NE | ARG | A | 11 | 21.613 | 9.715 | 76.466 | 0.00 | 0.00 | 7 |
| ATOM | 55 | CZ | ARG | A | 11 | 21.049 | 8.874 | 75.579 | 0.00 | 0.00 | 6 |
| ATOM | 56 | NH1 | ARG | A | 11 | 21.634 | 8.638 | 74.412 | 0.00 | 0.00 | 7 |
| ATOM | 57 | NH2 | ARG | A | 11 | 19.888 | 8.261 | 75.852 | 0.00 | 0.00 | 7 |
| ATOM | 58 | C | ARG | A | 11 | 22.150 | 15.125 | 77.847 | 0.00 | 0.00 | 6 |
| ATOM | 59 | O | ARG | A | 11 | 23.183 | 15.591 | 77.390 | 0.00 | 0.00 | 8 |
| ATOM | 60 | N | ALA | A | 12 | 21.044 | 15.843 | 78.004 | 0.00 | 0.00 | 7 |
| ATOM | 61 | CA | ALA | A | 12 | 20.905 | 17.162 | 77.399 | 0.00 | 0.00 | 6 |
| ATOM | 62 | CB | ALA | A | 12 | 19.645 | 17.872 | 77.902 | 0.00 | 0.00 | 6 |
| ATOM | 63 | C | ALA | A | 12 | 22.131 | 18.033 | 77.597 | 0.00 | 0.00 | 6 |
| ATOM | 64 | O | ALA | A | 12 | 22.790 | 18.447 | 76.637 | 0.00 | 0.00 | 8 |
| ATOM | 65 | N | ALA | A | 13 | 22.447 | 18.301 | 78.850 | 0.00 | 0.00 | 7 |
| ATOM | 66 | CA | ALA | A | 13 | 23.553 | 19.194 | 79.139 | 0.00 | 0.00 | 6 |
| ATOM | 67 | CB | ALA | A | 13 | 23.097 | 20.303 | 80.090 | 0.00 | 0.00 | 6 |
| ATOM | 68 | C | ALA | A | 13 | 24.716 | 18.413 | 79.730 | 0.00 | 0.00 | 6 |
| ATOM | 69 | O | ALA | A | 13 | 25.867 | 18.518 | 79.273 | 0.00 | 0.00 | 8 |
| ATOM | 70 | N | ILE | A | 14 | 24.385 | 17.635 | 80.757 | 0.00 | 0.00 | 7 |
| ATOM | 71 | CA | ILE | A | 14 | 25.330 | 16.776 | 81.440 | 0.00 | 0.00 | 6 |
| ATOM | 72 | CB | ILE | A | 14 | 24.586 | 15.764 | 82.366 | 0.00 | 0.00 | 6 |
| ATOM | 73 | CG1 | ILE | A | 14 | 25.474 | 14.571 | 82.753 | 0.00 | 0.00 | 6 |
| ATOM | 74 | CD1 | ILE | A | 14 | 26.275 | 14.794 | 84.013 | 0.00 | 0.00 | 6 |
| ATOM | 75 | CG2 | ILE | A | 14 | 23.284 | 15.304 | 81.727 | 0.00 | 0.00 | 6 |
| ATOM | 76 | C | ILE | A | 14 | 26.239 | 16.095 | 80.421 | 0.00 | 0.00 | 6 |
| ATOM | 77 | O | ILE | A | 14 | 27.462 | 16.166 | 80.538 | 0.00 | 0.00 | 8 |
| ATOM | 78 | N | ALA | A | 15 | 25.634 | 15.487 | 79.403 | 0.00 | 0.00 | 7 |
| ATOM | 79 | CA | ALA | A | 15 | 26.382 | 14.796 | 78.364 | 0.00 | 0.00 | 6 |
| ATOM | 80 | CB | ALA | A | 15 | 25.546 | 13.701 | 77.735 | 0.00 | 0.00 | 6 |
| ATOM | 81 | C | ALA | A | 15 | 26.906 | 15.755 | 77.304 | 0.00 | 0.00 | 6 |
| ATOM | 82 | O | ALA | A | 15 | 27.643 | 15.346 | 76.409 | 0.00 | 0.00 | 8 |
| ATOM | 83 | N | ALA | A | 16 | 26.558 | 17.032 | 77.422 | 0.00 | 0.00 | 7 |
| ATOM | 84 | CA | ALA | A | 16 | 27.006 | 18.008 | 76.448 | 0.00 | 0.00 | 6 |
| ATOM | 85 | CB | ALA | A | 16 | 26.043 | 19.195 | 76.375 | 0.00 | 0.00 | 6 |
| ATOM | 86 | C | ALA | A | 16 | 28.430 | 18.472 | 76.715 | 0.00 | 0.00 | 6 |
| ATOM | 87 | O | ALA | A | 16 | 29.142 | 18.826 | 75.794 | 0.00 | 0.00 | 8 |
| ATOM | 88 | N | THR | A | 17 | 28.869 | 18.426 | 77.961 | 0.00 | 0.00 | 7 |
| ATOM | 89 | CA | THR | A | 17 | 30.030 | 19.225 | 78.352 | 0.00 | 0.00 | 6 |
| ATOM | 90 | CB | THR | A | 17 | 29.643 | 20.204 | 79.486 | 0.00 | 0.00 | 6 |
| ATOM | 91 | OG1 | THR | A | 17 | 30.821 | 20.812 | 80.031 | 0.00 | 0.00 | 8 |
| ATOM | 92 | CG2 | THR | A | 17 | 28.896 | 19.481 | 80.593 | 0.00 | 0.00 | 6 |
| ATOM | 93 | C | THR | A | 17 | 31.367 | 18.547 | 78.696 | 0.00 | 0.00 | 6 |
| ATOM | 94 | O | THR | A | 17 | 32.405 | 19.005 | 78.245 | 0.00 | 0.00 | 8 |
| ATOM | 95 | N | ALA | A | 18 | 31.342 | 17.502 | 79.518 | 0.00 | 0.00 | 7 |
| ATOM | 96 | CA | ALA | A | 18 | 32.561 | 16.895 | 80.075 | 0.00 | 0.00 | 6 |
| ATOM | 97 | CB | ALA | A | 18 | 32.258 | 15.558 | 80.697 | 0.00 | 0.00 | 6 |
| ATOM | 98 | C | ALA | A | 18 | 33.711 | 16.776 | 79.087 | 0.00 | 0.00 | 6 |
| ATOM | 99 | O | ALA | A | 18 | 34.468 | 17.727 | 78.918 | 0.00 | 0.00 | 8 |
| ATOM | 100 | N | MET | A | 19 | 33.850 | 15.622 | 78.437 | 0.00 | 0.00 | 7 |
| ATOM | 101 | CA | MET | A | 19 | 34.844 | 15.493 | 77.364 | 0.00 | 0.00 | 6 |
| ATOM | 102 | CB | MET | A | 19 | 35.076 | 14.025 | 76.955 | 0.00 | 0.00 | 6 |
| ATOM | 103 | CG | MET | A | 19 | 36.183 | 13.869 | 75.875 | 0.00 | 0.00 | 6 |
| ATOM | 104 | SD | MET | A | 19 | 37.240 | 12.394 | 75.883 | 0.00 | 0.00 | 16 |
| ATOM | 105 | CE | MET | A | 19 | 37.325 | 12.075 | 77.644 | 0.00 | 0.00 | 6 |
| ATOM | 106 | C | MET | A | 19 | 34.504 | 16.397 | 76.152 | 0.00 | 0.00 | 6 |
| ATOM | 107 | O | MET | A | 19 | 34.866 | 16.111 | 74.992 | 0.00 | 0.00 | 8 |
| ATOM | 108 | N | ALA | A | 20 | 33.792 | 17.484 | 76.446 | 0.00 | 0.00 | 7 |
| ATOM | 109 | CA | ALA | A | 20 | 33.556 | 18.561 | 75.499 | 0.00 | 0.00 | 6 |
| ATOM | 110 | CB | ALA | A | 20 | 32.075 | 18.688 | 75.186 | 0.00 | 0.00 | 6 |
| ATOM | 111 | C | ALA | A | 20 | 34.079 | 19.817 | 76.168 | 0.00 | 0.00 | 6 |
| ATOM | 112 | O | ALA | A | 20 | 33.589 | 20.924 | 75.925 | 0.00 | 0.00 | 8 |
| ATOM | 113 | N | SER | A | 21 | 35.072 | 19.612 | 77.030 | 0.00 | 0.00 | 7 |
| ATOM | 114 | CA | SER | A | 21 | 35.665 | 20.670 | 77.817 | 0.00 | 0.00 | 6 |
| ATOM | 115 | CB | SER | A | 21 | 34.613 | 21.686 | 78.258 | 0.00 | 0.00 | 6 |
| ATOM | 116 | OG | SER | A | 21 | 33.450 | 21.026 | 78.714 | 0.00 | 0.00 | 8 |
| ATOM | 117 | C | SER | A | 21 | 36.360 | 20.101 | 79.026 | 0.00 | 0.00 | 6 |
| ATOM | 118 | O | SER | A | 21 | 36.804 | 20.846 | 79.891 | 0.00 | 0.00 | 8 |
| ATOM | 119 | N | LEU | A | 22 | 36.436 | 18.780 | 79.115 | 0.00 | 0.00 | 7 |
| ATOM | 120 | CA | LEU | A | 22 | 37.376 | 18.192 | 80.050 | 0.00 | 0.00 | 6 |
| ATOM | 121 | CB | LEU | A | 22 | 37.148 | 16.685 | 80.261 | 0.00 | 0.00 | 6 |
| ATOM | 122 | CG | LEU | A | 22 | 38.158 | 15.693 | 80.921 | 0.00 | 0.00 | 6 |
| ATOM | 123 | CD1 | LEU | A | 22 | 38.872 | 14.820 | 79.902 | 0.00 | 0.00 | 6 |
| ATOM | 124 | CD2 | LEU | A | 22 | 39.192 | 16.286 | 81.879 | 0.00 | 0.00 | 6 |
| ATOM | 125 | C | LEU | A | 22 | 38.669 | 18.424 | 79.348 | 0.00 | 0.00 | 6 |
| ATOM | 126 | O | LEU | A | 22 | 39.718 | 18.582 | 79.966 | 0.00 | 0.00 | 8 |
| ATOM | 127 | N | LEU | A | 23 | 38.577 | 18.483 | 78.033 | 0.00 | 0.00 | 7 |
| ATOM | 128 | CA | LEU | A | 23 | 39.770 | 18.550 | 77.261 | 0.00 | 0.00 | 6 |
| ATOM | 129 | CB | LEU | A | 23 | 39.714 | 17.506 | 76.166 | 0.00 | 0.00 | 6 |
| ATOM | 130 | CG | LEU | A | 23 | 39.797 | 16.101 | 76.759 | 0.00 | 0.00 | 6 |
| ATOM | 131 | CD1 | LEU | A | 23 | 39.426 | 15.054 | 75.755 | 0.00 | 0.00 | 6 |
| ATOM | 132 | CD2 | LEU | A | 23 | 41.193 | 15.839 | 77.310 | 0.00 | 0.00 | 6 |
| ATOM | 133 | C | LEU | A | 23 | 40.006 | 19.943 | 76.744 | 0.00 | 0.00 | 6 |
| ATOM | 134 | O | LEU | A | 23 | 41.159 | 20.344 | 76.528 | 0.00 | 0.00 | 8 |
| ATOM | 135 | N | LEU | A | 24 | 38.919 | 20.694 | 76.596 | 0.00 | 0.00 | 7 |
| ATOM | 136 | CA | LEU | A | 24 | 39.011 | 22.097 | 76.189 | 0.00 | 0.00 | 6 |
| ATOM | 137 | CB | LEU | A | 24 | 37.626 | 22.668 | 75.868 | 0.00 | 0.00 | 6 |
| ATOM | 138 | CG | LEU | A | 24 | 37.048 | 22.450 | 74.466 | 0.00 | 0.00 | 6 |
| ATOM | 139 | CD1 | LEU | A | 24 | 36.774 | 20.974 | 74.214 | 0.00 | 0.00 | 6 |
| ATOM | 140 | CD2 | LEU | A | 24 | 35.772 | 23.281 | 74.270 | 0.00 | 0.00 | 6 |
| ATOM | 141 | C | LEU | A | 24 | 39.729 | 22.985 | 77.220 | 0.00 | 0.00 | 6 |
| ATOM | 142 | O | LEU | A | 24 | 40.230 | 24.063 | 76.870 | 0.00 | 0.00 | 8 |
| ATOM | 143 | N | LEU | A | 25 | 39.774 | 22.531 | 78.477 | 0.00 | 0.00 | 7 |
| ATOM | 144 | CA | LEU | A | 25 | 40.440 | 23.274 | 79.562 | 0.00 | 0.00 | 6 |
| ATOM | 145 | CB | LEU | A | 25 | 39.438 | 23.658 | 80.676 | 0.00 | 0.00 | 6 |
| ATOM | 146 | CG | LEU | A | 25 | 39.902 | 24.444 | 81.921 | 0.00 | 0.00 | 6 |
| ATOM | 147 | CD1 | LEU | A | 25 | 40.186 | 25.926 | 81.614 | 0.00 | 0.00 | 6 |
| ATOM | 148 | CD2 | LEU | A | 25 | 38.888 | 24.307 | 83.062 | 0.00 | 0.00 | 6 |
| ATOM | 149 | C | LEU | A | 25 | 41.625 | 22.491 | 80.135 | 0.00 | 0.00 | 6 |
| ATOM | 150 | O | LEU | A | 25 | 42.789 | 22.865 | 79.919 | 0.00 | 0.00 | 8 |
| ATOM | 151 | N | ILE | A | 26 | 41.325 | 21.418 | 80.869 | 0.00 | 0.00 | 7 |
| ATOM | 152 | CA | ILE | A | 26 | 42.374 | 20.563 | 81.409 | 0.00 | 0.00 | 6 |
| ATOM | 153 | CB | ILE | A | 26 | 41.914 | 19.723 | 82.637 | 0.00 | 0.00 | 6 |
| ATOM | 154 | CG1 | ILE | A | 26 | 42.266 | 20.489 | 83.928 | 0.00 | 0.00 | 6 |
| ATOM | 155 | CD1 | ILE | A | 26 | 42.413 | 19.655 | 85.191 | 0.00 | 0.00 | 6 |
| ATOM | 156 | CG2 | ILE | A | 26 | 42.523 | 18.323 | 82.607 | 0.00 | 0.00 | 6 |
| ATOM | 157 | C | ILE | A | 26 | 43.020 | 19.764 | 80.279 | 0.00 | 0.00 | 6 |
| ATOM | 158 | O | ILE | A | 26 | 42.373 | 18.978 | 79.582 | 0.00 | 0.00 | 8 |
| ATOM | 159 | N | LYS | A | 27 | 44.309 | 20.024 | 80.099 | 0.00 | 0.00 | 7 |
| ATOM | 160 | CA | LYS | A | 27 | 45.068 | 19.531 | 78.968 | 0.00 | 0.00 | 6 |
| ATOM | 161 | CB | LYS | A | 27 | 45.201 | 18.005 | 79.008 | 0.00 | 0.00 | 6 |
| ATOM | 162 | CG | LYS | A | 27 | 46.652 | 17.522 | 78.998 | 0.00 | 0.00 | 6 |
| ATOM | 163 | CD | LYS | A | 27 | 47.594 | 18.404 | 79.843 | 0.00 | 0.00 | 6 |
| ATOM | 164 | CE | LYS | A | 27 | 49.042 | 17.999 | 79.639 | 0.00 | 0.00 | 6 |
| ATOM | 165 | NZ | LYS | A | 27 | 49.974 | 19.057 | 80.057 | 0.00 | 0.00 | 7 |
| ATOM | 166 | C | LYS | A | 27 | 44.498 | 20.063 | 77.652 | 0.00 | 0.00 | 6 |
| ATOM | 167 | O | LYS | A | 27 | 44.316 | 19.328 | 76.679 | 0.00 | 0.00 | 8 |
| ATOM | 168 | N | ILE | A | 28 | 44.167 | 21.353 | 77.681 | 0.00 | 0.00 | 7 |
| ATOM | 169 | CA | ILE | A | 28 | 44.274 | 22.215 | 76.514 | 0.00 | 0.00 | 6 |
| ATOM | 170 | CB | ILE | A | 28 | 43.226 | 23.365 | 76.494 | 0.00 | 0.00 | 6 |
| ATOM | 171 | CG1 | ILE | A | 28 | 43.110 | 23.979 | 75.092 | 0.00 | 0.00 | 6 |
| ATOM | 172 | CD1 | ILE | A | 28 | 42.182 | 23.232 | 74.150 | 0.00 | 0.00 | 6 |
| ATOM | 173 | CG2 | ILE | A | 28 | 43.551 | 24.468 | 77.510 | 0.00 | 0.00 | 6 |
| ATOM | 174 | C | ILE | A | 28 | 45.682 | 22.789 | 76.615 | 0.00 | 0.00 | 6 |
| ATOM | 175 | O | ILE | A | 28 | 46.299 | 23.148 | 75.607 | 0.00 | 0.00 | 8 |
| ATOM | 176 | N | PHE | A | 29 | 46.167 | 22.869 | 77.856 | 0.00 | 0.00 | 7 |
| ATOM | 177 | CA | PHE | A | 29 | 47.529 | 23.267 | 78.167 | 0.00 | 0.00 | 6 |
| ATOM | 178 | CB | PHE | A | 29 | 47.761 | 24.749 | 77.859 | 0.00 | 0.00 | 6 |
| ATOM | 179 | CG | PHE | A | 29 | 49.185 | 25.086 | 77.484 | 0.00 | 0.00 | 6 |
| ATOM | 180 | CD1 | PHE | A | 29 | 49.691 | 24.743 | 76.231 | 0.00 | 0.00 | 6 |
| ATOM | 181 | CE1 | PHE | A | 29 | 51.004 | 25.061 | 75.878 | 0.00 | 0.00 | 6 |
| ATOM | 182 | CZ | PHE | A | 29 | 51.823 | 25.739 | 76.780 | 0.00 | 0.00 | 6 |
| ATOM | 183 | CE2 | PHE | A | 29 | 51.329 | 26.091 | 78.032 | 0.00 | 0.00 | 6 |
| ATOM | 184 | CD2 | PHE | A | 29 | 50.012 | 25.766 | 78.376 | 0.00 | 0.00 | 6 |
| ATOM | 185 | C | PHE | A | 29 | 47.791 | 23.000 | 79.631 | 0.00 | 0.00 | 6 |
| ATOM | 186 | O | PHE | A | 29 | 46.907 | 23.168 | 80.477 | 0.00 | 0.00 | 8 |
| ATOM | 187 | N | ALA | A | 30 | 49.017 | 22.567 | 79.908 | 0.00 | 0.00 | 7 |
| ATOM | 188 | CA | ALA | A | 30 | 49.515 | 22.400 | 81.266 | 0.00 | 0.00 | 6 |
| ATOM | 189 | CB | ALA | A | 30 | 48.809 | 21.220 | 81.950 | 0.00 | 0.00 | 6 |
| ATOM | 190 | C | ALA | A | 30 | 51.052 | 22.248 | 81.322 | 0.00 | 0.00 | 6 |
| ATOM | 191 | O | ALA | A | 30 | 51.599 | 21.775 | 82.320 | 0.00 | 0.00 | 8 |
| ATOM | 192 | N | TRP | A | 31 | 51.747 | 22.672 | 80.266 | 0.00 | 0.00 | 7 |
| ATOM | 193 | CA | TRP | A | 31 | 53.188 | 22.445 | 80.164 | 0.00 | 0.00 | 6 |
| ATOM | 194 | CB | TRP | A | 31 | 53.468 | 20.976 | 79.806 | 0.00 | 0.00 | 6 |
| ATOM | 195 | CG | TRP | A | 31 | 53.323 | 20.622 | 78.348 | 0.00 | 0.00 | 6 |
| ATOM | 196 | CD1 | TRP | A | 31 | 54.307 | 20.162 | 77.519 | 0.00 | 0.00 | 6 |
| ATOM | 197 | NE1 | TRP | A | 31 | 53.805 | 19.943 | 76.258 | 0.00 | 0.00 | 7 |
| ATOM | 198 | CE2 | TRP | A | 31 | 52.473 | 20.262 | 76.247 | 0.00 | 0.00 | 6 |
| ATOM | 199 | CD2 | TRP | A | 31 | 52.130 | 20.693 | 77.549 | 0.00 | 0.00 | 6 |
| ATOM | 200 | CE3 | TRP | A | 31 | 50.807 | 21.081 | 77.805 | 0.00 | 0.00 | 6 |
| ATOM | 201 | CZ3 | TRP | A | 31 | 49.884 | 21.029 | 76.771 | 0.00 | 0.00 | 6 |
| ATOM | 202 | CH2 | TRP | A | 31 | 50.256 | 20.600 | 75.485 | 0.00 | 0.00 | 6 |
| ATOM | 203 | CZ2 | TRP | A | 31 | 51.539 | 20.208 | 75.204 | 0.00 | 0.00 | 6 |
| ATOM | 204 | C | TRP | A | 31 | 53.894 | 23.378 | 79.183 | 0.00 | 0.00 | 6 |
| ATOM | 205 | O | TRP | A | 31 | 53.409 | 23.621 | 78.082 | 0.00 | 0.00 | 8 |
| ATOM | 206 | N | TRP | A | 32 | 55.046 | 23.894 | 79.597 | 0.00 | 0.00 | 7 |
| ATOM | 207 | CA | TRP | A | 32 | 55.892 | 24.719 | 78.735 | 0.00 | 0.00 | 6 |
| ATOM | 208 | CB | TRP | A | 32 | 55.652 | 26.221 | 78.988 | 0.00 | 0.00 | 6 |
| ATOM | 209 | CG | TRP | A | 32 | 55.725 | 26.682 | 80.443 | 0.00 | 0.00 | 6 |
| ATOM | 210 | CD1 | TRP | A | 32 | 56.374 | 26.063 | 81.479 | 0.00 | 0.00 | 6 |
| ATOM | 211 | NE1 | TRP | A | 32 | 56.227 | 26.789 | 82.637 | 0.00 | 0.00 | 7 |
| ATOM | 212 | CE2 | TRP | A | 32 | 55.487 | 27.911 | 82.368 | 0.00 | 0.00 | 6 |
| ATOM | 213 | CD2 | TRP | A | 32 | 55.157 | 27.882 | 80.993 | 0.00 | 0.00 | 6 |
| ATOM | 214 | CE3 | TRP | A | 32 | 54.395 | 28.931 | 80.459 | 0.00 | 0.00 | 6 |
| ATOM | 215 | CZ3 | TRP | A | 32 | 53.992 | 29.962 | 81.306 | 0.00 | 0.00 | 6 |
| ATOM | 216 | CH2 | TRP | A | 32 | 54.337 | 29.960 | 82.670 | 0.00 | 0.00 | 6 |
| ATOM | 217 | CZ2 | TRP | A | 32 | 55.081 | 28.947 | 83.218 | 0.00 | 0.00 | 6 |
| ATOM | 218 | C | TRP | A | 32 | 57.373 | 24.346 | 78.895 | 0.00 | 0.00 | 6 |
| ATOM | 219 | O | TRP | A | 32 | 58.218 | 25.199 | 79.168 | 0.00 | 0.00 | 8 |
| ATOM | 220 | N | TYR | A | 33 | 57.679 | 23.065 | 78.707 | 0.00 | 0.00 | 7 |
| ATOM | 221 | CA | TYR | A | 33 | 59.007 | 22.531 | 79.011 | 0.00 | 0.00 | 6 |
| ATOM | 222 | CB | TYR | A | 33 | 58.919 | 21.046 | 79.368 | 0.00 | 0.00 | 6 |
| ATOM | 223 | CG | TYR | A | 33 | 58.221 | 20.791 | 80.682 | 0.00 | 0.00 | 6 |
| ATOM | 224 | CD1 | TYR | A | 33 | 58.943 | 20.701 | 81.871 | 0.00 | 0.00 | 6 |
| ATOM | 225 | CE1 | TYR | A | 33 | 58.303 | 20.468 | 83.091 | 0.00 | 0.00 | 6 |
| ATOM | 226 | CZ | TYR | A | 33 | 56.923 | 20.325 | 83.125 | 0.00 | 0.00 | 6 |
| ATOM | 227 | OH | TYR | A | 33 | 56.278 | 20.094 | 84.325 | 0.00 | 0.00 | 8 |
| ATOM | 228 | CE2 | TYR | A | 33 | 56.186 | 20.415 | 81.953 | 0.00 | 0.00 | 6 |
| ATOM | 229 | CD2 | TYR | A | 33 | 56.838 | 20.646 | 80.740 | 0.00 | 0.00 | 6 |
| ATOM | 230 | C | TYR | A | 33 | 60.063 | 22.788 | 77.931 | 0.00 | 0.00 | 6 |
| ATOM | 231 | O | TYR | A | 33 | 60.579 | 23.899 | 77.837 | 0.00 | 0.00 | 8 |
| ATOM | 232 | N | THR | A | 34 | 60.371 | 21.766 | 77.128 | 0.00 | 0.00 | 7 |
| ATOM | 233 | CA | THR | A | 34 | 61.490 | 21.799 | 76.164 | 0.00 | 0.00 | 6 |
| ATOM | 234 | CB | THR | A | 34 | 61.747 | 20.396 | 75.527 | 0.00 | 0.00 | 6 |
| ATOM | 235 | OG1 | THR | A | 34 | 61.605 | 19.372 | 76.521 | 0.00 | 0.00 | 8 |
| ATOM | 236 | CG2 | THR | A | 34 | 63.148 | 20.314 | 74.922 | 0.00 | 0.00 | 6 |
| ATOM | 237 | C | THR | A | 34 | 61.352 | 22.876 | 75.068 | 0.00 | 0.00 | 6 |
| ATOM | 238 | O | THR | A | 34 | 60.939 | 22.595 | 73.935 | 0.00 | 0.00 | 8 |
| ATOM | 239 | N | GLY | A | 35 | 61.721 | 24.105 | 75.428 | 0.00 | 0.00 | 7 |
| ATOM | 240 | CA | GLY | A | 35 | 61.646 | 25.271 | 74.543 | 0.00 | 0.00 | 6 |
| ATOM | 241 | C | GLY | A | 35 | 62.072 | 26.517 | 75.302 | 0.00 | 0.00 | 6 |
| ATOM | 242 | O | GLY | A | 35 | 63.123 | 27.101 | 75.018 | 0.00 | 0.00 | 8 |
| ATOM | 243 | N | SER | A | 36 | 61.240 | 26.921 | 76.262 | 0.00 | 0.00 | 7 |
| ATOM | 244 | CA | SER | A | 36 | 61.592 | 27.940 | 77.250 | 0.00 | 0.00 | 6 |
| ATOM | 245 | CB | SER | A | 36 | 60.545 | 29.058 | 77.276 | 0.00 | 0.00 | 6 |
| ATOM | 246 | OG | SER | A | 36 | 60.959 | 30.137 | 78.094 | 0.00 | 0.00 | 8 |
| ATOM | 247 | C | SER | A | 36 | 61.699 | 27.247 | 78.612 | 0.00 | 0.00 | 6 |
| ATOM | 248 | O | SER | A | 36 | 60.720 | 26.679 | 79.102 | 0.00 | 0.00 | 8 |
| ATOM | 249 | N | VAL | A | 37 | 62.893 | 27.301 | 79.208 | 0.00 | 0.00 | 7 |
| ATOM | 250 | CA | VAL | A | 37 | 63.280 | 26.460 | 80.362 | 0.00 | 0.00 | 6 |
| ATOM | 251 | CB | VAL | A | 37 | 62.392 | 26.695 | 81.632 | 0.00 | 0.00 | 6 |
| ATOM | 252 | CG1 | VAL | A | 37 | 62.929 | 25.913 | 82.826 | 0.00 | 0.00 | 6 |
| ATOM | 253 | CG2 | VAL | A | 37 | 62.311 | 28.179 | 81.974 | 0.00 | 0.00 | 6 |
| ATOM | 254 | C | VAL | A | 37 | 63.328 | 24.980 | 79.929 | 0.00 | 0.00 | 6 |
| ATOM | 255 | O | VAL | A | 37 | 62.353 | 24.239 | 80.084 | 0.00 | 0.00 | 8 |
| ATOM | 256 | N | SER | A | 38 | 64.480 | 24.573 | 79.389 | 0.00 | 0.00 | 7 |
| ATOM | 257 | CA | SER | A | 38 | 64.637 | 23.299 | 78.667 | 0.00 | 0.00 | 6 |
| ATOM | 258 | CB | SER | A | 38 | 65.708 | 23.434 | 77.567 | 0.00 | 0.00 | 6 |
| ATOM | 259 | OG | SER | A | 38 | 65.295 | 24.294 | 76.517 | 0.00 | 0.00 | 8 |
| ATOM | 260 | C | SER | A | 38 | 64.940 | 22.067 | 79.536 | 0.00 | 0.00 | 6 |
| ATOM | 261 | O | SER | A | 38 | 65.970 | 21.412 | 79.353 | 0.00 | 0.00 | 8 |
| ATOM | 262 | N | ILE | A | 39 | 64.046 | 21.747 | 80.468 | 0.00 | 0.00 | 7 |
| ATOM | 263 | CA | ILE | A | 39 | 64.111 | 20.458 | 81.173 | 0.00 | 0.00 | 6 |
| ATOM | 264 | CB | ILE | A | 39 | 63.759 | 20.563 | 82.694 | 0.00 | 0.00 | 6 |
| ATOM | 265 | CG1 | ILE | A | 39 | 62.486 | 21.387 | 82.930 | 0.00 | 0.00 | 6 |
| ATOM | 266 | CD1 | ILE | A | 39 | 61.909 | 21.257 | 84.336 | 0.00 | 0.00 | 6 |
| ATOM | 267 | CG2 | ILE | A | 39 | 64.934 | 21.149 | 83.473 | 0.00 | 0.00 | 6 |
| ATOM | 268 | C | ILE | A | 39 | 63.243 | 19.414 | 80.450 | 0.00 | 0.00 | 6 |
| ATOM | 269 | O | ILE | A | 39 | 62.144 | 19.732 | 79.981 | 0.00 | 0.00 | 8 |
| ATOM | 270 | N | LEU | A | 40 | 63.746 | 18.182 | 80.358 | 0.00 | 0.00 | 7 |
| ATOM | 271 | CA | LEU | A | 40 | 63.145 | 17.125 | 79.521 | 0.00 | 0.00 | 6 |
| ATOM | 272 | CB | LEU | A | 40 | 64.051 | 15.888 | 79.476 | 0.00 | 0.00 | 6 |
| ATOM | 273 | CG | LEU | A | 40 | 65.084 | 15.809 | 78.351 | 0.00 | 0.00 | 6 |
| ATOM | 274 | CD1 | LEU | A | 40 | 66.192 | 14.846 | 78.726 | 0.00 | 0.00 | 6 |
| ATOM | 275 | CD2 | LEU | A | 40 | 64.431 | 15.393 | 77.040 | 0.00 | 0.00 | 6 |
| ATOM | 276 | C | LEU | A | 40 | 61.706 | 16.701 | 79.859 | 0.00 | 0.00 | 6 |
| ATOM | 277 | O | LEU | A | 40 | 61.360 | 16.455 | 81.020 | 0.00 | 0.00 | 8 |
| ATOM | 278 | N | ALA | A | 41 | 60.883 | 16.617 | 78.815 | 0.00 | 0.00 | 7 |
| ATOM | 279 | CA | ALA | A | 41 | 59.508 | 16.134 | 78.917 | 0.00 | 0.00 | 6 |
| ATOM | 280 | CB | ALA | A | 41 | 58.533 | 17.302 | 78.976 | 0.00 | 0.00 | 6 |
| ATOM | 281 | C | ALA | A | 41 | 59.198 | 15.216 | 77.730 | 0.00 | 0.00 | 6 |
| ATOM | 282 | O | ALA | A | 41 | 58.951 | 15.679 | 76.606 | 0.00 | 0.00 | 8 |
| ATOM | 283 | N | ALA | A | 42 | 59.220 | 13.911 | 77.993 | 0.00 | 0.00 | 7 |
| ATOM | 284 | CA | ALA | A | 42 | 59.112 | 12.899 | 76.939 | 0.00 | 0.00 | 6 |
| ATOM | 285 | CB | ALA | A | 42 | 60.090 | 11.749 | 77.213 | 0.00 | 0.00 | 6 |
| ATOM | 286 | C | ALA | A | 42 | 57.687 | 12.366 | 76.724 | 0.00 | 0.00 | 6 |
| ATOM | 287 | O | ALA | A | 42 | 57.488 | 11.394 | 75.988 | 0.00 | 0.00 | 8 |
| ATOM | 288 | N | LEU | A | 43 | 56.707 | 13.012 | 77.358 | 0.00 | 0.00 | 7 |
| ATOM | 289 | CA | LEU | A | 43 | 55.296 | 12.617 | 77.257 | 0.00 | 0.00 | 6 |
| ATOM | 290 | CB | LEU | A | 43 | 54.718 | 12.307 | 78.662 | 0.00 | 0.00 | 6 |
| ATOM | 291 | CG | LEU | A | 43 | 53.518 | 11.363 | 78.902 | 0.00 | 0.00 | 6 |
| ATOM | 292 | CD1 | LEU | A | 43 | 53.876 | 9.892 | 78.675 | 0.00 | 0.00 | 6 |
| ATOM | 293 | CD2 | LEU | A | 43 | 52.928 | 11.541 | 80.307 | 0.00 | 0.00 | 6 |
| ATOM | 294 | C | LEU | A | 43 | 54.502 | 13.726 | 76.552 | 0.00 | 0.00 | 6 |
| ATOM | 295 | O | LEU | A | 43 | 54.448 | 14.865 | 77.035 | 0.00 | 0.00 | 8 |
| ATOM | 296 | N | VAL | A | 44 | 53.917 | 13.407 | 75.398 | 0.00 | 0.00 | 7 |
| ATOM | 297 | CA | VAL | A | 44 | 53.051 | 14.366 | 74.710 | 0.00 | 0.00 | 6 |
| ATOM | 298 | CB | VAL | A | 44 | 53.696 | 14.957 | 73.448 | 0.00 | 0.00 | 6 |
| ATOM | 299 | CG1 | VAL | A | 44 | 52.840 | 16.108 | 72.911 | 0.00 | 0.00 | 6 |
| ATOM | 300 | CG2 | VAL | A | 44 | 55.103 | 15.448 | 73.757 | 0.00 | 0.00 | 6 |
| ATOM | 301 | C | VAL | A | 44 | 51.679 | 13.776 | 74.413 | 0.00 | 0.00 | 6 |
| ATOM | 302 | O | VAL | A | 44 | 51.261 | 13.646 | 73.266 | 0.00 | 0.00 | 8 |
| ATOM | 303 | N | ASP | A | 45 | 50.989 | 13.410 | 75.482 | 0.00 | 0.00 | 7 |
| ATOM | 304 | CA | ASP | A | 45 | 49.597 | 13.008 | 75.401 | 0.00 | 0.00 | 6 |
| ATOM | 305 | CB | ASP | A | 45 | 49.371 | 11.662 | 76.097 | 0.00 | 0.00 | 6 |
| ATOM | 306 | CG | ASP | A | 45 | 47.905 | 11.367 | 76.333 | 0.00 | 0.00 | 6 |
| ATOM | 307 | OD1 | ASP | A | 45 | 47.067 | 11.751 | 75.492 | 0.00 | 0.00 | 8 |
| ATOM | 308 | OD2 | ASP | A | 45 | 47.588 | 10.767 | 77.374 | 0.00 | 0.00 | 8 |
| ATOM | 309 | C | ASP | A | 45 | 48.703 | 14.114 | 75.972 | 0.00 | 0.00 | 6 |
| ATOM | 310 | O | ASP | A | 45 | 47.976 | 13.936 | 76.963 | 0.00 | 0.00 | 8 |
| ATOM | 311 | N | SER | A | 46 | 48.799 | 15.276 | 75.342 | 0.00 | 0.00 | 7 |
| ATOM | 312 | CA | SER | A | 46 | 47.869 | 16.361 | 75.567 | 0.00 | 0.00 | 6 |
| ATOM | 313 | CB | SER | A | 46 | 48.638 | 17.635 | 75.917 | 0.00 | 0.00 | 6 |
| ATOM | 314 | OG | SER | A | 46 | 47.767 | 18.736 | 76.100 | 0.00 | 0.00 | 8 |
| ATOM | 315 | C | SER | A | 46 | 47.217 | 16.489 | 74.216 | 0.00 | 0.00 | 6 |
| ATOM | 316 | O | SER | A | 46 | 46.003 | 16.663 | 74.082 | 0.00 | 0.00 | 8 |
| ATOM | 317 | N | LEU | A | 47 | 48.085 | 16.352 | 73.222 | 0.00 | 0.00 | 7 |
| ATOM | 318 | CA | LEU | A | 47 | 47.748 | 16.435 | 71.832 | 0.00 | 0.00 | 6 |
| ATOM | 319 | CB | LEU | A | 47 | 48.998 | 16.892 | 71.075 | 0.00 | 0.00 | 6 |
| ATOM | 320 | CG | LEU | A | 47 | 49.124 | 16.960 | 69.545 | 0.00 | 0.00 | 6 |
| ATOM | 321 | CD1 | LEU | A | 47 | 48.051 | 17.810 | 68.832 | 0.00 | 0.00 | 6 |
| ATOM | 322 | CD2 | LEU | A | 47 | 50.522 | 17.476 | 69.224 | 0.00 | 0.00 | 6 |
| ATOM | 323 | C | LEU | A | 47 | 47.260 | 15.063 | 71.376 | 0.00 | 0.00 | 6 |
| ATOM | 324 | O | LEU | A | 47 | 46.505 | 14.940 | 70.406 | 0.00 | 0.00 | 8 |
| ATOM | 325 | N | VAL | A | 48 | 47.698 | 14.035 | 72.092 | 0.00 | 0.00 | 7 |
| ATOM | 326 | CA | VAL | A | 48 | 47.162 | 12.705 | 71.894 | 0.00 | 0.00 | 6 |
| ATOM | 327 | CB | VAL | A | 48 | 48.146 | 11.605 | 72.392 | 0.00 | 0.00 | 6 |
| ATOM | 328 | CG1 | VAL | A | 48 | 47.484 | 10.233 | 72.478 | 0.00 | 0.00 | 6 |
| ATOM | 329 | CG2 | VAL | A | 48 | 49.330 | 11.514 | 71.470 | 0.00 | 0.00 | 6 |
| ATOM | 330 | C | VAL | A | 48 | 45.791 | 12.658 | 72.572 | 0.00 | 0.00 | 6 |
| ATOM | 331 | O | VAL | A | 48 | 44.912 | 11.892 | 72.171 | 0.00 | 0.00 | 8 |
| ATOM | 332 | N | ASP | A | 49 | 45.588 | 13.501 | 73.578 | 0.00 | 0.00 | 7 |
| ATOM | 333 | CA | ASP | A | 49 | 44.263 | 13.582 | 74.188 | 0.00 | 0.00 | 6 |
| ATOM | 334 | CB | ASP | A | 49 | 44.343 | 13.592 | 75.718 | 0.00 | 0.00 | 6 |
| ATOM | 335 | CG | ASP | A | 49 | 44.301 | 12.183 | 76.314 | 0.00 | 0.00 | 6 |
| ATOM | 336 | OD1 | ASP | A | 49 | 43.631 | 11.287 | 75.713 | 0.00 | 0.00 | 8 |
| ATOM | 337 | OD2 | ASP | A | 49 | 44.939 | 11.987 | 77.382 | 0.00 | 0.00 | 8 |
| ATOM | 338 | C | ASP | A | 49 | 43.421 | 14.730 | 73.637 | 0.00 | 0.00 | 6 |
| ATOM | 339 | O | ASP | A | 49 | 42.200 | 14.755 | 73.826 | 0.00 | 0.00 | 8 |
| ATOM | 340 | N | ILE | A | 50 | 44.070 | 15.656 | 72.935 | 0.00 | 0.00 | 7 |
| ATOM | 341 | CA | ILE | A | 50 | 43.344 | 16.719 | 72.258 | 0.00 | 0.00 | 6 |
| ATOM | 342 | CB | ILE | A | 50 | 44.238 | 17.929 | 71.955 | 0.00 | 0.00 | 6 |
| ATOM | 343 | CG1 | ILE | A | 50 | 43.483 | 19.220 | 72.285 | 0.00 | 0.00 | 6 |
| ATOM | 344 | CD1 | ILE | A | 50 | 44.350 | 20.362 | 72.767 | 0.00 | 0.00 | 6 |
| ATOM | 345 | CG2 | ILE | A | 50 | 44.735 | 17.898 | 70.502 | 0.00 | 0.00 | 6 |
| ATOM | 346 | C | ILE | A | 50 | 42.681 | 16.174 | 70.994 | 0.00 | 0.00 | 6 |
| ATOM | 347 | O | ILE | A | 50 | 41.687 | 16.723 | 70.504 | 0.00 | 0.00 | 8 |
| ATOM | 348 | N | GLY | A | 51 | 43.243 | 15.083 | 70.478 | 0.00 | 0.00 | 7 |
| ATOM | 349 | CA | GLY | A | 51 | 42.575 | 14.288 | 69.460 | 0.00 | 0.00 | 6 |
| ATOM | 350 | C | GLY | A | 51 | 41.255 | 13.843 | 70.047 | 0.00 | 0.00 | 6 |
| ATOM | 351 | O | GLY | A | 51 | 40.207 | 14.063 | 69.454 | 0.00 | 0.00 | 8 |
| ATOM | 352 | N | ALA | A | 52 | 41.329 | 13.271 | 71.249 | 0.00 | 0.00 | 7 |
| ATOM | 353 | CA | ALA | A | 52 | 40.171 | 12.768 | 71.999 | 0.00 | 0.00 | 6 |
| ATOM | 354 | CB | ALA | A | 52 | 40.629 | 12.095 | 73.336 | 0.00 | 0.00 | 6 |
| ATOM | 355 | C | ALA | A | 52 | 39.095 | 13.824 | 72.266 | 0.00 | 0.00 | 6 |
| ATOM | 356 | O | ALA | A | 52 | 37.902 | 13.505 | 72.321 | 0.00 | 0.00 | 8 |
| ATOM | 357 | N | SER | A | 53 | 39.512 | 15.075 | 72.428 | 0.00 | 0.00 | 7 |
| ATOM | 358 | CA | SER | A | 53 | 38.574 | 16.141 | 72.751 | 0.00 | 0.00 | 6 |
| ATOM | 359 | CB | SER | A | 53 | 39.310 | 17.407 | 73.171 | 0.00 | 0.00 | 6 |
| ATOM | 360 | OG | SER | A | 53 | 38.411 | 18.335 | 73.760 | 0.00 | 0.00 | 8 |
| ATOM | 361 | C | SER | A | 53 | 37.716 | 16.455 | 71.557 | 0.00 | 0.00 | 6 |
| ATOM | 362 | O | SER | A | 53 | 36.535 | 16.088 | 71.503 | 0.00 | 0.00 | 8 |
| ATOM | 363 | N | LEU | A | 54 | 38.336 | 17.140 | 70.604 | 0.00 | 0.00 | 7 |
| ATOM | 364 | CA | LEU | A | 54 | 37.683 | 17.498 | 69.379 | 0.00 | 0.00 | 6 |
| ATOM | 365 | CB | LEU | A | 54 | 38.705 | 18.059 | 68.401 | 0.00 | 0.00 | 6 |
| ATOM | 366 | CG | LEU | A | 54 | 38.764 | 19.592 | 68.356 | 0.00 | 0.00 | 6 |
| ATOM | 367 | CD1 | LEU | A | 54 | 39.136 | 20.202 | 69.710 | 0.00 | 0.00 | 6 |
| ATOM | 368 | CD2 | LEU | A | 54 | 39.698 | 20.089 | 67.221 | 0.00 | 0.00 | 6 |
| ATOM | 369 | C | LEU | A | 54 | 36.931 | 16.301 | 68.811 | 0.00 | 0.00 | 6 |
| ATOM | 370 | O | LEU | A | 54 | 35.797 | 16.442 | 68.349 | 0.00 | 0.00 | 8 |
| ATOM | 371 | N | THR | A | 55 | 37.553 | 15.125 | 68.883 | 0.00 | 0.00 | 7 |
| ATOM | 372 | CA | THR | A | 55 | 36.872 | 13.861 | 68.606 | 0.00 | 0.00 | 6 |
| ATOM | 373 | CB | THR | A | 55 | 37.752 | 12.646 | 69.003 | 0.00 | 0.00 | 6 |
| ATOM | 374 | OG1 | THR | A | 55 | 38.919 | 12.623 | 68.171 | 0.00 | 0.00 | 8 |
| ATOM | 375 | CG2 | THR | A | 55 | 36.988 | 11.309 | 68.881 | 0.00 | 0.00 | 6 |
| ATOM | 376 | C | THR | A | 55 | 35.558 | 13.806 | 69.368 | 0.00 | 0.00 | 6 |
| ATOM | 377 | O | THR | A | 55 | 34.509 | 14.195 | 68.853 | 0.00 | 0.00 | 8 |
| ATOM | 378 | N | ASN | A | 56 | 35.628 | 13.362 | 70.614 | 0.00 | 0.00 | 7 |
| ATOM | 379 | CA | ASN | A | 56 | 34.427 | 13.119 | 71.355 | 0.00 | 0.00 | 6 |
| ATOM | 380 | CB | ASN | A | 56 | 34.721 | 12.647 | 72.773 | 0.00 | 0.00 | 6 |
| ATOM | 381 | CG | ASN | A | 56 | 33.929 | 11.397 | 73.133 | 0.00 | 0.00 | 6 |
| ATOM | 382 | OD1 | ASN | A | 56 | 33.637 | 10.576 | 72.257 | 0.00 | 0.00 | 8 |
| ATOM | 383 | ND2 | ASN | A | 56 | 33.575 | 11.243 | 74.414 | 0.00 | 0.00 | 7 |
| ATOM | 384 | C | ASN | A | 56 | 33.516 | 14.327 | 71.352 | 0.00 | 0.00 | 6 |
| ATOM | 385 | O | ASN | A | 56 | 32.303 | 14.171 | 71.229 | 0.00 | 0.00 | 8 |
| ATOM | 386 | N | LEU | A | 57 | 34.088 | 15.523 | 71.442 | 0.00 | 0.00 | 7 |
| ATOM | 387 | CA | LEU | A | 57 | 33.268 | 16.713 | 71.410 | 0.00 | 0.00 | 6 |
| ATOM | 388 | CB | LEU | A | 57 | 34.115 | 17.974 | 71.381 | 0.00 | 0.00 | 6 |
| ATOM | 389 | CG | LEU | A | 57 | 33.316 | 19.261 | 71.131 | 0.00 | 0.00 | 6 |
| ATOM | 390 | CD1 | LEU | A | 57 | 33.587 | 20.317 | 72.188 | 0.00 | 0.00 | 6 |
| ATOM | 391 | CD2 | LEU | A | 57 | 33.555 | 19.829 | 69.732 | 0.00 | 0.00 | 6 |
| ATOM | 392 | C | LEU | A | 57 | 32.326 | 16.670 | 70.218 | 0.00 | 0.00 | 6 |
| ATOM | 393 | O | LEU | A | 57 | 31.104 | 16.572 | 70.378 | 0.00 | 0.00 | 8 |
| ATOM | 394 | N | LEU | A | 58 | 32.899 | 16.716 | 69.024 | 0.00 | 0.00 | 7 |
| ATOM | 395 | CA | LEU | A | 58 | 32.099 | 16.779 | 67.809 | 0.00 | 0.00 | 6 |
| ATOM | 396 | CB | LEU | A | 58 | 32.996 | 16.818 | 66.587 | 0.00 | 0.00 | 6 |
| ATOM | 397 | CG | LEU | A | 58 | 33.554 | 18.228 | 66.425 | 0.00 | 0.00 | 6 |
| ATOM | 398 | CD1 | LEU | A | 58 | 34.856 | 18.268 | 65.584 | 0.00 | 0.00 | 6 |
| ATOM | 399 | CD2 | LEU | A | 58 | 32.442 | 19.150 | 65.864 | 0.00 | 0.00 | 6 |
| ATOM | 400 | C | LEU | A | 58 | 31.187 | 15.596 | 67.703 | 0.00 | 0.00 | 6 |
| ATOM | 401 | O | LEU | A | 58 | 30.028 | 15.719 | 67.328 | 0.00 | 0.00 | 8 |
| ATOM | 402 | N | VAL | A | 59 | 31.729 | 14.446 | 68.060 | 0.00 | 0.00 | 7 |
| ATOM | 403 | CA | VAL | A | 59 | 30.994 | 13.215 | 67.976 | 0.00 | 0.00 | 6 |
| ATOM | 404 | CB | VAL | A | 59 | 31.881 | 12.029 | 68.338 | 0.00 | 0.00 | 6 |
| ATOM | 405 | CG1 | VAL | A | 59 | 31.084 | 10.729 | 68.269 | 0.00 | 0.00 | 6 |
| ATOM | 406 | CG2 | VAL | A | 59 | 33.088 | 11.986 | 67.394 | 0.00 | 0.00 | 6 |
| ATOM | 407 | C | VAL | A | 59 | 29.748 | 13.255 | 68.842 | 0.00 | 0.00 | 6 |
| ATOM | 408 | O | VAL | A | 59 | 28.716 | 12.756 | 68.436 | 0.00 | 0.00 | 8 |
| ATOM | 409 | N | VAL | A | 60 | 29.817 | 13.864 | 70.013 | 0.00 | 0.00 | 7 |
| ATOM | 410 | CA | VAL | A | 60 | 28.619 | 13.912 | 70.821 | 0.00 | 0.00 | 6 |
| ATOM | 411 | CB | VAL | A | 60 | 28.916 | 14.023 | 72.302 | 0.00 | 0.00 | 6 |
| ATOM | 412 | CG1 | VAL | A | 60 | 29.604 | 12.755 | 72.776 | 0.00 | 0.00 | 6 |
| ATOM | 413 | CG2 | VAL | A | 60 | 29.746 | 15.249 | 72.596 | 0.00 | 0.00 | 6 |
| ATOM | 414 | C | VAL | A | 60 | 27.689 | 15.004 | 70.341 | 0.00 | 0.00 | 6 |
| ATOM | 415 | O | VAL | A | 60 | 26.467 | 14.878 | 70.421 | 0.00 | 0.00 | 8 |
| ATOM | 416 | N | ARG | A | 61 | 28.278 | 16.063 | 69.810 | 0.00 | 0.00 | 7 |
| ATOM | 417 | CA | ARG | A | 61 | 27.511 | 17.073 | 69.108 | 0.00 | 0.00 | 6 |
| ATOM | 418 | CB | ARG | A | 61 | 28.360 | 18.331 | 68.870 | 0.00 | 0.00 | 6 |
| ATOM | 419 | CG | ARG | A | 62 | 28.162 | 19.440 | 69.903 | 0.00 | 0.00 | 6 |
| ATOM | 420 | CD | ARG | A | 61 | 28.844 | 20.748 | 69.483 | 0.00 | 0.00 | 6 |
| ATOM | 421 | NE | ARG | A | 61 | 29.075 | 21.641 | 70.632 | 0.00 | 0.00 | 7 |
| ATOM | 422 | CZ | ARG | A | 61 | 30.040 | 22.576 | 70.713 | 0.00 | 0.00 | 6 |
| ATOM | 423 | NH1 | ARG | A | 61 | 30.898 | 22.774 | 69.704 | 0.00 | 0.00 | 7 |
| ATOM | 424 | NH2 | ARG | A | 61 | 30.158 | 23.326 | 71.818 | 0.00 | 0.00 | 7 |
| ATOM | 425 | C | ARG | A | 61 | 26.962 | 16.520 | 67.779 | 0.00 | 0.00 | 6 |
| ATOM | 426 | O | ARG | A | 61 | 26.761 | 17.259 | 66.813 | 0.00 | 0.00 | 8 |
| ATOM | 427 | N | TYR | A | 62 | 26.723 | 15.215 | 67.735 | 0.00 | 0.00 | 7 |
| ATOM | 428 | CA | TYR | A | 62 | 26.208 | 14.542 | 66.548 | 0.00 | 0.00 | 6 |
| ATOM | 429 | CB | TYR | A | 62 | 27.353 | 14.045 | 65.661 | 0.00 | 0.00 | 6 |
| ATOM | 430 | CG | TYR | A | 62 | 26.923 | 13.345 | 64.389 | 0.00 | 0.00 | 6 |
| ATOM | 431 | CD1 | TYR | A | 62 | 27.585 | 12.198 | 63.915 | 0.00 | 0.00 | 6 |
| ATOM | 432 | CE1 | TYR | A | 62 | 27.172 | 11.561 | 62.723 | 0.00 | 0.00 | 6 |
| ATOM | 433 | CZ | TYR | A | 62 | 26.073 | 12.090 | 61.995 | 0.00 | 0.00 | 6 |
| ATOM | 434 | OH | TYR | A | 62 | 25.573 | 11.552 | 60.802 | 0.00 | 0.00 | 8 |
| ATOM | 435 | CE2 | TYR | A | 62 | 25.433 | 13.222 | 62.459 | 0.00 | 0.00 | 6 |
| ATOM | 436 | CD2 | TYR | A | 62 | 25.860 | 13.840 | 63.647 | 0.00 | 0.00 | 6 |
| ATOM | 437 | C | TYR | A | 62 | 25.426 | 13.374 | 67.074 | 0.00 | 0.00 | 6 |
| ATOM | 438 | O | TYR | A | 62 | 24.500 | 12.886 | 66.444 | 0.00 | 0.00 | 8 |
| ATOM | 439 | N | SER | A | 63 | 25.828 | 12.923 | 68.256 | 0.00 | 0.00 | 7 |
| ATOM | 440 | CA | SER | A | 63 | 25.075 | 11.945 | 69.006 | 0.00 | 0.00 | 6 |
| ATOM | 441 | CB | SER | A | 63 | 25.896 | 11.427 | 70.187 | 0.00 | 0.00 | 6 |
| ATOM | 442 | OG | SER | A | 63 | 26.893 | 10.523 | 69.751 | 0.00 | 0.00 | 8 |
| ATOM | 443 | C | SER | A | 63 | 23.879 | 12.694 | 69.517 | 0.00 | 0.00 | 6 |
| ATOM | 444 | O | SER | A | 63 | 23.412 | 12.452 | 70.637 | 0.00 | 0.00 | 8 |
| ATOM | 445 | N | LEU | A | 64 | 23.388 | 13.604 | 68.676 | 0.00 | 0.00 | 7 |
| ATOM | 446 | CA | LEU | A | 64 | 22.540 | 14.654 | 69.153 | 0.00 | 0.00 | 6 |
| ATOM | 447 | CB | LEU | A | 64 | 23.304 | 15.415 | 70.228 | 0.00 | 0.00 | 6 |
| ATOM | 448 | CG | LEU | A | 64 | 22.428 | 16.088 | 71.280 | 0.00 | 0.00 | 6 |
| ATOM | 449 | CD1 | LEU | A | 64 | 21.455 | 15.088 | 71.978 | 0.00 | 0.00 | 6 |
| ATOM | 450 | CD2 | LEU | A | 64 | 23.321 | 16.809 | 72.290 | 0.00 | 0.00 | 6 |
| ATOM | 451 | C | LEU | A | 64 | 22.061 | 15.648 | 68.111 | 0.00 | 0.00 | 6 |
| ATOM | 452 | O | LEU | A | 64 | 22.620 | 16.729 | 67.998 | 0.00 | 0.00 | 8 |
| ATOM | 453 | N | GLN | A | 65 | 21.036 | 15.270 | 67.354 | 0.00 | 0.00 | 7 |
| ATOM | 454 | CA | GLN | A | 65 | 20.159 | 16.193 | 66.637 | 0.00 | 0.00 | 6 |
| ATOM | 455 | CB | GLN | A | 65 | 20.630 | 16.437 | 65.228 | 0.00 | 0.00 | 6 |
| ATOM | 456 | CG | GLN | A | 65 | 21.676 | 17.476 | 65.116 | 0.00 | 0.00 | 6 |
| ATOM | 457 | CD | GLN | A | 65 | 23.070 | 16.877 | 64.973 | 0.00 | 0.00 | 6 |
| ATOM | 458 | OE1 | GLN | A | 65 | 23.829 | 17.277 | 64.084 | 0.00 | 0.00 | 8 |
| ATOM | 459 | NE2 | GLN | A | 65 | 23.413 | 15.908 | 65.835 | 0.00 | 0.00 | 7 |
| ATOM | 460 | C | GLN | A | 65 | 18.947 | 15.350 | 66.541 | 0.00 | 0.00 | 6 |
| ATOM | 461 | O | GLN | A | 65 | 18.899 | 14.326 | 67.201 | 0.00 | 0.00 | 8 |
| ATOM | 462 | N | PRO | A | 66 | 17.957 | 15.749 | 65.725 | 0.00 | 0.00 | 7 |
| ATOM | 463 | CA | PRO | A | 66 | 17.028 | 14.697 | 65.287 | 0.00 | 0.00 | 6 |
| ATOM | 464 | CB | PRO | A | 66 | 15.875 | 15.449 | 64.617 | 0.00 | 0.00 | 6 |
| ATOM | 465 | CG | PRO | A | 66 | 16.130 | 16.897 | 64.879 | 0.00 | 0.00 | 6 |
| ATOM | 466 | CD | PRO | A | 66 | 17.593 | 17.069 | 65.196 | 0.00 | 0.00 | 6 |
| ATOM | 467 | C | PRO | A | 66 | 17.780 | 13.791 | 64.313 | 0.00 | 0.00 | 6 |
| ATOM | 468 | O | PRO | A | 66 | 17.994 | 12.631 | 64.655 | 0.00 | 0.00 | 8 |
| ATOM | 469 | N | ALA | A | 67 | 18.216 | 14.305 | 63.149 | 0.00 | 0.00 | 7 |
| ATOM | 470 | CA | ALA | A | 67 | 19.144 | 13.556 | 62.247 | 0.00 | 0.00 | 6 |
| ATOM | 471 | CB | ALA | A | 67 | 18.523 | 12.255 | 61.826 | 0.00 | 0.00 | 6 |
| ATOM | 472 | C | ALA | A | 67 | 19.680 | 14.324 | 61.007 | 0.00 | 0.00 | 6 |
| ATOM | 473 | O | ALA | A | 67 | 19.609 | 15.562 | 60.968 | 0.00 | 0.00 | 8 |
| ATOM | 474 | N | ASP | A | 68 | 20.266 | 13.600 | 60.034 | 0.00 | 0.00 | 7 |
| ATOM | 475 | CA | ASP | A | 68 | 20.293 | 14.058 | 58.627 | 0.00 | 0.00 | 6 |
| ATOM | 476 | CB | ASP | A | 68 | 21.467 | 13.461 | 57.813 | 0.00 | 0.00 | 6 |
| ATOM | 477 | CG | ASP | A | 68 | 22.851 | 13.877 | 58.352 | 0.00 | 0.00 | 6 |
| ATOM | 478 | OD1 | ASP | A | 68 | 22.932 | 14.755 | 59.235 | 0.00 | 0.00 | 8 |
| ATOM | 479 | OD2 | ASP | A | 68 | 23.873 | 13.314 | 57.904 | 0.00 | 0.00 | 8 |
| ATOM | 480 | C | ASP | A | 68 | 18.927 | 13.562 | 58.168 | 0.00 | 0.00 | 6 |
| ATOM | 481 | O | ASP | A | 68 | 18.760 | 12.997 | 57.089 | 0.00 | 0.00 | 8 |
| ATOM | 482 | N | ASP | A | 69 | 17.959 | 13.898 | 59.021 | 0.00 | 0.00 | 7 |
| ATOM | 483 | CA | ASP | A | 69 | 16.754 | 13.142 | 59.351 | 0.00 | 0.00 | 6 |
| ATOM | 484 | CB | ASP | A | 69 | 15.654 | 14.108 | 59.772 | 0.00 | 0.00 | 6 |
| ATOM | 485 | CG | ASP | A | 69 | 15.861 | 14.621 | 61.190 | 0.00 | 0.00 | 6 |
| ATOM | 486 | OD1 | ASP | A | 69 | 15.934 | 13.793 | 62.138 | 0.00 | 0.00 | 8 |
| ATOM | 487 | OD2 | ASP | A | 69 | 15.951 | 15.858 | 61.347 | 0.00 | 0.00 | 8 |
| ATOM | 488 | C | ASP | A | 69 | 16.260 | 12.104 | 58.361 | 0.00 | 0.00 | 6 |
| ATOM | 489 | O | ASP | A | 69 | 15.828 | 10.995 | 58.733 | 0.00 | 0.00 | 8 |
| ATOM | 490 | N | ASN | A | 70 | 16.342 | 12.479 | 57.100 | 0.00 | 0.00 | 7 |
| ATOM | 491 | CA | ASN | A | 70 | 16.010 | 11.610 | 55.997 | 0.00 | 0.00 | 6 |
| ATOM | 492 | CB | ASN | A | 70 | 16.036 | 12.447 | 54.737 | 0.00 | 0.00 | 6 |
| ATOM | 493 | CG | ASN | A | 70 | 15.690 | 13.887 | 55.031 | 0.00 | 0.00 | 6 |
| ATOM | 494 | OD1 | ASN | A | 70 | 14.553 | 14.320 | 54.784 | 0.00 | 0.00 | 8 |
| ATOM | 495 | ND2 | ASN | A | 70 | 16.645 | 14.626 | 55.638 | 0.00 | 0.00 | 7 |
| ATOM | 496 | C | ASN | A | 70 | 16.994 | 10.458 | 55.923 | 0.00 | 0.00 | 6 |
| ATOM | 497 | O | ASN | A | 70 | 16.588 | 9.298 | 56.030 | 0.00 | 0.00 | 8 |
| ATOM | 498 | N | HIS | A | 71 | 18.282 | 10.786 | 55.777 | 0.00 | 0.00 | 7 |
| ATOM | 499 | CA | HIS | A | 71 | 19.354 | 9.782 | 55.740 | 0.00 | 0.00 | 6 |
| ATOM | 500 | CB | HIS | A | 71 | 20.592 | 10.362 | 55.069 | 0.00 | 0.00 | 6 |
| ATOM | 501 | CG | HIS | A | 71 | 20.307 | 10.888 | 53.711 | 0.00 | 0.00 | 6 |
| ATOM | 502 | ND1 | HIS | A | 71 | 20.226 | 12.237 | 53.443 | 0.00 | 0.00 | 7 |
| ATOM | 503 | CE1 | HIS | A | 71 | 19.913 | 12.410 | 52.166 | 0.00 | 0.00 | 6 |
| ATOM | 504 | NE2 | HIS | A | 71 | 19.769 | 11.221 | 51.603 | 0.00 | 0.00 | 7 |
| ATOM | 505 | CD2 | HIS | A | 71 | 19.997 | 10.250 | 52.555 | 0.00 | 0.00 | 6 |
| ATOM | 506 | C | HIS | A | 71 | 19.654 | 9.224 | 57.140 | 0.00 | 0.00 | 6 |
| ATOM | 507 | O | HIS | A | 71 | 19.434 | 8.037 | 57.428 | 0.00 | 0.00 | 8 |
| ATOM | 508 | N | SER | A | 72 | 20.126 | 10.074 | 58.032 | 0.00 | 0.00 | 7 |
| ATOM | 509 | CA | SER | A | 72 | 20.156 | 9.648 | 59.380 | 0.00 | 0.00 | 6 |
| ATOM | 510 | CB | SER | A | 72 | 21.202 | 10.459 | 60.109 | 0.00 | 0.00 | 6 |
| ATOM | 511 | OG | SER | A | 72 | 22.459 | 10.292 | 59.463 | 0.00 | 0.00 | 8 |
| ATOM | 512 | C | SER | A | 72 | 18.719 | 9.776 | 59.921 | 0.00 | 0.00 | 6 |
| ATOM | 513 | O | SER | A | 72 | 18.290 | 10.895 | 60.207 | 0.00 | 0.00 | 8 |
| ATOM | 514 | N | PHE | A | 73 | 17.966 | 8.655 | 59.983 | 0.00 | 0.00 | 7 |
| ATOM | 515 | CA | PHE | A | 73 | 16.590 | 8.642 | 60.515 | 0.00 | 0.00 | 6 |
| ATOM | 516 | CB | PHE | A | 73 | 16.140 | 7.245 | 60.844 | 0.00 | 0.00 | 6 |
| ATOM | 517 | CG | PHE | A | 73 | 16.198 | 7.002 | 62.324 | 0.00 | 0.00 | 6 |
| ATOM | 518 | CD1 | PHE | A | 73 | 17.280 | 6.344 | 62.891 | 0.00 | 0.00 | 6 |
| ATOM | 519 | CE1 | PHE | A | 73 | 17.366 | 6.179 | 64.291 | 0.00 | 0.00 | 6 |
| ATOM | 520 | CZ | PHE | A | 73 | 16.392 | 6.726 | 65.132 | 0.00 | 0.00 | 6 |
| ATOM | 521 | CE2 | PHE | A | 73 | 15.347 | 7.446 | 64.578 | 0.00 | 0.00 | 6 |
| ATOM | 522 | CD2 | PHE | A | 73 | 15.248 | 7.586 | 63.183 | 0.00 | 0.00 | 6 |
| ATOM | 523 | C | PHE | A | 73 | 16.516 | 9.357 | 61.897 | 0.00 | 0.00 | 6 |
| ATOM | 524 | O | PHE | A | 73 | 15.511 | 10.015 | 62.185 | 0.00 | 0.00 | 8 |
| ATOM | 525 | N | GLY | A | 74 | 17.536 | 9.158 | 62.763 | 0.00 | 0.00 | 7 |
| ATOM | 526 | CA | GLY | A | 74 | 17.547 | 9.630 | 64.178 | 0.00 | 0.00 | 6 |
| ATOM | 527 | C | GLY | A | 74 | 18.675 | 9.125 | 65.098 | 0.00 | 0.00 | 6 |
| ATOM | 528 | O | GLY | A | 74 | 18.385 | 8.410 | 66.061 | 0.00 | 0.00 | 8 |
| ATOM | 529 | N | HIS | A | 75 | 19.926 | 9.584 | 64.825 | 0.00 | 0.00 | 7 |
| ATOM | 530 | CA | HIS | A | 75 | 21.283 | 9.218 | 65.428 | 0.00 | 0.00 | 6 |
| ATOM | 531 | CB | HIS | A | 75 | 22.398 | 9.690 | 64.479 | 0.00 | 0.00 | 6 |
| ATOM | 532 | CG | HIS | A | 75 | 22.182 | 11.069 | 63.886 | 0.00 | 0.00 | 6 |
| ATOM | 533 | ND1 | HIS | A | 75 | 21.793 | 12.164 | 64.631 | 0.00 | 0.00 | 7 |
| ATOM | 534 | CE1 | HIS | A | 75 | 21.692 | 13.219 | 63.843 | 0.00 | 0.00 | 6 |
| ATOM | 535 | NE2 | HIS | A | 75 | 22.016 | 12.855 | 62.616 | 0.00 | 0.00 | 7 |
| ATOM | 536 | CD2 | HIS | A | 75 | 22.330 | 11.521 | 62.615 | 0.00 | 0.00 | 6 |
| ATOM | 537 | C | HIS | A | 75 | 21.768 | 9.706 | 66.791 | 0.00 | 0.00 | 6 |
| ATOM | 538 | O | HIS | A | 75 | 21.221 | 10.594 | 67.421 | 0.00 | 0.00 | 8 |
| ATOM | 539 | N | GLY | A | 76 | 22.902 | 9.175 | 67.173 | 0.00 | 0.00 | 7 |
| ATOM | 540 | CA | GLY | A | 76 | 23.351 | 9.337 | 68.530 | 0.00 | 0.00 | 6 |
| ATOM | 541 | C | GLY | A | 76 | 23.929 | 8.014 | 69.011 | 0.00 | 0.00 | 6 |
| ATOM | 542 | O | GLY | A | 76 | 24.876 | 7.966 | 69.820 | 0.00 | 0.00 | 8 |
| ATOM | 543 | N | LYS | A | 77 | 23.330 | 6.926 | 68.521 | 0.00 | 0.00 | 7 |
| ATOM | 544 | CA | LYS | A | 77 | 24.032 | 5.644 | 68.341 | 0.00 | 0.00 | 6 |
| ATOM | 545 | CB | LYS | A | 77 | 23.468 | 4.984 | 67.076 | 0.00 | 0.00 | 6 |
| ATOM | 546 | CG | LYS | A | 77 | 22.729 | 3.702 | 67.324 | 0.00 | 0.00 | 6 |
| ATOM | 547 | CD | LYS | A | 77 | 23.718 | 2.560 | 67.579 | 0.00 | 0.00 | 6 |
| ATOM | 548 | CE | LYS | A | 77 | 22.976 | 1.233 | 67.644 | 0.00 | 0.00 | 6 |
| ATOM | 549 | NZ | LYS | A | 77 | 22.188 | 1.001 | 66.388 | 0.00 | 0.00 | 7 |
| ATOM | 550 | C | LYS | A | 77 | 25.530 | 5.880 | 68.114 | 0.00 | 0.00 | 6 |
| ATOM | 551 | O | LYS | A | 77 | 26.395 | 5.109 | 68.540 | 0.00 | 0.00 | 8 |
| ATOM | 552 | N | ALA | A | 78 | 25.778 | 6.956 | 67.372 | 0.00 | 0.00 | 7 |
| ATOM | 553 | CA | ALA | A | 78 | 27.059 | 7.554 | 67.148 | 0.00 | 0.00 | 6 |
| ATOM | 554 | CB | ALA | A | 78 | 26.835 | 9.029 | 66.855 | 0.00 | 0.00 | 6 |
| ATOM | 555 | C | ALA | A | 78 | 28.029 | 7.383 | 68.316 | 0.00 | 0.00 | 6 |
| ATOM | 556 | O | ALA | A | 78 | 29.177 | 6.978 | 68.150 | 0.00 | 0.00 | 8 |
| ATOM | 557 | N | GLU | A | 79 | 27.583 | 7.697 | 69.511 | 0.00 | 0.00 | 7 |
| ATOM | 558 | CA | GLU | A | 79 | 28.518 | 7.667 | 70.571 | 0.00 | 0.00 | 6 |
| ATOM | 559 | CB | GLU | A | 79 | 27.940 | 8.292 | 71.816 | 0.00 | 0.00 | 6 |
| ATOM | 560 | CG | GLU | A | 79 | 26.544 | 7.872 | 72.230 | 0.00 | 0.00 | 6 |
| ATOM | 561 | CD | GLU | A | 79 | 25.945 | 8.857 | 73.255 | 0.00 | 0.00 | 6 |
| ATOM | 562 | OE1 | GLU | A | 79 | 26.612 | 9.891 | 73.584 | 0.00 | 0.00 | 8 |
| ATOM | 563 | OE2 | GLU | A | 79 | 24.799 | 8.598 | 73.723 | 0.00 | 0.00 | 8 |
| ATOM | 564 | C | GLU | A | 79 | 28.926 | 6.254 | 70.787 | 0.00 | 0.00 | 6 |
| ATOM | 565 | O | GLU | A | 79 | 30.088 | 5.958 | 70.769 | 0.00 | 0.00 | 8 |
| ATOM | 566 | N | SER | A | 80 | 27.955 | 5.372 | 70.947 | 0.00 | 0.00 | 7 |
| ATOM | 567 | CA | SER | A | 80 | 28.237 | 3.948 | 71.188 | 0.00 | 0.00 | 6 |
| ATOM | 568 | CB | SER | A | 80 | 26.954 | 3.054 | 71.028 | 0.00 | 0.00 | 6 |
| ATOM | 569 | OG | SER | A | 80 | 26.168 | 2.825 | 72.244 | 0.00 | 0.00 | 8 |
| ATOM | 570 | C | SER | A | 80 | 29.359 | 3.495 | 70.267 | 0.00 | 0.00 | 6 |
| ATOM | 571 | O | SER | A | 80 | 30.276 | 2.811 | 70.701 | 0.00 | 0.00 | 8 |
| ATOM | 572 | N | LEU | A | 81 | 29.262 | 3.896 | 69.000 | 0.00 | 0.00 | 7 |
| ATOM | 573 | CA | LEU | A | 81 | 30.363 | 3.806 | 68.050 | 0.00 | 0.00 | 6 |
| ATOM | 574 | CB | LEU | A | 81 | 29.948 | 4.499 | 66.718 | 0.00 | 0.00 | 6 |
| ATOM | 575 | CG | LEU | A | 81 | 30.844 | 4.904 | 65.503 | 0.00 | 0.00 | 6 |
| ATOM | 576 | CD1 | LEU | A | 81 | 30.159 | 5.889 | 64.536 | 0.00 | 0.00 | 6 |
| ATOM | 577 | CD2 | LEU | A | 81 | 32.252 | 5.497 | 65.809 | 0.00 | 0.00 | 6 |
| ATOM | 578 | C | LEU | A | 81 | 31.672 | 4.406 | 68.683 | 0.00 | 0.00 | 6 |
| ATOM | 579 | O | LEU | A | 81 | 32.645 | 3.680 | 69.031 | 0.00 | 0.00 | 8 |
| ATOM | 580 | N | ALA | A | 82 | 31.680 | 5.726 | 68.860 | 0.00 | 0.00 | 7 |
| ATOM | 581 | CA | ALA | A | 82 | 32.861 | 6.418 | 69.352 | 0.00 | 0.00 | 6 |
| ATOM | 582 | CB | ALA | A | 82 | 32.648 | 7.902 | 69.274 | 0.00 | 0.00 | 6 |
| ATOM | 583 | C | ALA | A | 82 | 33.127 | 5.996 | 70.783 | 0.00 | 0.00 | 6 |
| ATOM | 584 | O | ALA | A | 82 | 33.207 | 6.819 | 71.696 | 0.00 | 0.00 | 8 |
| ATOM | 585 | N | ALA | A | 83 | 33.226 | 4.701 | 70.995 | 0.00 | 0.00 | 7 |
| ATOM | 586 | CA | ALA | A | 83 | 33.420 | 4.201 | 72.319 | 0.00 | 0.00 | 6 |
| ATOM | 587 | CB | ALA | A | 83 | 32.104 | 3.862 | 72.971 | 0.00 | 0.00 | 6 |
| ATOM | 588 | C | ALA | A | 83 | 34.161 | 2.982 | 71.966 | 0.00 | 0.00 | 6 |
| ATOM | 589 | O | ALA | A | 83 | 35.210 | 2.716 | 72.525 | 0.00 | 0.00 | 8 |
| ATOM | 590 | N | LEU | A | 84 | 33.643 | 2.282 | 70.967 | 0.00 | 0.00 | 7 |
| ATOM | 591 | CA | LEU | A | 84 | 34.218 | 1.028 | 70.561 | 0.00 | 0.00 | 6 |
| ATOM | 592 | CB | LEU | A | 84 | 33.534 | 0.522 | 69.304 | 0.00 | 0.00 | 6 |
| ATOM | 593 | CG | LEU | A | 84 | 34.222 | −0.701 | 68.701 | 0.00 | 0.00 | 6 |
| ATOM | 594 | CD1 | LEU | A | 84 | 33.209 | −1.790 | 68.403 | 0.00 | 0.00 | 6 |
| ATOM | 595 | CD2 | LEU | A | 84 | 35.081 | −0.332 | 67.451 | 0.00 | 0.00 | 6 |
| ATOM | 596 | C | LEU | A | 84 | 35.696 | 1.234 | 70.320 | 0.00 | 0.00 | 6 |
| ATOM | 597 | O | LEU | A | 84 | 36.540 | 0.416 | 70.733 | 0.00 | 0.00 | 8 |
| ATOM | 598 | N | ALA | A | 85 | 35.995 | 2.349 | 69.659 | 0.00 | 0.00 | 7 |
| ATOM | 599 | CA | ALA | A | 85 | 37.365 | 2.683 | 69.288 | 0.00 | 0.00 | 6 |
| ATOM | 600 | CB | ALA | A | 85 | 37.370 | 3.936 | 68.422 | 0.00 | 0.00 | 6 |
| ATOM | 601 | C | ALA | A | 85 | 38.195 | 2.892 | 70.536 | 0.00 | 0.00 | 6 |
| ATOM | 602 | O | ALA | A | 85 | 38.924 | 2.015 | 70.985 | 0.00 | 0.00 | 8 |
| ATOM | 603 | N | GLN | A | 86 | 38.053 | 4.086 | 71.069 | 0.00 | 0.00 | 7 |
| ATOM | 604 | CA | GLN | A | 86 | 38.440 | 4.417 | 72.414 | 0.00 | 0.00 | 6 |
| ATOM | 605 | CB | GLN | A | 86 | 37.272 | 5.133 | 73.095 | 0.00 | 0.00 | 6 |
| ATOM | 606 | CG | GLN | A | 86 | 36.359 | 5.835 | 72.089 | 0.00 | 0.00 | 6 |
| ATOM | 607 | CD | GLN | A | 86 | 36.985 | 7.097 | 71.506 | 0.00 | 0.00 | 6 |
| ATOM | 608 | OE1 | GLN | A | 86 | 37.361 | 8.009 | 72.261 | 0.00 | 0.00 | 8 |
| ATOM | 609 | NE2 | GLN | A | 86 | 37.100 | 7.163 | 70.164 | 0.00 | 0.00 | 7 |
| ATOM | 610 | C | GLN | A | 86 | 38.817 | 3.198 | 73.227 | 0.00 | 0.00 | 6 |
| ATOM | 611 | O | GLN | A | 86 | 39.902 | 3.131 | 73.788 | 0.00 | 0.00 | 8 |
| ATOM | 612 | N | SER | A | 87 | 37.922 | 2.226 | 73.284 | 0.00 | 0.00 | 7 |
| ATOM | 613 | CA | SER | A | 87 | 38.114 | 1.096 | 74.173 | 0.00 | 0.00 | 6 |
| ATOM | 614 | CB | SER | A | 87 | 36.783 | 0.439 | 74.452 | 0.00 | 0.00 | 6 |
| ATOM | 615 | OG | SER | A | 87 | 36.190 | 0.054 | 73.220 | 0.00 | 0.00 | 8 |
| ATOM | 616 | C | SER | A | 87 | 39.047 | 0.046 | 73.599 | 0.00 | 0.00 | 6 |
| ATOM | 617 | O | SER | A | 87 | 40.267 | 0.233 | 73.569 | 0.00 | 0.00 | 8 |
| ATOM | 618 | N | MET | A | 88 | 38.441 | −1.066 | 73.171 | 0.00 | 0.00 | 7 |
| ATOM | 619 | CA | MET | A | 88 | 39.133 | −2.223 | 72.585 | 0.00 | 0.00 | 6 |
| ATOM | 620 | CB | MET | A | 88 | 38.200 | −3.000 | 71.605 | 0.00 | 0.00 | 6 |
| ATOM | 621 | CG | MET | A | 88 | 37.226 | −4.054 | 72.273 | 0.00 | 0.00 | 6 |
| ATOM | 622 | SD | MET | A | 88 | 36.070 | −5.002 | 71.194 | 0.00 | 0.00 | 16 |
| ATOM | 623 | CE | MET | A | 88 | 37.218 | −5.928 | 70.109 | 0.00 | 0.00 | 6 |
| ATOM | 624 | C | MET | A | 88 | 40.423 | −1.772 | 71.896 | 0.00 | 0.00 | 6 |
| ATOM | 625 | O | MET | A | 88 | 41.530 | −2.178 | 72.286 | 0.00 | 0.00 | 8 |
| ATOM | 626 | N | PHE | A | 89 | 40.264 | −0.902 | 70.900 | 0.00 | 0.00 | 7 |
| ATOM | 627 | CA | PHE | A | 89 | 41.400 | −0.339 | 70.200 | 0.00 | 0.00 | 6 |
| ATOM | 628 | CB | PHE | A | 89 | 41.181 | −0.248 | 68.654 | 0.00 | 0.00 | 6 |
| ATOM | 629 | CG | PHE | A | 89 | 40.122 | −1.229 | 68.081 | 0.00 | 0.00 | 6 |
| ATOM | 630 | CD1 | PHE | A | 89 | 39.058 | −0.743 | 67.275 | 0.00 | 0.00 | 6 |
| ATOM | 631 | CE1 | PHE | A | 89 | 36.068 | −1.621 | 66.738 | 0.00 | 0.00 | 6 |
| ATOM | 632 | CZ | PHE | A | 89 | 38.137 | −3.012 | 67.007 | 0.00 | 0.00 | 6 |
| ATOM | 633 | CE2 | PHE | A | 89 | 39.204 | −3.522 | 67.809 | 0.00 | 0.00 | 6 |
| ATOM | 634 | CD2 | PHE | A | 89 | 40.191 | −2.626 | 68.334 | 0.00 | 0.00 | 6 |
| ATOM | 635 | C | PHE | A | 89 | 41.676 | 1.031 | 70.813 | 0.00 | 0.00 | 6 |
| ATOM | 636 | O | PHE | A | 89 | 40.829 | 1.597 | 71.501 | 0.00 | 0.00 | 8 |
| ATOM | 637 | N | ILE | A | 90 | 42.889 | 1.525 | 70.574 | 0.00 | 0.00 | 7 |
| ATOM | 638 | CA | ILE | A | 90 | 43.346 | 2.901 | 70.927 | 0.00 | 0.00 | 6 |
| ATOM | 639 | CB | ILE | A | 90 | 42.801 | 3.993 | 69.835 | 0.00 | 0.00 | 6 |
| ATOM | 640 | CG1 | ILE | A | 90 | 42.763 | 3.377 | 68.424 | 0.00 | 0.00 | 6 |
| ATOM | 641 | CD1 | ILE | A | 90 | 42.084 | 4.210 | 67.380 | 0.00 | 0.00 | 6 |
| ATOM | 642 | CG2 | ILE | A | 90 | 43.667 | 5.255 | 69.755 | 0.00 | 0.00 | 6 |
| ATOM | 643 | C | ILE | A | 90 | 43.301 | 3.226 | 72.502 | 0.00 | 0.00 | 6 |
| ATOM | 644 | O | ILE | A | 90 | 43.751 | 4.296 | 72.970 | 0.00 | 0.00 | 8 |
| ATOM | 645 | N | SER | A | 91 | 42.793 | 2.269 | 73.289 | 0.00 | 0.00 | 7 |
| ATOM | 646 | CA | SER | A | 91 | 42.988 | 2.191 | 74.742 | 0.00 | 0.00 | 6 |
| ATOM | 647 | CB | SER | A | 91 | 42.037 | 3.097 | 75.525 | 0.00 | 0.00 | 6 |
| ATOM | 648 | OG | SER | A | 91 | 42.126 | 2.883 | 76.928 | 0.00 | 0.00 | 8 |
| ATOM | 649 | C | SER | A | 91 | 42.667 | 0.767 | 75.031 | 0.00 | 0.00 | 6 |
| ATOM | 650 | O | SER | A | 91 | 42.371 | 0.020 | 74.113 | 0.00 | 0.00 | 8 |
| ATOM | 651 | N | GLY | A | 92 | 42.702 | 0.368 | 76.292 | 0.00 | 0.00 | 7 |
| ATOM | 652 | CA | GLY | A | 92 | 42.501 | −1.046 | 76.611 | 0.00 | 0.00 | 6 |
| ATOM | 653 | C | GLY | A | 92 | 43.275 | −1.855 | 75.595 | 0.00 | 0.00 | 6 |
| ATOM | 654 | O | GLY | A | 92 | 42.827 | −2.908 | 75.118 | 0.00 | 0.00 | 8 |
| ATOM | 655 | N | SER | A | 93 | 44.447 | −1.306 | 75.281 | 0.00 | 0.00 | 7 |
| ATOM | 656 | CA | SER | A | 93 | 45.343 | −1.737 | 74.228 | 0.00 | 0.00 | 6 |
| ATOM | 657 | CB | SER | A | 93 | 44.616 | −1.811 | 72.889 | 0.00 | 0.00 | 6 |
| ATOM | 658 | OG | SER | A | 93 | 43.638 | −0.791 | 72.793 | 0.00 | 0.00 | 8 |
| ATOM | 659 | C | SER | A | 93 | 46.450 | −0.685 | 74.194 | 0.00 | 0.00 | 6 |
| ATOM | 660 | O | SER | A | 93 | 47.605 | −0.982 | 73.856 | 0.00 | 0.00 | 8 |
| ATOM | 661 | N | ALA | A | 94 | 46.082 | 0.549 | 74.556 | 0.00 | 0.00 | 7 |
| ATOM | 662 | CA | ALA | A | 94 | 47.052 | 1.574 | 74.936 | 0.00 | 0.00 | 6 |
| ATOM | 663 | CB | ALA | A | 94 | 46.353 | 2.897 | 75.203 | 0.00 | 0.00 | 6 |
| ATOM | 664 | C | ALA | A | 94 | 47.737 | 1.056 | 76.197 | 0.00 | 0.00 | 6 |
| ATOM | 665 | O | ALA | A | 94 | 48.718 | 1.616 | 76.694 | 0.00 | 0.00 | 8 |
| ATOM | 666 | N | LEU | A | 95 | 47.185 | −0.041 | 76.696 | 0.00 | 0.00 | 7 |
| ATOM | 667 | CA | LEU | A | 95 | 47.727 | −0.767 | 77.811 | 0.00 | 0.00 | 6 |
| ATOM | 668 | CB | LEU | A | 95 | 46.694 | −1.792 | 78.284 | 0.00 | 0.00 | 6 |
| ATOM | 669 | CG | LEU | A | 95 | 46.556 | −3.164 | 77.614 | 0.00 | 0.00 | 6 |
| ATOM | 670 | CD1 | LEU | A | 95 | 47.540 | −4.144 | 78.217 | 0.00 | 0.00 | 6 |
| ATOM | 671 | CD2 | LEU | A | 95 | 45.149 | −3.697 | 77.775 | 0.00 | 0.00 | 6 |
| ATOM | 672 | C | LEU | A | 95 | 49.002 | −1.479 | 77.413 | 0.00 | 0.00 | 6 |
| ATOM | 673 | O | LEU | A | 95 | 49.931 | −1.591 | 78.206 | 0.00 | 0.00 | 8 |
| ATOM | 674 | N | PHE | A | 96 | 49.031 | −1.956 | 76.177 | 0.00 | 0.00 | 7 |
| ATOM | 675 | CA | PHE | A | 96 | 50.069 | −2.877 | 75.741 | 0.00 | 0.00 | 6 |
| ATOM | 676 | CB | PHE | A | 96 | 49.568 | −3.746 | 74.590 | 0.00 | 0.00 | 6 |
| ATOM | 677 | CG | PHE | A | 96 | 48.706 | −4.880 | 75.036 | 0.00 | 0.00 | 6 |
| ATOM | 678 | CD1 | PHE | A | 96 | 49.241 | −5.924 | 75.778 | 0.00 | 0.00 | 6 |
| ATOM | 679 | CE1 | PHE | A | 96 | 48.443 | −6.977 | 76.199 | 0.00 | 0.00 | 6 |
| ATOM | 680 | CZ | PHE | A | 96 | 47.092 | −6.997 | 75.875 | 0.00 | 0.00 | 6 |
| ATOM | 681 | CE2 | PHE | A | 96 | 46.546 | −5.960 | 75.133 | 0.00 | 0.00 | 6 |
| ATOM | 682 | CD2 | PHE | A | 96 | 47.356 | −4.908 | 74.715 | 0.00 | 0.00 | 6 |
| ATOM | 683 | C | PHE | A | 96 | 51.442 | −2.266 | 75.425 | 0.00 | 0.00 | 6 |
| ATOM | 684 | O | PHE | A | 96 | 52.409 | −3.002 | 75.152 | 0.00 | 0.00 | 8 |
| ATOM | 685 | N | LEU | A | 97 | 51.540 | −0.934 | 75.465 | 0.00 | 0.00 | 7 |
| ATOM | 686 | CA | LEU | A | 97 | 52.863 | −0.293 | 75.578 | 0.00 | 0.00 | 6 |
| ATOM | 687 | CB | LEU | A | 97 | 52.915 | 1.137 | 74.968 | 0.00 | 0.00 | 6 |
| ATOM | 688 | CG | LEU | A | 97 | 53.402 | 1.303 | 73.496 | 0.00 | 0.00 | 6 |
| ATOM | 689 | CD1 | LEU | A | 97 | 52.371 | 0.861 | 72.427 | 0.00 | 0.00 | 6 |
| ATOM | 690 | CD2 | LEU | A | 97 | 53.883 | 2.728 | 73.187 | 0.00 | 0.00 | 6 |
| ATOM | 691 | C | LEU | A | 97 | 53.338 | −0.407 | 77.051 | 0.00 | 0.00 | 6 |
| ATOM | 692 | O | LEU | A | 97 | 54.287 | 0.267 | 77.472 | 0.00 | 0.00 | 8 |
| ATOM | 693 | N | PHE | A | 98 | 52.598 | −1.228 | 77.817 | 0.00 | 0.00 | 7 |
| ATOM | 694 | CA | PHE | A | 98 | 53.152 | −2.163 | 78.818 | 0.00 | 0.00 | 6 |
| ATOM | 695 | CB | PHE | A | 98 | 54.054 | −1.517 | 79.867 | 0.00 | 0.00 | 6 |
| ATOM | 696 | CG | PHE | A | 98 | 55.507 | −1.772 | 79.610 | 0.00 | 0.00 | 6 |
| ATOM | 697 | CD1 | PHE | A | 98 | 56.459 | −0.780 | 79.815 | 0.00 | 0.00 | 6 |
| ATOM | 698 | CE1 | PHE | A | 98 | 57.807 | −1.024 | 79.552 | 0.00 | 0.00 | 6 |
| ATOM | 699 | CZ | PHE | A | 98 | 58.201 | −2.266 | 79.056 | 0.00 | 0.00 | 6 |
| ATOM | 700 | CE2 | PHE | A | 98 | 57.250 | −3.260 | 78.832 | 0.00 | 0.00 | 6 |
| ATOM | 701 | CD2 | PHE | A | 98 | 55.917 | −3.008 | 79.104 | 0.00 | 0.00 | 6 |
| ATOM | 702 | C | PHE | A | 98 | 52.205 | −3.191 | 79.435 | 0.00 | 0.00 | 6 |
| ATOM | 703 | O | PHE | A | 98 | 51.453 | −2.881 | 80.357 | 0.00 | 0.00 | 8 |
| ATOM | 704 | N | LEU | A | 99 | 52.259 | −4.407 | 78.893 | 0.00 | 0.00 | 7 |
| ATOM | 705 | CA | LEU | A | 99 | 51.605 | −5.561 | 79.491 | 0.00 | 0.00 | 6 |
| ATOM | 706 | CB | LEU | A | 99 | 51.417 | −6.693 | 78.474 | 0.00 | 0.00 | 6 |
| ATOM | 707 | CG | LEU | A | 99 | 50.841 | −8.074 | 78.860 | 0.00 | 0.00 | 6 |
| ATOM | 708 | CD1 | LEU | A | 99 | 51.937 | −9.102 | 79.064 | 0.00 | 0.00 | 6 |
| ATOM | 709 | CD2 | LEU | A | 99 | 49.869 | −8.069 | 80.052 | 0.00 | 0.00 | 6 |
| ATOM | 710 | C | LEU | A | 99 | 52.445 | −6.029 | 80.663 | 0.00 | 0.00 | 6 |
| ATOM | 711 | O | LEU | A | 99 | 51.908 | −6.226 | 81.752 | 0.00 | 0.00 | 8 |
| ATOM | 712 | N | THR | A | 100 | 53.751 | −6.218 | 80.426 | 0.00 | 0.00 | 7 |
| ATOM | 713 | CA | THR | A | 100 | 54.752 | −6.518 | 81.484 | 0.00 | 0.00 | 6 |
| ATOM | 714 | CB | THR | A | 100 | 54.807 | −8.036 | 81.886 | 0.00 | 0.00 | 6 |
| ATOM | 715 | OG1 | THR | A | 100 | 53.538 | −8.460 | 82.403 | 0.00 | 0.00 | 8 |
| ATOM | 716 | CG2 | THR | A | 100 | 55.894 | −8.299 | 82.944 | 0.00 | 0.00 | 6 |
| ATOM | 717 | C | THR | A | 100 | 56.155 | −6.070 | 81.073 | 0.00 | 0.00 | 6 |
| ATOM | 718 | O | THR | A | 100 | 56.640 | −5.034 | 81.531 | 0.00 | 0.00 | 8 |
| ATOM | 719 | N | GLY | A | 101 | 56.790 | −6.872 | 80.221 | 0.00 | 0.00 | 7 |
| ATOM | 720 | CA | GLY | A | 101 | 58.140 | −6.621 | 79.736 | 0.00 | 0.00 | 6 |
| ATOM | 721 | C | GLY | A | 101 | 59.147 | −6.312 | 80.826 | 0.00 | 0.00 | 6 |
| ATOM | 722 | O | GLY | A | 101 | 59.498 | −7.188 | 81.619 | 0.00 | 0.00 | 8 |
| ATOM | 723 | N | ILE | A | 102 | 59.583 | −5.049 | 80.849 | 0.00 | 0.00 | 7 |
| ATOM | 724 | CA | ILE | A | 102 | 60.630 | −4.526 | 81.743 | 0.00 | 0.00 | 6 |
| ATOM | 725 | CB | ILE | A | 102 | 60.790 | −2.963 | 81.565 | 0.00 | 0.00 | 6 |
| ATOM | 726 | CG1 | ILE | A | 102 | 61.528 | −2.648 | 80.254 | 0.00 | 0.00 | 6 |
| ATOM | 727 | CD1 | ILE | A | 102 | 61.578 | −1.165 | 79.882 | 0.00 | 0.00 | 6 |
| ATOM | 728 | CG2 | ILE | A | 102 | 61.517 | −2.313 | 82.737 | 0.00 | 0.00 | 6 |
| ATOM | 729 | C | ILE | A | 102 | 60.427 | −4.962 | 83.205 | 0.00 | 0.00 | 6 |
| ATOM | 730 | O | ILE | A | 102 | 59.812 | −4.253 | 84.005 | 0.00 | 0.00 | 8 |
| ATOM | 731 | N | GLN | A | 103 | 60.949 | −6.145 | 83.529 | 0.00 | 0.00 | 7 |
| ATOM | 732 | CA | GLN | A | 103 | 60.813 | −6.732 | 84.864 | 0.00 | 0.00 | 6 |
| ATOM | 733 | CB | GLN | A | 103 | 59.575 | −7.634 | 84.941 | 0.00 | 0.00 | 6 |
| ATOM | 734 | CG | GLN | A | 103 | 59.176 | −8.029 | 86.368 | 0.00 | 0.00 | 6 |
| ATOM | 735 | CD | GLN | A | 103 | 58.181 | −9.176 | 86.426 | 0.00 | 0.00 | 6 |
| ATOM | 736 | OE1 | GLN | A | 103 | 57.572 | −9.544 | 85.419 | 0.00 | 0.00 | 8 |
| ATOM | 737 | NE2 | GLN | A | 103 | 58.012 | −9.748 | 87.615 | 0.00 | 0.00 | 7 |
| ATOM | 738 | C | GLN | A | 103 | 62.052 | −7.520 | 85.290 | 0.00 | 0.00 | 6 |
| ATOM | 739 | O | GLN | A | 103 | 62.393 | −7.547 | 86.475 | 0.00 | 0.00 | 8 |
| ATOM | 740 | N | HIS | A | 104 | 62.727 | −8.142 | 84.325 | 0.00 | 0.00 | 7 |
| ATOM | 741 | CA | HIS | A | 104 | 63.767 | −9.123 | 84.636 | 0.00 | 0.00 | 6 |
| ATOM | 742 | CB | HIS | A | 104 | 63.421 | −10.485 | 84.023 | 0.00 | 0.00 | 6 |
| ATOM | 743 | CG | HIS | A | 104 | 62.222 | −11.133 | 84.643 | 0.00 | 0.00 | 6 |
| ATOM | 744 | ND1 | HIS | A | 104 | 62.175 | −11.498 | 85.971 | 0.00 | 0.00 | 7 |
| ATOM | 745 | CE1 | HIS | A | 104 | 61.001 | −12.041 | 86.237 | 0.00 | 0.00 | 6 |
| ATOM | 746 | NE2 | HIS | A | 104 | 60.285 | −12.045 | 85.127 | 0.00 | 0.00 | 7 |
| ATOM | 747 | CD2 | HIS | A | 104 | 61.025 | −11.481 | 84.116 | 0.00 | 0.00 | 6 |
| ATOM | 748 | C | HIS | A | 104 | 65.210 | −8.720 | 84.307 | 0.00 | 0.00 | 6 |
| ATOM | 749 | O | HIS | A | 104 | 66.090 | −8.849 | 85.163 | 0.00 | 0.00 | 8 |
| ATOM | 750 | N | LEU | A | 105 | 65.455 | −8.244 | 83.086 | 0.00 | 0.00 | 7 |
| ATOM | 751 | CA | LEU | A | 105 | 66.815 | −7.868 | 82.670 | 0.00 | 0.00 | 6 |
| ATOM | 752 | CB | LEU | A | 105 | 66.878 | −7.625 | 81.156 | 0.00 | 0.00 | 6 |
| ATOM | 753 | CG | LEU | A | 105 | 66.997 | −8.841 | 80.229 | 0.00 | 0.00 | 6 |
| ATOM | 754 | CD1 | LEU | A | 105 | 66.907 | −8.392 | 78.783 | 0.00 | 0.00 | 6 |
| ATOM | 755 | CD2 | LEU | A | 105 | 68.288 | −9.636 | 80.458 | 0.00 | 0.00 | 6 |
| ATOM | 756 | C | LEU | A | 105 | 67.361 | −6.656 | 83.444 | 0.00 | 0.00 | 6 |
| ATOM | 757 | O | LEU | A | 105 | 66.641 | −6.061 | 84.250 | 0.00 | 0.00 | 8 |
| ATOM | 758 | N | ILE | A | 106 | 68.633 | −6.311 | 83.211 | 0.00 | 0.00 | 7 |
| ATOM | 759 | CA | ILE | A | 106 | 69.263 | −5.124 | 83.828 | 0.00 | 0.00 | 6 |
| ATOM | 760 | CB | ILE | A | 106 | 70.842 | −5.093 | 83.666 | 0.00 | 0.00 | 6 |
| ATOM | 761 | CG1 | ILE | A | 106 | 71.471 | −6.469 | 83.948 | 0.00 | 0.00 | 6 |
| ATOM | 762 | CD1 | ILE | A | 106 | 72.956 | −6.581 | 83.594 | 0.00 | 0.00 | 6 |
| ATOM | 763 | CG2 | ILE | A | 106 | 71.476 | −4.027 | 84.581 | 0.00 | 0.00 | 6 |
| ATOM | 764 | C | ILE | A | 106 | 68.595 | −3.849 | 83.272 | 0.00 | 0.00 | 6 |
| ATOM | 765 | O | ILE | A | 106 | 69.213 | −3.050 | 82.554 | 0.00 | 0.00 | 8 |
| ATOM | 766 | N | SER | A | 107 | 67.315 | −3.689 | 83.606 | 0.00 | 0.00 | 7 |
| ATOM | 767 | CA | SER | A | 107 | 66.502 | −2.587 | 83.117 | 0.00 | 0.00 | 6 |
| ATOM | 768 | CB | SER | A | 107 | 65.656 | −3.029 | 81.911 | 0.00 | 0.00 | 6 |
| ATOM | 769 | OG | SER | A | 107 | 65.404 | −1.952 | 81.027 | 0.00 | 0.00 | 8 |
| ATOM | 770 | C | SER | A | 107 | 65.654 | −2.014 | 84.266 | 0.00 | 0.00 | 6 |
| ATOM | 771 | O | SER | A | 107 | 65.892 | −0.879 | 84.683 | 0.00 | 0.00 | 8 |
| ATOM | 772 | N | PRO | A | 108 | 64.682 | −2.794 | 84.796 | 0.00 | 0.00 | 7 |
| ATOM | 773 | CA | PRO | A | 108 | 63.959 | −2.301 | 85.969 | 0.00 | 0.00 | 6 |
| ATOM | 774 | CB | PRO | A | 108 | 62.674 | −3.126 | 85.952 | 0.00 | 0.00 | 6 |
| ATOM | 775 | CG | PRO | A | 108 | 63.093 | −4.410 | 85.375 | 0.00 | 0.00 | 6 |
| ATOM | 776 | CD | PRO | A | 108 | 64.178 | −4.117 | 84.376 | 0.00 | 0.00 | 6 |
| ATOM | 777 | C | PRO | A | 108 | 64.721 | −2.560 | 87.267 | 0.00 | 0.00 | 6 |
| ATOM | 778 | O | PRO | A | 108 | 64.691 | −1.724 | 88.168 | 0.00 | 0.00 | 8 |
| ATOM | 779 | N | THR | A | 109 | 65.388 | −3.715 | 87.347 | 0.00 | 0.00 | 7 |
| ATOM | 780 | CA | THR | A | 109 | 66.198 | −4.119 | 88.506 | 0.00 | 0.00 | 6 |
| ATOM | 781 | CB | THR | A | 109 | 66.559 | −5.637 | 88.437 | 0.00 | 0.00 | 6 |
| ATOM | 782 | OG1 | THR | A | 109 | 66.876 | −6.005 | 87.088 | 0.00 | 0.00 | 8 |
| ATOM | 783 | CG2 | THR | A | 109 | 65.393 | −6.497 | 88.934 | 0.00 | 0.00 | 6 |
| ATOM | 784 | C | THR | A | 109 | 67.446 | −3.209 | 88.663 | 0.00 | 0.00 | 6 |
| ATOM | 785 | O | THR | A | 109 | 67.701 | −2.383 | 87.780 | 0.00 | 0.00 | 8 |
| ATOM | 786 | N | PRO | A | 110 | 68.233 | −3.375 | 89.761 | 0.00 | 0.00 | 7 |
| ATOM | 787 | CA | PRO | A | 110 | 69.211 | −2.420 | 90.305 | 0.00 | 0.00 | 6 |
| ATOM | 788 | CB | PRO | A | 110 | 70.419 | −3.320 | 90.595 | 0.00 | 0.00 | 6 |
| ATOM | 789 | CG | PRO | A | 110 | 69.779 | −4.678 | 90.960 | 0.00 | 0.00 | 6 |
| ATOM | 790 | CD | PRO | A | 110 | 68.304 | −4.616 | 90.556 | 0.00 | 0.00 | 6 |
| ATOM | 791 | C | PRO | A | 110 | 69.623 | −1.132 | 89.543 | 0.00 | 0.00 | 6 |
| ATOM | 792 | O | PRO | A | 110 | 69.678 | −0.069 | 90.173 | 0.00 | 0.00 | 8 |
| ATOM | 793 | N | MET | A | 111 | 69.894 | −1.204 | 88.236 | 0.00 | 0.00 | 7 |
| ATOM | 794 | CA | MET | A | 111 | 70.591 | −0.099 | 87.537 | 0.00 | 0.00 | 6 |
| ATOM | 795 | CB | MET | A | 111 | 71.870 | −0.614 | 86.849 | 0.00 | 0.00 | 6 |
| ATOM | 796 | CG | MET | A | 111 | 72.972 | −1.079 | 87.811 | 0.00 | 0.00 | 6 |
| ATOM | 797 | SD | MET | A | 111 | 73.842 | 0.248 | 88.683 | 0.00 | 0.00 | 16 |
| ATOM | 798 | CE | MET | A | 111 | 72.928 | 0.379 | 90.221 | 0.00 | 0.00 | 6 |
| ATOM | 799 | C | MET | A | 111 | 69.808 | 0.867 | 86.600 | 0.00 | 0.00 | 6 |
| ATOM | 800 | O | MET | A | 111 | 69.836 | 2.080 | 86.828 | 0.00 | 0.00 | 8 |
| ATOM | 801 | N | THR | A | 112 | 69.126 | 0.348 | 85.573 | 0.00 | 0.00 | 7 |
| ATOM | 802 | CA | THR | A | 112 | 68.649 | 1.188 | 84.446 | 0.00 | 0.00 | 6 |
| ATOM | 803 | CB | THR | A | 112 | 68.448 | 0.356 | 83.140 | 0.00 | 0.00 | 6 |
| ATOM | 804 | OG1 | THR | A | 112 | 69.713 | −0.145 | 82.689 | 0.00 | 0.00 | 8 |
| ATOM | 805 | CG2 | THR | A | 112 | 67.834 | 1.198 | 82.025 | 0.00 | 0.00 | 6 |
| ATOM | 806 | C | THR | A | 112 | 67.435 | 2.100 | 84.702 | 0.00 | 0.00 | 6 |
| ATOM | 807 | O | THR | A | 112 | 67.429 | 3.249 | 84.255 | 0.00 | 0.00 | 8 |
| ATOM | 808 | N | ASP | A | 113 | 66.420 | 1.610 | 85.404 | 0.00 | 0.00 | 7 |
| ATOM | 809 | CA | ASP | A | 113 | 65.212 | 2.418 | 85.615 | 0.00 | 0.00 | 6 |
| ATOM | 810 | CB | ASP | A | 113 | 63.950 | 1.674 | 85.158 | 0.00 | 0.00 | 6 |
| ATOM | 811 | CG | ASP | A | 113 | 63.620 | 1.927 | 83.689 | 0.00 | 0.00 | 6 |
| ATOM | 812 | OD1 | ASP | A | 113 | 62.418 | 1.919 | 83.334 | 0.00 | 0.00 | 8 |
| ATOM | 813 | OD2 | ASP | A | 113 | 64.559 | 2.140 | 82.890 | 0.00 | 0.00 | 8 |
| ATOM | 814 | C | ASP | A | 113 | 65.008 | 3.048 | 87.004 | 0.00 | 0.00 | 6 |
| ATOM | 815 | O | ASP | A | 113 | 64.391 | 4.110 | 87.097 | 0.00 | 0.00 | 8 |
| ATOM | 816 | N | PRO | A | 114 | 65.511 | 2.409 | 88.081 | 0.00 | 0.00 | 7 |
| ATOM | 817 | CA | PRO | A | 114 | 65.348 | 3.028 | 89.399 | 0.00 | 0.00 | 6 |
| ATOM | 818 | CB | PRO | A | 114 | 65.410 | 1.830 | 90.348 | 0.00 | 0.00 | 6 |
| ATOM | 819 | CG | PRO | A | 114 | 66.318 | 0.872 | 89.665 | 0.00 | 0.00 | 6 |
| ATOM | 820 | CD | PRO | A | 114 | 66.220 | 1.120 | 88.175 | 0.00 | 0.00 | 6 |
| ATOM | 821 | C | PRO | A | 114 | 66.450 | 4.043 | 89.731 | 0.00 | 0.00 | 6 |
| ATOM | 822 | O | PRO | A | 114 | 66.935 | 4.091 | 90.867 | 0.00 | 0.00 | 8 |
| ATOM | 823 | N | GLY | A | 115 | 66.829 | 4.847 | 88.741 | 0.00 | 0.00 | 7 |
| ATOM | 824 | CA | GLY | A | 115 | 67.867 | 5.858 | 88.910 | 0.00 | 0.00 | 6 |
| ATOM | 825 | C | GLY | A | 115 | 67.577 | 7.130 | 88.139 | 0.00 | 0.00 | 6 |
| ATOM | 826 | O | GLY | A | 115 | 67.435 | 8.203 | 88.733 | 0.00 | 0.00 | 8 |
| ATOM | 827 | N | VAL | A | 116 | 67.481 | 7.001 | 86.814 | 0.00 | 0.00 | 7 |
| ATOM | 828 | CA | VAL | A | 116 | 67.291 | 8.148 | 85.908 | 0.00 | 0.00 | 6 |
| ATOM | 829 | CB | VAL | A | 116 | 67.618 | 7.805 | 84.407 | 0.00 | 0.00 | 6 |
| ATOM | 830 | CG1 | VAL | A | 116 | 69.127 | 7.723 | 84.178 | 0.00 | 0.00 | 6 |
| ATOM | 831 | CG2 | VAL | A | 116 | 66.920 | 6.521 | 83.950 | 0.00 | 0.00 | 6 |
| ATOM | 832 | C | VAL | A | 116 | 65.909 | 8.806 | 86.019 | 0.00 | 0.00 | 6 |
| ATOM | 833 | O | VAL | A | 116 | 64.874 | 8.137 | 85.916 | 0.00 | 0.00 | 8 |
| ATOM | 834 | N | GLY | A | 117 | 65.911 | 10.121 | 86.237 | 0.00 | 0.00 | 7 |
| ATOM | 835 | CA | GLY | A | 117 | 64.685 | 10.910 | 86.326 | 0.00 | 0.00 | 6 |
| ATOM | 836 | C | GLY | A | 117 | 64.395 | 11.440 | 87.718 | 0.00 | 0.00 | 6 |
| ATOM | 837 | O | GLY | A | 117 | 63.350 | 11.138 | 88.294 | 0.00 | 0.00 | 8 |
| ATOM | 838 | N | VAL | A | 118 | 65.322 | 12.229 | 88.258 | 0.00 | 0.00 | 7 |
| ATOM | 839 | CA | VAL | A | 118 | 65.137 | 12.887 | 89.560 | 0.00 | 0.00 | 6 |
| ATOM | 840 | CB | VAL | A | 118 | 66.420 | 12.748 | 90.469 | 0.00 | 0.00 | 6 |
| ATOM | 841 | CG1 | VAL | A | 118 | 67.538 | 13.700 | 90.035 | 0.00 | 0.00 | 6 |
| ATOM | 842 | CG2 | VAL | A | 118 | 66.084 | 12.930 | 91.949 | 0.00 | 0.00 | 6 |
| ATOM | 843 | C | VAL | A | 118 | 64.661 | 14.349 | 89.376 | 0.00 | 0.00 | 6 |
| ATOM | 844 | O | VAL | A | 118 | 64.609 | 15.128 | 90.336 | 0.00 | 0.00 | 8 |
| ATOM | 845 | N | ILE | A | 119 | 64.293 | 14.689 | 88.135 | 0.00 | 0.00 | 7 |
| ATOM | 846 | CA | ILE | A | 119 | 63.853 | 16.044 | 87.747 | 0.00 | 0.00 | 6 |
| ATOM | 847 | CB | ILE | A | 119 | 64.607 | 16.564 | 86.470 | 0.00 | 0.00 | 6 |
| ATOM | 848 | CG1 | ILE | A | 119 | 64.723 | 15.465 | 85.400 | 0.00 | 0.00 | 6 |
| ATOM | 849 | CD1 | ILE | A | 119 | 65.242 | 15.945 | 84.050 | 0.00 | 0.00 | 6 |
| ATOM | 850 | CG2 | ILE | A | 119 | 65.983 | 17.122 | 86.842 | 0.00 | 0.00 | 6 |
| ATOM | 851 | C | ILE | A | 119 | 62.333 | 16.149 | 87.538 | 0.00 | 0.00 | 6 |
| ATOM | 852 | O | ILE | A | 119 | 61.863 | 16.857 | 86.643 | 0.00 | 0.00 | 8 |
| ATOM | 853 | N | VAL | A | 120 | 61.577 | 15.462 | 88.391 | 0.00 | 0.00 | 7 |
| ATOM | 854 | CA | VAL | A | 120 | 60.133 | 15.300 | 88.209 | 0.00 | 0.00 | 6 |
| ATOM | 855 | CB | VAL | A | 120 | 59.631 | 13.962 | 88.836 | 0.00 | 0.00 | 6 |
| ATOM | 856 | CG1 | VAL | A | 120 | 58.126 | 13.971 | 89.064 | 0.00 | 0.00 | 6 |
| ATOM | 857 | CG2 | VAL | A | 120 | 60.024 | 12.786 | 87.954 | 0.00 | 0.00 | 6 |
| ATOM | 858 | C | VAL | A | 120 | 59.292 | 16.501 | 88.670 | 0.00 | 0.00 | 6 |
| ATOM | 859 | O | VAL | A | 120 | 59.038 | 16.691 | 89.865 | 0.00 | 0.00 | 8 |
| ATOM | 860 | N | THR | A | 121 | 58.883 | 17.312 | 87.696 | 0.00 | 0.00 | 7 |
| ATOM | 861 | CA | THR | A | 121 | 57.828 | 18.313 | 87.881 | 0.00 | 0.00 | 6 |
| ATOM | 862 | CB | THR | A | 121 | 58.234 | 19.708 | 87.323 | 0.00 | 0.00 | 6 |
| ATOM | 863 | OG1 | THR | A | 121 | 59.652 | 19.888 | 87.433 | 0.00 | 0.00 | 8 |
| ATOM | 864 | CG2 | THR | A | 121 | 57.519 | 20.831 | 88.082 | 0.00 | 0.00 | 6 |
| ATOM | 865 | C | THR | A | 121 | 56.558 | 17.783 | 87.187 | 0.00 | 0.00 | 6 |
| ATOM | 866 | O | THR | A | 121 | 55.682 | 18.547 | 86.768 | 0.00 | 0.00 | 8 |
| ATOM | 867 | N | ILE | A | 122 | 56.484 | 16.455 | 87.073 | 0.00 | 0.00 | 7 |
| ATOM | 868 | CA | ILE | A | 122 | 55.336 | 15.743 | 86.505 | 0.00 | 0.00 | 6 |
| ATOM | 869 | CB | ILE | A | 122 | 55.688 | 14.252 | 86.200 | 0.00 | 0.00 | 6 |
| ATOM | 870 | CG1 | ILE | A | 122 | 57.089 | 14.107 | 85.561 | 0.00 | 0.00 | 6 |
| ATOM | 871 | CD1 | ILE | A | 122 | 57.308 | 14.820 | 84.215 | 0.00 | 0.00 | 6 |
| ATOM | 872 | CG2 | ILE | A | 122 | 54.593 | 13.576 | 85.372 | 0.00 | 0.00 | 6 |
| ATOM | 873 | C | ILE | A | 122 | 54.169 | 15.814 | 87.487 | 0.00 | 0.00 | 6 |
| ATOM | 874 | O | ILE | A | 122 | 53.009 | 15.634 | 87.113 | 0.00 | 0.00 | 8 |
| ATOM | 875 | N | VAL | A | 123 | 54.499 | 16.089 | 88.746 | 0.00 | 0.00 | 7 |
| ATOM | 876 | CA | VAL | A | 123 | 53.516 | 16.353 | 89.790 | 0.00 | 0.00 | 6 |
| ATOM | 877 | CB | VAL | A | 123 | 54.178 | 16.459 | 91.191 | 0.00 | 0.00 | 6 |
| ATOM | 878 | CG1 | VAL | A | 123 | 53.255 | 15.890 | 92.270 | 0.00 | 0.00 | 6 |
| ATOM | 879 | CG2 | VAL | A | 123 | 55.521 | 15.739 | 91.217 | 0.00 | 0.00 | 6 |
| ATOM | 880 | C | VAL | A | 123 | 52.748 | 17.646 | 89.482 | 0.00 | 0.00 | 6 |
| ATOM | 881 | O | VAL | A | 123 | 51.790 | 17.986 | 90.179 | 0.00 | 0.00 | 8 |
| ATOM | 882 | N | ALA | A | 124 | 53.171 | 18.355 | 88.432 | 0.00 | 0.00 | 7 |
| ATOM | 883 | CA | ALA | A | 124 | 52.486 | 19.562 | 87.965 | 0.00 | 0.00 | 6 |
| ATOM | 884 | CB | ALA | A | 124 | 53.135 | 20.094 | 86.700 | 0.00 | 0.00 | 6 |
| ATOM | 885 | C | ALA | A | 124 | 51.016 | 19.272 | 87.721 | 0.00 | 0.00 | 6 |
| ATOM | 886 | O | ALA | A | 124 | 50.160 | 20.109 | 88.001 | 0.00 | 0.00 | 8 |
| ATOM | 887 | N | LEU | A | 125 | 50.738 | 18.077 | 87.204 | 0.00 | 0.00 | 7 |
| ATOM | 888 | CA | LEU | A | 125 | 49.371 | 17.617 | 87.006 | 0.00 | 0.00 | 6 |
| ATOM | 889 | CB | LEU | A | 125 | 49.205 | 16.951 | 85.638 | 0.00 | 0.00 | 6 |
| ATOM | 890 | CG | LEU | A | 125 | 47.900 | 17.197 | 84.869 | 0.00 | 0.00 | 6 |
| ATOM | 891 | CD1 | LEU | A | 125 | 47.623 | 18.687 | 84.641 | 0.00 | 0.00 | 6 |
| ATOM | 892 | CD2 | LEU | A | 125 | 47.926 | 16.464 | 83.534 | 0.00 | 0.00 | 6 |
| ATOM | 893 | C | LEU | A | 125 | 48.992 | 16.672 | 88.130 | 0.00 | 0.00 | 6 |
| ATOM | 894 | O | LEU | A | 125 | 49.224 | 16.994 | 89.293 | 0.00 | 0.00 | 8 |
| ATOM | 895 | N | ILE | A | 126 | 48.427 | 15.512 | 87.789 | 0.00 | 0.00 | 7 |
| ATOM | 896 | CA | ILE | A | 126 | 47.802 | 14.609 | 88.769 | 0.00 | 0.00 | 6 |
| ATOM | 897 | CB | ILE | A | 126 | 48.837 | 13.942 | 89.721 | 0.00 | 0.00 | 6 |
| ATOM | 898 | CG1 | ILE | A | 126 | 50.031 | 13.398 | 88.934 | 0.00 | 0.00 | 6 |
| ATOM | 899 | CD1 | ILE | A | 126 | 49.692 | 12.329 | 87.918 | 0.00 | 0.00 | 6 |
| ATOM | 900 | CG2 | ILE | A | 126 | 48.199 | 12.832 | 90.549 | 0.00 | 0.00 | 6 |
| ATOM | 901 | C | ILE | A | 126 | 46.710 | 15.365 | 89.540 | 0.00 | 0.00 | 6 |
| ATOM | 902 | O | ILE | A | 126 | 45.918 | 14.773 | 90.275 | 0.00 | 0.00 | 8 |
| ATOM | 903 | N | CYS | A | 127 | 46.692 | 16.684 | 89.350 | 0.00 | 0.00 | 7 |
| ATOM | 904 | CA | CYS | A | 127 | 45.594 | 17.551 | 89.761 | 0.00 | 0.00 | 6 |
| ATOM | 905 | CB | CYS | A | 127 | 46.014 | 19.015 | 89.634 | 0.00 | 0.00 | 6 |
| ATOM | 906 | SG | CYS | A | 127 | 46.280 | 19.543 | 87.915 | 0.00 | 0.00 | 16 |
| ATOM | 907 | C | CYS | A | 127 | 44.401 | 17.288 | 88.845 | 0.00 | 0.00 | 6 |
| ATOM | 908 | O | CYS | A | 127 | 43.255 | 17.282 | 89.286 | 0.00 | 0.00 | 8 |
| ATOM | 909 | N | THR | A | 128 | 44.699 | 17.063 | 87.567 | 0.00 | 0.00 | 7 |
| ATOM | 910 | CA | THR | A | 128 | 43.717 | 16.735 | 86.543 | 0.00 | 0.00 | 6 |
| ATOM | 911 | CB | THR | A | 128 | 44.433 | 16.205 | 85.302 | 0.00 | 0.00 | 6 |
| ATOM | 912 | OG1 | THR | A | 128 | 44.865 | 17.320 | 84.522 | 0.00 | 0.00 | 8 |
| ATOM | 913 | CG2 | THR | A | 128 | 43.533 | 15.318 | 84.461 | 0.00 | 0.00 | 6 |
| ATOM | 914 | C | THR | A | 128 | 42.620 | 15.778 | 87.001 | 0.00 | 0.00 | 6 |
| ATOM | 915 | O | THR | A | 128 | 41.488 | 15.867 | 86.534 | 0.00 | 0.00 | 8 |
| ATOM | 916 | N | ILE | A | 129 | 42.961 | 14.880 | 87.920 | 0.00 | 0.00 | 7 |
| ATOM | 917 | CA | ILE | A | 129 | 41.985 | 14.036 | 88.603 | 0.00 | 0.00 | 6 |
| ATOM | 918 | CB | ILE | A | 129 | 42.587 | 13.429 | 89.890 | 0.00 | 0.00 | 6 |
| ATOM | 919 | CG1 | ILE | A | 129 | 43.662 | 12.396 | 89.541 | 0.00 | 0.00 | 6 |
| ATOM | 920 | CD1 | ILE | A | 129 | 43.148 | 11.157 | 88.811 | 0.00 | 0.00 | 6 |
| ATOM | 921 | CG2 | ILE | A | 129 | 41.512 | 12.796 | 90.775 | 0.00 | 0.00 | 6 |
| ATOM | 922 | C | ILE | A | 129 | 40.704 | 14.806 | 88.924 | 0.00 | 0.00 | 6 |
| ATOM | 923 | O | ILE | A | 129 | 39.637 | 14.214 | 89.071 | 0.00 | 0.00 | 8 |
| ATOM | 924 | N | ILE | A | 130 | 40.821 | 16.126 | 89.019 | 0.00 | 0.00 | 7 |
| ATOM | 925 | CA | ILE | A | 130 | 39.665 | 17.005 | 89.168 | 0.00 | 0.00 | 6 |
| ATOM | 926 | CB | ILE | A | 130 | 40.091 | 18.511 | 89.344 | 0.00 | 0.00 | 6 |
| ATOM | 927 | CG1 | ILE | A | 130 | 38.873 | 19.443 | 89.484 | 0.00 | 0.00 | 6 |
| ATOM | 928 | CD1 | ILE | A | 130 | 38.263 | 19.525 | 90.894 | 0.00 | 0.00 | 6 |
| ATOM | 929 | CG2 | ILE | A | 130 | 41.020 | 18.978 | 88.216 | 0.00 | 0.00 | 6 |
| ATOM | 930 | C | ILE | A | 130 | 38.667 | 16.819 | 88.014 | 0.00 | 0.00 | 6 |
| ATOM | 931 | O | ILE | A | 130 | 37.465 | 16.643 | 88.243 | 0.00 | 0.00 | 8 |
| ATOM | 932 | N | LEU | A | 131 | 39.169 | 16.829 | 86.782 | 0.00 | 0.00 | 7 |
| ATOM | 933 | CA | LEU | A | 131 | 38.304 | 16.726 | 85.615 | 0.00 | 0.00 | 6 |
| ATOM | 934 | CB | LEU | A | 131 | 38.758 | 17.703 | 84.524 | 0.00 | 0.00 | 6 |
| ATOM | 935 | CG | LEU | A | 131 | 38.187 | 19.134 | 84.592 | 0.00 | 0.00 | 6 |
| ATOM | 936 | CD1 | LEU | A | 131 | 38.871 | 20.016 | 85.641 | 0.00 | 0.00 | 6 |
| ATOM | 937 | CD2 | LEU | A | 131 | 38.227 | 19.830 | 83.231 | 0.00 | 0.00 | 6 |
| ATOM | 938 | C | LEU | A | 131 | 38.147 | 15.288 | 85.115 | 0.00 | 0.00 | 6 |
| ATOM | 939 | O | LEU | A | 131 | 37.714 | 15.033 | 83.997 | 0.00 | 0.00 | 8 |
| ATOM | 940 | N | VAL | A | 132 | 38.504 | 14.350 | 85.979 | 0.00 | 0.00 | 7 |
| ATOM | 941 | CA | VAL | A | 132 | 38.113 | 12.957 | 85.832 | 0.00 | 0.00 | 6 |
| ATOM | 942 | CB | VAL | A | 132 | 39.254 | 12.012 | 86.248 | 0.00 | 0.00 | 6 |
| ATOM | 943 | CG1 | VAL | A | 132 | 38.767 | 10.569 | 86.367 | 0.00 | 0.00 | 6 |
| ATOM | 944 | CG2 | VAL | A | 132 | 40.402 | 12.118 | 85.264 | 0.00 | 0.00 | 6 |
| ATOM | 945 | C | VAL | A | 132 | 36.928 | 12.763 | 86.761 | 0.00 | 0.00 | 6 |
| ATOM | 946 | O | VAL | A | 132 | 35.914 | 12.180 | 86.392 | 0.00 | 0.00 | 8 |
| ATOM | 947 | N | SER | A | 133 | 37.069 | 13.283 | 87.974 | 0.00 | 0.00 | 7 |
| ATOM | 948 | CA | SER | A | 133 | 35.999 | 13.267 | 88.948 | 0.00 | 0.00 | 6 |
| ATOM | 949 | CB | SER | A | 133 | 36.550 | 13.513 | 90.360 | 0.00 | 0.00 | 6 |
| ATOM | 950 | OG | SER | A | 133 | 37.124 | 12.334 | 90.912 | 0.00 | 0.00 | 8 |
| ATOM | 951 | C | SER | A | 133 | 34.907 | 14.274 | 88.591 | 0.00 | 0.00 | 6 |
| ATOM | 952 | O | SER | A | 133 | 33.969 | 14.471 | 89.351 | 0.00 | 0.00 | 8 |
| ATOM | 953 | N | PHE | A | 134 | 35.040 | 14.918 | 87.441 | 0.00 | 0.00 | 7 |
| ATOM | 954 | CA | PHE | A | 134 | 33.968 | 15.731 | 86.905 | 0.00 | 0.00 | 6 |
| ATOM | 955 | CB | PHE | A | 134 | 34.518 | 17.034 | 86.335 | 0.00 | 0.00 | 6 |
| ATOM | 956 | CG | PHE | A | 134 | 33.547 | 17.793 | 85.468 | 0.00 | 0.00 | 6 |
| ATOM | 957 | CD1 | PHE | A | 134 | 32.206 | 17.893 | 85.801 | 0.00 | 0.00 | 6 |
| ATOM | 958 | CE1 | PHE | A | 134 | 31.326 | 18.602 | 84.994 | 0.00 | 0.00 | 6 |
| ATOM | 959 | CZ | PHE | A | 134 | 31.788 | 19.243 | 83.854 | 0.00 | 0.00 | 6 |
| ATOM | 960 | CE2 | PHE | A | 134 | 33.124 | 19.164 | 83.520 | 0.00 | 0.00 | 6 |
| ATOM | 961 | CD2 | PHE | A | 134 | 33.996 | 18.444 | 84.328 | 0.00 | 0.00 | 6 |
| ATOM | 962 | C | PHE | A | 134 | 33.300 | 14.889 | 85.847 | 0.00 | 0.00 | 6 |
| ATOM | 963 | O | PHE | A | 134 | 32.072 | 14.883 | 85.716 | 0.00 | 0.00 | 8 |
| ATOM | 964 | N | GLN | A | 135 | 34.127 | 14.162 | 85.107 | 0.00 | 0.00 | 7 |
| ATOM | 965 | CA | GLN | A | 135 | 33.646 | 13.135 | 84.203 | 0.00 | 0.00 | 6 |
| ATOM | 966 | CB | GLN | A | 135 | 34.801 | 12.536 | 83.403 | 0.00 | 0.00 | 6 |
| ATOM | 967 | CG | GLN | A | 135 | 35.197 | 13.346 | 82.164 | 0.00 | 0.00 | 6 |
| ATOM | 968 | CD | GLN | A | 135 | 36.079 | 12.568 | 81.174 | 0.00 | 0.00 | 6 |
| ATOM | 969 | OE1 | GLN | A | 135 | 37.243 | 12.258 | 81.470 | 0.00 | 0.00 | 8 |
| ATOM | 970 | NE2 | GLN | A | 135 | 35.527 | 12.265 | 79.988 | 0.00 | 0.00 | 7 |
| ATOM | 971 | C | GLN | A | 135 | 32.953 | 12.055 | 85.014 | 0.00 | 0.00 | 6 |
| ATOM | 972 | O | GLN | A | 135 | 32.000 | 11.415 | 84.561 | 0.00 | 0.00 | 8 |
| ATOM | 973 | N | ARG | A | 136 | 33.432 | 11.868 | 86.233 | 0.00 | 0.00 | 7 |
| ATOM | 974 | CA | ARG | A | 136 | 32.784 | 10.961 | 87.144 | 0.00 | 0.00 | 6 |
| ATOM | 975 | CB | ARG | A | 136 | 33.585 | 10.828 | 88.445 | 0.00 | 0.00 | 6 |
| ATOM | 976 | CG | ARG | A | 136 | 34.736 | 9.782 | 88.446 | 0.00 | 0.00 | 6 |
| ATOM | 977 | CD | ARG | A | 136 | 34.247 | 8.308 | 88.343 | 0.00 | 0.00 | 6 |
| ATOM | 978 | NE | ARG | A | 136 | 33.321 | 7.873 | 89.408 | 0.00 | 0.00 | 7 |
| ATOM | 979 | CZ | ARG | A | 136 | 32.471 | 6.842 | 89.314 | 0.00 | 0.00 | 6 |
| ATOM | 980 | NH1 | ARG | A | 136 | 32.398 | 6.110 | 88.196 | 0.00 | 0.00 | 7 |
| ATOM | 981 | NH2 | ARG | A | 136 | 31.677 | 6.546 | 90.341 | 0.00 | 0.00 | 7 |
| ATOM | 982 | C | ARG | A | 136 | 31.353 | 11.416 | 87.434 | 0.00 | 0.00 | 6 |
| ATOM | 983 | O | ARG | A | 136 | 30.458 | 10.592 | 87.509 | 0.00 | 0.00 | 8 |
| ATOM | 984 | N | TRP | A | 137 | 31.136 | 12.721 | 87.582 | 0.00 | 0.00 | 7 |
| ATOM | 985 | CA | TRP | A | 137 | 29.805 | 13.232 | 87.917 | 0.00 | 0.00 | 6 |
| ATOM | 986 | CB | TRP | A | 137 | 29.841 | 14.727 | 88.251 | 0.00 | 0.00 | 6 |
| ATOM | 987 | CG | TRP | A | 137 | 28.499 | 15.449 | 88.395 | 0.00 | 0.00 | 6 |
| ATOM | 988 | CD1 | TRP | A | 137 | 28.182 | 16.661 | 87.854 | 0.00 | 0.00 | 6 |
| ATOM | 989 | NE1 | TRP | A | 137 | 26.897 | 17.022 | 88.193 | 0.00 | 0.00 | 7 |
| ATOM | 990 | CE2 | TRP | A | 137 | 26.342 | 16.038 | 88.972 | 0.00 | 0.00 | 6 |
| ATOM | 991 | CD2 | TRP | A | 137 | 27.323 | 15.026 | 89.133 | 0.00 | 0.00 | 6 |
| ATOM | 992 | CE3 | TRP | A | 137 | 27.000 | 13.893 | 89.906 | 0.00 | 0.00 | 6 |
| ATOM | 993 | CZ3 | TRP | A | 137 | 25.703 | 13.811 | 90.495 | 0.00 | 0.00 | 6 |
| ATOM | 994 | CH2 | TRP | A | 137 | 24.757 | 14.837 | 90.312 | 0.00 | 0.00 | 6 |
| ATOM | 995 | CZ2 | TRP | A | 137 | 25.051 | 15.953 | 89.560 | 0.00 | 0.00 | 6 |
| ATOM | 996 | C | TRP | A | 137 | 28.874 | 12.953 | 86.775 | 0.00 | 0.00 | 6 |
| ATOM | 997 | O | TRP | A | 137 | 27.702 | 12.653 | 86.981 | 0.00 | 0.00 | 8 |
| ATOM | 998 | N | VAL | A | 138 | 29.408 | 13.010 | 85.567 | 0.00 | 0.00 | 7 |
| ATOM | 999 | CA | VAL | A | 138 | 28.603 | 12.710 | 84.403 | 0.00 | 0.00 | 6 |
| ATOM | 1000 | CB | VAL | A | 138 | 29.405 | 12.862 | 83.125 | 0.00 | 0.00 | 6 |
| ATOM | 1001 | CG1 | VAL | A | 138 | 28.555 | 12.512 | 81.930 | 0.00 | 0.00 | 6 |
| ATOM | 1002 | CG2 | VAL | A | 138 | 29.890 | 14.298 | 83.022 | 0.00 | 0.00 | 6 |
| ATOM | 1003 | C | VAL | A | 138 | 27.921 | 11.352 | 84.521 | 0.00 | 0.00 | 6 |
| ATOM | 1004 | O | VAL | A | 138 | 26.694 | 11.279 | 84.464 | 0.00 | 0.00 | 8 |
| ATOM | 1005 | N | VAL | A | 139 | 28.714 | 10.305 | 84.747 | 0.00 | 0.00 | 7 |
| ATOM | 1006 | CA | VAL | A | 139 | 28.188 | 8.953 | 84.933 | 0.00 | 0.00 | 6 |
| ATOM | 1007 | CB | VAL | A | 139 | 28.804 | 8.202 | 86.152 | 0.00 | 0.00 | 6 |
| ATOM | 1008 | CG1 | VAL | A | 139 | 28.350 | 8.810 | 87.499 | 0.00 | 0.00 | 6 |
| ATOM | 1009 | CG2 | VAL | A | 139 | 28.432 | 6.709 | 86.111 | 0.00 | 0.00 | 6 |
| ATOM | 1010 | C | VAL | A | 139 | 26.681 | 8.931 | 85.083 | 0.00 | 0.00 | 6 |
| ATOM | 1011 | O | VAL | A | 139 | 25.967 | 8.741 | 84.118 | 0.00 | 0.00 | 8 |
| ATOM | 1012 | N | ARG | A | 140 | 26.191 | 9.115 | 86.295 | 0.00 | 0.00 | 7 |
| ATOM | 1013 | CA | ARG | A | 140 | 24.777 | 8.946 | 86.511 | 0.00 | 0.00 | 6 |
| ATOM | 1014 | CB | ARG | A | 140 | 24.467 | 7.654 | 87.323 | 0.00 | 0.00 | 6 |
| ATOM | 1015 | CG | ARG | A | 140 | 22.951 | 7.355 | 87.707 | 0.00 | 0.00 | 6 |
| ATOM | 1016 | CD | ARG | A | 140 | 21.915 | 7.526 | 86.547 | 0.00 | 0.00 | 6 |
| ATOM | 1017 | NE | ARG | A | 140 | 20.677 | 8.198 | 86.990 | 0.00 | 0.00 | 7 |
| ATOM | 1018 | CZ | ARG | A | 140 | 19.704 | 8.645 | 86.187 | 0.00 | 0.00 | 6 |
| ATOM | 1019 | NH1 | ARG | A | 140 | 19.775 | 8.495 | 84.861 | 0.00 | 0.00 | 7 |
| ATOM | 1020 | NH2 | ARG | A | 140 | 18.644 | 9.245 | 86.723 | 0.00 | 0.00 | 7 |
| ATOM | 1021 | C | ARG | A | 140 | 24.157 | 10.213 | 87.080 | 0.00 | 0.00 | 6 |
| ATOM | 1022 | O | ARG | A | 140 | 23.424 | 10.185 | 88.081 | 0.00 | 0.00 | 8 |
| ATOM | 1023 | N | ARG | A | 141 | 24.471 | 11.338 | 86.450 | 0.00 | 0.00 | 7 |
| ATOM | 1024 | CA | ARG | A | 141 | 23.458 | 12.369 | 86.361 | 0.00 | 0.00 | 6 |
| ATOM | 1025 | CB | ARG | A | 141 | 24.033 | 13.786 | 86.479 | 0.00 | 0.00 | 6 |
| ATOM | 1026 | CG | ARG | A | 141 | 23.028 | 14.888 | 86.939 | 0.00 | 0.00 | 6 |
| ATOM | 1027 | CD | ARG | A | 141 | 22.198 | 14.560 | 88.217 | 0.00 | 0.00 | 6 |
| ATOM | 1028 | NE | ARG | A | 141 | 20.807 | 14.147 | 87.932 | 0.00 | 0.00 | 7 |
| ATOM | 1029 | CZ | ARG | A | 141 | 19.771 | 14.245 | 88.780 | 0.00 | 0.00 | 6 |
| ATOM | 1030 | NH1 | ARG | A | 141 | 19.929 | 14.757 | 90.003 | 0.00 | 0.00 | 7 |
| ATOM | 1031 | NH2 | ARG | A | 141 | 18.560 | 13.837 | 88.401 | 0.00 | 0.00 | 7 |
| ATOM | 1032 | C | ARG | A | 141 | 22.902 | 11.990 | 84.992 | 0.00 | 0.00 | 6 |
| ATOM | 1033 | O | ARG | A | 141 | 21.698 | 12.084 | 84.718 | 0.00 | 0.00 | 8 |
| ATOM | 1034 | N | THR | A | 142 | 23.820 | 11.509 | 84.161 | 0.00 | 0.00 | 7 |
| ATOM | 1035 | CA | THR | A | 142 | 23.514 | 10.531 | 83.139 | 0.00 | 0.00 | 6 |
| ATOM | 1036 | CB | THR | A | 142 | 22.417 | 10.930 | 82.179 | 0.00 | 0.00 | 6 |
| ATOM | 1037 | OG1 | THR | A | 142 | 21.980 | 9.746 | 81.516 | 0.00 | 0.00 | 8 |
| ATOM | 1038 | CG2 | THR | A | 142 | 22.941 | 11.889 | 81.136 | 0.00 | 0.00 | 6 |
| ATOM | 1039 | C | THR | A | 142 | 24.728 | 10.254 | 82.316 | 0.00 | 0.00 | 6 |
| ATOM | 1040 | O | THR | A | 142 | 25.582 | 11.120 | 82.140 | 0.00 | 0.00 | 8 |
| ATOM | 1041 | N | GLN | A | 143 | 24.790 | 9.028 | 81.817 | 0.00 | 0.00 | 7 |
| ATOM | 1042 | CA | GLN | A | 143 | 25.819 | 8.625 | 80.890 | 0.00 | 0.00 | 6 |
| ATOM | 1043 | CB | GLN | A | 143 | 25.770 | 7.117 | 80.652 | 0.00 | 0.00 | 6 |
| ATOM | 1044 | CG | GLN | A | 143 | 24.398 | 6.518 | 80.734 | 0.00 | 0.00 | 6 |
| ATOM | 1045 | CD | GLN | A | 143 | 23.885 | 6.512 | 82.157 | 0.00 | 0.00 | 6 |
| ATOM | 1046 | OE1 | GLN | A | 143 | 23.162 | 7.417 | 82.570 | 0.00 | 0.00 | 8 |
| ATOM | 1047 | NE2 | GLN | A | 143 | 24.290 | 5.508 | 82.930 | 0.00 | 0.00 | 7 |
| ATOM | 1048 | C | GLN | A | 143 | 25.565 | 9.373 | 79.607 | 0.00 | 0.00 | 6 |
| ATOM | 1049 | O | GLN | A | 143 | 24.398 | 9.575 | 79.234 | 0.00 | 0.00 | 8 |
| ATOM | 1050 | N | SER | A | 144 | 26.648 | 9.832 | 78.963 | 0.00 | 0.00 | 7 |
| ATOM | 1051 | CA | SER | A | 144 | 26.610 | 10.212 | 77.537 | 0.00 | 0.00 | 6 |
| ATOM | 1052 | CB | SER | A | 144 | 27.872 | 10.968 | 77.112 | 0.00 | 0.00 | 6 |
| ATOM | 1053 | OG | SER | A | 144 | 28.950 | 10.074 | 76.859 | 0.00 | 0.00 | 8 |
| ATOM | 1054 | C | SER | A | 144 | 26.540 | 8.867 | 76.815 | 0.00 | 0.00 | 6 |
| ATOM | 1055 | O | SER | A | 144 | 27.482 | 8.470 | 76.089 | 0.00 | 0.00 | 8 |
| ATOM | 1056 | N | GLN | A | 145 | 25.404 | 8.184 | 77.026 | 0.00 | 0.00 | 7 |
| ATOM | 1057 | CA | GLN | A | 145 | 25.371 | 6.705 | 77.057 | 0.00 | 0.00 | 6 |
| ATOM | 1058 | CB | GLN | A | 145 | 24.483 | 6.068 | 75.920 | 0.00 | 0.00 | 6 |
| ATOM | 1059 | CG | GLN | A | 145 | 22.946 | 5.889 | 76.344 | 0.00 | 0.00 | 6 |
| ATOM | 1060 | CD | GLN | A | 145 | 21.943 | 5.526 | 75.212 | 0.00 | 0.00 | 6 |
| ATOM | 1061 | OE1 | GLN | A | 145 | 21.816 | 6.243 | 74.212 | 0.00 | 0.00 | 8 |
| ATOM | 1062 | NE2 | GLN | A | 145 | 21.195 | 4.431 | 75.415 | 0.00 | 0.00 | 7 |
| ATOM | 1063 | C | GLN | A | 145 | 26.833 | 6.192 | 77.231 | 0.00 | 0.00 | 6 |
| ATOM | 1064 | O | GLN | A | 145 | 27.517 | 5.762 | 76.283 | 0.00 | 0.00 | 8 |
| ATOM | 1065 | N | ALA | A | 146 | 27.312 | 6.377 | 78.462 | 0.00 | 0.00 | 7 |
| ATOM | 1066 | CA | ALA | A | 146 | 28.625 | 5.956 | 78.863 | 0.00 | 0.00 | 6 |
| ATOM | 1067 | CB | ALA | A | 146 | 28.576 | 4.470 | 79.315 | 0.00 | 0.00 | 6 |
| ATOM | 1068 | C | ALA | A | 146 | 29.684 | 6.198 | 77.770 | 0.00 | 0.00 | 6 |
| ATOM | 1069 | O | ALA | A | 146 | 30.641 | 5.451 | 77.635 | 0.00 | 0.00 | 8 |
| ATOM | 1070 | N | VAL | A | 147 | 29.526 | 7.248 | 76.990 | 0.00 | 0.00 | 7 |
| ATOM | 1071 | CA | VAL | A | 147 | 30.493 | 7.479 | 75.952 | 0.00 | 0.00 | 6 |
| ATOM | 1072 | CB | VAL | A | 147 | 29.815 | 7.968 | 74.729 | 0.00 | 0.00 | 6 |
| ATOM | 1073 | CG1 | VAL | A | 147 | 30.694 | 8.943 | 73.974 | 0.00 | 0.00 | 6 |
| ATOM | 1074 | CG2 | VAL | A | 147 | 29.457 | 6.779 | 73.912 | 0.00 | 0.00 | 6 |
| ATOM | 1075 | C | VAL | A | 147 | 31.515 | 8.448 | 76.448 | 0.00 | 0.00 | 6 |
| ATOM | 1076 | O | VAL | A | 147 | 32.668 | 8.435 | 76.026 | 0.00 | 0.00 | 8 |
| ATOM | 1077 | N | ARG | A | 148 | 31.068 | 9.286 | 77.367 | 0.00 | 0.00 | 7 |
| ATOM | 1078 | CA | ARG | A | 148 | 31.973 | 10.038 | 78.183 | 0.00 | 0.00 | 6 |
| ATOM | 1079 | CB | ARG | A | 148 | 31.230 | 10.858 | 79.240 | 0.00 | 0.00 | 6 |
| ATOM | 1080 | CG | ARG | A | 148 | 30.179 | 11.851 | 78.730 | 0.00 | 0.00 | 6 |
| ATOM | 1081 | CD | ARG | A | 148 | 30.729 | 13.201 | 78.181 | 0.00 | 0.00 | 6 |
| ATOM | 1082 | NE | ARG | A | 148 | 29.982 | 14.333 | 78.753 | 0.00 | 0.00 | 7 |
| ATOM | 1083 | CZ | ARG | A | 148 | 29.817 | 15.545 | 78.216 | 0.00 | 0.00 | 6 |
| ATOM | 1084 | NH1 | ARG | A | 148 | 30.312 | 15.870 | 77.031 | 0.00 | 0.00 | 7 |
| ATOM | 1085 | NH2 | ARG | A | 148 | 29.117 | 16.445 | 78.886 | 0.00 | 0.00 | 7 |
| ATOM | 1086 | C | ARG | A | 148 | 32.836 | 9.012 | 78.877 | 0.00 | 0.00 | 6 |
| ATOM | 1087 | O | ARG | A | 148 | 34.037 | 9.231 | 79.038 | 0.00 | 0.00 | 8 |
| ATOM | 1088 | N | ALA | A | 149 | 32.231 | 7.879 | 79.249 | 0.00 | 0.00 | 7 |
| ATOM | 1089 | CA | ALA | A | 149 | 32.905 | 6.859 | 80.060 | 0.00 | 0.00 | 6 |
| ATOM | 1090 | CB | ALA | A | 149 | 31.957 | 5.787 | 80.489 | 0.00 | 0.00 | 6 |
| ATOM | 1091 | C | ALA | A | 149 | 34.138 | 6.264 | 79.401 | 0.00 | 0.00 | 6 |
| ATOM | 1092 | O | ALA | A | 149 | 34.671 | 5.247 | 79.858 | 0.00 | 0.00 | 8 |
| ATOM | 1093 | N | ASP | A | 150 | 34.590 | 6.906 | 78.327 | 0.00 | 0.00 | 7 |
| ATOM | 1094 | CA | ASP | A | 150 | 35.941 | 6.700 | 77.841 | 0.00 | 0.00 | 6 |
| ATOM | 1095 | CB | ASP | A | 150 | 36.134 | 7.319 | 76.450 | 0.00 | 0.00 | 6 |
| ATOM | 1096 | CG | ASP | A | 150 | 36.756 | 8.699 | 76.497 | 0.00 | 0.00 | 6 |
| ATOM | 1097 | OD1 | ASP | A | 150 | 36.510 | 9.445 | 77.484 | 0.00 | 0.00 | 8 |
| ATOM | 1098 | OD2 | ASP | A | 150 | 37.499 | 9.028 | 75.537 | 0.00 | 0.00 | 8 |
| ATOM | 1099 | C | ASP | A | 150 | 36.880 | 7.288 | 78.898 | 0.00 | 0.00 | 6 |
| ATOM | 1100 | O | ASP | A | 150 | 37.905 | 6.705 | 79.207 | 0.00 | 0.00 | 8 |
| ATOM | 1101 | N | MET | A | 151 | 36.503 | 8.437 | 79.453 | 0.00 | 0.00 | 7 |
| ATOM | 1102 | CA | MET | A | 151 | 37.077 | 8.963 | 80.687 | 0.00 | 0.00 | 6 |
| ATOM | 1103 | CB | MET | A | 151 | 35.947 | 9.298 | 81.660 | 0.00 | 0.00 | 6 |
| ATOM | 1104 | CG | MET | A | 151 | 36.372 | 9.396 | 83.116 | 0.00 | 0.00 | 6 |
| ATOM | 1105 | SD | MET | A | 151 | 35.232 | 8.559 | 84.231 | 0.00 | 0.00 | 16 |
| ATOM | 1106 | CE | MET | A | 151 | 36.388 | 8.096 | 85.511 | 0.00 | 0.00 | 6 |
| ATOM | 1107 | C | MET | A | 151 | 38.058 | 8.022 | 81.389 | 0.00 | 0.00 | 6 |
| ATOM | 1108 | O | MET | A | 151 | 39.197 | 8.405 | 81.650 | 0.00 | 0.00 | 8 |
| ATOM | 1109 | N | LEU | A | 152 | 37.607 | 6.805 | 81.711 | 0.00 | 0.00 | 7 |
| ATOM | 1110 | CA | LEU | A | 152 | 38.452 | 5.829 | 82.395 | 0.00 | 0.00 | 6 |
| ATOM | 1111 | CB | LEU | A | 152 | 37.730 | 4.477 | 82.590 | 0.00 | 0.00 | 6 |
| ATOM | 1112 | CG | LEU | A | 152 | 37.150 | 4.012 | 83.951 | 0.00 | 0.00 | 6 |
| ATOM | 1113 | CD1 | LEU | A | 152 | 35.926 | 4.805 | 84.355 | 0.00 | 0.00 | 6 |
| ATOM | 1114 | CD2 | LEU | A | 152 | 36.808 | 2.504 | 84.016 | 0.00 | 0.00 | 6 |
| ATOM | 1115 | C | LEU | A | 152 | 39.806 | 5.687 | 81.676 | 0.00 | 0.00 | 6 |
| ATOM | 1116 | O | LEU | A | 152 | 40.744 | 5.115 | 82.217 | 0.00 | 0.00 | 8 |
| ATOM | 1117 | N | HIS | A | 153 | 39.892 | 6.220 | 80.457 | 0.00 | 0.00 | 7 |
| ATOM | 1118 | CA | HIS | A | 153 | 41.153 | 6.394 | 79.745 | 0.00 | 0.00 | 6 |
| ATOM | 1119 | CB | HIS | A | 153 | 40.908 | 7.053 | 78.387 | 0.00 | 0.00 | 6 |
| ATOM | 1120 | CG | HIS | A | 153 | 42.150 | 7.369 | 77.594 | 0.00 | 0.00 | 6 |
| ATOM | 1121 | ND1 | HIS | A | 153 | 42.283 | 7.042 | 76.256 | 0.00 | 0.00 | 7 |
| ATOM | 1122 | CE1 | HIS | A | 153 | 43.451 | 7.466 | 75.806 | 0.00 | 0.00 | 6 |
| ATOM | 1123 | NE2 | HIS | A | 153 | 44.081 | 8.066 | 76.801 | 0.00 | 0.00 | 7 |
| ATOM | 1124 | CD2 | HIS | A | 153 | 43.284 | 8.033 | 77.925 | 0.00 | 0.00 | 6 |
| ATOM | 1125 | C | HIS | A | 153 | 41.977 | 7.292 | 80.613 | 0.00 | 0.00 | 6 |
| ATOM | 1126 | O | HIS | A | 153 | 43.101 | 6.963 | 80.918 | 0.00 | 0.00 | 8 |
| ATOM | 1127 | N | TYR | A | 154 | 41.401 | 8.411 | 81.028 | 0.00 | 0.00 | 7 |
| ATOM | 1128 | CA | TYR | A | 154 | 42.067 | 9.321 | 81.940 | 0.00 | 0.00 | 6 |
| ATOM | 1129 | CB | TYR | A | 154 | 41.334 | 10.650 | 81.994 | 0.00 | 0.00 | 6 |
| ATOM | 1130 | CG | TYR | A | 154 | 41.186 | 11.202 | 80.629 | 0.00 | 0.00 | 6 |
| ATOM | 1131 | CD1 | TYR | A | 154 | 40.326 | 10.599 | 79.737 | 0.00 | 0.00 | 6 |
| ATOM | 1132 | CE1 | TYR | A | 154 | 40.188 | 11.062 | 78.452 | 0.00 | 0.00 | 6 |
| ATOM | 1133 | CZ | TYR | A | 154 | 40.918 | 12.160 | 78.024 | 0.00 | 0.00 | 6 |
| ATOM | 1134 | OH | TYR | A | 154 | 40.741 | 12.592 | 76.708 | 0.00 | 0.00 | 8 |
| ATOM | 1135 | CE2 | TYR | A | 154 | 41.806 | 12.783 | 78.909 | 0.00 | 0.00 | 6 |
| ATOM | 1136 | CD2 | TYR | A | 154 | 41.937 | 12.290 | 80.203 | 0.00 | 0.00 | 6 |
| ATOM | 1137 | C | TYR | A | 154 | 42.191 | 8.709 | 83.315 | 0.00 | 0.00 | 6 |
| ATOM | 1138 | O | TYR | A | 154 | 43.237 | 8.831 | 83.953 | 0.00 | 0.00 | 8 |
| ATOM | 1139 | N | GLN | A | 155 | 41.149 | 8.018 | 83.768 | 0.00 | 0.00 | 7 |
| ATOM | 1140 | CA | GLN | A | 155 | 41.222 | 7.352 | 85.072 | 0.00 | 0.00 | 6 |
| ATOM | 1141 | CB | GLN | A | 155 | 39.910 | 6.623 | 85.396 | 0.00 | 0.00 | 6 |
| ATOM | 1142 | CG | GLN | A | 155 | 39.645 | 6.462 | 86.903 | 0.00 | 0.00 | 6 |
| ATOM | 1143 | CD | GLN | A | 155 | 38.444 | 5.574 | 87.232 | 0.00 | 0.00 | 6 |
| ATOM | 1144 | OE1 | GLN | A | 155 | 38.253 | 4.505 | 86.638 | 0.00 | 0.00 | 8 |
| ATOM | 1145 | NE2 | GLN | A | 155 | 37.644 | 6.008 | 88.210 | 0.00 | 0.00 | 7 |
| ATOM | 1146 | C | GLN | A | 155 | 42.437 | 6.406 | 85.134 | 0.00 | 0.00 | 6 |
| ATOM | 1147 | O | GLN | A | 155 | 42.830 | 5.935 | 86.203 | 0.00 | 0.00 | 8 |
| ATOM | 1148 | N | SER | A | 156 | 43.030 | 6.164 | 83.970 | 0.00 | 0.00 | 7 |
| ATOM | 1149 | CA | SER | A | 156 | 44.204 | 5.322 | 83.838 | 0.00 | 0.00 | 6 |
| ATOM | 1150 | CB | SER | A | 156 | 43.815 | 4.007 | 83.179 | 0.00 | 0.00 | 6 |
| ATOM | 1151 | OG | SER | A | 156 | 42.786 | 3.354 | 83.888 | 0.00 | 0.00 | 8 |
| ATOM | 1152 | C | SER | A | 156 | 45.288 | 6.033 | 83.022 | 0.00 | 0.00 | 6 |
| ATOM | 1153 | O | SER | A | 156 | 46.391 | 5.520 | 82.822 | 0.00 | 0.00 | 8 |
| ATOM | 1154 | N | ASP | A | 157 | 44.955 | 7.220 | 82.541 | 0.00 | 0.00 | 7 |
| ATOM | 1155 | CA | ASP | A | 157 | 45.923 | 8.076 | 81.895 | 0.00 | 0.00 | 6 |
| ATOM | 1156 | CB | ASP | A | 157 | 45.321 | 8.735 | 80.665 | 0.00 | 0.00 | 6 |
| ATOM | 1157 | CG | ASP | A | 157 | 46.282 | 8.800 | 79.518 | 0.00 | 0.00 | 6 |
| ATOM | 1158 | OD1 | ASP | A | 157 | 47.308 | 8.098 | 79.547 | 0.00 | 0.00 | 8 |
| ATOM | 1159 | OD2 | ASP | A | 157 | 46.002 | 9.554 | 78.572 | 0.00 | 0.00 | 8 |
| ATOM | 1160 | C | ASP | A | 157 | 46.320 | 9.127 | 82.902 | 0.00 | 0.00 | 6 |
| ATOM | 1161 | O | ASP | A | 157 | 47.178 | 9.953 | 82.628 | 0.00 | 0.00 | 8 |
| ATOM | 1162 | N | VAL | A | 158 | 45.640 | 9.118 | 84.046 | 0.00 | 0.00 | 7 |
| ATOM | 1163 | CA | VAL | A | 158 | 46.128 | 9.754 | 85.259 | 0.00 | 0.00 | 6 |
| ATOM | 1164 | CB | VAL | A | 158 | 45.183 | 10.845 | 85.820 | 0.00 | 0.00 | 6 |
| ATOM | 1165 | CG1 | VAL | A | 158 | 45.944 | 11.738 | 86.779 | 0.00 | 0.00 | 6 |
| ATOM | 1166 | CG2 | VAL | A | 158 | 44.607 | 11.700 | 84.708 | 0.00 | 0.00 | 6 |
| ATOM | 1167 | C | VAL | A | 158 | 46.317 | 8.605 | 86.240 | 0.00 | 0.00 | 6 |
| ATOM | 1168 | O | VAL | A | 158 | 45.695 | 8.541 | 87.300 | 0.00 | 0.00 | 8 |
| ATOM | 1169 | N | MET | A | 159 | 47.169 | 7.673 | 85.828 | 0.00 | 0.00 | 7 |
| ATOM | 1170 | CA | MET | A | 159 | 47.547 | 6.533 | 86.633 | 0.00 | 0.00 | 6 |
| ATOM | 1171 | CB | MET | A | 159 | 47.049 | 5.252 | 85.989 | 0.00 | 0.00 | 6 |
| ATOM | 1172 | CG | MET | A | 159 | 46.414 | 4.293 | 86.949 | 0.00 | 0.00 | 6 |
| ATOM | 1173 | SD | MET | A | 159 | 45.092 | 5.085 | 87.852 | 0.00 | 0.00 | 16 |
| ATOM | 1174 | CE | MET | A | 159 | 44.122 | 3.648 | 88.319 | 0.00 | 0.00 | 6 |
| ATOM | 1175 | C | MET | A | 159 | 49.059 | 6.506 | 86.759 | 0.00 | 0.00 | 6 |
| ATOM | 1176 | O | MET | A | 159 | 49.713 | 5.504 | 86.462 | 0.00 | 0.00 | 8 |
| ATOM | 1177 | N | MET | A | 160 | 49.608 | 7.641 | 87.171 | 0.00 | 0.00 | 7 |
| ATOM | 1178 | CA | MET | A | 160 | 50.978 | 7.710 | 87.622 | 0.00 | 0.00 | 6 |
| ATOM | 1179 | CB | MET | A | 160 | 51.460 | 9.157 | 87.659 | 0.00 | 0.00 | 6 |
| ATOM | 1180 | CG | MET | A | 160 | 51.919 | 9.705 | 86.325 | 0.00 | 0.00 | 6 |
| ATOM | 1181 | SD | MET | A | 160 | 50.578 | 10.044 | 85.177 | 0.00 | 0.00 | 16 |
| ATOM | 1182 | CE | MET | A | 160 | 51.479 | 10.646 | 83.740 | 0.00 | 0.00 | 6 |
| ATOM | 1183 | C | MET | A | 160 | 50.988 | 7.123 | 89.018 | 0.00 | 0.00 | 6 |
| ATOM | 1184 | O | MET | A | 160 | 50.970 | 7.857 | 90.006 | 0.00 | 0.00 | 0 |
| ATOM | 1185 | N | ASN | A | 161 | 50.966 | 5.793 | 89.086 | 0.00 | 0.00 | 7 |
| ATOM | 1186 | CA | ASN | A | 161 | 51.033 | 5.060 | 90.357 | 0.00 | 0.00 | 6 |
| ATOM | 1187 | CB | ASN | A | 161 | 49.986 | 3.940 | 90.406 | 0.00 | 0.00 | 6 |
| ATOM | 1188 | CG | ASN | A | 161 | 48.571 | 4.461 | 90.649 | 0.00 | 0.00 | 6 |
| ATOM | 1189 | OD1 | ASN | A | 161 | 48.323 | 5.234 | 91.578 | 0.00 | 0.00 | 8 |
| ATOM | 1190 | ND2 | ASN | A | 161 | 47.631 | 4.010 | 89.826 | 0.00 | 0.00 | 7 |
| ATOM | 1191 | C | ASN | A | 161 | 52.440 | 4.510 | 90.605 | 0.00 | 0.00 | 6 |
| ATOM | 1192 | O | ASN | A | 161 | 52.739 | 3.940 | 91.666 | 0.00 | 0.00 | 8 |
| ATOM | 1193 | N | GLY | A | 162 | 53.290 | 4.672 | 89.597 | 0.00 | 0.00 | 7 |
| ATOM | 1194 | CA | GLY | A | 162 | 54.722 | 4.552 | 89.772 | 0.00 | 0.00 | 6 |
| ATOM | 1195 | C | GLY | A | 162 | 55.231 | 5.937 | 90.112 | 0.00 | 0.00 | 6 |
| ATOM | 1196 | O | GLY | A | 162 | 55.819 | 6.144 | 91.178 | 0.00 | 0.00 | 8 |
| ATOM | 1197 | N | ALA | A | 163 | 54.973 | 6.887 | 89.210 | 0.00 | 0.00 | 7 |
| ATOM | 1198 | CA | ALA | A | 163 | 55.383 | 8.281 | 89.391 | 0.00 | 0.00 | 6 |
| ATOM | 1199 | CB | ALA | A | 163 | 55.163 | 9.076 | 88.108 | 0.00 | 0.00 | 6 |
| ATOM | 1200 | C | ALA | A | 163 | 54.661 | 8.935 | 90.569 | 0.00 | 0.00 | 6 |
| ATOM | 1201 | O | ALA | A | 163 | 53.437 | 8.870 | 90.667 | 0.00 | 0.00 | 8 |
| ATOM | 1202 | N | ILE | A | 164 | 55.440 | 9.558 | 91.457 | 0.00 | 0.00 | 7 |
| ATOM | 1203 | CA | ILE | A | 164 | 54.948 | 10.189 | 92.695 | 0.00 | 0.00 | 6 |
| ATOM | 1204 | CB | ILE | A | 164 | 53.957 | 11.371 | 92.418 | 0.00 | 0.00 | 6 |
| ATOM | 1205 | CG1 | ILE | A | 164 | 54.440 | 12.204 | 91.224 | 0.00 | 0.00 | 6 |
| ATOM | 1206 | CD1 | ILE | A | 164 | 53.343 | 12.651 | 90.284 | 0.00 | 0.00 | 6 |
| ATOM | 1207 | CG2 | ILE | A | 164 | 53.815 | 12.279 | 93.646 | 0.00 | 0.00 | 6 |
| ATOM | 1208 | C | ILE | A | 164 | 54.379 | 9.133 | 93.656 | 0.00 | 0.00 | 6 |
| ATOM | 1209 | O | ILE | A | 164 | 53.627 | 9.445 | 94.580 | 0.00 | 0.00 | 8 |
| ATOM | 1210 | N | LEU | A | 165 | 54.763 | 7.881 | 93.421 | 0.00 | 0.00 | 7 |
| ATOM | 1211 | CA | LEU | A | 165 | 54.439 | 6.774 | 94.306 | 0.00 | 0.00 | 6 |
| ATOM | 1212 | CB | LEU | A | 165 | 53.073 | 6.180 | 93.957 | 0.00 | 0.00 | 6 |
| ATOM | 1213 | CG | LEU | A | 165 | 52.211 | 5.488 | 95.028 | 0.00 | 0.00 | 6 |
| ATOM | 1214 | CD1 | LEU | A | 165 | 52.703 | 4.081 | 95.369 | 0.00 | 0.00 | 6 |
| ATOM | 1215 | CD2 | LEU | A | 165 | 52.038 | 6.344 | 96.291 | 0.00 | 0.00 | 6 |
| ATOM | 1216 | C | LEU | A | 165 | 55.547 | 5.735 | 94.185 | 0.00 | 0.00 | 6 |
| ATOM | 1217 | O | LEU | A | 165 | 55.347 | 4.640 | 93.657 | 0.00 | 0.00 | 8 |
| ATOM | 1218 | N | LEU | A | 166 | 56.724 | 6.112 | 94.671 | 0.00 | 0.00 | 7 |
| ATOM | 1219 | CA | LEU | A | 166 | 57.923 | 5.286 | 94.580 | 0.00 | 0.00 | 6 |
| ATOM | 1220 | CB | LEU | A | 166 | 59.157 | 6.157 | 94.294 | 0.00 | 0.00 | 6 |
| ATOM | 1221 | CG | LEU | A | 166 | 59.217 | 7.612 | 94.786 | 0.00 | 0.00 | 6 |
| ATOM | 1222 | CD1 | LEU | A | 166 | 59.384 | 7.729 | 96.297 | 0.00 | 0.00 | 6 |
| ATOM | 1223 | CD2 | LEU | A | 166 | 60.334 | 8.351 | 94.084 | 0.00 | 0.00 | 6 |
| ATOM | 1224 | C | LEU | A | 166 | 58.153 | 4.445 | 95.830 | 0.00 | 0.00 | 6 |
| ATOM | 1225 | O | LEU | A | 166 | 57.819 | 4.855 | 96.942 | 0.00 | 0.00 | 8 |
| ATOM | 1226 | N | ALA | A | 167 | 58.718 | 3.259 | 95.628 | 0.00 | 0.00 | 7 |
| ATOM | 1227 | CA | ALA | A | 167 | 59.182 | 2.429 | 96.728 | 0.00 | 0.00 | 6 |
| ATOM | 1228 | CB | ALA | A | 167 | 58.924 | 0.957 | 96.434 | 0.00 | 0.00 | 6 |
| ATOM | 1229 | C | ALA | A | 167 | 60.672 | 2.704 | 96.958 | 0.00 | 0.00 | 6 |
| ATOM | 1230 | O | ALA | A | 167 | 61.512 | 1.802 | 96.896 | 0.00 | 0.00 | 8 |
| ATOM | 1231 | N | LEU | A | 168 | 60.977 | 3.973 | 97.223 | 0.00 | 0.00 | 7 |
| ATOM | 1232 | CA | LEU | A | 168 | 62.344 | 4.451 | 97.416 | 0.00 | 0.00 | 6 |
| ATOM | 1233 | CB | LEU | A | 168 | 62.429 | 5.940 | 97.045 | 0.00 | 0.00 | 6 |
| ATOM | 1234 | CG | LEU | A | 168 | 63.530 | 6.857 | 97.590 | 0.00 | 0.00 | 6 |
| ATOM | 1235 | CD1 | LEU | A | 168 | 64.880 | 6.564 | 96.952 | 0.00 | 0.00 | 6 |
| ATOM | 1236 | CD2 | LEU | A | 168 | 63.142 | 8.311 | 97.378 | 0.00 | 0.00 | 6 |
| ATOM | 1237 | C | LEU | A | 168 | 62.853 | 4.210 | 98.839 | 0.00 | 0.00 | 6 |
| ATOM | 1238 | O | LEU | A | 168 | 62.356 | 4.799 | 99.802 | 0.00 | 0.00 | 8 |
| ATOM | 1239 | N | GLY | A | 169 | 63.845 | 3.332 | 98.951 | 0.00 | 0.00 | 7 |
| ATOM | 1240 | CA | GLY | A | 169 | 64.530 | 3.075 | 100.214 | 0.00 | 0.00 | 6 |
| ATOM | 1241 | C | GLY | A | 169 | 63.676 | 2.476 | 101.315 | 0.00 | 0.00 | 6 |
| ATOM | 1242 | O | GLY | A | 169 | 63.697 | 2.959 | 102.448 | 0.00 | 0.00 | 8 |
| ATOM | 1243 | N | LEU | A | 170 | 62.927 | 1.426 | 100.983 | 0.00 | 0.00 | 7 |
| ATOM | 1244 | CA | LEU | A | 170 | 62.119 | 0.706 | 101.972 | 0.00 | 0.00 | 6 |
| ATOM | 1245 | CB | LEU | A | 170 | 60.668 | 1.193 | 101.966 | 0.00 | 0.00 | 6 |
| ATOM | 1246 | CG | LEU | A | 170 | 60.259 | 2.182 | 103.055 | 0.00 | 0.00 | 6 |
| ATOM | 1247 | CD1 | LEU | A | 170 | 60.460 | 3.619 | 102.599 | 0.00 | 0.00 | 6 |
| ATOM | 1248 | CD2 | LEU | A | 170 | 58.813 | 1.929 | 103.414 | 0.00 | 0.00 | 6 |
| ATOM | 1249 | C | LEU | A | 170 | 62.166 | −0.817 | 101.839 | 0.00 | 0.00 | 6 |
| ATOM | 1250 | O | LEU | A | 170 | 62.471 | −1.512 | 102.810 | 0.00 | 0.00 | 8 |
| ATOM | 1251 | N | SER | A | 171 | 61.852 | −1.335 | 100.651 | 0.00 | 0.00 | 7 |
| ATOM | 1252 | CA | SER | A | 171 | 61.855 | −2.786 | 100.423 | 0.00 | 0.00 | 6 |
| ATOM | 1253 | CB | SER | A | 171 | 60.523 | −3.422 | 100.858 | 0.00 | 0.00 | 6 |
| ATOM | 1254 | OG | SER | A | 171 | 60.404 | −3.470 | 102.273 | 0.00 | 0.00 | 8 |
| ATOM | 1255 | C | SER | A | 171 | 62.221 | −3.198 | 98.989 | 0.00 | 0.00 | 6 |
| ATOM | 1256 | O | SER | A | 171 | 63.142 | −3.995 | 98.793 | 0.00 | 0.00 | 8 |
| ATOM | 1257 | N | TRP | A | 172 | 61.507 | −2.664 | 97.998 | 0.00 | 0.00 | 7 |
| ATOM | 1258 | CA | TRP | A | 172 | 61.760 | −3.006 | 96.594 | 0.00 | 0.00 | 6 |
| ATOM | 1259 | CB | TRP | A | 172 | 60.454 | −3.015 | 95.780 | 0.00 | 0.00 | 6 |
| ATOM | 1260 | CG | TRP | A | 172 | 59.527 | −4.170 | 96.107 | 0.00 | 0.00 | 6 |
| ATOM | 1261 | CD1 | TRP | A | 172 | 59.648 | −5.467 | 95.689 | 0.00 | 0.00 | 6 |
| ATOM | 1262 | NE1 | TRP | A | 172 | 58.617 | −6.227 | 96.186 | 0.00 | 0.00 | 7 |
| ATOM | 1263 | CE2 | TRP | A | 172 | 57.801 | −5.427 | 96.941 | 0.00 | 0.00 | 6 |
| ATOM | 1264 | CD2 | TRP | A | 172 | 58.341 | −4.121 | 96.912 | 0.00 | 0.00 | 6 |
| ATOM | 1265 | CE3 | TRP | A | 172 | 57.686 | −3.102 | 97.613 | 0.00 | 0.00 | 6 |
| ATOM | 1266 | CZ3 | TRP | A | 172 | 56.528 | −3.415 | 98.313 | 0.00 | 0.00 | 6 |
| ATOM | 1267 | CH2 | TRP | A | 172 | 56.016 | −4.725 | 98.322 | 0.00 | 0.00 | 6 |
| ATOM | 1268 | CZ2 | TRP | A | 172 | 56.637 | −5.741 | 97.644 | 0.00 | 0.00 | 6 |
| ATOM | 1269 | C | TRP | A | 172 | 62.806 | −2.073 | 95.969 | 0.00 | 0.00 | 6 |
| ATOM | 1270 | O | TRP | A | 172 | 62.597 | −0.858 | 95.889 | 0.00 | 0.00 | 8 |
| ATOM | 1271 | N | TYR | A | 173 | 63.929 | −2.656 | 95.542 | 0.00 | 0.00 | 7 |
| ATOM | 1272 | CA | TYR | A | 173 | 65.061 | −1.909 | 94.977 | 0.00 | 0.00 | 6 |
| ATOM | 1273 | CB | TYR | A | 173 | 66.269 | −2.838 | 94.750 | 0.00 | 0.00 | 6 |
| ATOM | 1274 | CG | TYR | A | 173 | 67.611 | −2.135 | 94.600 | 0.00 | 0.00 | 6 |
| ATOM | 1275 | CD1 | TYR | A | 173 | 67.875 | −1.305 | 93.507 | 0.00 | 0.00 | 6 |
| ATOM | 1276 | CE1 | TYR | A | 173 | 69.102 | −0.662 | 93.368 | 0.00 | 0.00 | 6 |
| ATOM | 1277 | CZ | TYR | A | 173 | 70.088 | −0.856 | 94.319 | 0.00 | 0.00 | 6 |
| ATOM | 1278 | OH | TYR | A | 173 | 71.302 | −0.223 | 94.177 | 0.00 | 0.00 | 8 |
| ATOM | 1279 | CE2 | TYR | A | 173 | 69.857 | −1.681 | 95.410 | 0.00 | 0.00 | 6 |
| ATOM | 1280 | CD2 | TYR | A | 173 | 68.623 | −2.318 | 95.543 | 0.00 | 0.00 | 6 |
| ATOM | 1281 | C | TYR | A | 173 | 64.667 | −1.223 | 93.670 | 0.00 | 0.00 | 6 |
| ATOM | 1282 | O | TYR | A | 173 | 64.628 | 0.006 | 93.587 | 0.00 | 0.00 | 8 |
| ATOM | 1283 | N | GLY | A | 174 | 64.379 | −2.031 | 92.655 | 0.00 | 0.00 | 7 |
| ATOM | 1284 | CA | GLY | A | 174 | 63.960 | −1.526 | 91.355 | 0.00 | 0.00 | 6 |
| ATOM | 1285 | C | GLY | A | 174 | 62.658 | −2.148 | 90.894 | 0.00 | 0.00 | 6 |
| ATOM | 1286 | O | GLY | A | 174 | 62.234 | −1.944 | 89.753 | 0.00 | 0.00 | 8 |
| ATOM | 1287 | N | TRP | A | 175 | 62.025 | −2.907 | 91.788 | 0.00 | 0.00 | 7 |
| ATOM | 1288 | CA | TRP | A | 175 | 60.739 | −3.542 | 91.509 | 0.00 | 0.00 | 6 |
| ATOM | 1289 | CB | TRP | A | 175 | 60.609 | −4.865 | 92.291 | 0.00 | 0.00 | 6 |
| ATOM | 1290 | CG | TRP | A | 175 | 61.520 | −5.985 | 91.806 | 0.00 | 0.00 | 6 |
| ATOM | 1291 | CD1 | TRP | A | 175 | 61.453 | −6.636 | 90.605 | 0.00 | 0.00 | 6 |
| ATOM | 1292 | NE1 | TRP | A | 175 | 62.436 | −7.594 | 90.525 | 0.00 | 0.00 | 7 |
| ATOM | 1293 | CE2 | TRP | A | 175 | 63.159 | −7.588 | 91.687 | 0.00 | 0.00 | 6 |
| ATOM | 1294 | CD2 | TRP | A | 175 | 62.610 | −6.589 | 92.523 | 0.00 | 0.00 | 6 |
| ATOM | 1295 | CE3 | TRP | A | 175 | 63.179 | −6.378 | 93.787 | 0.00 | 0.00 | 6 |
| ATOM | 1296 | CZ3 | TRP | A | 175 | 64.265 | −7.163 | 94.171 | 0.00 | 0.00 | 6 |
| ATOM | 1297 | CH2 | TRP | A | 175 | 64.786 | −8.148 | 93.315 | 0.00 | 0.00 | 6 |
| ATOM | 1298 | CZ2 | TRP | A | 175 | 64.249 | −8.375 | 92.073 | 0.00 | 0.00 | 6 |
| ATOM | 1299 | C | TRP | A | 175 | 59.557 | −2.590 | 91.795 | 0.00 | 0.00 | 6 |
| ATOM | 1300 | O | TRP | A | 175 | 58.476 | −3.030 | 92.196 | 0.00 | 0.00 | 8 |
| ATOM | 1301 | N | HIS | A | 176 | 59.776 | −1.290 | 91.570 | 0.00 | 0.00 | 7 |
| ATOM | 1302 | CA | HIS | A | 176 | 58.765 | −0.245 | 91.807 | 0.00 | 0.00 | 6 |
| ATOM | 1303 | CB | HIS | A | 176 | 59.426 | 1.138 | 91.922 | 0.00 | 0.00 | 6 |
| ATOM | 1304 | CG | HIS | A | 176 | 60.024 | 1.638 | 90.640 | 0.00 | 0.00 | 6 |
| ATOM | 1305 | ND1 | HIS | A | 176 | 61.344 | 1.430 | 90.303 | 0.00 | 0.00 | 7 |
| ATOM | 1306 | CE1 | HIS | A | 176 | 61.587 | 1.979 | 89.126 | 0.00 | 0.00 | 6 |
| ATOM | 1307 | NE2 | HIS | A | 176 | 60.473 | 2.538 | 88.688 | 0.00 | 0.00 | 7 |
| ATOM | 1308 | CD2 | HIS | A | 176 | 59.481 | 2.340 | 89.617 | 0.00 | 0.00 | 6 |
| ATOM | 1309 | C | HIS | A | 176 | 57.676 | −0.218 | 90.734 | 0.00 | 0.00 | 6 |
| ATOM | 1310 | O | HIS | A | 176 | 56.547 | 0.210 | 90.988 | 0.00 | 0.00 | 8 |
| ATOM | 1311 | N | ARG | A | 177 | 58.032 | −0.661 | 89.533 | 0.00 | 0.00 | 7 |
| ATOM | 1312 | CA | ARG | A | 177 | 57.099 | −0.705 | 88.421 | 0.00 | 0.00 | 6 |
| ATOM | 1313 | CB | ARG | A | 177 | 57.612 | 0.139 | 87.245 | 0.00 | 0.00 | 6 |
| ATOM | 1314 | CG | ARG | A | 177 | 58.918 | −0.317 | 86.597 | 0.00 | 0.00 | 6 |
| ATOM | 1315 | CD | ARG | A | 177 | 59.595 | 0.830 | 85.844 | 0.00 | 0.00 | 6 |
| ATOM | 1316 | NE | ARG | A | 177 | 58.640 | 1.664 | 85.113 | 0.00 | 0.00 | 7 |
| ATOM | 1317 | CZ | ARG | A | 177 | 58.894 | 2.886 | 84.652 | 0.00 | 0.00 | 6 |
| ATOM | 1318 | NH1 | ARG | A | 177 | 60.084 | 3.446 | 84.834 | 0.00 | 0.00 | 7 |
| ATOM | 1319 | NH2 | ARG | A | 177 | 57.948 | 3.554 | 84.006 | 0.00 | 0.00 | 7 |
| ATOM | 1320 | C | ARG | A | 177 | 56.775 | −2.140 | 88.006 | 0.00 | 0.00 | 6 |
| ATOM | 1321 | O | ARG | A | 177 | 55.778 | −2.387 | 87.328 | 0.00 | 0.00 | 8 |
| ATOM | 1322 | N | ALA | A | 178 | 57.615 | −3.080 | 88.442 | 0.00 | 0.00 | 7 |
| ATOM | 1323 | CA | ALA | A | 178 | 57.397 | −4.512 | 88.221 | 0.00 | 0.00 | 6 |
| ATOM | 1324 | CB | ALA | A | 178 | 58.542 | −5.316 | 88.804 | 0.00 | 0.00 | 6 |
| ATOM | 1325 | C | ALA | A | 178 | 56.075 | −4.949 | 88.833 | 0.00 | 0.00 | 6 |
| ATOM | 1326 | O | ALA | A | 178 | 55.507 | −5.970 | 88.453 | 0.00 | 0.00 | 8 |
| ATOM | 1327 | N | ASP | A | 179 | 55.616 | −4.169 | 89.803 | 0.00 | 0.00 | 7 |
| ATOM | 1328 | CA | ASP | A | 179 | 54.268 | −4.256 | 90.331 | 0.00 | 0.00 | 6 |
| ATOM | 1329 | CB | ASP | A | 179 | 54.234 | −5.109 | 91.599 | 0.00 | 0.00 | 6 |
| ATOM | 1330 | CG | ASP | A | 179 | 52.909 | −5.822 | 91.789 | 0.00 | 0.00 | 6 |
| ATOM | 1331 | OD1 | ASP | A | 179 | 52.607 | −6.735 | 90.992 | 0.00 | 0.00 | 8 |
| ATOM | 1332 | OD2 | ASP | A | 179 | 52.177 | −5.481 | 92.743 | 0.00 | 0.00 | 8 |
| ATOM | 1333 | C | ASP | A | 179 | 53.858 | −2.822 | 90.622 | 0.00 | 0.00 | 6 |
| ATOM | 1334 | O | ASP | A | 179 | 54.648 | −1.901 | 90.399 | 0.00 | 0.00 | 8 |
| ATOM | 1335 | N | ALA | A | 180 | 52.635 | −2.627 | 91.114 | 0.00 | 0.00 | 7 |
| ATOM | 1336 | CA | ALA | A | 180 | 52.057 | −1.289 | 91.288 | 0.00 | 0.00 | 6 |
| ATOM | 1337 | CB | ALA | A | 180 | 52.582 | −0.618 | 92.562 | 0.00 | 0.00 | 6 |
| ATOM | 1338 | C | ALA | A | 180 | 52.304 | −0.415 | 90.054 | 0.00 | 0.00 | 6 |
| ATOM | 1339 | O | ALA | A | 180 | 52.390 | 0.813 | 90.152 | 0.00 | 0.00 | 8 |
| ATOM | 1340 | N | LEU | A | 181 | 52.435 | −1.082 | 88.903 | 0.00 | 0.00 | 7 |
| ATOM | 1341 | CA | LEU | A | 181 | 52.558 | −0.461 | 87.579 | 0.00 | 0.00 | 6 |
| ATOM | 1342 | CB | LEU | A | 181 | 53.892 | 0.281 | 87.436 | 0.00 | 0.00 | 6 |
| ATOM | 1343 | CG | LEU | A | 181 | 54.031 | 1.366 | 86.357 | 0.00 | 0.00 | 6 |
| ATOM | 1344 | CD1 | LEU | A | 181 | 54.843 | 2.549 | 86.872 | 0.00 | 0.00 | 6 |
| ATOM | 1345 | CD2 | LEU | A | 181 | 54.629 | 0.830 | 85.055 | 0.00 | 0.00 | 6 |
| ATOM | 1346 | C | LEU | A | 181 | 52.400 | −1.527 | 86.484 | 0.00 | 0.00 | 6 |
| ATOM | 1347 | O | LEU | A | 181 | 52.191 | −1.211 | 85.310 | 0.00 | 0.00 | 8 |
| ATOM | 1348 | N | PHE | A | 182 | 52.494 | −2.791 | 86.884 | 0.00 | 0.00 | 7 |
| ATOM | 1349 | CA | PHE | A | 182 | 52.302 | −3.921 | 85.977 | 0.00 | 0.00 | 6 |
| ATOM | 1350 | CB | PHE | A | 182 | 53.214 | −5.085 | 86.397 | 0.00 | 0.00 | 6 |
| ATOM | 1351 | CG | PHE | A | 182 | 52.556 | −6.441 | 86.374 | 0.00 | 0.00 | 6 |
| ATOM | 1352 | CD1 | PHE | A | 182 | 52.411 | −7.147 | 85.183 | 0.00 | 0.00 | 6 |
| ATOM | 1353 | CE1 | PHE | A | 182 | 51.813 | −8.406 | 85.167 | 0.00 | 0.00 | 6 |
| ATOM | 1354 | CZ | PHE | A | 182 | 51.367 | −8.977 | 86.354 | 0.00 | 0.00 | 6 |
| ATOM | 1355 | CE2 | PHE | A | 182 | 51.515 | −8.288 | 87.552 | 0.00 | 0.00 | 6 |
| ATOM | 1356 | CD2 | PHE | A | 182 | 52.113 | −7.029 | 87.557 | 0.00 | 0.00 | 6 |
| ATOM | 1357 | C | PHE | A | 182 | 50.828 | −4.331 | 85.873 | 0.00 | 0.00 | 6 |
| ATOM | 1358 | O | PHE | A | 182 | 50.323 | −4.573 | 84.776 | 0.00 | 0.00 | 8 |
| ATOM | 1359 | N | ALA | A | 183 | 50.149 | −4.404 | 87.017 | 0.00 | 0.00 | 7 |
| ATOM | 1360 | CA | ALA | A | 183 | 48.711 | −4.672 | 87.060 | 0.00 | 0.00 | 6 |
| ATOM | 1361 | CB | ALA | A | 183 | 48.289 | −5.135 | 88.452 | 0.00 | 0.00 | 6 |
| ATOM | 1362 | C | ALA | A | 183 | 47.934 | −3.430 | 86.651 | 0.00 | 0.00 | 6 |
| ATOM | 1363 | O | ALA | A | 183 | 46.736 | −3.499 | 86.390 | 0.00 | 0.00 | 8 |
| ATOM | 1364 | N | LEU | A | 184 | 48.639 | −2.301 | 86.595 | 0.00 | 0.00 | 7 |
| ATOM | 1365 | CA | LEU | A | 184 | 48.087 | −1.018 | 86.180 | 0.00 | 0.00 | 6 |
| ATOM | 1366 | CB | LEU | A | 184 | 49.217 | −0.037 | 85.850 | 0.00 | 0.00 | 6 |
| ATOM | 1367 | CG | LEU | A | 184 | 48.891 | 1.449 | 85.674 | 0.00 | 0.00 | 6 |
| ATOM | 1368 | CD1 | LEU | A | 184 | 48.965 | 2.158 | 87.013 | 0.00 | 0.00 | 6 |
| ATOM | 1369 | CD2 | LEU | A | 184 | 49.835 | 2.105 | 84.664 | 0.00 | 0.00 | 6 |
| ATOM | 1370 | C | LEU | A | 184 | 47.178 | −1.167 | 84.971 | 0.00 | 0.00 | 6 |
| ATOM | 1371 | O | LEU | A | 184 | 46.117 | −0.570 | 84.921 | 0.00 | 0.00 | 8 |
| ATOM | 1372 | N | GLY | A | 185 | 47.593 | −1.961 | 83.995 | 0.00 | 0.00 | 7 |
| ATOM | 1373 | CA | GLY | A | 185 | 46.781 | −2.146 | 82.809 | 0.00 | 0.00 | 6 |
| ATOM | 1374 | C | GLY | A | 185 | 45.888 | −3.348 | 82.945 | 0.00 | 0.00 | 6 |
| ATOM | 1375 | O | GLY | A | 185 | 44.674 | −3.264 | 82.763 | 0.00 | 0.00 | 8 |
| ATOM | 1376 | N | ILE | A | 186 | 46.515 | −4.461 | 83.301 | 0.00 | 0.00 | 7 |
| ATOM | 1377 | CA | ILE | A | 186 | 45.903 | −5.775 | 83.221 | 0.00 | 0.00 | 6 |
| ATOM | 1378 | CB | ILE | A | 186 | 46.774 | −6.846 | 83.953 | 0.00 | 0.00 | 6 |
| ATOM | 1379 | CG1 | ILE | A | 186 | 46.774 | −8.171 | 83.178 | 0.00 | 0.00 | 6 |
| ATOM | 1380 | CD1 | ILE | A | 186 | 48.115 | −8.908 | 83.181 | 0.00 | 0.00 | 6 |
| ATOM | 1381 | CG2 | ILE | A | 186 | 46.364 | −7.013 | 85.423 | 0.00 | 0.00 | 6 |
| ATOM | 1382 | C | ILE | A | 186 | 44.441 | −5.766 | 83.667 | 0.00 | 0.00 | 6 |
| ATOM | 1383 | O | ILE | A | 186 | 43.568 | −6.236 | 82.944 | 0.00 | 0.00 | 8 |
| ATOM | 1384 | N | GLY | A | 187 | 44.177 | −5.179 | 84.828 | 0.00 | 0.00 | 7 |
| ATOM | 1385 | CA | GLY | A | 187 | 42.829 | −5.170 | 85.404 | 0.00 | 0.00 | 6 |
| ATOM | 1386 | C | GLY | A | 187 | 42.153 | −3.805 | 85.477 | 0.00 | 0.00 | 6 |
| ATOM | 1387 | O | GLY | A | 187 | 41.204 | −3.606 | 86.263 | 0.00 | 0.00 | 8 |
| ATOM | 1388 | N | ILE | A | 188 | 42.654 | −2.860 | 84.678 | 0.00 | 0.00 | 7 |
| ATOM | 1389 | CA | ILE | A | 188 | 42.054 | −1.529 | 84.568 | 0.00 | 0.00 | 6 |
| ATOM | 1390 | CB | ILE | A | 188 | 42.604 | −0.503 | 85.653 | 0.00 | 0.00 | 6 |
| ATOM | 1391 | CG1 | ILE | A | 188 | 41.465 | 0.209 | 86.421 | 0.00 | 0.00 | 6 |
| ATOM | 1392 | CD1 | ILE | A | 188 | 41.123 | −0.387 | 87.786 | 0.00 | 0.00 | 6 |
| ATOM | 1393 | CG2 | ILE | A | 188 | 43.588 | 0.499 | 85.049 | 0.00 | 0.00 | 6 |
| ATOM | 1394 | C | ILE | A | 188 | 42.264 | −1.094 | 83.125 | 0.00 | 0.00 | 6 |
| ATOM | 1395 | O | ILE | A | 188 | 42.335 | 0.091 | 82.803 | 0.00 | 0.00 | 8 |
| ATOM | 1396 | N | TYR | A | 189 | 42.354 | −2.089 | 82.257 | 0.00 | 0.00 | 7 |
| ATOM | 1397 | CA | TYR | A | 189 | 42.381 | −1.827 | 80.849 | 0.00 | 0.00 | 6 |
| ATOM | 1398 | CB | TYR | A | 189 | 43.795 | −1.603 | 80.374 | 0.00 | 0.00 | 6 |
| ATOM | 1399 | CG | TYR | A | 189 | 44.178 | −0.155 | 80.405 | 0.00 | 0.00 | 6 |
| ATOM | 1400 | CD1 | TYR | A | 189 | 44.772 | 0.400 | 81.534 | 0.00 | 0.00 | 6 |
| ATOM | 1401 | CE1 | TYR | A | 189 | 45.131 | 1.740 | 81.568 | 0.00 | 0.00 | 6 |
| ATOM | 1402 | CZ | TYR | A | 189 | 44.893 | 2.554 | 80.459 | 0.00 | 0.00 | 6 |
| ATOM | 1403 | OH | TYR | A | 189 | 45.259 | 3.892 | 80.498 | 0.00 | 0.00 | 8 |
| ATOM | 1404 | CE2 | TYR | A | 189 | 44.290 | 2.023 | 79.318 | 0.00 | 0.00 | 6 |
| ATOM | 1405 | CD2 | TYR | A | 189 | 43.937 | 0.671 | 79.302 | 0.00 | 0.00 | 6 |
| ATOM | 1406 | C | TYR | A | 189 | 41.746 | −2.938 | 80.093 | 0.00 | 0.00 | 6 |
| ATOM | 1407 | O | TYR | A | 189 | 40.688 | −2.754 | 79.501 | 0.00 | 0.00 | 8 |
| ATOM | 1408 | N | ILE | A | 190 | 42.391 | −4.096 | 80.108 | 0.00 | 0.00 | 7 |
| ATOM | 1409 | CA | ILE | A | 190 | 41.795 | −5.259 | 79.488 | 0.00 | 0.00 | 6 |
| ATOM | 1410 | CB | ILE | A | 190 | 42.624 | −6.558 | 79.717 | 0.00 | 0.00 | 6 |
| ATOM | 1411 | CG1 | ILE | A | 190 | 43.603 | −6.761 | 78.556 | 0.00 | 0.00 | 6 |
| ATOM | 1412 | CD1 | ILE | A | 190 | 44.281 | −8.126 | 78.527 | 0.00 | 0.00 | 6 |
| ATOM | 1413 | CG2 | ILE | A | 190 | 41.712 | −7.808 | 79.876 | 0.00 | 0.00 | 6 |
| ATOM | 1414 | C | ILE | A | 190 | 40.353 | −5.367 | 79.984 | 0.00 | 0.00 | 6 |
| ATOM | 1415 | O | ILE | A | 190 | 39.415 | −5.293 | 79.179 | 0.00 | 0.00 | 8 |
| ATOM | 1416 | N | LEU | A | 191 | 40.172 | −5.492 | 81.302 | 0.00 | 0.00 | 7 |
| ATOM | 1417 | CA | LEU | A | 191 | 38.815 | −5.573 | 81.840 | 0.00 | 0.00 | 6 |
| ATOM | 1418 | CB | LEU | A | 191 | 38.742 | −6.214 | 83.235 | 0.00 | 0.00 | 6 |
| ATOM | 1419 | CG | LEU | A | 191 | 38.105 | −7.612 | 83.200 | 0.00 | 0.00 | 6 |
| ATOM | 1420 | CD1 | LEU | A | 191 | 39.142 | −8.679 | 82.815 | 0.00 | 0.00 | 6 |
| ATOM | 1421 | CD2 | LEU | A | 191 | 37.404 | −7.954 | 84.514 | 0.00 | 0.00 | 6 |
| ATOM | 1422 | C | LEU | A | 191 | 38.116 | −4.224 | 81.784 | 0.00 | 0.00 | 6 |
| ATOM | 1423 | O | LEU | A | 191 | 36.895 | −4.155 | 81.871 | 0.00 | 0.00 | 8 |
| ATOM | 1424 | N | TYR | A | 192 | 38.878 | −3.159 | 81.592 | 0.00 | 0.00 | 7 |
| ATOM | 1425 | CA | TYR | A | 192 | 38.257 | −1.879 | 81.376 | 0.00 | 0.00 | 6 |
| ATOM | 1426 | CB | TYR | A | 192 | 39.201 | −0.783 | 81.849 | 0.00 | 0.00 | 6 |
| ATOM | 1427 | CG | TYR | A | 192 | 39.112 | 0.554 | 81.157 | 0.00 | 0.00 | 6 |
| ATOM | 1428 | CD1 | TYR | A | 192 | 37.875 | 1.177 | 80.917 | 0.00 | 0.00 | 6 |
| ATOM | 1429 | CE1 | TYR | A | 192 | 37.809 | 2.426 | 80.282 | 0.00 | 0.00 | 6 |
| ATOM | 1430 | CZ | TYR | A | 192 | 38.999 | 3.075 | 79.907 | 0.00 | 0.00 | 6 |
| ATOM | 1431 | OH | TYR | A | 192 | 38.959 | 4.309 | 79.287 | 0.00 | 0.00 | 8 |
| ATOM | 1432 | CE2 | TYR | A | 192 | 40.239 | 2.483 | 80.154 | 0.00 | 0.00 | 6 |
| ATOM | 1433 | CD2 | TYR | A | 192 | 40.285 | 1.229 | 80.780 | 0.00 | 0.00 | 6 |
| ATOM | 1434 | C | TYR | A | 192 | 37.782 | −1.746 | 79.924 | 0.00 | 0.00 | 6 |
| ATOM | 1435 | O | TYR | A | 192 | 36.768 | −2.313 | 79.551 | 0.00 | 0.00 | 8 |
| ATOM | 1436 | N | SER | A | 193 | 38.519 | −1.026 | 79.102 | 0.00 | 0.00 | 7 |
| ATOM | 1437 | CA | SER | A | 193 | 38.074 | −0.724 | 77.759 | 0.00 | 0.00 | 6 |
| ATOM | 1438 | CB | SER | A | 193 | 39.247 | −0.199 | 76.936 | 0.00 | 0.00 | 6 |
| ATOM | 1439 | OG | SER | A | 193 | 39.721 | 1.069 | 77.358 | 0.00 | 0.00 | 8 |
| ATOM | 1440 | C | SER | A | 193 | 37.590 | −1.982 | 77.086 | 0.00 | 0.00 | 6 |
| ATOM | 1441 | O | SER | A | 193 | 36.416 | −2.098 | 76.721 | 0.00 | 0.00 | 8 |
| ATOM | 1442 | N | ALA | A | 194 | 38.536 | −2.917 | 76.949 | 0.00 | 0.00 | 7 |
| ATOM | 1443 | CA | ALA | A | 194 | 38.390 | −4.163 | 76.197 | 0.00 | 0.00 | 6 |
| ATOM | 1444 | CB | ALA | A | 194 | 39.772 | −4.846 | 75.974 | 0.00 | 0.00 | 6 |
| ATOM | 1445 | C | ALA | A | 194 | 37.381 | −5.112 | 76.851 | 0.00 | 0.00 | 6 |
| ATOM | 1446 | O | ALA | A | 194 | 37.545 | −6.338 | 76.833 | 0.00 | 0.00 | 8 |
| ATOM | 1447 | N | LEU | A | 195 | 36.376 | −4.508 | 77.478 | 0.00 | 0.00 | 7 |
| ATOM | 1448 | CA | LEU | A | 195 | 35.061 | −5.098 | 77.641 | 0.00 | 0.00 | 6 |
| ATOM | 1449 | CB | LEU | A | 195 | 34.864 | −5.803 | 79.008 | 0.00 | 0.00 | 6 |
| ATOM | 1450 | CG | LEU | A | 195 | 33.436 | −6.336 | 79.389 | 0.00 | 0.00 | 6 |
| ATOM | 1451 | CD1 | LEU | A | 195 | 33.210 | −7.830 | 79.023 | 0.00 | 0.00 | 6 |
| ATOM | 1452 | CD2 | LEU | A | 195 | 32.969 | −6.078 | 80.871 | 0.00 | 0.00 | 6 |
| ATOM | 1453 | C | LEU | A | 195 | 34.133 | −3.918 | 77.555 | 0.00 | 0.00 | 6 |
| ATOM | 1454 | O | LEU | A | 195 | 33.329 | −3.820 | 76.629 | 0.00 | 0.00 | 8 |
| ATOM | 1455 | N | ARG | A | 196 | 34.301 | −3.010 | 78.524 | 0.00 | 0.00 | 7 |
| ATOM | 1456 | CA | ARG | A | 196 | 33.258 | −2.062 | 78.926 | 0.00 | 0.00 | 6 |
| ATOM | 1457 | CB | ARG | A | 196 | 33.773 | −1.044 | 79.969 | 0.00 | 0.00 | 6 |
| ATOM | 1458 | CG | ARG | A | 196 | 32.941 | 0.274 | 79.985 | 0.00 | 0.00 | 6 |
| ATOM | 1459 | CD | ARG | A | 196 | 33.317 | 1.278 | 81.095 | 0.00 | 0.00 | 6 |
| ATOM | 1460 | NE | ARG | A | 196 | 32.404 | 2.444 | 81.111 | 0.00 | 0.00 | 7 |
| ATOM | 1461 | CZ | ARG | A | 196 | 31.253 | 2.513 | 81.800 | 0.00 | 0.00 | 6 |
| ATOM | 1462 | NH1 | ARG | A | 196 | 30.837 | 1.484 | 82.557 | 0.00 | 0.00 | 7 |
| ATOM | 1463 | NH2 | ARG | A | 196 | 30.505 | 3.617 | 81.741 | 0.00 | 0.00 | 7 |
| ATOM | 1464 | C | ARG | A | 196 | 32.788 | −1.307 | 77.737 | 0.00 | 0.00 | 6 |
| ATOM | 1465 | O | ARG | A | 196 | 31.635 | −1.405 | 77.278 | 0.00 | 0.00 | 8 |
| ATOM | 1466 | N | MET | A | 197 | 33.732 | −0.536 | 77.257 | 0.00 | 0.00 | 7 |
| ATOM | 1467 | CA | MET | A | 197 | 33.478 | 0.314 | 76.182 | 0.00 | 0.00 | 6 |
| ATOM | 1468 | CB | MET | A | 197 | 34.646 | 1.272 | 76.069 | 0.00 | 0.00 | 6 |
| ATOM | 1469 | CG | MET | A | 197 | 35.070 | 1.888 | 77.415 | 0.00 | 0.00 | 6 |
| ATOM | 1470 | SD | MET | A | 197 | 33.995 | 3.239 | 77.988 | 0.00 | 0.00 | 16 |
| ATOM | 1471 | CE | MET | A | 197 | 33.959 | 4.264 | 76.472 | 0.00 | 0.00 | 6 |
| ATOM | 1472 | C | MET | A | 197 | 33.339 | −0.615 | 74.985 | 0.00 | 0.00 | 6 |
| ATOM | 1473 | O | MET | A | 197 | 32.528 | −0.352 | 74.094 | 0.00 | 0.00 | 8 |
| ATOM | 1474 | N | GLY | A | 198 | 34.085 | −1.731 | 75.005 | 0.00 | 0.00 | 7 |
| ATOM | 1475 | CA | GLY | A | 198 | 34.049 | −2.737 | 73.922 | 0.00 | 0.00 | 6 |
| ATOM | 1476 | C | GLY | A | 198 | 32.775 | −3.549 | 73.979 | 0.00 | 0.00 | 6 |
| ATOM | 1477 | O | GLY | A | 198 | 32.734 | −4.707 | 73.597 | 0.00 | 0.00 | 8 |
| ATOM | 1478 | N | TYR | A | 199 | 31.734 | −2.927 | 74.493 | 0.00 | 0.00 | 7 |
| ATOM | 1479 | CA | TYR | A | 199 | 30.508 | −3.605 | 74.661 | 0.00 | 0.00 | 6 |
| ATOM | 1480 | CB | TYR | A | 199 | 30.420 | −4.225 | 76.022 | 0.00 | 0.00 | 6 |
| ATOM | 1481 | CG | TYR | A | 199 | 30.260 | −5.676 | 75.810 | 0.00 | 0.00 | 6 |
| ATOM | 1482 | CD1 | TYR | A | 199 | 31.386 | −6.504 | 75.619 | 0.00 | 0.00 | 6 |
| ATOM | 1483 | CE1 | TYR | A | 199 | 31.228 | −7.894 | 75.384 | 0.00 | 0.00 | 6 |
| ATOM | 1484 | CZ | TYR | A | 199 | 29.920 | −8.440 | 75.310 | 0.00 | 0.00 | 6 |
| ATOM | 1485 | OH | TYR | A | 199 | 29.738 | −9.795 | 75.083 | 0.00 | 0.00 | 8 |
| ATOM | 1486 | CE2 | TYR | A | 199 | 28.791 | −7.610 | 75.464 | 0.00 | 0.00 | 6 |
| ATOM | 1487 | CD2 | TYR | A | 199 | 28.971 | −6.237 | 75.702 | 0.00 | 0.00 | 6 |
| ATOM | 1488 | C | TYR | A | 199 | 29.290 | −2.798 | 74.352 | 0.00 | 0.00 | 6 |
| ATOM | 1489 | O | TYR | A | 199 | 28.520 | −3.188 | 73.460 | 0.00 | 0.00 | 8 |
| ATOM | 1490 | N | GLU | A | 200 | 29.100 | −1.689 | 75.086 | 0.00 | 0.00 | 7 |
| ATOM | 1491 | CA | GLU | A | 200 | 28.086 | −0.660 | 74.709 | 0.00 | 0.00 | 6 |
| ATOM | 1492 | CB | GLU | A | 200 | 28.272 | 0.679 | 75.513 | 0.00 | 0.00 | 6 |
| ATOM | 1493 | CG | GLU | A | 200 | 29.056 | 1.872 | 74.783 | 0.00 | 0.00 | 6 |
| ATOM | 1494 | CD | GLU | A | 200 | 28.662 | 3.318 | 75.240 | 0.00 | 0.00 | 6 |
| ATOM | 1495 | OE1 | GLU | A | 200 | 27.909 | 4.029 | 74.523 | 0.00 | 0.00 | 8 |
| ATOM | 1496 | OE2 | GLU | A | 200 | 29.119 | 3.754 | 76.314 | 0.00 | 0.00 | 8 |
| ATOM | 1497 | C | GLU | A | 200 | 28.269 | −0.487 | 73.193 | 0.00 | 0.00 | 6 |
| ATOM | 1498 | O | GLU | A | 200 | 27.299 | −0.366 | 72.410 | 0.00 | 0.00 | 8 |
| ATOM | 1499 | N | ALA | A | 201 | 29.570 | −0.525 | 72.862 | 0.00 | 0.00 | 7 |
| ATOM | 1500 | CA | ALA | A | 201 | 30.160 | −0.561 | 71.549 | 0.00 | 0.00 | 6 |
| ATOM | 1501 | CB | ALA | A | 201 | 31.654 | −0.870 | 71.659 | 0.00 | 0.00 | 6 |
| ATOM | 1502 | C | ALA | A | 201 | 29.509 | −1.643 | 70.765 | 0.00 | 0.00 | 6 |
| ATOM | 1503 | O | ALA | A | 201 | 28.951 | −1.376 | 69.710 | 0.00 | 0.00 | 8 |
| ATOM | 1504 | N | VAL | A | 202 | 29.590 | −2.872 | 71.257 | 0.00 | 0.00 | 7 |
| ATOM | 1505 | CA | VAL | A | 202 | 29.096 | −3.958 | 70.442 | 0.00 | 0.00 | 6 |
| ATOM | 1506 | CB | VAL | A | 202 | 29.711 | −5.282 | 70.824 | 0.00 | 0.00 | 6 |
| ATOM | 1507 | CG1 | VAL | A | 202 | 30.817 | −5.660 | 69.801 | 0.00 | 0.00 | 6 |
| ATOM | 1508 | CG2 | VAL | A | 202 | 30.232 | −5.211 | 72.252 | 0.00 | 0.00 | 6 |
| ATOM | 1509 | C | VAL | A | 202 | 27.585 | −3.996 | 70.425 | 0.00 | 0.00 | 6 |
| ATOM | 1510 | O | VAL | A | 202 | 27.004 | −4.714 | 69.627 | 0.00 | 0.00 | 8 |
| ATOM | 1511 | N | GLN | A | 203 | 26.966 | −3.177 | 71.273 | 0.00 | 0.00 | 7 |
| ATOM | 1512 | CA | GLN | A | 203 | 25.531 | −2.951 | 71.199 | 0.00 | 0.00 | 6 |
| ATOM | 1513 | CB | GLN | A | 203 | 24.910 | −3.145 | 72.560 | 0.00 | 0.00 | 6 |
| ATOM | 1514 | CG | GLN | A | 203 | 24.560 | −4.642 | 72.829 | 0.00 | 0.00 | 6 |
| ATOM | 1515 | CD | GLN | A | 203 | 25.766 | −5.634 | 72.966 | 0.00 | 0.00 | 6 |
| ATOM | 1516 | OE1 | GLN | A | 203 | 25.602 | −6.848 | 72.716 | 0.00 | 0.00 | 8 |
| ATOM | 1517 | NE2 | GLN | A | 203 | 26.943 | −5.134 | 73.390 | 0.00 | 0.00 | 7 |
| ATOM | 1518 | C | GLN | A | 203 | 25.203 | −1.624 | 70.512 | 0.00 | 0.00 | 6 |
| ATOM | 1519 | O | GLN | A | 203 | 24.119 | −1.055 | 70.636 | 0.00 | 0.00 | 8 |
| ATOM | 1520 | N | SER | A | 204 | 26.238 | −1.159 | 69.812 | 0.00 | 0.00 | 7 |
| ATOM | 1521 | CA | SER | A | 204 | 26.168 | −0.512 | 68.487 | 0.00 | 0.00 | 6 |
| ATOM | 1522 | CB | SER | A | 204 | 27.605 | −0.347 | 67.855 | 0.00 | 0.00 | 6 |
| ATOM | 1523 | OG | SER | A | 204 | 27.978 | 0.943 | 67.325 | 0.00 | 0.00 | 8 |
| ATOM | 1524 | C | SER | A | 204 | 25.321 | −1.494 | 67.643 | 0.00 | 0.00 | 6 |
| ATOM | 1525 | O | SER | A | 204 | 24.635 | −1.091 | 66.710 | 0.00 | 0.00 | 8 |
| ATOM | 1526 | N | LEU | A | 205 | 25.373 | −2.788 | 67.944 | 0.00 | 0.00 | 7 |
| ATOM | 1527 | CA | LEU | A | 205 | 24.304 | −3.645 | 67.468 | 0.00 | 0.00 | 6 |
| ATOM | 1528 | CB | LEU | A | 205 | 24.739 | −5.085 | 67.155 | 0.00 | 0.00 | 6 |
| ATOM | 1529 | CG | LEU | A | 205 | 25.570 | −5.879 | 68.171 | 0.00 | 0.00 | 6 |
| ATOM | 1530 | CD1 | LEU | A | 205 | 24.777 | −6.269 | 69.433 | 0.00 | 0.00 | 6 |
| ATOM | 1531 | CD2 | LEU | A | 205 | 26.158 | −7.106 | 67.530 | 0.00 | 0.00 | 6 |
| ATOM | 1532 | C | LEU | A | 205 | 23.151 | −3.522 | 68.485 | 0.00 | 0.00 | 6 |
| ATOM | 1533 | O | LEU | A | 205 | 23.308 | −3.728 | 69.711 | 0.00 | 0.00 | 8 |
| ATOM | 1534 | N | LEU | A | 206 | 22.014 | −3.095 | 67.925 | 0.00 | 0.00 | 7 |
| ATOM | 1535 | CA | LEU | A | 206 | 20.803 | −2.773 | 68.654 | 0.00 | 0.00 | 6 |
| ATOM | 1536 | CB | LEU | A | 206 | 19.689 | −2.301 | 67.753 | 0.00 | 0.00 | 6 |
| ATOM | 1537 | CG | LEU | A | 206 | 19.910 | −1.311 | 66.645 | 0.00 | 0.00 | 6 |
| ATOM | 1538 | CD1 | LEU | A | 206 | 19.075 | −1.783 | 65.464 | 0.00 | 0.00 | 6 |
| ATOM | 1539 | CD2 | LEU | A | 206 | 19.555 | 0.082 | 67.189 | 0.00 | 0.00 | 6 |
| ATOM | 1540 | C | LEU | A | 206 | 20.393 | −4.093 | 69.068 | 0.00 | 0.00 | 6 |
| ATOM | 1541 | O | LEU | A | 206 | 20.301 | −5.020 | 68.240 | 0.00 | 0.00 | 8 |
| ATOM | 1542 | N | ASP | A | 207 | 20.120 | −4.148 | 70.356 | 0.00 | 0.00 | 7 |
| ATOM | 1543 | CA | ASP | A | 207 | 19.949 | −5.373 | 71.075 | 0.00 | 0.00 | 6 |
| ATOM | 1544 | CB | ASP | A | 207 | 21.220 | −6.248 | 70.956 | 0.00 | 0.00 | 6 |
| ATOM | 1545 | CG | ASP | A | 207 | 21.125 | −7.341 | 69.860 | 0.00 | 0.00 | 6 |
| ATOM | 1546 | OD1 | ASP | A | 207 | 20.215 | −7.318 | 68.967 | 0.00 | 0.00 | 8 |
| ATOM | 1547 | OD2 | ASP | A | 207 | 22.006 | −8.241 | 69.932 | 0.00 | 0.00 | 8 |
| ATOM | 1548 | C | ASP | A | 207 | 19.832 | −4.928 | 72.495 | 0.00 | 0.00 | 6 |
| ATOM | 1549 | O | ASP | A | 207 | 19.647 | −3.736 | 72.793 | 0.00 | 0.00 | 8 |
| ATOM | 1550 | N | ARG | A | 208 | 20.000 | −5.917 | 73.360 | 0.00 | 0.00 | 7 |
| ATOM | 1551 | CA | ARG | A | 208 | 19.895 | −5.760 | 74.792 | 0.00 | 0.00 | 6 |
| ATOM | 1552 | CB | ARG | A | 208 | 21.111 | −4.986 | 75.342 | 0.00 | 0.00 | 6 |
| ATOM | 1553 | CG | ARG | A | 208 | 22.458 | −5.684 | 75.062 | 0.00 | 0.00 | 6 |
| ATOM | 1554 | CD | ARG | A | 208 | 22.735 | −6.892 | 76.003 | 0.00 | 0.00 | 6 |
| ATOM | 1555 | NE | ARG | A | 208 | 23.400 | −8.017 | 75.320 | 0.00 | 0.00 | 7 |
| ATOM | 1556 | CZ | ARG | A | 208 | 23.892 | −9.100 | 75.929 | 0.00 | 0.00 | 6 |
| ATOM | 1557 | NH1 | ARG | A | 208 | 23.827 | −9.230 | 77.258 | 0.00 | 0.00 | 7 |
| ATOM | 1558 | NH2 | ARG | A | 208 | 24.463 | −10.057 | 75.197 | 0.00 | 0.00 | 7 |
| ATOM | 1559 | C | ARG | A | 208 | 18.546 | −5.113 | 75.090 | 0.00 | 0.00 | 6 |
| ATOM | 1560 | O | ARG | A | 208 | 18.360 | −4.486 | 76.155 | 0.00 | 0.00 | 8 |
| ATOM | 1561 | N | ALA | A | 209 | 17.621 | −5.327 | 74.130 | 0.00 | 0.00 | 7 |
| ATOM | 1562 | CA | ALA | A | 209 | 16.291 | −4.674 | 74.044 | 0.00 | 0.00 | 6 |
| ATOM | 1563 | CB | ALA | A | 209 | 15.081 | −5.718 | 73.897 | 0.00 | 0.00 | 6 |
| ATOM | 1564 | C | ALA | A | 209 | 16.109 | −3.690 | 75.199 | 0.00 | 0.00 | 6 |
| ATOM | 1565 | O | ALA | A | 209 | 16.048 | −2.486 | 74.990 | 0.00 | 0.00 | 8 |
| ATOM | 1566 | N | LEU | A | 210 | 16.036 | −4.215 | 76.408 | 0.00 | 0.00 | 7 |
| ATOM | 1567 | CA | LEU | A | 210 | 16.621 | −3.541 | 77.527 | 0.00 | 0.00 | 6 |
| ATOM | 1568 | CB | LEU | A | 210 | 15.680 | −2.490 | 78.154 | 0.00 | 0.00 | 6 |
| ATOM | 1569 | CG | LEU | A | 210 | 15.897 | −1.050 | 77.608 | 0.00 | 0.00 | 6 |
| ATOM | 1570 | CD1 | LEU | A | 210 | 14.594 | −0.273 | 77.296 | 0.00 | 0.00 | 6 |
| ATOM | 1571 | CD2 | LEU | A | 210 | 16.881 | −0.166 | 78.437 | 0.00 | 0.00 | 6 |
| ATOM | 1572 | C | LEU | A | 210 | 17.059 | −4.645 | 78.477 | 0.00 | 0.00 | 6 |
| ATOM | 1573 | O | LEU | A | 210 | 16.891 | −5.848 | 78.192 | 0.00 | 0.00 | 8 |
| ATOM | 1574 | N | PRO | A | 211 | 17.745 | −4.242 | 79.547 | 0.00 | 0.00 | 7 |
| ATOM | 1575 | CA | PRO | A | 211 | 17.735 | −4.977 | 80.801 | 0.00 | 0.00 | 6 |
| ATOM | 1576 | CB | PRO | A | 211 | 18.190 | −3.939 | 81.838 | 0.00 | 0.00 | 6 |
| ATOM | 1577 | CG | PRO | A | 211 | 18.483 | −2.612 | 81.028 | 0.00 | 0.00 | 6 |
| ATOM | 1578 | CD | PRO | A | 211 | 18.655 | −3.079 | 79.599 | 0.00 | 0.00 | 6 |
| ATOM | 1579 | C | PRO | A | 211 | 16.351 | −5.431 | 81.161 | 0.00 | 0.00 | 6 |
| ATOM | 1580 | O | PRO | A | 211 | 15.375 | −4.661 | 81.152 | 0.00 | 0.00 | 8 |
| ATOM | 1581 | N | ASP | A | 212 | 16.314 | −6.712 | 81.453 | 0.00 | 0.00 | 7 |
| ATOM | 1582 | CA | ASP | A | 212 | 15.173 | −7.356 | 82.005 | 0.00 | 0.00 | 6 |
| ATOM | 1583 | CB | ASP | A | 212 | 15.525 | −8.812 | 82.378 | 0.00 | 0.00 | 6 |
| ATOM | 1584 | CG | ASP | A | 212 | 16.453 | −9.491 | 81.347 | 0.00 | 0.00 | 6 |
| ATOM | 1585 | OD1 | ASP | A | 212 | 16.164 | −10.642 | 80.915 | 0.00 | 0.00 | 8 |
| ATOM | 1586 | OD2 | ASP | A | 212 | 17.478 | −8.869 | 80.972 | 0.00 | 0.00 | 8 |
| ATOM | 1587 | C | ASP | A | 212 | 14.821 | −6.512 | 83.211 | 0.00 | 0.00 | 6 |
| ATOM | 1588 | O | ASP | A | 212 | 15.341 | −6.700 | 84.300 | 0.00 | 0.00 | 8 |
| ATOM | 1589 | N | GLU | A | 213 | 13.963 | −5.537 | 82.996 | 0.00 | 0.00 | 7 |
| ATOM | 1590 | CA | GLU | A | 213 | 13.702 | −4.587 | 84.029 | 0.00 | 0.00 | 6 |
| ATOM | 1591 | CB | GLU | A | 213 | 14.992 | −3.814 | 84.351 | 0.00 | 0.00 | 6 |
| ATOM | 1592 | CG | GLU | A | 213 | 14.862 | −2.715 | 85.428 | 0.00 | 0.00 | 6 |
| ATOM | 1593 | CD | GLU | A | 213 | 14.349 | −3.245 | 86.772 | 0.00 | 0.00 | 6 |
| ATOM | 1594 | OE1 | GLU | A | 213 | 15.157 | −3.857 | 87.511 | 0.00 | 0.00 | 8 |
| ATOM | 1595 | OE2 | GLU | A | 213 | 13.142 | −3.044 | 87.088 | 0.00 | 0.00 | 8 |
| ATOM | 1596 | C | GLU | A | 213 | 12.628 | −3.662 | 83.521 | 0.00 | 0.00 | 6 |
| ATOM | 1597 | O | GLU | A | 213 | 11.446 | −3.916 | 83.693 | 0.00 | 0.00 | 8 |
| ATOM | 1598 | N | GLU | A | 214 | 13.049 | −2.577 | 82.887 | 0.00 | 0.00 | 7 |
| ATOM | 1599 | CA | GLU | A | 214 | 12.113 | −1.710 | 82.203 | 0.00 | 0.00 | 6 |
| ATOM | 1600 | CB | GLU | A | 214 | 12.818 | −0.506 | 81.532 | 0.00 | 0.00 | 6 |
| ATOM | 1601 | CG | GLU | A | 214 | 13.937 | 0.215 | 82.358 | 0.00 | 0.00 | 6 |
| ATOM | 1602 | CD | GLU | A | 214 | 15.361 | −0.038 | 81.804 | 0.00 | 0.00 | 6 |
| ATOM | 1603 | OE1 | GLU | A | 214 | 15.828 | −1.206 | 81.828 | 0.00 | 0.00 | 8 |
| ATOM | 1604 | OE2 | GLU | A | 214 | 16.011 | 0.935 | 81.332 | 0.00 | 0.00 | 8 |
| ATOM | 1605 | C | GLU | A | 214 | 11.449 | −2.637 | 81.191 | 0.00 | 0.00 | 6 |
| ATOM | 1606 | O | GLU | A | 214 | 10.355 | −2.372 | 80.725 | 0.00 | 0.00 | 8 |
| ATOM | 1607 | N | ARG | A | 215 | 12.135 | −3.732 | 80.872 | 0.00 | 0.00 | 7 |
| ATOM | 1608 | CA | ARG | A | 215 | 11.484 | −4.838 | 80.260 | 0.00 | 0.00 | 6 |
| ATOM | 1609 | CB | ARG | A | 215 | 12.383 | −6.060 | 80.253 | 0.00 | 0.00 | 6 |
| ATOM | 1610 | CG | ARG | A | 215 | 11.863 | −7.260 | 79.409 | 0.00 | 0.00 | 6 |
| ATOM | 1611 | CD | ARG | A | 215 | 12.361 | −7.259 | 77.927 | 0.00 | 0.00 | 6 |
| ATOM | 1612 | NE | ARG | A | 215 | 13.824 | −7.404 | 77.802 | 0.00 | 0.00 | 7 |
| ATOM | 1613 | CZ | ARG | A | 215 | 14.457 | −8.506 | 77.397 | 0.00 | 0.00 | 6 |
| ATOM | 1614 | NH1 | ARG | A | 215 | 13.765 | −9.591 | 77.048 | 0.00 | 0.00 | 7 |
| ATOM | 1615 | NH2 | ARG | A | 215 | 15.787 | −8.513 | 77.342 | 0.00 | 0.00 | 7 |
| ATOM | 1616 | C | ARG | A | 215 | 10.289 | −5.046 | 81.161 | 0.00 | 0.00 | 6 |
| ATOM | 1617 | O | ARG | A | 215 | 9.203 | −4.582 | 80.834 | 0.00 | 0.00 | 8 |
| ATOM | 1618 | N | GLN | A | 216 | 10.490 | −5.672 | 82.320 | 0.00 | 0.00 | 7 |
| ATOM | 1619 | CA | GLN | A | 216 | 9.379 | −5.978 | 83.260 | 0.00 | 0.00 | 6 |
| ATOM | 1620 | CB | GLN | A | 216 | 9.973 | −6.474 | 84.604 | 0.00 | 0.00 | 6 |
| ATOM | 1621 | CG | GLN | A | 216 | 9.015 | −7.291 | 85.499 | 0.00 | 0.00 | 6 |
| ATOM | 1622 | CD | GLN | A | 216 | 8.485 | −8.532 | 84.799 | 0.00 | 0.00 | 6 |
| ATOM | 1623 | OE1 | GLN | A | 216 | 9.141 | −9.048 | 83.887 | 0.00 | 0.00 | 8 |
| ATOM | 1624 | NE2 | GLN | A | 216 | 7.299 | −9.021 | 85.219 | 0.00 | 0.00 | 7 |
| ATOM | 1625 | C | GLN | A | 216 | 8.306 | −4.836 | 83.463 | 0.00 | 0.00 | 6 |
| ATOM | 1626 | O | GLN | A | 216 | 7.101 | −5.003 | 83.185 | 0.00 | 0.00 | 8 |
| ATOM | 1627 | N | GLU | A | 217 | 8.776 | −3.689 | 83.948 | 0.00 | 0.00 | 7 |
| ATOM | 1628 | CA | GLU | A | 217 | 7.982 | −2.489 | 84.019 | 0.00 | 0.00 | 6 |
| ATOM | 1629 | CB | GLU | A | 217 | 8.888 | −1.240 | 84.229 | 0.00 | 0.00 | 6 |
| ATOM | 1630 | CG | GLU | A | 217 | 9.798 | −1.291 | 85.533 | 0.00 | 0.00 | 6 |
| ATOM | 1631 | CD | GLU | A | 217 | 10.808 | −0.100 | 85.753 | 0.00 | 0.00 | 6 |
| ATOM | 1632 | OE1 | GLU | A | 217 | 10.743 | 0.910 | 85.046 | 0.00 | 0.00 | 8 |
| ATOM | 1633 | OE2 | GLU | A | 217 | 11.675 | −0.153 | 86.661 | 0.00 | 0.00 | 8 |
| ATOM | 1634 | C | GLU | A | 217 | 7.180 | −2.473 | 82.714 | 0.00 | 0.00 | 6 |
| ATOM | 1635 | O | GLU | A | 217 | 6.026 | −2.837 | 82.731 | 0.00 | 0.00 | 8 |
| ATOM | 1636 | N | ILE | A | 218 | 7.802 | −2.161 | 81.575 | 0.00 | 0.00 | 7 |
| ATOM | 1637 | CA | ILE | A | 218 | 7.047 | −1.964 | 80.313 | 0.00 | 0.00 | 6 |
| ATOM | 1638 | CB | ILE | A | 218 | 7.889 | −2.047 | 78.997 | 0.00 | 0.00 | 6 |
| ATOM | 1639 | CG1 | ILE | A | 218 | 8.835 | −0.866 | 78.889 | 0.00 | 0.00 | 6 |
| ATOM | 1640 | CD1 | ILE | A | 218 | 9.774 | −0.968 | 77.770 | 0.00 | 0.00 | 6 |
| ATOM | 1641 | CG2 | ILE | A | 218 | 6.988 | −1.983 | 77.764 | 0.00 | 0.00 | 6 |
| ATOM | 1642 | C | ILE | A | 218 | 5.934 | −2.943 | 80.203 | 0.00 | 0.00 | 6 |
| ATOM | 1643 | O | ILE | A | 218 | 4.797 | −2.561 | 80.064 | 0.00 | 0.00 | 8 |
| ATOM | 1644 | N | ILE | A | 219 | 6.264 | −4.214 | 80.280 | 0.00 | 0.00 | 7 |
| ATOM | 1645 | CA | ILE | A | 219 | 5.251 | −5.203 | 80.138 | 0.00 | 0.00 | 6 |
| ATOM | 1646 | CB | ILE | A | 219 | 5.814 | −6.638 | 80.334 | 0.00 | 0.00 | 6 |
| ATOM | 1647 | CG1 | ILE | A | 219 | 4.756 | −7.711 | 79.987 | 0.00 | 0.00 | 6 |
| ATOM | 1648 | CD1 | ILE | A | 219 | 4.744 | −8.204 | 78.510 | 0.00 | 0.00 | 6 |
| ATOM | 1649 | CG2 | ILE | A | 219 | 6.368 | −6.840 | 81.733 | 0.00 | 0.00 | 6 |
| ATOM | 1650 | C | ILE | A | 219 | 4.129 | −4.855 | 81.117 | 0.00 | 0.00 | 6 |
| ATOM | 1651 | O | ILE | A | 219 | 2.986 | −4.569 | 80.709 | 0.00 | 0.00 | 8 |
| ATOM | 1652 | N | ASP | A | 220 | 4.483 | −4.810 | 82.401 | 0.00 | 0.00 | 7 |
| ATOM | 1653 | CA | ASP | A | 220 | 3.498 | −4.624 | 83.485 | 0.00 | 0.00 | 6 |
| ATOM | 1654 | CB | ASP | A | 220 | 4.196 | −4.518 | 84.846 | 0.00 | 0.00 | 6 |
| ATOM | 1655 | CG | ASP | A | 220 | 4.531 | −5.863 | 85.433 | 0.00 | 0.00 | 6 |
| ATOM | 1656 | OD1 | ASP | A | 220 | 3.568 | −6.655 | 85.743 | 0.00 | 0.00 | 8 |
| ATOM | 1657 | OD2 | ASP | A | 220 | 5.765 | −6.092 | 85.580 | 0.00 | 0.00 | 8 |
| ATOM | 1658 | C | ASP | A | 220 | 2.616 | −3.404 | 83.322 | 0.00 | 0.00 | 6 |
| ATOM | 1659 | O | ASP | A | 220 | 1.482 | −3.391 | 83.785 | 0.00 | 0.00 | 8 |
| ATOM | 1660 | N | ILE | A | 221 | 3.164 | −2.363 | 82.711 | 0.00 | 0.00 | 7 |
| ATOM | 1661 | CA | ILE | A | 221 | 2.419 | −1.152 | 82.542 | 0.00 | 0.00 | 6 |
| ATOM | 1662 | CB | ILE | A | 221 | 3.306 | −0.017 | 82.139 | 0.00 | 0.00 | 6 |
| ATOM | 1663 | CG1 | ILE | A | 221 | 4.261 | 0.270 | 83.263 | 0.00 | 0.00 | 6 |
| ATOM | 1664 | CD1 | ILE | A | 221 | 5.649 | 0.439 | 82.756 | 0.00 | 0.00 | 6 |
| ATOM | 1665 | CG2 | ILE | A | 221 | 2.511 | 1.221 | 81.944 | 0.00 | 0.00 | 6 |
| ATOM | 1666 | C | ILE | A | 221 | 1.404 | −1.448 | 81.482 | 0.00 | 0.00 | 6 |
| ATOM | 1667 | O | ILE | A | 221 | 0.239 | −1.115 | 81.651 | 0.00 | 0.00 | 8 |
| ATOM | 1668 | N | VAL | A | 222 | 1.829 | −2.123 | 80.422 | 0.00 | 0.00 | 7 |
| ATOM | 1669 | CA | VAL | A | 222 | 0.930 | −2.406 | 79.328 | 0.00 | 0.00 | 6 |
| ATOM | 1670 | CB | VAL | A | 222 | 1.685 | −2.755 | 78.062 | 0.00 | 0.00 | 6 |
| ATOM | 1671 | CG1 | VAL | A | 222 | 0.803 | −2.690 | 76.884 | 0.00 | 0.00 | 6 |
| ATOM | 1672 | CG2 | VAL | A | 222 | 2.695 | −1.748 | 77.846 | 0.00 | 0.00 | 6 |
| ATOM | 1673 | C | VAL | A | 222 | −0.105 | −3.476 | 79.720 | 0.00 | 0.00 | 6 |
| ATOM | 1674 | O | VAL | A | 222 | −1.280 | −3.413 | 79.309 | 0.00 | 0.00 | 8 |
| ATOM | 1675 | N | THR | A | 223 | 0.289 | −4.424 | 80.560 | 0.00 | 0.00 | 7 |
| ATOM | 1676 | CA | THR | A | 223 | −0.602 | −5.535 | 80.934 | 0.00 | 0.00 | 6 |
| ATOM | 1677 | CB | THR | A | 223 | 0.192 | −6.575 | 81.728 | 0.00 | 0.00 | 6 |
| ATOM | 1678 | OG1 | THR | A | 223 | 1.554 | −6.613 | 81.268 | 0.00 | 0.00 | 8 |
| ATOM | 1679 | CG2 | THR | A | 223 | −0.467 | −7.943 | 81.625 | 0.00 | 0.00 | 6 |
| ATOM | 1680 | C | THR | A | 223 | −1.775 | −5.149 | 81.827 | 0.00 | 0.00 | 6 |
| ATOM | 1681 | O | THR | A | 223 | −2.485 | −6.009 | 82.310 | 0.00 | 0.00 | 8 |
| ATOM | 1682 | N | SER | A | 224 | −1.971 | −3.864 | 82.060 | 0.00 | 0.00 | 7 |
| ATOM | 1683 | CA | SER | A | 224 | −2.706 | −3.458 | 83.230 | 0.00 | 0.00 | 6 |
| ATOM | 1684 | CB | SER | A | 224 | −1.711 | −3.002 | 84.277 | 0.00 | 0.00 | 6 |
| ATOM | 1685 | OG | SER | A | 224 | −0.825 | −2.065 | 83.691 | 0.00 | 0.00 | 8 |
| ATOM | 1686 | C | SER | A | 224 | −3.707 | −2.352 | 82.966 | 0.00 | 0.00 | 6 |
| ATOM | 1687 | O | SER | A | 224 | −4.216 | −1.725 | 83.891 | 0.00 | 0.00 | 8 |
| ATOM | 1688 | N | TRP | A | 225 | −4.021 | −2.115 | 81.712 | 0.00 | 0.00 | 7 |
| ATOM | 1689 | CA | TRP | A | 225 | −4.912 | −1.026 | 81.415 | 0.00 | 0.00 | 6 |
| ATOM | 1690 | CB | TRP | A | 225 | −4.397 | −0.317 | 80.186 | 0.00 | 0.00 | 6 |
| ATOM | 1691 | CG | TRP | A | 225 | −3.695 | 0.785 | 80.667 | 0.00 | 0.00 | 6 |
| ATOM | 1692 | CD1 | TRP | A | 225 | −2.857 | 0.778 | 81.715 | 0.00 | 0.00 | 6 |
| ATOM | 1693 | NE1 | TRP | A | 225 | −2.386 | 2.039 | 81.952 | 0.00 | 0.00 | 7 |
| ATOM | 1694 | CE2 | TRP | A | 225 | −2.953 | 2.893 | 81.049 | 0.00 | 0.00 | 6 |
| ATOM | 1695 | CD2 | TRP | A | 225 | −3.795 | 2.130 | 80.232 | 0.00 | 0.00 | 6 |
| ATOM | 1696 | CE3 | TRP | A | 225 | −4.486 | 2.762 | 79.222 | 0.00 | 0.00 | 6 |
| ATOM | 1697 | CZ3 | TRP | A | 225 | −4.325 | 4.099 | 79.065 | 0.00 | 0.00 | 6 |
| ATOM | 1698 | CH2 | TRP | A | 225 | −3.486 | 4.842 | 79.881 | 0.00 | 0.00 | 6 |
| ATOM | 1699 | CZ2 | TRP | A | 225 | −2.784 | 4.261 | 80.879 | 0.00 | 0.00 | 6 |
| ATOM | 1700 | C | TRP | A | 225 | −6.400 | −1.371 | 81.350 | 0.00 | 0.00 | 6 |
| ATOM | 1701 | O | TRP | A | 225 | −6.812 | −2.369 | 81.933 | 0.00 | 0.00 | 8 |
| ATOM | 1702 | N | PRO | A | 226 | −7.229 | −0.476 | 80.772 | 0.00 | 0.00 | 7 |
| ATOM | 1703 | CA | PRO | A | 226 | −8.385 | −0.880 | 79.969 | 0.00 | 0.00 | 6 |
| ATOM | 1704 | CB | PRO | A | 226 | −9.048 | 0.456 | 79.624 | 0.00 | 0.00 | 6 |
| ATOM | 1705 | CG | PRO | A | 226 | −7.982 | 1.484 | 79.804 | 0.00 | 0.00 | 6 |
| ATOM | 1706 | CD | PRO | A | 226 | −7.208 | 0.984 | 80.970 | 0.00 | 0.00 | 6 |
| ATOM | 1707 | C | PRO | A | 226 | −8.007 | −1.608 | 78.656 | 0.00 | 0.00 | 6 |
| ATOM | 1708 | O | PRO | A | 226 | −8.878 | −2.232 | 78.053 | 0.00 | 0.00 | 8 |
| ATOM | 1709 | N | GLY | A | 227 | −6.731 | −1.521 | 78.241 | 0.00 | 0.00 | 7 |
| ATOM | 1710 | CA | GLY | A | 227 | −6.180 | −2.093 | 76.978 | 0.00 | 0.00 | 6 |
| ATOM | 1711 | C | GLY | A | 227 | −5.598 | −3.470 | 77.198 | 0.00 | 0.00 | 6 |
| ATOM | 1712 | O | GLY | A | 227 | −4.430 | −3.775 | 76.922 | 0.00 | 0.00 | 8 |
| ATOM | 1713 | N | VAL | A | 228 | −6.480 | −4.309 | 77.698 | 0.00 | 0.00 | 7 |
| ATOM | 1714 | CA | VAL | A | 228 | −6.095 | −5.508 | 78.375 | 0.00 | 0.00 | 6 |
| ATOM | 1715 | CB | VAL | A | 228 | −7.130 | −5.927 | 79.506 | 0.00 | 0.00 | 6 |
| ATOM | 1716 | CG1 | VAL | A | 228 | −6.429 | −6.619 | 80.747 | 0.00 | 0.00 | 6 |
| ATOM | 1717 | CG2 | VAL | A | 228 | −7.983 | −4.730 | 79.977 | 0.00 | 0.00 | 6 |
| ATOM | 1718 | C | VAL | A | 228 | −5.943 | −6.591 | 77.364 | 0.00 | 0.00 | 6 |
| ATOM | 1719 | O | VAL | A | 228 | −5.550 | −6.331 | 76.232 | 0.00 | 0.00 | 8 |
| ATOM | 1720 | N | SER | A | 229 | −6.336 | −7.791 | 77.784 | 0.00 | 0.00 | 7 |
| ATOM | 1721 | CA | SER | A | 229 | −5.649 | −8.993 | 77.380 | 0.00 | 0.00 | 6 |
| ATOM | 1722 | CB | SER | A | 229 | −6.484 | −10.277 | 77.560 | 0.00 | 0.00 | 6 |
| ATOM | 1723 | OG | SER | A | 229 | −5.656 | −11.415 | 77.861 | 0.00 | 0.00 | 8 |
| ATOM | 1724 | C | SER | A | 229 | −5.341 | −8.725 | 75.965 | 0.00 | 0.00 | 6 |
| ATOM | 1725 | O | SER | A | 229 | −6.271 | −8.504 | 75.175 | 0.00 | 0.00 | 8 |
| ATOM | 1726 | N | GLY | A | 230 | −4.030 | −8.649 | 75.696 | 0.00 | 0.00 | 7 |
| ATOM | 1727 | CA | GLY | A | 230 | −3.504 | −8.443 | 74.357 | 0.00 | 0.00 | 6 |
| ATOM | 1728 | C | GLY | A | 230 | −2.153 | −7.813 | 74.320 | 0.00 | 0.00 | 6 |
| ATOM | 1729 | O | GLY | A | 230 | −1.938 | −6.923 | 73.512 | 0.00 | 0.00 | 8 |
| ATOM | 1730 | N | ALA | A | 231 | −1.276 | −8.257 | 75.224 | 0.00 | 0.00 | 7 |
| ATOM | 1731 | CA | ALA | A | 231 | 0.156 | −7.967 | 75.150 | 0.00 | 0.00 | 6 |
| ATOM | 1732 | CB | ALA | A | 231 | 0.793 | −8.112 | 76.487 | 0.00 | 0.00 | 6 |
| ATOM | 1733 | C | ALA | A | 231 | 0.767 | −8.979 | 74.219 | 0.00 | 0.00 | 6 |
| ATOM | 1734 | O | ALA | A | 231 | 0.719 | −10.174 | 74.502 | 0.00 | 0.00 | 8 |
| ATOM | 1735 | N | HIS | A | 232 | 1.318 | −8.520 | 73.096 | 0.00 | 0.00 | 7 |
| ATOM | 1736 | CA | HIS | A | 232 | 2.033 | −9.451 | 72.209 | 0.00 | 0.00 | 6 |
| ATOM | 1737 | CB | HIS | A | 232 | 1.166 | −10.232 | 71.102 | 0.00 | 0.00 | 6 |
| ATOM | 1738 | CG | HIS | A | 232 | 1.143 | −9.688 | 69.680 | 0.00 | 0.00 | 6 |
| ATOM | 1739 | ND1 | HIS | A | 232 | −0.029 | −9.584 | 68.967 | 0.00 | 0.00 | 7 |
| ATOM | 1740 | CE1 | HIS | A | 232 | 0.213 | −9.149 | 67.749 | 0.00 | 0.00 | 6 |
| ATOM | 1741 | NE2 | HIS | A | 232 | 1.513 | −9.026 | 67.616 | 0.00 | 0.00 | 7 |
| ATOM | 1742 | CD2 | HIS | A | 232 | 2.120 | −9.368 | 68.803 | 0.00 | 0.00 | 6 |
| ATOM | 1743 | C | HIS | A | 232 | 3.563 | −9.313 | 72.067 | 0.00 | 0.00 | 6 |
| ATOM | 1744 | O | HIS | A | 232 | 4.296 | −10.144 | 72.630 | 0.00 | 0.00 | 8 |
| ATOM | 1745 | N | ASP | A | 233 | 4.093 | −8.258 | 71.455 | 0.00 | 0.00 | 7 |
| ATOM | 1746 | CA | ASP | A | 233 | 5.548 | −8.177 | 71.651 | 0.00 | 0.00 | 6 |
| ATOM | 1747 | CB | ASP | A | 233 | 6.253 | −9.498 | 71.186 | 0.00 | 0.00 | 6 |
| ATOM | 1748 | CG | ASP | A | 233 | 6.878 | −9.410 | 69.779 | 0.00 | 0.00 | 6 |
| ATOM | 1749 | OD1 | ASP | A | 233 | 6.321 | −10.094 | 68.865 | 0.00 | 0.00 | 8 |
| ATOM | 1750 | OD2 | ASP | A | 233 | 7.941 | −8.698 | 69.612 | 0.00 | 0.00 | 8 |
| ATOM | 1751 | C | ASP | A | 233 | 6.446 | −6.868 | 71.582 | 0.00 | 0.00 | 6 |
| ATOM | 1752 | O | ASP | A | 233 | 6.300 | −5.964 | 70.734 | 0.00 | 0.00 | 8 |
| ATOM | 1753 | N | LEU | A | 234 | 7.447 | −6.897 | 72.460 | 0.00 | 0.00 | 7 |
| ATOM | 1754 | CA | LEU | A | 234 | 7.895 | −5.775 | 73.222 | 0.00 | 0.00 | 6 |
| ATOM | 1755 | CB | LEU | A | 234 | 8.359 | −6.303 | 74.586 | 0.00 | 0.00 | 6 |
| ATOM | 1756 | CG | LEU | A | 234 | 9.141 | −7.657 | 74.666 | 0.00 | 0.00 | 6 |
| ATOM | 1757 | CD1 | LEU | A | 234 | 8.464 | −8.819 | 73.958 | 0.00 | 0.00 | 6 |
| ATOM | 1758 | CD2 | LEU | A | 234 | 10.565 | −7.641 | 74.169 | 0.00 | 0.00 | 6 |
| ATOM | 1759 | C | LEU | A | 234 | 9.035 | −5.052 | 72.581 | 0.00 | 0.00 | 6 |
| ATOM | 1760 | O | LEU | A | 234 | 9.330 | −3.940 | 73.022 | 0.00 | 0.00 | 8 |
| ATOM | 1761 | N | ARG | A | 235 | 9.663 | −5.663 | 71.558 | 0.00 | 0.00 | 7 |
| ATOM | 1762 | CA | ARG | A | 235 | 11.122 | −5.410 | 71.196 | 0.00 | 0.00 | 6 |
| ATOM | 1763 | CB | ARG | A | 235 | 11.392 | −5.830 | 69.727 | 0.00 | 0.00 | 6 |
| ATOM | 1764 | CG | ARG | A | 235 | 12.915 | −5.850 | 69.275 | 0.00 | 0.00 | 6 |
| ATOM | 1765 | CD | ARG | A | 235 | 13.066 | −5.164 | 67.858 | 0.00 | 0.00 | 6 |
| ATOM | 1766 | NE | ARG | A | 235 | 14.419 | −4.774 | 67.395 | 0.00 | 0.00 | 7 |
| ATOM | 1767 | CZ | ARG | A | 235 | 14.964 | −3.558 | 67.454 | 0.00 | 0.00 | 6 |
| ATOM | 1768 | NH1 | ARG | A | 235 | 14.341 | −2.531 | 68.009 | 0.00 | 0.00 | 7 |
| ATOM | 1769 | NH2 | ARG | A | 235 | 16.169 | −3.375 | 66.964 | 0.00 | 0.00 | 7 |
| ATOM | 1770 | C | ARG | A | 235 | 11.804 | −4.027 | 71.540 | 0.00 | 0.00 | 6 |
| ATOM | 1771 | O | ARG | A | 235 | 11.150 | −2.953 | 71.481 | 0.00 | 0.00 | 8 |
| ATOM | 1772 | N | THR | A | 236 | 13.105 | −4.042 | 71.856 | 0.00 | 0.00 | 7 |
| ATOM | 1773 | CA | THR | A | 236 | 13.694 | −2.811 | 72.382 | 0.00 | 0.00 | 6 |
| ATOM | 1774 | CB | THR | A | 236 | 13.560 | −2.913 | 73.871 | 0.00 | 0.00 | 6 |
| ATOM | 1775 | OG1 | THR | A | 236 | 12.877 | −4.142 | 74.169 | 0.00 | 0.00 | 8 |
| ATOM | 1776 | CG2 | THR | A | 236 | 12.847 | −1.698 | 74.436 | 0.00 | 0.00 | 6 |
| ATOM | 1777 | C | THR | A | 236 | 15.165 | −2.463 | 71.968 | 0.00 | 0.00 | 6 |
| ATOM | 1778 | O | THR | A | 236 | 15.854 | −3.334 | 71.408 | 0.00 | 0.00 | 8 |
| ATOM | 1779 | N | ARG | A | 237 | 15.639 | −1.220 | 72.242 | 0.00 | 0.00 | 7 |
| ATOM | 1780 | CA | ARG | A | 237 | 17.076 | −0.787 | 71.997 | 0.00 | 0.00 | 6 |
| ATOM | 1781 | CB | ARG | A | 237 | 17.359 | −0.801 | 70.490 | 0.00 | 0.00 | 6 |
| ATOM | 1782 | CG | ARG | A | 237 | 16.065 | −0.695 | 69.649 | 0.00 | 0.00 | 6 |
| ATOM | 1783 | CD | ARG | A | 237 | 16.333 | −0.832 | 68.153 | 0.00 | 0.00 | 6 |
| ATOM | 1784 | NE | ARG | A | 237 | 16.726 | 0.428 | 67.500 | 0.00 | 0.00 | 7 |
| ATOM | 1785 | CZ | ARG | A | 237 | 15.900 | 1.230 | 66.815 | 0.00 | 0.00 | 6 |
| ATOM | 1786 | NH1 | ARG | A | 237 | 14.598 | 0.919 | 66.666 | 0.00 | 0.00 | 7 |
| ATOM | 1787 | NH2 | ARG | A | 237 | 16.375 | 2.363 | 66.290 | 0.00 | 0.00 | 7 |
| ATOM | 1788 | C | ARG | A | 237 | 17.541 | 0.573 | 72.656 | 0.00 | 0.00 | 6 |
| ATOM | 1789 | O | ARG | A | 237 | 16.762 | 1.164 | 73.415 | 0.00 | 0.00 | 8 |
| ATOM | 1790 | N | GLN | A | 238 | 18.771 | 1.061 | 72.352 | 0.00 | 0.00 | 7 |
| ATOM | 1791 | CA | GLN | A | 238 | 19.402 | 2.363 | 72.909 | 0.00 | 0.00 | 6 |
| ATOM | 1792 | CB | GLN | A | 238 | 20.939 | 2.388 | 72.672 | 0.00 | 0.00 | 6 |
| ATOM | 1793 | CG | GLN | A | 238 | 21.453 | 3.081 | 71.259 | 0.00 | 0.00 | 6 |
| ATOM | 1794 | CD | GLN | A | 238 | 21.793 | 4.654 | 71.249 | 0.00 | 0.00 | 6 |
| ATOM | 1795 | OE1 | GLN | A | 238 | 22.747 | 5.131 | 71.929 | 0.00 | 0.00 | 8 |
| ATOM | 1796 | NE2 | GLN | A | 238 | 21.035 | 5.422 | 70.406 | 0.00 | 0.00 | 7 |
| ATOM | 1797 | C | GLN | A | 238 | 18.896 | 3.861 | 72.570 | 0.00 | 0.00 | 6 |
| ATOM | 1798 | O | GLN | A | 238 | 18.600 | 4.216 | 71.370 | 0.00 | 0.00 | 8 |
| ATOM | 1799 | N | SER | A | 239 | 18.953 | 4.731 | 73.622 | 0.00 | 0.00 | 7 |
| ATOM | 1800 | CA | SER | A | 239 | 18.444 | 6.170 | 73.691 | 0.00 | 0.00 | 6 |
| ATOM | 1801 | CB | SER | A | 239 | 19.073 | 7.070 | 72.603 | 0.00 | 0.00 | 6 |
| ATOM | 1802 | OG | SER | A | 239 | 20.298 | 7.593 | 73.080 | 0.00 | 0.00 | 8 |
| ATOM | 1803 | C | SER | A | 239 | 16.878 | 6.380 | 73.840 | 0.00 | 0.00 | 6 |
| ATOM | 1804 | O | SER | A | 239 | 16.363 | 7.523 | 73.717 | 0.00 | 0.00 | 8 |
| ATOM | 1805 | N | GLY | A | 240 | 16.174 | 5.284 | 74.179 | 0.00 | 0.00 | 7 |
| ATOM | 1806 | CA | GLY | A | 240 | 14.759 | 5.154 | 74.003 | 0.00 | 0.00 | 6 |
| ATOM | 1807 | C | GLY | A | 240 | 14.512 | 3.766 | 73.441 | 0.00 | 0.00 | 6 |
| ATOM | 1808 | O | GLY | A | 240 | 14.738 | 2.806 | 74.178 | 0.00 | 0.00 | 8 |
| ATOM | 1809 | N | PRO | A | 241 | 14.139 | 3.660 | 72.108 | 0.00 | 0.00 | 7 |
| ATOM | 1810 | CA | PRO | A | 241 | 13.315 | 2.624 | 71.391 | 0.00 | 0.00 | 6 |
| ATOM | 1811 | CB | PRO | A | 241 | 14.015 | 2.504 | 70.001 | 0.00 | 0.00 | 6 |
| ATOM | 1812 | CG | PRO | A | 241 | 14.379 | 3.981 | 69.646 | 0.00 | 0.00 | 6 |
| ATOM | 1813 | CD | PRO | A | 241 | 14.587 | 4.666 | 71.095 | 0.00 | 0.00 | 6 |
| ATOM | 1814 | C | PRO | A | 241 | 12.802 | 1.281 | 72.004 | 0.00 | 0.00 | 6 |
| ATOM | 1815 | O | PRO | A | 241 | 13.531 | 0.278 | 72.134 | 0.00 | 0.00 | 8 |
| ATOM | 1816 | N | THR | A | 242 | 11.510 | 1.362 | 72.340 | 0.00 | 0.00 | 7 |
| ATOM | 1817 | CA | THR | A | 242 | 10.576 | 0.266 | 72.568 | 0.00 | 0.00 | 6 |
| ATOM | 1818 | CB | THR | A | 242 | 9.710 | 0.581 | 73.805 | 0.00 | 0.00 | 6 |
| ATOM | 1819 | OG1 | THR | A | 242 | 10.523 | 1.168 | 74.830 | 0.00 | 0.00 | 8 |
| ATOM | 1820 | CG2 | THR | A | 242 | 8.974 | −0.653 | 74.340 | 0.00 | 0.00 | 6 |
| ATOM | 1821 | C | THR | A | 242 | 9.604 | 0.238 | 71.388 | 0.00 | 0.00 | 6 |
| ATOM | 1822 | O | THR | A | 242 | 9.724 | 1.023 | 70.445 | 0.00 | 0.00 | 8 |
| ATOM | 1823 | N | ARG | A | 243 | 8.601 | −0.616 | 71.468 | 0.00 | 0.00 | 7 |
| ATOM | 1824 | CA | ARG | A | 243 | 7.593 | −0.682 | 70.449 | 0.00 | 0.00 | 6 |
| ATOM | 1825 | CB | ARG | A | 243 | 8.254 | −0.998 | 69.113 | 0.00 | 0.00 | 6 |
| ATOM | 1826 | CG | ARG | A | 243 | 8.748 | −2.465 | 69.019 | 0.00 | 0.00 | 6 |
| ATOM | 1827 | CD | ARG | A | 243 | 9.319 | −2.738 | 67.672 | 0.00 | 0.00 | 6 |
| ATOM | 1828 | NE | ARG | A | 243 | 10.454 | −1.836 | 67.506 | 0.00 | 0.00 | 7 |
| ATOM | 1829 | CZ | ARG | A | 243 | 11.245 | −1.721 | 66.421 | 0.00 | 0.00 | 6 |
| ATOM | 1830 | NH1 | ARG | A | 243 | 11.032 | −2.465 | 65.323 | 0.00 | 0.00 | 7 |
| ATOM | 1831 | NH2 | ARG | A | 243 | 12.271 | −0.839 | 66.433 | 0.00 | 0.00 | 7 |
| ATOM | 1832 | C | ARG | A | 243 | 6.724 | −1.868 | 70.783 | 0.00 | 0.00 | 6 |
| ATOM | 1833 | O | ARG | A | 243 | 7.244 | −2.893 | 71.279 | 0.00 | 0.00 | 8 |
| ATOM | 1834 | N | PHE | A | 244 | 5.421 | −1.770 | 70.487 | 0.00 | 0.00 | 7 |
| ATOM | 1835 | CA | PHE | A | 244 | 4.677 | −2.994 | 70.100 | 0.00 | 0.00 | 6 |
| ATOM | 1836 | CB | PHE | A | 244 | 5.193 | −4.155 | 70.896 | 0.00 | 0.00 | 6 |
| ATOM | 1837 | CG | PHE | A | 244 | 4.599 | −4.207 | 72.178 | 0.00 | 0.00 | 6 |
| ATOM | 1838 | CD1 | PHE | A | 244 | 3.535 | −5.045 | 72.401 | 0.00 | 0.00 | 6 |
| ATOM | 1839 | CE1 | PHE | A | 244 | 2.937 | −5.058 | 73.601 | 0.00 | 0.00 | 6 |
| ATOM | 1840 | CZ | PHE | A | 244 | 3.403 | −4.198 | 74.588 | 0.00 | 0.00 | 6 |
| ATOM | 1841 | CE2 | PHE | A | 244 | 4.471 | −3.334 | 74.327 | 0.00 | 0.00 | 6 |
| ATOM | 1842 | CD2 | PHE | A | 244 | 5.028 | −3.337 | 73.138 | 0.00 | 0.00 | 6 |
| ATOM | 1843 | C | PHE | A | 244 | 3.135 | −3.158 | 70.107 | 0.00 | 0.00 | 6 |
| ATOM | 1844 | O | PHE | A | 244 | 2.339 | −2.264 | 70.419 | 0.00 | 0.00 | 8 |
| ATOM | 1845 | N | ILE | A | 245 | 2.773 | −4.399 | 69.798 | 0.00 | 0.00 | 7 |
| ATOM | 1846 | CA | ILE | A | 245 | 1.466 | −4.755 | 69.339 | 0.00 | 0.00 | 6 |
| ATOM | 1847 | CB | ILE | A | 245 | 1.559 | −6.029 | 68.403 | 0.00 | 0.00 | 6 |
| ATOM | 1848 | CG1 | ILE | A | 245 | 2.887 | −6.118 | 67.623 | 0.00 | 0.00 | 6 |
| ATOM | 1849 | CD1 | ILE | A | 245 | 2.850 | −7.050 | 66.377 | 0.00 | 0.00 | 6 |
| ATOM | 1850 | CG2 | ILE | A | 245 | 0.418 | −6.082 | 67.430 | 0.00 | 0.00 | 6 |
| ATOM | 1851 | C | ILE | A | 245 | 0.644 | −5.017 | 70.605 | 0.00 | 0.00 | 6 |
| ATOM | 1852 | O | ILE | A | 245 | 1.259 | −5.297 | 71.636 | 0.00 | 0.00 | 8 |
| ATOM | 1853 | N | GLN | A | 246 | −0.708 | −4.912 | 70.525 | 0.00 | 0.00 | 7 |
| ATOM | 1854 | CA | GLN | A | 246 | −1.672 | −5.282 | 71.599 | 0.00 | 0.00 | 6 |
| ATOM | 1855 | CB | GLN | A | 246 | −1.237 | −4.617 | 72.888 | 0.00 | 0.00 | 6 |
| ATOM | 1856 | CG | GLN | A | 246 | −0.699 | −3.182 | 72.634 | 0.00 | 0.00 | 6 |
| ATOM | 1857 | CD | GLN | A | 246 | −1.236 | −2.123 | 73.575 | 0.00 | 0.00 | 6 |
| ATOM | 1858 | OE1 | GLN | A | 246 | −2.435 | −1.837 | 73.584 | 0.00 | 0.00 | 8 |
| ATOM | 1859 | NE2 | GLN | A | 246 | −0.339 | −1.506 | 74.355 | 0.00 | 0.00 | 7 |
| ATOM | 1860 | C | GLN | A | 246 | −3.010 | −4.675 | 71.388 | 0.00 | 0.00 | 6 |
| ATOM | 1861 | O | GLN | A | 246 | −3.052 | −3.492 | 71.255 | 0.00 | 0.00 | 8 |
| ATOM | 1862 | N | ILE | A | 247 | −4.096 | −5.430 | 71.341 | 0.00 | 0.00 | 7 |
| ATOM | 1863 | CA | ILE | A | 247 | −5.415 | −4.990 | 71.987 | 0.00 | 0.00 | 6 |
| ATOM | 1864 | CB | ILE | A | 247 | −6.529 | −4.001 | 71.223 | 0.00 | 0.00 | 6 |
| ATOM | 1865 | CG1 | ILE | A | 247 | −6.936 | −2.794 | 72.124 | 0.00 | 0.00 | 6 |
| ATOM | 1866 | CD1 | ILE | A | 247 | −7.498 | −1.546 | 71.417 | 0.00 | 0.00 | 6 |
| ATOM | 1867 | CG2 | ILE | A | 247 | −7.826 | −4.733 | 70.727 | 0.00 | 0.00 | 6 |
| ATOM | 1868 | C | ILE | A | 247 | −5.952 | −6.309 | 72.413 | 0.00 | 0.00 | 6 |
| ATOM | 1869 | O | ILE | A | 247 | −5.134 | −7.152 | 72.789 | 0.00 | 0.00 | 8 |
| ATOM | 1870 | N | HIS | A | 248 | −7.253 | −6.545 | 72.270 | 0.00 | 0.00 | 7 |
| ATOM | 1871 | CA | HIS | A | 248 | −7.891 | −7.495 | 73.151 | 0.00 | 0.00 | 6 |
| ATOM | 1872 | CB | HIS | A | 248 | −9.146 | −6.876 | 73.660 | 0.00 | 0.00 | 6 |
| ATOM | 1873 | CG | HIS | A | 248 | −8.868 | −5.637 | 74.435 | 0.00 | 0.00 | 6 |
| ATOM | 1874 | ND1 | HIS | A | 248 | −9.359 | −5.421 | 75.705 | 0.00 | 0.00 | 7 |
| ATOM | 1875 | CE1 | HIS | A | 248 | −8.912 | −4.261 | 76.153 | 0.00 | 0.00 | 6 |
| ATOM | 1876 | NE2 | HIS | A | 248 | −8.118 | −3.736 | 75.233 | 0.00 | 0.00 | 7 |
| ATOM | 1877 | CD2 | HIS | A | 248 | −8.068 | −4.581 | 74.153 | 0.00 | 0.00 | 6 |
| ATOM | 1878 | C | HIS | A | 248 | −8.014 | −8.941 | 72.737 | 0.00 | 0.00 | 6 |
| ATOM | 1879 | O | HIS | A | 248 | −8.574 | −9.271 | 71.724 | 0.00 | 0.00 | 8 |
| ATOM | 1880 | N | LEU | A | 249 | −7.429 | −9.794 | 73.561 | 0.00 | 0.00 | 7 |
| ATOM | 1881 | CA | LEU | A | 249 | −7.145 | −11.162 | 73.184 | 0.00 | 0.00 | 6 |
| ATOM | 1882 | CB | LEU | A | 249 | −5.628 | −11.561 | 73.475 | 0.00 | 0.00 | 6 |
| ATOM | 1883 | CG | LEU | A | 249 | −4.248 | −10.973 | 72.875 | 0.00 | 0.00 | 6 |
| ATOM | 1884 | CD1 | LEU | A | 249 | −2.968 | −11.268 | 73.707 | 0.00 | 0.00 | 6 |
| ATOM | 1885 | CD2 | LEU | A | 249 | −3.897 | −11.258 | 71.386 | 0.00 | 0.00 | 6 |
| ATOM | 1886 | C | LEU | A | 249 | −8.187 | −11.994 | 73.912 | 0.00 | 0.00 | 6 |
| ATOM | 1887 | O | LEU | A | 249 | −7.979 | −13.182 | 74.165 | 0.00 | 0.00 | 8 |
| ATOM | 1888 | N | GLU | A | 250 | −9.296 | −11.318 | 74.263 | 0.00 | 0.00 | 7 |
| ATOM | 1889 | CA | GLU | A | 250 | −10.588 | −11.936 | 74.735 | 0.00 | 0.00 | 6 |
| ATOM | 1890 | CB | GLU | A | 250 | −11.018 | −11.510 | 76.158 | 0.00 | 0.00 | 6 |
| ATOM | 1891 | CG | GLU | A | 250 | −11.617 | −10.119 | 76.282 | 0.00 | 0.00 | 6 |
| ATOM | 1892 | CD | GLU | A | 250 | −10.631 | −9.121 | 76.874 | 0.00 | 0.00 | 6 |
| ATOM | 1893 | OE1 | GLU | A | 250 | −9.396 | −9.263 | 76.692 | 0.00 | 0.00 | 8 |
| ATOM | 1894 | OE2 | GLU | A | 250 | −11.101 | −8.181 | 77.537 | 0.00 | 0.00 | 8 |
| ATOM | 1895 | C | GLU | A | 250 | −11.754 | −11.704 | 73.761 | 0.00 | 0.00 | 6 |
| ATOM | 1896 | O | GLU | A | 250 | −12.124 | −12.580 | 72.991 | 0.00 | 0.00 | 8 |
| ATOM | 1897 | N | MET | A | 251 | −12.354 | −10.539 | 73.776 | 0.00 | 0.00 | 7 |
| ATOM | 1898 | CA | MET | A | 251 | −13.257 | −10.328 | 72.709 | 0.00 | 0.00 | 6 |
| ATOM | 1899 | CB | MET | A | 251 | −14.707 | −10.381 | 73.200 | 0.00 | 0.00 | 6 |
| ATOM | 1900 | CG | MET | A | 251 | −15.805 | −10.074 | 72.096 | 0.00 | 0.00 | 6 |
| ATOM | 1901 | SD | MET | A | 251 | −17.373 | −11.065 | 71.929 | 0.00 | 0.00 | 16 |
| ATOM | 1902 | CE | MET | A | 251 | −16.772 | −12.452 | 70.922 | 0.00 | 0.00 | 6 |
| ATOM | 1903 | C | MET | A | 251 | −12.910 | −9.107 | 71.890 | 0.00 | 0.00 | 6 |
| ATOM | 1904 | O | MET | A | 251 | −13.030 | −9.155 | 70.662 | 0.00 | 0.00 | 8 |
| ATOM | 1905 | N | GLU | A | 252 | −12.448 | −8.036 | 72.552 | 0.00 | 0.00 | 7 |
| ATOM | 1906 | CA | GLU | A | 252 | −12.136 | −6.743 | 71.888 | 0.00 | 0.00 | 6 |
| ATOM | 1907 | CB | GLU | A | 252 | −11.952 | −5.608 | 72.898 | 0.00 | 0.00 | 6 |
| ATOM | 1908 | CG | GLU | A | 252 | −12.573 | −5.855 | 74.325 | 0.00 | 0.00 | 6 |
| ATOM | 1909 | CD | GLU | A | 252 | −14.125 | −6.081 | 74.412 | 0.00 | 0.00 | 6 |
| ATOM | 1910 | OE1 | GLU | A | 252 | −14.863 | −5.904 | 73.413 | 0.00 | 0.00 | 8 |
| ATOM | 1911 | OE2 | GLU | A | 252 | −14.620 | −6.434 | 75.517 | 0.00 | 0.00 | 8 |
| ATOM | 1912 | C | GLU | A | 252 | −10.921 | −6.988 | 71.026 | 0.00 | 0.00 | 6 |
| ATOM | 1913 | O | GLU | A | 252 | −10.088 | −6.106 | 70.750 | 0.00 | 0.00 | 8 |
| ATOM | 1914 | N | ASP | A | 253 | −10.881 | −8.295 | 70.729 | 0.00 | 0.00 | 7 |
| ATOM | 1915 | CA | ASP | A | 253 | −10.199 | −9.096 | 69.679 | 0.00 | 0.00 | 6 |
| ATOM | 1916 | CB | ASP | A | 253 | −10.353 | −10.588 | 70.080 | 0.00 | 0.00 | 6 |
| ATOM | 1917 | CG | ASP | A | 253 | −9.193 | −11.471 | 69.619 | 0.00 | 0.00 | 6 |
| ATOM | 1918 | OD1 | ASP | A | 253 | −9.411 | −12.338 | 68.738 | 0.00 | 0.00 | 8 |
| ATOM | 1919 | OD2 | ASP | A | 253 | −8.083 | −11.325 | 70.164 | 0.00 | 0.00 | 8 |
| ATOM | 1920 | C | ASP | A | 253 | −10.803 | −8.896 | 68.257 | 0.00 | 0.00 | 6 |
| ATOM | 1921 | O | ASP | A | 253 | −10.893 | −9.843 | 67.446 | 0.00 | 0.00 | 8 |
| ATOM | 1922 | N | SER | A | 254 | −11.240 | −7.658 | 68.011 | 0.00 | 0.00 | 7 |
| ATOM | 1923 | CA | SER | A | 254 | −11.627 | −7.048 | 66.707 | 0.00 | 0.00 | 6 |
| ATOM | 1924 | CB | SER | A | 254 | −11.626 | −7.988 | 65.458 | 0.00 | 0.00 | 6 |
| ATOM | 1925 | OG | SER | A | 254 | −12.716 | −8.891 | 65.420 | 0.00 | 0.00 | 8 |
| ATOM | 1926 | C | SER | A | 254 | −12.910 | −6.259 | 66.926 | 0.00 | 0.00 | 6 |
| ATOM | 1927 | O | SER | A | 254 | −13.129 | −5.234 | 66.267 | 0.00 | 0.00 | 8 |
| ATOM | 1928 | N | LEU | A | 255 | −13.688 | −6.689 | 67.925 | 0.00 | 0.00 | 7 |
| ATOM | 1929 | CA | LEU | A | 255 | −14.922 | −6.013 | 68.284 | 0.00 | 0.00 | 6 |
| ATOM | 1930 | CB | LEU | A | 255 | −15.477 | −6.478 | 69.650 | 0.00 | 0.00 | 6 |
| ATOM | 1931 | CG | LEU | A | 255 | −16.764 | −5.807 | 70.199 | 0.00 | 0.00 | 6 |
| ATOM | 1932 | CD1 | LEU | A | 255 | −17.953 | −6.096 | 69.298 | 0.00 | 0.00 | 6 |
| ATOM | 1933 | CD2 | LEU | A | 255 | −17.110 | −6.169 | 71.654 | 0.00 | 0.00 | 6 |
| ATOM | 1934 | C | LEU | A | 255 | −14.798 | −4.489 | 68.264 | 0.00 | 0.00 | 6 |
| ATOM | 1935 | O | LEU | A | 255 | −15.680 | −3.837 | 67.690 | 0.00 | 0.00 | 8 |
| ATOM | 1936 | N | PRO | A | 256 | −13.724 | −3.917 | 68.883 | 0.00 | 0.00 | 7 |
| ATOM | 1937 | CA | PRO | A | 256 | −13.766 | −2.452 | 69.152 | 0.00 | 0.00 | 6 |
| ATOM | 1938 | CB | PRO | A | 256 | −12.669 | −2.238 | 70.230 | 0.00 | 0.00 | 6 |
| ATOM | 1939 | CG | PRO | A | 256 | −12.086 | −3.618 | 70.532 | 0.00 | 0.00 | 6 |
| ATOM | 1940 | CD | PRO | A | 256 | −12.476 | −4.522 | 69.397 | 0.00 | 0.00 | 6 |
| ATOM | 1941 | C | PRO | A | 256 | −13.626 | −1.473 | 67.951 | 0.00 | 0.00 | 6 |
| ATOM | 1942 | O | PRO | A | 256 | −13.786 | −1.878 | 66.788 | 0.00 | 0.00 | 8 |
| ATOM | 1943 | N | LEU | A | 257 | −13.351 | −0.197 | 68.251 | 0.00 | 0.00 | 7 |
| ATOM | 1944 | CA | LEU | A | 257 | −13.450 | 0.884 | 67.268 | 0.00 | 0.00 | 6 |
| ATOM | 1945 | CB | LEU | A | 257 | −14.829 | 1.502 | 67.358 | 0.00 | 0.00 | 6 |
| ATOM | 1946 | CG | LEU | A | 257 | −15.697 | 0.808 | 68.416 | 0.00 | 0.00 | 6 |
| ATOM | 1947 | CD1 | LEU | A | 257 | −16.589 | 1.813 | 69.135 | 0.00 | 0.00 | 6 |
| ATOM | 1948 | CD2 | LEU | A | 257 | −16.511 | −0.384 | 67.902 | 0.00 | 0.00 | 6 |
| ATOM | 1949 | C | LEU | A | 257 | −12.378 | 1.940 | 67.506 | 0.00 | 0.00 | 6 |
| ATOM | 1950 | O | LEU | A | 257 | −12.041 | 2.257 | 68.658 | 0.00 | 0.00 | 8 |
| ATOM | 1951 | N | VAL | A | 258 | −11.892 | 2.511 | 66.408 | 0.00 | 0.00 | 7 |
| ATOM | 1952 | CA | VAL | A | 258 | −10.528 | 3.040 | 66.355 | 0.00 | 0.00 | 6 |
| ATOM | 1953 | CB | VAL | A | 258 | −10.064 | 3.295 | 64.921 | 0.00 | 0.00 | 6 |
| ATOM | 1954 | CG1 | VAL | A | 258 | −8.523 | 3.405 | 64.829 | 0.00 | 0.00 | 6 |
| ATOM | 1955 | CG2 | VAL | A | 258 | −10.508 | 2.165 | 64.092 | 0.00 | 0.00 | 6 |
| ATOM | 1956 | C | VAL | A | 258 | −10.243 | 4.246 | 67.223 | 0.00 | 0.00 | 6 |
| ATOM | 1957 | O | VAL | A | 258 | −9.084 | 4.620 | 67.398 | 0.00 | 0.00 | 8 |
| ATOM | 1958 | N | GLN | A | 259 | −11.272 | 4.855 | 67.780 | 0.00 | 0.00 | 7 |
| ATOM | 1959 | CA | GLN | A | 259 | −11.037 | 5.687 | 68.941 | 0.00 | 0.00 | 6 |
| ATOM | 1960 | CB | GLN | A | 259 | −12.322 | 5.791 | 69.743 | 0.00 | 0.00 | 6 |
| ATOM | 1961 | CG | GLN | A | 259 | −13.572 | 6.278 | 68.966 | 0.00 | 0.00 | 6 |
| ATOM | 1962 | CD | GLN | A | 259 | −14.932 | 6.123 | 69.787 | 0.00 | 0.00 | 6 |
| ATOM | 1963 | OE1 | GLN | A | 259 | −14.937 | 5.632 | 70.936 | 0.00 | 0.00 | 8 |
| ATOM | 1964 | NE2 | GLN | A | 259 | −16.072 | 6.529 | 69.173 | 0.00 | 0.00 | 7 |
| ATOM | 1965 | C | GLN | A | 259 | −9.947 | 5.034 | 69.831 | 0.00 | 0.00 | 6 |
| ATOM | 1966 | O | GLN | A | 259 | −8.894 | 5.636 | 70.098 | 0.00 | 0.00 | 8 |
| ATOM | 1967 | N | ALA | A | 260 | −10.252 | 3.808 | 70.281 | 0.00 | 0.00 | 7 |
| ATOM | 1968 | CA | ALA | A | 260 | −9.315 | 2.848 | 70.915 | 0.00 | 0.00 | 6 |
| ATOM | 1969 | CB | ALA | A | 260 | −9.917 | 1.461 | 70.851 | 0.00 | 0.00 | 6 |
| ATOM | 1970 | C | ALA | A | 260 | −7.877 | 2.816 | 70.367 | 0.00 | 0.00 | 6 |
| ATOM | 1971 | O | ALA | A | 260 | −7.119 | 1.826 | 70.528 | 0.00 | 0.00 | 8 |
| ATOM | 1972 | N | HIS | A | 261 | −7.554 | 3.903 | 69.675 | 0.00 | 0.00 | 7 |
| ATOM | 1973 | CA | HIS | A | 261 | −6.191 | 4.298 | 69.421 | 0.00 | 0.00 | 6 |
| ATOM | 1974 | CB | HIS | A | 261 | −6.107 | 5.492 | 68.452 | 0.00 | 0.00 | 6 |
| ATOM | 1975 | CG | HIS | A | 261 | −4.718 | 6.068 | 68.290 | 0.00 | 0.00 | 6 |
| ATOM | 1976 | ND1 | HIS | A | 261 | −4.417 | 7.014 | 67.335 | 0.00 | 0.00 | 7 |
| ATOM | 1977 | CE1 | HIS | A | 261 | −3.142 | 7.337 | 67.422 | 0.00 | 0.00 | 6 |
| ATOM | 1978 | NE2 | HIS | A | 261 | −2.593 | 6.619 | 68.381 | 0.00 | 0.00 | 7 |
| ATOM | 1979 | CD2 | HIS | A | 261 | −3.555 | 5.814 | 68.937 | 0.00 | 0.00 | 6 |
| ATOM | 1980 | C | HIS | A | 261 | −5.739 | 4.807 | 70.737 | 0.00 | 0.00 | 6 |
| ATOM | 1981 | O | HIS | A | 261 | −4.948 | 4.168 | 71.426 | 0.00 | 0.00 | 8 |
| ATOM | 1982 | N | MET | A | 262 | −6.266 | 5.976 | 71.087 | 0.00 | 0.00 | 7 |
| ATOM | 1983 | CA | MET | A | 262 | −5.690 | 6.742 | 72.178 | 0.00 | 0.00 | 6 |
| ATOM | 1984 | CB | MET | A | 262 | −6.573 | 7.962 | 72.577 | 0.00 | 0.00 | 6 |
| ATOM | 1985 | CG | MET | A | 262 | −7.506 | 7.854 | 73.821 | 0.00 | 0.00 | 6 |
| ATOM | 1986 | SD | MET | A | 262 | −9.274 | 7.530 | 73.575 | 0.00 | 0.00 | 16 |
| ATOM | 1987 | CE | MET | A | 262 | −9.266 | 5.758 | 73.299 | 0.00 | 0.00 | 6 |
| ATOM | 1988 | C | MET | A | 262 | −5.361 | 5.782 | 73.312 | 0.00 | 0.00 | 6 |
| ATOM | 1989 | O | MET | A | 262 | −4.449 | 6.025 | 74.088 | 0.00 | 0.00 | 8 |
| ATOM | 1990 | N | VAL | A | 263 | −6.076 | 4.657 | 73.313 | 0.00 | 0.00 | 7 |
| ATOM | 1991 | CA | VAL | A | 263 | −5.990 | 3.644 | 74.331 | 0.00 | 0.00 | 6 |
| ATOM | 1992 | CB | VAL | A | 263 | −7.085 | 2.624 | 74.120 | 0.00 | 0.00 | 6 |
| ATOM | 1993 | CG1 | VAL | A | 263 | −6.547 | 1.368 | 73.403 | 0.00 | 0.00 | 6 |
| ATOM | 1994 | CG2 | VAL | A | 263 | −7.749 | 2.324 | 75.466 | 0.00 | 0.00 | 6 |
| ATOM | 1995 | C | VAL | A | 263 | −4.613 | 3.020 | 74.326 | 0.00 | 0.00 | 6 |
| ATOM | 1996 | O | VAL | A | 263 | −3.917 | 3.008 | 75.321 | 0.00 | 0.00 | 8 |
| ATOM | 1997 | N | ALA | A | 264 | −4.204 | 2.514 | 73.188 | 0.00 | 0.00 | 7 |
| ATOM | 1998 | CA | ALA | A | 264 | −2.815 | 2.209 | 72.999 | 0.00 | 0.00 | 6 |
| ATOM | 1999 | CB | ALA | A | 264 | −2.625 | 1.745 | 71.588 | 0.00 | 0.00 | 6 |
| ATOM | 2000 | C | ALA | A | 264 | −1.987 | 3.475 | 73.297 | 0.00 | 0.00 | 6 |
| ATOM | 2001 | O | ALA | A | 264 | −1.108 | 3.472 | 74.130 | 0.00 | 0.00 | 8 |
| ATOM | 2002 | N | ASP | A | 265 | −2.331 | 4.569 | 72.636 | 0.00 | 0.00 | 7 |
| ATOM | 2003 | CA | ASP | A | 265 | −1.655 | 5.853 | 72.779 | 0.00 | 0.00 | 6 |
| ATOM | 2004 | CB | ASP | A | 265 | −2.336 | 6.895 | 71.863 | 0.00 | 0.00 | 6 |
| ATOM | 2005 | CG | ASP | A | 265 | −1.440 | 8.133 | 71.510 | 0.00 | 0.00 | 6 |
| ATOM | 2006 | OD1 | ASP | A | 265 | −1.651 | 8.691 | 70.386 | 0.00 | 0.00 | 8 |
| ATOM | 2007 | OD2 | ASP | A | 265 | −0.567 | 8.555 | 72.328 | 0.00 | 0.00 | 8 |
| ATOM | 2008 | C | ASP | A | 265 | −1.734 | 6.330 | 74.200 | 0.00 | 0.00 | 6 |
| ATOM | 2009 | O | ASP | A | 265 | −1.125 | 7.315 | 74.555 | 0.00 | 0.00 | 8 |
| ATOM | 2010 | N | GLN | A | 266 | −2.526 | 5.659 | 75.013 | 0.00 | 0.00 | 7 |
| ATOM | 2011 | CA | GLN | A | 266 | −2.529 | 5.957 | 76.436 | 0.00 | 0.00 | 6 |
| ATOM | 2012 | CB | GLN | A | 266 | −3.903 | 5.630 | 77.076 | 0.00 | 0.00 | 6 |
| ATOM | 2013 | CG | GLN | A | 266 | −5.032 | 6.766 | 77.007 | 0.00 | 0.00 | 6 |
| ATOM | 2014 | CD | GLN | A | 266 | −6.562 | 6.272 | 77.177 | 0.00 | 0.00 | 6 |
| ATOM | 2015 | OE1 | GLN | A | 266 | −6.875 | 5.071 | 77.378 | 0.00 | 0.00 | 8 |
| ATOM | 2016 | NE2 | GLN | A | 266 | −7.495 | 7.232 | 77.077 | 0.00 | 0.00 | 7 |
| ATOM | 2017 | C | GLN | A | 266 | −1.374 | 5.119 | 76.991 | 0.00 | 0.00 | 6 |
| ATOM | 2018 | O | GLN | A | 266 | −0.393 | 5.638 | 77.524 | 0.00 | 0.00 | 8 |
| ATOM | 2019 | N | VAL | A | 267 | −1.476 | 3.819 | 76.800 | 0.00 | 0.00 | 7 |
| ATOM | 2020 | CA | VAL | A | 267 | −0.374 | 2.951 | 77.052 | 0.00 | 0.00 | 6 |
| ATOM | 2021 | CB | VAL | A | 267 | −0.474 | 1.752 | 76.147 | 0.00 | 0.00 | 6 |
| ATOM | 2022 | CG1 | VAL | A | 267 | 0.791 | 0.899 | 76.243 | 0.00 | 0.00 | 6 |
| ATOM | 2023 | CG2 | VAL | A | 267 | −1.734 | 0.963 | 76.469 | 0.00 | 0.00 | 6 |
| ATOM | 2024 | C | VAL | A | 267 | 0.861 | 3.668 | 76.646 | 0.00 | 0.00 | 6 |
| ATOM | 2025 | O | VAL | A | 267 | 1.676 | 4.022 | 77.463 | 0.00 | 0.00 | 8 |
| ATOM | 2026 | N | GLU | A | 268 | 0.972 | 3.884 | 75.343 | 0.00 | 0.00 | 7 |
| ATOM | 2027 | CA | GLU | A | 268 | 2.167 | 4.478 | 74.756 | 0.00 | 0.00 | 6 |
| ATOM | 2028 | CB | GLU | A | 269 | 1.954 | 4.919 | 73.283 | 0.00 | 0.00 | 6 |
| ATOM | 2029 | CG | GLU | A | 268 | 1.583 | 3.783 | 72.271 | 0.00 | 0.00 | 6 |
| ATOM | 2030 | CD | GLU | A | 268 | 1.500 | 4.218 | 70.747 | 0.00 | 0.00 | 6 |
| ATOM | 2031 | OE1 | GLU | A | 268 | 1.371 | 5.439 | 70.434 | 0.00 | 0.00 | 8 |
| ATOM | 2032 | OE2 | GLU | A | 268 | 1.550 | 3.322 | 69.845 | 0.00 | 0.00 | 8 |
| ATOM | 2033 | C | GLU | A | 268 | 2.550 | 5.651 | 75.641 | 0.00 | 0.00 | 6 |
| ATOM | 2034 | O | GLU | A | 268 | 3.601 | 5.636 | 76.267 | 0.00 | 0.00 | 8 |
| ATOM | 2035 | N | GLN | A | 269 | 1.660 | 6.635 | 75.733 | 0.00 | 0.00 | 7 |
| ATOM | 2036 | CA | GLN | A | 269 | 1.861 | 7.773 | 76.603 | 0.00 | 0.00 | 6 |
| ATOM | 2037 | CB | GLN | A | 269 | 0.546 | 8.497 | 76.843 | 0.00 | 0.00 | 6 |
| ATOM | 2038 | CG | GLN | A | 269 | 0.617 | 9.646 | 77.882 | 0.00 | 0.00 | 6 |
| ATOM | 2039 | CD | GLN | A | 269 | 1.023 | 11.029 | 77.303 | 0.00 | 0.00 | 6 |
| ATOM | 2040 | OE1 | GLN | A | 269 | 1.308 | 11.153 | 76.099 | 0.00 | 0.00 | 8 |
| ATOM | 2041 | NE2 | GLN | A | 269 | 1.041 | 12.072 | 78.168 | 0.00 | 0.00 | 7 |
| ATOM | 2042 | C | GLN | A | 269 | 2.381 | 7.299 | 77.928 | 0.00 | 0.00 | 6 |
| ATOM | 2043 | O | GLN | A | 269 | 3.484 | 7.673 | 78.338 | 0.00 | 0.00 | 8 |
| ATOM | 2044 | N | ALA | A | 270 | 1.586 | 6.467 | 78.592 | 0.00 | 0.00 | 7 |
| ATOM | 2045 | CA | ALA | A | 270 | 1.918 | 6.059 | 79.954 | 0.00 | 0.00 | 6 |
| ATOM | 2046 | CB | ALA | A | 270 | 0.761 | 5.224 | 80.602 | 0.00 | 0.00 | 6 |
| ATOM | 2047 | C | ALA | A | 270 | 3.309 | 5.376 | 80.061 | 0.00 | 0.00 | 6 |
| ATOM | 2048 | O | ALA | A | 270 | 3.968 | 5.452 | 81.129 | 0.00 | 0.00 | 8 |
| ATOM | 2049 | N | ILE | A | 271 | 3.754 | 4.748 | 78.954 | 0.00 | 0.00 | 7 |
| ATOM | 2050 | CA | ILE | A | 271 | 5.175 | 4.455 | 78.800 | 0.00 | 0.00 | 6 |
| ATOM | 2051 | CB | ILE | A | 271 | 5.523 | 3.417 | 77.706 | 0.00 | 0.00 | 6 |
| ATOM | 2052 | CG1 | ILE | A | 271 | 4.349 | 2.507 | 77.382 | 0.00 | 0.00 | 6 |
| ATOM | 2053 | CD1 | ILE | A | 271 | 4.767 | 1.329 | 76.517 | 0.00 | 0.00 | 6 |
| ATOM | 2054 | CG2 | ILE | A | 271 | 6.713 | 2.566 | 78.133 | 0.00 | 0.00 | 6 |
| ATOM | 2055 | C | ILE | A | 271 | 5.867 | 5.822 | 78.603 | 0.00 | 0.00 | 6 |
| ATOM | 2056 | O | ILE | A | 271 | 6.637 | 6.084 | 77.669 | 0.00 | 0.00 | 8 |
| ATOM | 2057 | N | LEU | A | 272 | 5.505 | 6.725 | 79.505 | 0.00 | 0.00 | 7 |
| ATOM | 2058 | CA | LEU | A | 272 | 6.428 | 7.722 | 79.986 | 0.00 | 0.00 | 6 |
| ATOM | 2059 | CB | LEU | A | 272 | 5.788 | 8.511 | 81.144 | 0.00 | 0.00 | 6 |
| ATOM | 2060 | CG | LEU | A | 272 | 6.468 | 9.677 | 81.903 | 0.00 | 0.00 | 6 |
| ATOM | 2061 | CD1 | LEU | A | 272 | 5.608 | 9.955 | 83.143 | 0.00 | 0.00 | 6 |
| ATOM | 2062 | CD2 | LEU | A | 272 | 7.947 | 9.535 | 82.308 | 0.00 | 0.00 | 6 |
| ATOM | 2063 | C | LEU | A | 272 | 7.605 | 6.894 | 80.532 | 0.00 | 0.00 | 6 |
| ATOM | 2064 | O | LEU | A | 272 | 8.612 | 6.680 | 79.819 | 0.00 | 0.00 | 8 |
| ATOM | 2065 | N | ARG | A | 273 | 7.366 | 6.318 | 81.728 | 0.00 | 0.00 | 7 |
| ATOM | 2066 | CA | ARG | A | 273 | 8.349 | 6.086 | 82.782 | 0.00 | 0.00 | 6 |
| ATOM | 2067 | CB | ARG | A | 273 | 8.315 | 4.688 | 83.386 | 0.00 | 0.00 | 6 |
| ATOM | 2068 | CG | ARG | A | 273 | 8.799 | 4.706 | 84.835 | 0.00 | 0.00 | 6 |
| ATOM | 2069 | CD | ARG | A | 273 | 8.573 | 3.403 | 85.563 | 0.00 | 0.00 | 6 |
| ATOM | 2070 | NE | ARG | A | 273 | 7.140 | 3.134 | 85.710 | 0.00 | 0.00 | 7 |
| ATOM | 2071 | CZ | ARG | A | 273 | 6.596 | 2.102 | 86.366 | 0.00 | 0.00 | 6 |
| ATOM | 2072 | NH1 | ARG | A | 273 | 7.380 | 1.198 | 86.976 | 0.00 | 0.00 | 7 |
| ATOM | 2073 | NH2 | ARG | A | 273 | 5.251 | 1.983 | 86.410 | 0.00 | 0.00 | 7 |
| ATOM | 2074 | C | ARG | A | 273 | 9.733 | 6.525 | 82.427 | 0.00 | 0.00 | 6 |
| ATOM | 2075 | O | ARG | A | 273 | 10.368 | 7.154 | 83.239 | 0.00 | 0.00 | 8 |
| ATOM | 2076 | N | ARG | A | 274 | 10.197 | 6.230 | 81.219 | 0.00 | 0.00 | 7 |
| ATOM | 2077 | CA | ARG | A | 274 | 11.497 | 6.742 | 80.774 | 0.00 | 0.00 | 6 |
| ATOM | 2078 | CB | ARG | A | 274 | 12.143 | 5.855 | 79.697 | 0.00 | 0.00 | 6 |
| ATOM | 2079 | CG | ARG | A | 274 | 13.217 | 4.812 | 80.221 | 0.00 | 0.00 | 6 |
| ATOM | 2080 | CD | ARG | A | 274 | 12.764 | 3.307 | 80.063 | 0.00 | 0.00 | 6 |
| ATOM | 2081 | NE | ARG | A | 274 | 12.032 | 2.740 | 81.205 | 0.00 | 0.00 | 7 |
| ATOM | 2082 | CZ | ARG | A | 274 | 10.731 | 2.918 | 81.467 | 0.00 | 0.00 | 6 |
| ATOM | 2083 | NH1 | ARG | A | 274 | 9.946 | 3.664 | 80.693 | 0.00 | 0.00 | 7 |
| ATOM | 2084 | NH2 | ARG | A | 274 | 10.195 | 2.344 | 82.535 | 0.00 | 0.00 | 7 |
| ATOM | 2085 | C | ARG | A | 274 | 11.453 | 8.174 | 80.297 | 0.00 | 0.00 | 6 |
| ATOM | 2086 | O | ARG | A | 274 | 10.399 | 8.781 | 80.118 | 0.00 | 0.00 | 8 |
| ATOM | 2087 | N | PHE | A | 275 | 12.631 | 8.702 | 80.061 | 0.00 | 0.00 | 7 |
| ATOM | 2088 | CA | PHE | A | 275 | 12.733 | 10.115 | 79.871 | 0.00 | 0.00 | 6 |
| ATOM | 2089 | CB | PHE | A | 275 | 13.684 | 10.756 | 80.951 | 0.00 | 0.00 | 6 |
| ATOM | 2090 | CG | PHE | A | 275 | 15.133 | 10.097 | 81.095 | 0.00 | 0.00 | 6 |
| ATOM | 2091 | CD1 | PHE | A | 275 | 15.839 | 9.498 | 79.975 | 0.00 | 0.00 | 6 |
| ATOM | 2092 | CE1 | PHE | A | 275 | 17.193 | 8.918 | 80.151 | 0.00 | 0.00 | 6 |
| ATOM | 2093 | CZ | PHE | A | 275 | 17.836 | 8.962 | 81.444 | 0.00 | 0.00 | 6 |
| ATOM | 2094 | CE2 | PHE | A | 275 | 17.159 | 9.571 | 82.550 | 0.00 | 0.00 | 6 |
| ATOM | 2095 | CD2 | PHE | A | 275 | 15.825 | 10.144 | 82.370 | 0.00 | 0.00 | 6 |
| ATOM | 2096 | C | PHE | A | 275 | 12.985 | 10.641 | 78.415 | 0.00 | 0.00 | 6 |
| ATOM | 2097 | O | PHE | A | 275 | 13.644 | 11.685 | 78.253 | 0.00 | 0.00 | 8 |
| ATOM | 2098 | N | PRO | A | 276 | 12.445 | 9.973 | 77.343 | 0.00 | 0.00 | 7 |
| ATOM | 2099 | CA | PRO | A | 276 | 11.693 | 8.718 | 77.089 | 0.00 | 0.00 | 6 |
| ATOM | 2100 | CB | PRO | A | 276 | 10.511 | 9.249 | 76.260 | 0.00 | 0.00 | 6 |
| ATOM | 2101 | CG | PRO | A | 276 | 11.238 | 10.379 | 75.296 | 0.00 | 0.00 | 6 |
| ATOM | 2102 | CD | PRO | A | 276 | 12.531 | 10.759 | 76.072 | 0.00 | 0.00 | 6 |
| ATOM | 2103 | C | PRO | A | 276 | 12.408 | 7.658 | 76.196 | 0.00 | 0.00 | 6 |
| ATOM | 2104 | O | PRO | A | 276 | 13.656 | 7.589 | 76.107 | 0.00 | 0.00 | 8 |
| ATOM | 2105 | N | GLY | A | 277 | 11.573 | 6.843 | 75.554 | 0.00 | 0.00 | 7 |
| ATOM | 2106 | CA | GLY | A | 277 | 11.932 | 6.144 | 74.340 | 0.00 | 0.00 | 6 |
| ATOM | 2107 | C | GLY | A | 277 | 11.462 | 7.074 | 73.259 | 0.00 | 0.00 | 6 |
| ATOM | 2108 | O | GLY | A | 277 | 11.639 | 8.293 | 73.399 | 0.00 | 0.00 | 8 |
| ATOM | 2109 | N | SER | A | 278 | 10.852 | 6.515 | 72.201 | 0.00 | 0.00 | 7 |
| ATOM | 2110 | CA | SER | A | 278 | 10.246 | 7.333 | 71.098 | 0.00 | 0.00 | 6 |
| ATOM | 2111 | CB | SER | A | 278 | 10.289 | 6.590 | 69.727 | 0.00 | 0.00 | 6 |
| ATOM | 2112 | OG | SER | A | 278 | 11.124 | 5.422 | 69.747 | 0.00 | 0.00 | 8 |
| ATOM | 2113 | C | SER | A | 278 | 8.809 | 7.825 | 71.554 | 0.00 | 0.00 | 6 |
| ATOM | 2114 | O | SER | A | 278 | 8.717 | 8.494 | 72.603 | 0.00 | 0.00 | 8 |
| ATOM | 2115 | N | ASP | A | 279 | 7.733 | 7.573 | 70.763 | 0.00 | 0.00 | 7 |
| ATOM | 2116 | CA | ASP | A | 279 | 6.320 | 7.220 | 71.263 | 0.00 | 0.00 | 6 |
| ATOM | 2117 | CB | ASP | A | 279 | 5.125 | 8.074 | 70.631 | 0.00 | 0.00 | 6 |
| ATOM | 2118 | CG | ASP | A | 279 | 3.730 | 8.052 | 71.491 | 0.00 | 0.00 | 6 |
| ATOM | 2119 | OD1 | ASP | A | 279 | 3.627 | 7.528 | 72.660 | 0.00 | 0.00 | 8 |
| ATOM | 2120 | OD2 | ASP | A | 279 | 2.723 | 8.600 | 70.944 | 0.00 | 0.00 | 8 |
| ATOM | 2121 | C | ASP | A | 279 | 6.332 | 5.740 | 70.831 | 0.00 | 0.00 | 6 |
| ATOM | 2122 | O | ASP | A | 279 | 5.641 | 5.297 | 69.865 | 0.00 | 0.00 | 8 |
| ATOM | 2123 | N | VAL | A | 280 | 7.237 | 5.027 | 71.501 | 0.00 | 0.00 | 7 |
| ATOM | 2124 | CA | VAL | A | 280 | 7.795 | 3.839 | 70.930 | 0.00 | 0.00 | 6 |
| ATOM | 2125 | CB | VAL | A | 280 | 8.924 | 3.326 | 71.806 | 0.00 | 0.00 | 6 |
| ATOM | 2126 | CG1 | VAL | A | 280 | 10.260 | 3.737 | 71.244 | 0.00 | 0.00 | 6 |
| ATOM | 2127 | CG2 | VAL | A | 280 | 8.764 | 3.907 | 73.159 | 0.00 | 0.00 | 6 |
| ATOM | 2128 | C | VAL | A | 280 | 6.498 | 3.069 | 70.818 | 0.00 | 0.00 | 6 |
| ATOM | 2129 | O | VAL | A | 280 | 5.706 | 3.061 | 71.786 | 0.00 | 0.00 | 8 |
| ATOM | 2130 | N | ILE | A | 281 | 6.283 | 2.551 | 69.594 | 0.00 | 0.00 | 7 |
| ATOM | 2131 | CA | ILE | A | 281 | 4.981 | 2.483 | 68.869 | 0.00 | 0.00 | 6 |
| ATOM | 2132 | CB | ILE | A | 281 | 5.202 | 2.240 | 67.371 | 0.00 | 0.00 | 6 |
| ATOM | 2133 | CG1 | ILE | A | 281 | 6.565 | 2.733 | 66.885 | 0.00 | 0.00 | 6 |
| ATOM | 2134 | CD1 | ILE | A | 281 | 7.619 | 1.571 | 66.806 | 0.00 | 0.00 | 6 |
| ATOM | 2135 | CG2 | ILE | A | 281 | 3.968 | 2.555 | 66.543 | 0.00 | 0.00 | 6 |
| ATOM | 2136 | C | ILE | A | 281 | 4.126 | 1.288 | 69.132 | 0.00 | 0.00 | 6 |
| ATOM | 2137 | O | ILE | A | 281 | 4.622 | 0.165 | 69.037 | 0.00 | 0.00 | 8 |
| ATOM | 2138 | N | ILE | A | 282 | 2.834 | 1.498 | 69.357 | 0.00 | 0.00 | 7 |
| ATOM | 2139 | CA | ILE | A | 282 | 1.972 | 0.359 | 69.486 | 0.00 | 0.00 | 6 |
| ATOM | 2140 | CB | ILE | A | 282 | 0.949 | 0.463 | 70.606 | 0.00 | 0.00 | 6 |
| ATOM | 2141 | CG1 | ILE | A | 282 | 1.397 | −0.243 | 71.868 | 0.00 | 0.00 | 6 |
| ATOM | 2142 | CD1 | ILE | A | 282 | 2.722 | 0.079 | 72.349 | 0.00 | 0.00 | 6 |
| ATOM | 2143 | CG2 | ILE | A | 282 | −0.199 | −0.391 | 70.309 | 0.00 | 0.00 | 6 |
| ATOM | 2144 | C | ILE | A | 282 | 1.291 | 0.190 | 68.176 | 0.00 | 0.00 | 6 |
| ATOM | 2145 | O | ILE | A | 282 | 0.953 | 1.176 | 67.515 | 0.00 | 0.00 | 8 |
| ATOM | 2146 | N | HIS | A | 283 | 1.169 | −1.086 | 67.805 | 0.00 | 0.00 | 7 |
| ATOM | 2147 | CA | HIS | A | 283 | 0.378 | −1.594 | 66.711 | 0.00 | 0.00 | 6 |
| ATOM | 2148 | CB | HIS | A | 283 | 1.143 | −2.694 | 66.027 | 0.00 | 0.00 | 6 |
| ATOM | 2149 | CG | HIS | A | 283 | 0.290 | −3.630 | 65.239 | 0.00 | 0.00 | 6 |
| ATOM | 2150 | ND1 | HIS | A | 283 | −0.815 | −3.219 | 64.529 | 0.00 | 0.00 | 7 |
| ATOM | 2151 | CE1 | HIS | A | 283 | −1.356 | −4.260 | 63.912 | 0.00 | 0.00 | 6 |
| ATOM | 2152 | NE2 | HIS | A | 283 | −0.631 | −5.331 | 64.185 | 0.00 | 0.00 | 7 |
| ATOM | 2153 | CD2 | HIS | A | 283 | 0.409 | −4.961 | 65.007 | 0.00 | 0.00 | 6 |
| ATOM | 2154 | C | HIS | A | 283 | −0.639 | −2.239 | 67.520 | 0.00 | 0.00 | 6 |
| ATOM | 2155 | O | HIS | A | 283 | −0.290 | −2.972 | 68.417 | 0.00 | 0.00 | 8 |
| ATOM | 2156 | N | GLN | A | 284 | −1.895 | −1.947 | 67.248 | 0.00 | 0.00 | 7 |
| ATOM | 2157 | CA | GLN | A | 284 | −2.968 | −2.363 | 68.136 | 0.00 | 0.00 | 6 |
| ATOM | 2158 | CB | GLN | A | 284 | −3.983 | −1.264 | 68.342 | 0.00 | 0.00 | 6 |
| ATOM | 2159 | CG | GLN | A | 284 | −4.225 | −0.457 | 67.118 | 0.00 | 0.00 | 6 |
| ATOM | 2160 | CD | GLN | A | 284 | −3.300 | 0.711 | 67.101 | 0.00 | 0.00 | 6 |
| ATOM | 2161 | OE1 | GLN | A | 284 | −2.305 | 0.741 | 66.338 | 0.00 | 0.00 | 8 |
| ATOM | 2162 | NE2 | GLN | A | 284 | −3.562 | 1.668 | 68.008 | 0.00 | 0.00 | 7 |
| ATOM | 2163 | C | GLN | A | 284 | −3.672 | −3.484 | 67.517 | 0.00 | 0.00 | 6 |
| ATOM | 2164 | O | GLN | A | 284 | −4.548 | −3.265 | 66.688 | 0.00 | 0.00 | 8 |
| ATOM | 2165 | N | ASP | A | 285 | −3.297 | −4.687 | 67.939 | 0.00 | 0.00 | 7 |
| ATOM | 2166 | CA | ASP | A | 285 | −3.806 | −5.940 | 67.324 | 0.00 | 0.00 | 6 |
| ATOM | 2167 | CB | ASP | A | 285 | −2.709 | −7.053 | 67.208 | 0.00 | 0.00 | 6 |
| ATOM | 2168 | CG | ASP | A | 285 | −1.998 | −7.068 | 65.870 | 0.00 | 0.00 | 6 |
| ATOM | 2169 | OD1 | ASP | A | 285 | −2.483 | −6.472 | 64.908 | 0.00 | 0.00 | 8 |
| ATOM | 2170 | OD2 | ASP | A | 285 | −0.938 | −7.689 | 65.769 | 0.00 | 0.00 | 8 |
| ATOM | 2171 | C | ASP | A | 285 | −5.133 | −6.483 | 67.981 | 0.00 | 0.00 | 6 |
| ATOM | 2172 | O | ASP | A | 285 | −5.197 | −6.739 | 69.203 | 0.00 | 0.00 | 8 |
| ATOM | 2173 | N | PRO | A | 286 | −6.182 | −6.665 | 67.156 | 0.00 | 0.00 | 7 |
| ATOM | 2174 | CA | PRO | A | 286 | −7.417 | −7.206 | 67.571 | 0.00 | 0.00 | 6 |
| ATOM | 2175 | CB | PRO | A | 286 | −8.274 | −6.967 | 66.352 | 0.00 | 0.00 | 6 |
| ATOM | 2176 | CG | PRO | A | 286 | −7.361 | −7.119 | 65.239 | 0.00 | 0.00 | 6 |
| ATOM | 2177 | CD | PRO | A | 286 | −6.198 | −6.375 | 65.714 | 0.00 | 0.00 | 6 |
| ATOM | 2178 | C | PRO | A | 286 | −7.248 | −8.690 | 67.751 | 0.00 | 0.00 | 6 |
| ATOM | 2179 | O | PRO | A | 286 | −7.104 | −9.133 | 68.883 | 0.00 | 0.00 | 8 |
| ATOM | 2180 | N | CYS | A | 287 | −7.186 | −9.419 | 66.620 | 0.00 | 0.00 | 7 |
| ATOM | 2181 | CA | CYS | A | 287 | −7.522 | −10.883 | 66.524 | 0.00 | 0.00 | 6 |
| ATOM | 2182 | CB | CYS | A | 287 | −8.606 | −11.188 | 65.476 | 0.00 | 0.00 | 6 |
| ATOM | 2183 | SG | CYS | A | 287 | −9.524 | −12.697 | 65.882 | 0.00 | 0.00 | 16 |
| ATOM | 2184 | C | CYS | A | 287 | −6.450 | −12.000 | 66.521 | 0.00 | 0.00 | 6 |
| ATOM | 2185 | O | CYS | A | 287 | −5.588 | −12.157 | 65.621 | 0.00 | 0.00 | 8 |
| ATOM | 2186 | N | SER | A | 288 | −6.716 | −12.854 | 67.502 | 0.00 | 0.00 | 7 |
| ATOM | 2187 | CA | SER | A | 288 | −5.738 | −13.484 | 68.364 | 0.00 | 0.00 | 6 |
| ATOM | 2188 | CB | SER | A | 288 | −6.424 | −14.001 | 69.658 | 0.00 | 0.00 | 6 |
| ATOM | 2189 | OG | SER | A | 288 | −7.786 | −14.383 | 69.462 | 0.00 | 0.00 | 8 |
| ATOM | 2190 | C | SER | A | 288 | −4.884 | −14.572 | 67.750 | 0.00 | 0.00 | 6 |
| ATOM | 2191 | O | SER | A | 288 | −5.385 | −15.519 | 67.123 | 0.00 | 0.00 | 8 |
| ATOM | 2192 | N | VAL | A | 289 | −3.578 | −14.403 | 67.933 | 0.00 | 0.00 | 7 |
| ATOM | 2193 | CA | VAL | A | 289 | −2.663 | −15.526 | 67.975 | 0.00 | 0.00 | 6 |
| ATOM | 2194 | CB | VAL | A | 289 | −1.162 | −15.034 | 67.987 | 0.00 | 0.00 | 6 |
| ATOM | 2195 | CG1 | VAL | A | 289 | −0.222 | −16.178 | 67.685 | 0.00 | 0.00 | 6 |
| ATOM | 2196 | CG2 | VAL | A | 289 | −0.905 | −13.845 | 66.996 | 0.00 | 0.00 | 6 |
| ATOM | 2197 | C | VAL | A | 289 | −3.095 | −16.155 | 69.315 | 0.00 | 0.00 | 6 |
| ATOM | 2198 | O | VAL | A | 289 | −3.199 | −15.429 | 70.318 | 0.00 | 0.00 | 8 |
| ATOM | 2199 | N | VAL | A | 290 | −3.423 | −17.453 | 69.346 | 0.00 | 0.00 | 7 |
| ATOM | 2200 | CA | VAL | A | 290 | −3.993 | −18.039 | 70.595 | 0.00 | 0.00 | 6 |
| ATOM | 2201 | CB | VAL | A | 290 | −5.591 | −17.939 | 70.632 | 0.00 | 0.00 | 6 |
| ATOM | 2202 | CG1 | VAL | A | 290 | −6.279 | −19.215 | 70.092 | 0.00 | 0.00 | 6 |
| ATOM | 2203 | CG2 | VAL | A | 290 | −6.112 | −17.579 | 72.044 | 0.00 | 0.00 | 6 |
| ATOM | 2204 | C | VAL | A | 290 | −3.472 | −19.448 | 70.975 | 0.00 | 0.00 | 6 |
| ATOM | 2205 | O | VAL | A | 290 | −2.981 | −19.684 | 72.098 | 0.00 | 0.00 | 8 |
| ATOM | 2206 | ZN | HET | C | 12 | −1.140 | 7.727 | 67.301 | 0.00 | 0.00 | 30 |
| ATOM | 2207 | ZN | HET | C | 13 | 21.502 | −12.566 | 70.326 | 0.00 | 0.00 | 30 |
| ATOM | 2208 | ZN | HET | C | 16 | 0.777 | 9.471 | 64.534 | 0.00 | 0.00 | 30 |
| ATOM | 2209 | ZN | HET | C | 17 | 46.373 | 11.138 | 78.740 | 0.00 | 0.00 | 30 |
| END | | | | | | | | | | | |

1. A method of identifying a compound that has a sufficient level of binding with a target site on a mammalian zinc transporter comprising:
(a) providing a homology model of a mammalian zinc transporter, or portion thereof, comprising at least one target site;
(b) computationally providing a candidate compound; and
(c) computationally evaluating the level of binding of the candidate compound with a target site,
wherein if a sufficient level of binding is found, then the compound is identified.

2. The method of claim 1, wherein the homology model of a mammalian zinc transporter is based upon a three-dimensional structure of YiiP, said three-dimensional structure defined by structure coordinates within Appendix I.

3. The method of claim 2, wherein the three-dimensional structure of YiiP has a root mean square deviation of backbone atoms of less than about 0.75 Angstroms when superimposed on the structure coordinates within Appendix I.

4. The method of claim 1, wherein the target site comprises Zn²⁺ binding sites.

5. The method of claim 4 wherein Zn²⁺ binding sites are Site Z1, Site Z2, Site Z3, Site Z4 or combinations thereof.

6. The method of claim 1, wherein a sufficient level of binding is indicated by a dissociation constant of about 10⁻² M or less.

7. The method of claim 1, wherein the homology model is of mammalian zinc transporter-3 or of mammalian zinc transporter-8.

8. The method of claim 1, wherein a candidate compound is computationally provided by a method selected from the group consisting of (1) assembling molecular fragments into a candidate compound, (2) designing a candidate compound de novo, (3) modifying a compound known to bind with a target site to form a candidate compound, and (4) screening a database for a candidate compound.

9. The method of claim 1, further comprising synthesizing the compound.

10. The method of claim 9, further comprising screening the synthesized compound for biological activity.

11. A method of forming crystals of YiiP comprising:
contacting a YiiP protein with an aqueous solution comprising zinc salt; at least one type of polyethylene; and at least one type of detergent, wherein at least one detergent belongs to the maltoside family; and
allowing crystals to grow.

12. The method of claim 11 wherein the detergent is selected from the group consisting of dodecyl-maltoside, undecyl-maltoside, decyl-maltoside, nonyl-b-D-maltoside, and combinations thereof.

13. The method of claim 11 wherein the polyethylene is selected from the group consisting of polyethylene glycols with molecular weights ranging from about 250 to about 5000 KDa.

14. The method of claim 11 wherein the aqueous solution further comprises a detergent selected from the group consisting of phospholipid analogues.

15. The method of claim 14 wherein the aqueous solution further comprises additional salts.

16. The method of claim 15 wherein the ratio of salts:detergent:polyethylene ranges from about 20:0.1:1 to about 135:2:50.

17. A plurality of crystals of YiiP produced by a method comprising:
contacting a YiiP protein with an aqueous solution comprising zinc salt; at least one type of polyethylene; and at least one type of detergent, wherein at least one detergent belongs to the maltoside family; and
allowing YiiP crystals to grow.

18. The crystals of claim 17 wherein the detergent is selected from the group consisting of dodecyl-malto side, undecyl-maltoside, decyl-malto side, nonyl-b-D-maltoside, and combinations thereof.

19. The crystals of claim 17 wherein the polyethylene is selected from the group consisting of polyethylene glycols with molecular weights ranging from about 250 to about 5000 KDa.

20. The crystals of claim 17 wherein the aqueous solution further comprises a detergent selected from the group consisting of phospholipid analogues.

21. The crystals of claim 20 wherein the aqueous solution further comprises additional salts.

22. The crystals of claim 21 wherein the ratio of salts:detergent:polyethylene ranges from about 20:0.1:1 to about 135:2:50.

23. A homology model of a mammalian zinc transporter, or a portion thereof, based upon a three-dimensional structure of YiiP, said three-dimensional structure defined by structure coordinates within Appendix I, or defined by structures coordinates having a 0.75 Angstrom root mean square deviation from the structure coordinates within Appendix I.

24. The homology model of claim 23, wherein the homology model is of mammalian zinc transporter or of mammalian zinc transporter-8.

25. A method for evaluating the ability of a candidate compound to bind with a mammalian zinc transporter comprising at least one target site, said method comprising:
a) constructing a computer model of a target site defined by a mammalian homology model based upon structure coordinates in Appendix I, or based upon structures coordinates having a 0.75 Angstrom root mean square deviation from the structure coordinates in Appendix I;
b) selecting a candidate compound to be evaluated by a method selected from the group consisting of (i) assembling molecular fragments into the candidate compound, (ii) selecting the candidate compound from a small molecule database, (iii) designing the candidate compound de novo, and (iv) modifying a ligand known to bind to a target site, or a portion thereof, to form the candidate compound;
c) employing computational means to perform a fitting program operation between computer models of the candidate compound to be evaluated and the target site in order to provide an energy-minimized configuration of the candidate compound in the target site; and
d) evaluating the results of said fitting operation to quantify the association between the candidate compound and the target site.
